(19) United States
(12) Patent Application Publication
(10) Pub. No.: US 2015/0044653 A1
(43) Pub. Date: Feb. 12, 2015

(54) SYSTEMS AND METHODS OF TRAINING AND TESTING MEDICAL PROCEDURES ON MOBILE DEVICES

(71) Applicant: ArchieMD, Inc., Boca Raton, FL (US)

(72) Inventors: Robert J. Levine, Boca Raton, FL (US); Kirk J. Macolini, Ithaca, NY (US); Jeffrey D. Kelsey, Pompano Beach, FL (US)

(73) Assignee: ArchieMD, Inc., Boca Raton, FL (US)

(21) Appl. No.: 14/273,448

(22) Filed: May 8, 2014

Related U.S. Application Data
(60) Provisional application No. 61/862,934, filed on Aug. 6, 2013.
(60) Provisional application No. 61/863,387, filed on Aug. 7, 2013.
(60) Provisional application No. 61/864,497, filed on Aug. 9, 2013.

(51) Int. Cl. G09B 7/08; G09B 23/28

(52) U.S. Cl. CPC G09B 7/08; G09B 23/28; G09B 23/288
USPC 434/262

(57) ABSTRACT

Systems, methods, and devices for providing interactive medical procedure testing are provided. One method includes providing a medical training and/or testing prompt on the device indicating equipment and/or procedures for one or more of: administering oxygen to a patient, performing cardiopulmonary resuscitation (CPR), performing airway management, managing shock, managing spinal cord injury, managing fracture, and performing triage. The method further includes receiving a medical training and/or testing interaction in response to the medical training and/or testing prompt. The method further includes evaluating the medical training and/or testing interaction. The method further includes adjusting a characteristic of the device based on said evaluating.

### CROSS-REFERENCE TO RELATED APPLICATIONS

This application claims the benefit of U.S. Provisional Application No. 61/862,934, filed Aug. 6, 2013; U.S. Provisional Application No. 61/863,387, filed Aug. 7, 2013; and U.S. Provisional Application No. 61/864,497, filed Aug. 9, 2013 the entirety of each of which is incorporated herein by reference.

### FIELD

The present application relates generally to medical training and testing, and more specifically to systems, methods, and devices for training and testing medical procedures on mobile devices.

### BACKGROUND

Training for medical procedures is often provided in a live class setting. Live training can often be expensive, however, due to the presence of an instructor. Moreover, live training can be inefficient when members of the class learn at different rates. Live training can also be difficult to schedule, and missed classes can be hard to make up.

Medical training can also be provided via passive media such as simple video, audio, or text. Such approaches can be ineffective, particularly because it can be hard to assess how much has been learned. Assessment of progress can be particularly difficult with respect to hands-on medical techniques.

Similarly, interactive online training fails to provide active practice and assessment. Online training is typically academic, with any interaction being performed through awkward interfaces such as keyboards or mice. Accordingly, interaction in conventional online medical training is often limited. Thus, improved techniques for providing greater interaction in mobile medical training and testing are desired.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include improved interactive medical training and testing.

One innovative aspect of the present disclosure provides a method of providing interactive medical procedure testing on a mobile touchscreen device. The method includes providing a medical training and/or testing prompt on the device indicating equipment and/or procedures for one or more of: administering oxygen to a patient, performing cardiopulmonary resuscitation (CPR), performing airway management, managing shock, managing spinal cord injury, managing fracture, and performing triage. The method further includes receiving a medical training and/or testing interaction in response to the medical training and/or testing prompt. The method further includes evaluating the medical training and/or testing interaction. The method further includes adjusting a characteristic of the device based on said evaluating.

Another aspect provides a mobile touchscreen device configured to provide interactive medical procedure testing. The device includes a display, processor and memory configured to provide a medical training and/or testing prompt indicating equipment and/or procedures for one or more of: administering oxygen to a patient, performing cardiopulmonary resuscitation (CPR), performing airway management, managing shock, managing spinal cord injury, managing fracture, and performing triage. The device further includes an input configured to receive a medical training and/or testing interaction in response to the medical training and/or testing prompt. The display, processor, and memory are configured to evaluate the medical training and/or testing interaction, and adjust a characteristic of the device based on said evaluating.

Another aspect provides a mobile touchscreen device for providing interactive medical procedure testing. The device includes means for providing a medical training and/or testing prompt indicating equipment and/or procedures for one or more of: administering oxygen to a patient, performing cardiopulmonary resuscitation (CPR), performing airway management, managing shock, managing spinal cord injury, managing fracture, and performing triage. The device further includes means for receiving a medical training and/or testing interaction in response to the medical training and/or testing prompt. The device further includes means for evaluating the medical training and/or testing interaction. The device further includes means for adjusting a characteristic of the device based on said evaluating.

Another aspect provides a non-transitory computer-readable medium. The medium includes code that, when executed, causes an apparatus to provide a medical training and/or testing prompt indicating equipment and/or procedures for one or more of: administering oxygen to a patient, performing cardiopulmonary resuscitation (CPR), performing airway management, managing shock, managing spinal cord injury, managing fracture, and performing triage. The medium further includes code that, when executed, causes the apparatus to receive a medical training and/or testing interaction in response to the medical training and/or testing prompt. The medium further includes code that, when executed, causes the apparatus to evaluate the medical training and/or testing interaction. The medium further includes code that, when executed, causes the apparatus to adjust a characteristic of the device based on said evaluating.

Another aspect of the disclosure provides a method of providing interactive medical procedure testing on a mobile touchscreen device. The method includes providing a medical training and/or testing prompt on the device indicating equipment and/or procedures for administering cardiopulmonary resuscitation (CPR) to a patient. The method further includes receiving a medical training and/or testing interaction in response to the medical training and/or testing prompt. The method further includes evaluating the medical training and/or testing interaction. The method further includes adjusting a characteristic of the device based on said evaluating.

Another aspect provides a mobile touchscreen device configured to provide interactive medical procedure testing. The device includes a display, processor, and memory are configured to provide a medical training and/or testing prompt indicating equipment and/or procedures for administering cardiopulmonary resuscitation (CPR) to a patient. The device further includes an input configured to receive a medical training and/or testing interaction in response to the medical training and/or testing prompt. The display, processor, and memory are further configured to evaluate the medical training and/or testing interaction and to adjust a characteristic of the device based on said evaluating.

Another aspect provides mobile touchscreen device for providing interactive medical procedure testing. The device includes means for providing a medical training and/or testing prompt indicating equipment and/or procedures for administering cardiopulmonary resuscitation (CPR) to a patient. The device further includes means for receiving a medical training and/or testing interaction in response to the medical training and/or testing prompt. The device further includes means for evaluating the medical training and/or testing interaction. The device further includes means for adjusting a characteristic of the device based on said evaluating. Another aspect provides a non-transitory computer-readable medium. The medium includes code that, when executed, causes a mobile touchscreen device to provide a medical training and/or testing prompt indicating equipment and/or procedures for administering cardiopulmonary resuscitation (CPR) to a patient. The medium further includes code that, when executed, causes the mobile touchscreen device to receive a medical training and/or testing interaction in response to the medical training and/or testing prompt. The medium further includes code that, when executed, causes the mobile touchscreen device to evaluate the medical training and/or testing interaction. The medium further includes code that, when executed, causes the mobile touchscreen device to adjust a characteristic of the device based on said evaluating.

In various aspects, as described in greater detail herein, medical procedures can include administering oxygen, performing cardiopulmonary resuscitation (CPR), airway management, managing shock, managing spinal cord injury, managing fractures, and triage.

### BRIEF DESCRIPTION OF THE DRAWINGS

FIG. 1 illustrates a device that can provide medical training and testing as described herein, including interactive illustrations and sensing gesture feedback from trainees.

FIG. 2 shows a flowchart for an exemplary method of medical training and/or testing.

FIG. 3 shows a flowchart for an exemplary method of setting up a medical training and/or testing interaction.

FIGS. 4A-4D show flowcharts for various exemplary methods of receiving a medical training and/or testing interaction.

FIG. 5 is a functional block diagram of a mobile touchscreen device for providing interactive medical procedure testing.

FIG. 6A illustrates an exemplary image swap interface, according to an oxygen administration training embodiment.

FIGS. 7A-7C illustrate exemplary multi-choice point interfaces, according to various oxygen administration training embodiments.

FIGS. 8A-8G illustrate exemplary single-choice point interfaces, according to various oxygen administration training embodiments.

FIGS. 9A-9F illustrate exemplary drag-and-drop interfaces, according to various oxygen administration training embodiments.

FIG. 10A illustrates an exemplary rotate interface, according to an oxygen administration training embodiment.

FIGS. 11A-11B illustrate exemplary slider interfaces, according to various oxygen administration training embodiments.

FIGS. 12A-12R illustrate exemplary interfaces for cardiopulmonary resuscitation (CPR) training and/or testing, according to various embodiments.

FIGS. 13A-13G illustrate exemplary point-and-vibrate interfaces for cardiopulmonary resuscitation (CPR) training and/or testing, according to various embodiments.

FIGS. 14A-14ZB illustrate exemplary interfaces for airway management training and/or testing, according to various embodiments.

FIGS. 15A-17B illustrate exemplary interfaces for shock management training and/or testing, according to various embodiments.

FIGS. 18A-18P illustrate exemplary interfaces for spinal cord injury management training and/or testing, according to various embodiments.

FIGS. 19A-20A illustrate exemplary interfaces for fracture management training and/or testing, according to various embodiments.

FIGS. 21A-21U illustrate exemplary interfaces for triage training and/or testing, according to various embodiments.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

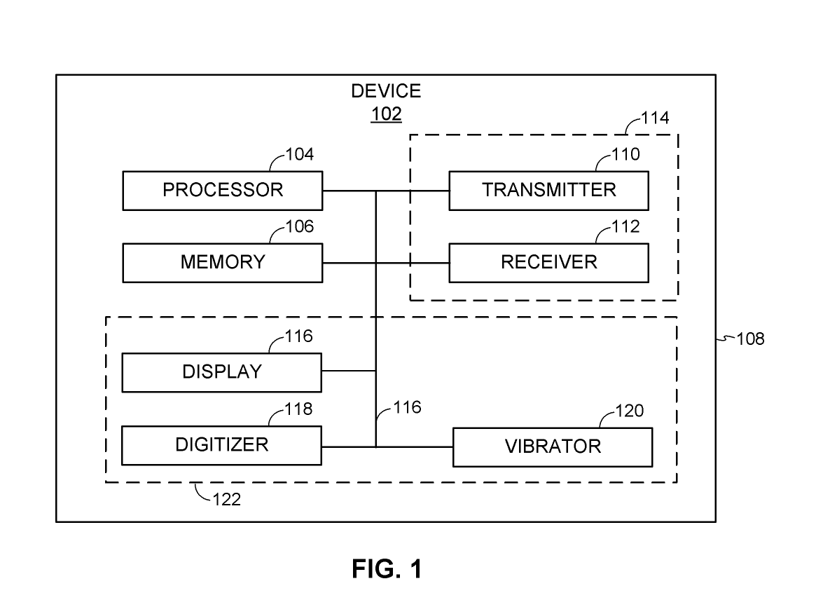

FIG. 1 shows an exemplary functional block diagram of a device 102 that can provide medical training and testing as described herein, including interactive illustrations and sensing gesture feedback from trainees. The device 102 is an example of a device, such as a smart phone, tablet, or computer with a touchscreen interface, that can be configured to implement the various methods described herein. As shown in FIG. 1, the device 102 includes a processor 104, a memory 106, housing 108, a transceiver 114 including a transmitter 110 and a receiver 112, a user interface including a display 116, a digitizer 118, and a vibrator 120, and a bus system 126. Although various portions of the device 102 are shown in FIG. 1, a person having ordinary skill in the art will appreciate that any combination of portions can be rearranged, new portions can be added, and/or some portions can be omitted. For example, in some embodiments the device 102 is a mobile device including a battery. In some embodiments, the device 102 can include a wired power source. Some embodiments can omit the vibrator 120.

The processor 104 serves to control operation of the device 102. The processor 104 can also be referred to as a central processing unit (CPU). Memory 106, which can include both read-only memory (ROM) and random access memory (RAM), can provide instructions and data to the processor 104. A portion of the memory 106 can also include non-volatile random access memory (NVRAM). The processor 104 typically performs logical and arithmetic operations based on program instructions stored within the memory 106. The instructions in the memory 106 can be executable to implement the methods described herein.

The processor 104 can include or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, combinations thereof, or otherwise. Instructions can include code (e.g., in source code format, binary code format, executable code format, or any other suitable format of code). The instructions, when executed by the one or more processors, cause the processing system to perform the various functions described herein.

The transceiver 114 serves to allow transmission and reception of data between the device 102 and a remote location. In various embodiments, the transceiver 114 can include separate transmitter 110 and receiver 112, and either can be omitted in various embodiments. The transmitter 110 and receiver 112 can be configured to communicate via wired and/or wireless communications, including via protocols such as WIFI, Bluetooth, cellular data, etc.

The user interface 122 can include any element or component that conveys information to a user of the device 102 and/or receives input from the user. The user interface 122 can include, for example, a physical or virtual keypad, a microphone, a speaker, a touch screen, a light source, a physical or virtual button, and/or an accelerometer. In the embodiment of FIG. 1, the user interface 122 includes the touchscreen display 116, the digitizer 118, and the vibrator 120.

The illustrated display 116 serves to provide visual output. Visual output can include still or moving pictures, text, etc. In various embodiments, the display 116 can include a liquid crystal display (LCD), one or more light emitting diodes (LEDs), an organic LED display (OLED), a microelectromechanical systems (MEMS) display, a cathode ray tube (CRT) display, an electronic ink display, etc. In various embodiments, the display 116 can be unlit, backlit, and/or front-lit.

The digitizer 118 serves to receive coordinate input from a user. Coordinate input can include one or more points of contact with, for example, one or more fingers or styluses. The digitizer 118 can be configured to track changes in coordinate input over time. In some embodiments, the digitizer 118 can include a separate gesture processor configured to recognize one or more gesture inputs. In various embodiments, the digitizer 118 can include a resistive and/or capacitive touch screen. In some embodiments, the digitizer 118 and the display 116 can be integrated. User feedback can additionally be received from a pointer device such as a mouse, touchpad, etc. (not shown).

The vibrator 120 serves to vibrate, shake, or otherwise move the device 102. In various embodiments, the vibrator 120 can include, for example, an offset-weight motor, a piezoelectric vibrator, etc. In some embodiments, the vibrator 120 can be configured to vibrate based on one or more display 116 outputs and/or digitizer 118 inputs, as will be described in greater detail herein. As noted, the vibrator 120 can be omitted in some implementations.

The various components of the device 102 can be coupled together by the bus system 126. The bus system 126 can include a data bus, for example, as well as a power bus, a control signal bus, and a status signal bus in addition to the data bus. The components of the device 102 can be coupled together or accept or provide inputs to each other using some other mechanism.

Although a number of separate components are illustrated in FIG. 1, one or more of the components can be combined or commonly implemented. For example, the processor 104 can be used to implement not only the functionality described above with respect to the processor 104, but also to implement the functionality of a digitizer 118 and/or a DSP. Further, each of the components illustrated in FIG. 1 can be implemented using a plurality of separate elements.

In various embodiments, the user interface 122 and/or the display 116 can include means for providing a medical training and/or testing prompt indicating equipment and/or procedures for administering cardiopulmonary resuscitation (CPR) to a patient. In various embodiments, the user interface 122 and/or the digitizer 118 can include means for receiving a medical training and/or testing interaction in response to the medical training and/or testing prompt. In various embodiments, the processor 104, or another processing element, can include means for evaluating a medical training and/or testing interaction and means for adjusting a characteristic of the device 102.

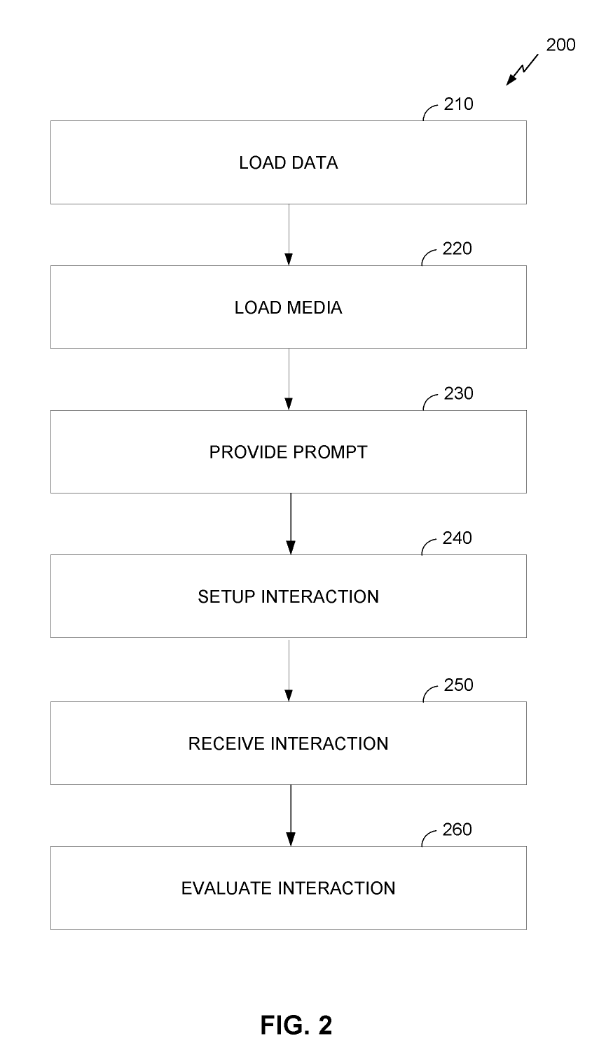

FIG. 2 shows a flowchart 200 for an exemplary method of medical training and/or testing. The method can be implemented in whole or in part by the devices described herein, such as the device 102 shown in FIG. 1. Although the illustrated method is described herein with reference to the device 102 discussed above with respect to FIG. 1, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 210, the device 102 loads medical training and/or testing data. For example, the processor 104 can copy medical training and/or testing data from a long-term storage memory to a local cache memory of the device's memory 106. In various embodiments, medical training and/or testing data can include extensible markup language (XML) data, a parameter file, JavaScript object notation data, one or more database entries, a text file, etc. The medical training and/or testing data can include, for example, a list of medical training and/or testing media and/or media locations, medical gesture information, correct answers related to the medical training and/or testing media, etc.

In various embodiments, as described in greater detail herein, the medical training and/or testing data can include medical training and/or testing data for one or more medical procedures such as, for example, administering oxygen, performing cardiopulmonary resuscitation (CPR), airway management, managing shock, managing spinal cord injury, managing fractures, and triage.

Next, at block 220, the device 102 loads medical training and/or testing media. For example, the processor 104 can copy medical training and/or testing media from a long-term storage memory to a local cache memory of the device's memory 106. In various embodiments, medical training and/or testing media can include introductory video, one or more color maps, one or more still images, audio, a vibration pattern, etc. The color maps can serve to identify areas of interaction using, for example, an alpha channel or one or more key colors. In some embodiments, loading the medical training and/or testing media can include loading video, loading a color map, loading images, and loading a gesture database. In some embodiments, the medical training and/or testing media includes a medical training and/or testing prompt.

In various embodiments, as described in greater detail herein, the medical training and/or testing media can include medical training and/or testing media for one or more medical procedures such as, for example, administering oxygen, performing cardiopulmonary resuscitation (CPR), airway management, managing shock, managing spinal cord injury, managing fractures, and triage. In various embodiments, the medical training and/or testing media can further include medical training media for one or more of the medical procedures discussed herein. For example, one or more introductory text, images, videos, and/or animation can provide medical procedure information, for example including answers to one or more medical training and/or testing prompts described herein.

Then, at block 230, the device 102 provides a medical training and/or testing prompt. For example, the processor 104 can display medical training and/or testing media such as a video on the display 116. The medical training and/or testing prompt can include, for example, animated and/or static text such as a question or instruction. The medical training and/or testing prompt can further include related still and/or moving images depicting, for example, one or more of a patient, an emergency situation, one or more medical devices, etc.

In various embodiments, as described in greater detail herein, the medical training and/or testing prompt can include a medical training and/or testing prompt for one or more medical procedures such as, for example, administering oxygen, performing cardiopulmonary resuscitation (CPR), airway management, managing shock, managing spinal cord injury, managing fractures, and triage.

Thereafter, at block 240, the device 102 sets up a medical training and/or testing interaction. For example, the processor 104 can set the device 102 in a mode configured to wait for, receive, and/or process a user interaction. The device 102 can further respond to user interaction, for example, by adjusting the medical training and/or testing prompt in coordination with the user interaction. In some embodiments, setting up the medical training and/or testing interaction can include setting a starting image from one or more parameters of the medical training and/or testing data, setting up interaction detection, and setting up gesture detection.

In an embodiment, setting the starting image can include, for example, loading a starting image related to a medical procedure into the memory 106. The processor 104 can read the starting image from the memory 106 and can cause the display 116 to output the starting image. In some embodiments, the processor 104 can cue a plurality of images for subsequent output on the display 116.

In an embodiment, setting up touch detection can include, for example, adding one or more event listeners (for example, at an operating system) for one or more touch events. For example, the processor 104 can monitor an output of the digitizer 118 to detect and/or store data on a coordinates of one or more touch points. The processor 104 can maintain meta-data regarding the touch points including, for example, a number of touch blobs, a distance between touch blobs, movement of the touch blobs, etc. In some embodiments, the processor 104 can perform at least part of the touch detection using an application programming interface (API), or can indirectly perform the touch detection via the digitizer 118.

In an embodiment, setting up gesture detection can include loading one or more gesture profiles. In various embodiments, for example, the processor 104 can load one or more gesture profiles from the memory 106. Gesture profiles can include, for example, single-choice point gestures, multi-choice point gestures, point-and-hold gestures, point-and-vibrate gestures, image swap gestures, drag-and-drop gestures, drag-and-wipe gestures, maze gestures, slider gestures, two-finger slider gestures, image rotate gestures, image rotate slider gestures, point-and-ping gestures, etc. Various gestures are described in greater detail herein.

Subsequently, at block 250, the device 102 receives the medical training and/or testing interaction. For example, the processor 104 can receive user input via the digitizer 118. In various embodiments, the medical training and/or testing interaction can include one or more gestures, which can be performed with respect to the medical training and/or testing prompt. In some embodiments, receiving the medical training and/or testing interaction can include detecting the start of a gesture, comparing the gesture to the one or more gesture profiles and/or to the medical training and/or testing data, and updating the medical training and/or testing prompt in response to the gesture based on the comparison.

In some embodiments, providing the medical training and/or testing prompt can include, for example, playing a video. The processor 104 can play the video until a cue point is reached. When the cue point is reached, the processor 104 can pause the video. In an embodiment, the processor 104 can play a video loop when the cue point is reached.

Detecting the start of the gesture can include, for example, directly detecting the gesture at the processor 104, or receiving an application programming interface (API) notification. In an embodiment, the processor 104 can identify a gesture type. Comparing the gesture can include determining if the identified gesture type is compatible with the loaded medical training and/or testing data. For example, the processor 104 can determine that a pinch gesture is incompatible with medical training and/or testing data configured for a point gesture. Updating the medical training and/or testing prompt can include, for example, moving one or more displayed images, or displaying one or more previous or subsequent images in a series. For example, the processor 104 can cause the display 116 to output new images consistent with a progressing gesture.

Next, at block 260, the device 102 evaluates the received interaction. For example, the processor 104 can interpret the received interaction as an answer to the medical training and/or testing prompt. In various embodiments, the received interaction can include one or more gestures discussed herein. The processor 104 can compare the received gesture, and one or more parameters related thereto, to the loaded medical training and/or testing data. For example, the processor 104 can compare a touch position to a “correct” touch position included in the medical training and/or testing data. In some embodiments, multiple interactions can be evaluated together such as, for example, the selection of an image and the activation of a submission button.

If the processor 104 determines that the received interaction correctly answers the medical training and/or testing prompt, the processor 104 can indicate a correct answer. For example, the processor 104 can cause the display 116 to output text and/or video indicating a correct answer. If the processor 104 determines that the received interaction incorrectly answer the medical training and/or testing prompt, the processor 104 can indicate an incorrect answer. For example, the processor 104 can cause the display 116 to output text and/or video indicating an incorrect answer. The processor 104 can continue to receive additional interactions until receiving a correct answer. In some embodiments, the processor 104 can count a number of incorrect answers, and cause the display 116 to output text and/or video indicating a failed test when the number of incorrect answers surpasses a threshold or can tally correct answers and indicate a passed test when the number of correct answers surpasses a threshold.

In various embodiments, after evaluating the interaction, the processor 104 can score the interaction. As used herein, scoring can include, for example, maintaining a tally of correct and/or incorrect responses, weighting one or more correct and/or incorrect responses and maintaining a weighted score, determining an overall passage or failure based on the tally or weighted score (such as by comparing it to a passage threshold), providing a reward or prize based on passage or failure (such as unlocking an achievement, virtual medal or trophy, a new medical training and/or testing prompt, one or more gestures or interactions, etc.), adjusting another characteristic of the device 102 (for example, displaying a message on the display 116, storing a result in the memory 106, transmitting a message via the transmitter 110, vibrating the device 102 using the vibrator 120, playing a sound via a speaker of the user interface 122, etc.), or the like.

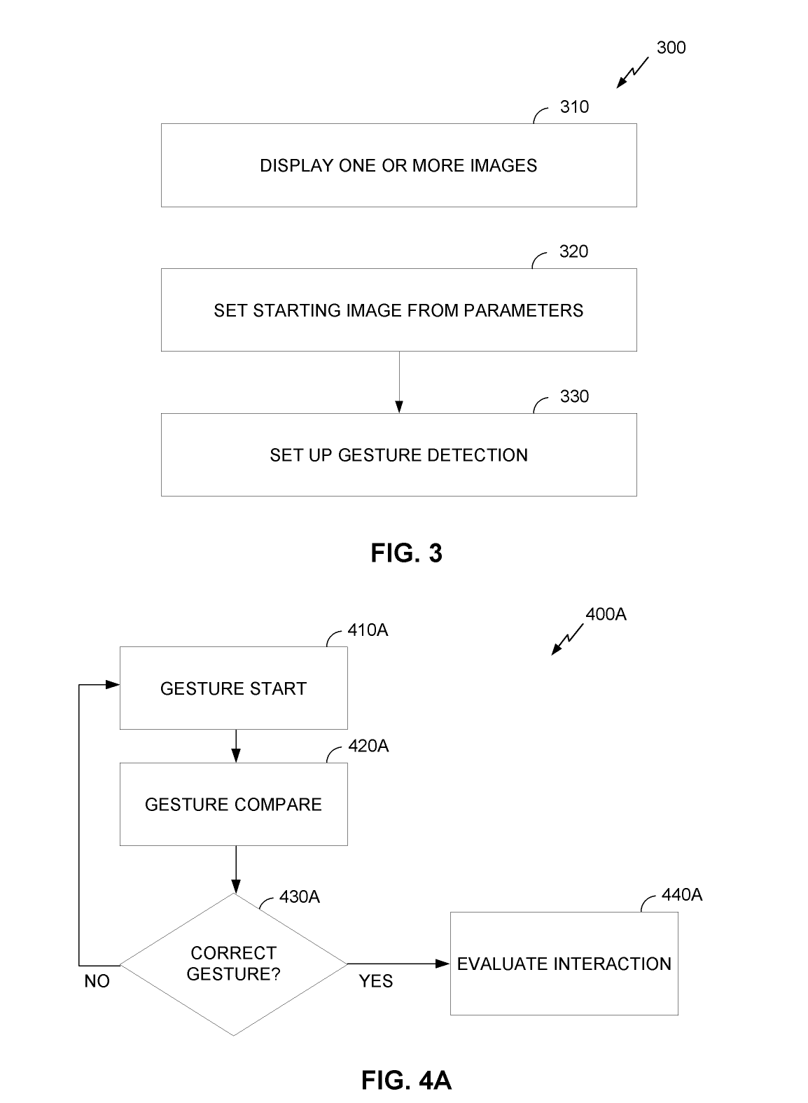

FIG. 3 shows a flowchart 300 for an exemplary method of setting up a medical training and/or testing interaction. In some embodiments, the method of flowchart 300 can implement block 240 discussed above with respect to FIG. 2. The method can be implemented in whole or in part by the devices described herein, such as the device 102 shown in FIG. 1. Although the illustrated method is described herein with reference to the device 102 discussed above with respect to FIG. 1, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 310, the device 102 displays one or more images. For example, the processor 104 can load one or more medical training and/or testing media images from the memory 106, and can cause the display 116 to output the images. In various embodiments, the images can be displayed successively, for example, as video. In some embodiments, the one or more displayed images can constitute a medical training and/or testing prompt, and can include text and/or images indicating a medical training and/or testing question.

Next, at block 320, the device 102 sets a starting image from one or more parameters of the medical training and/or testing data. Setting the starting image can include, for example, loading a starting image related to a medical procedure into the memory 106. The processor 104 can read the starting image from the memory 106 and can cause the display 116 to output the starting image. In some embodiments, the processor 104 can cue a plurality of images for subsequent output on the display 116.

Then, at block 330, the device 102 sets up gesture detection. For example, the device 102 can add one or more event listeners for one or more touch events. In an embodiment processor 104 can monitor an output of the digitizer 118 to detect and/or store data on a coordinates of one or more touch points. The processor 104 can maintain meta-data regarding the touch points including, for example, a number of touch blobs, a distance between touch blobs, movement of the touch blobs, etc. In some embodiments, the processor 104 can perform at least part of the touch detection using an application programming interface (API), or can indirectly perform the touch detection via the digitizer 118.

In an embodiment, setting up gesture detection can further include loading one or more gesture profiles. In various embodiments, for example, the processor 104 can load one or more gesture profiles from the memory 106. Gesture profiles can include, for example, single-choice point gestures, multi-choice point gestures, point-and-hold gestures, point-and-vibrate gestures, image swap gestures, drag-and-drop gestures, drag-and-wipe gestures, maze gestures, slider gestures, two-finger slider gestures, image rotate gestures, image rotate slider gestures, point-and-ping gestures, etc. Various gestures are described in greater detail herein.

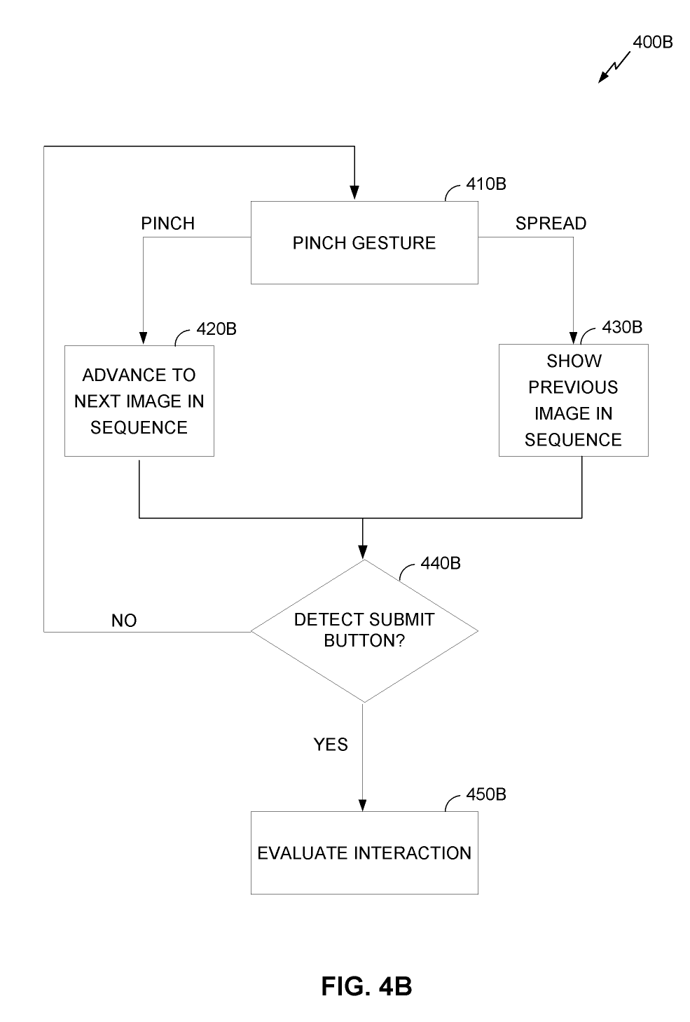

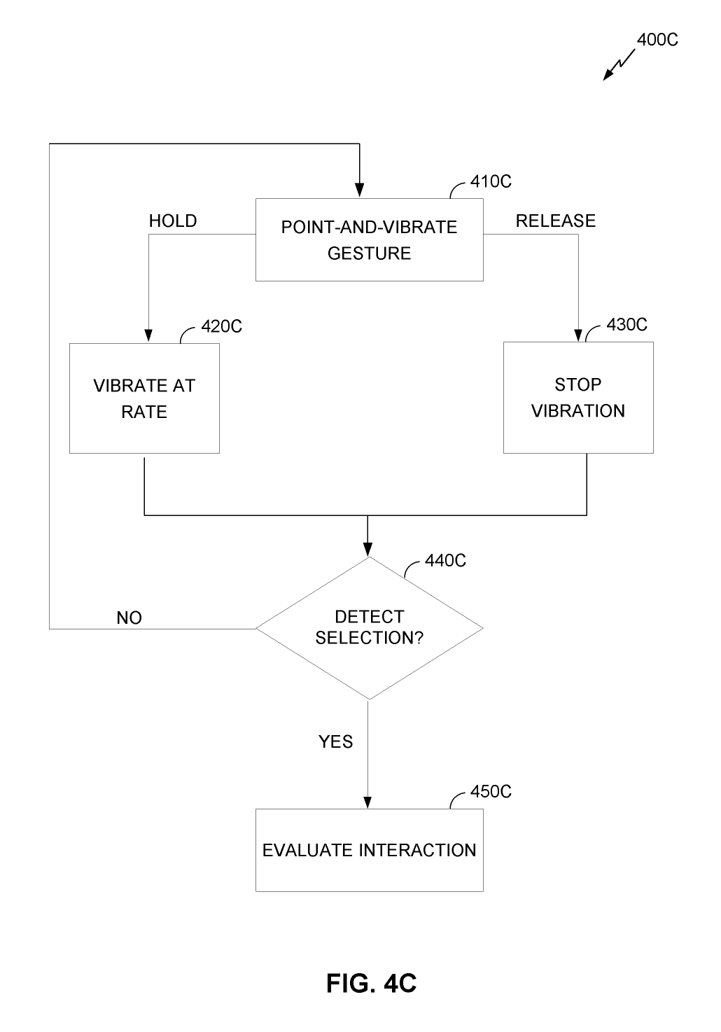

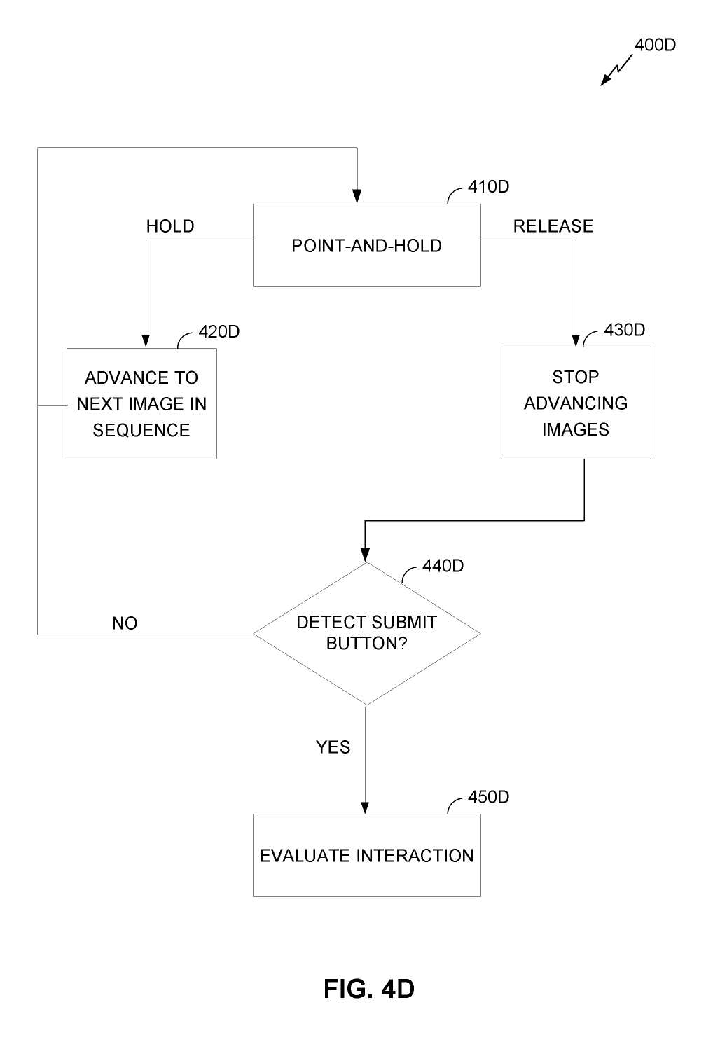

FIG. 4A shows a flowchart 400A for an exemplary method of receiving a medical training and/or testing interaction. In some embodiments, the method of flowchart 400A can implement block 250 discussed above with respect to FIG. 2. The method can be implemented in whole or in part by the devices described herein, such as the device 102 shown in FIG. 1. Although the illustrated method is described herein with reference to the device 102 discussed above with respect to FIG. 1, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 410A, the device 102 receives an interaction. For example, the digitizer 118 can receive one or more touch coordinates from a user. The one or more touch coordinates can, together, form a medical training and/or testing gesture. Various medical training and/or testing interactions described herein can include point-and-hold, point-and-vibrate, image-swap, drag-and-drop (with or without fill spots), one- and two-finger sliders, rotate, rotate sliders, rotate 360, drag-and-gesture, drag-and-wipe, point-and-pinch, countdown point, single- and multi-choice point, drag-and-drop maze, unity explore and answer, and unity scene explore and answer. In various embodiments, interactions can be described herein as gestures. In various embodiments the processor 104 is configured to track gestures received via the digitizer 118 and to store the interaction in the memory 106.

Next, at block 420A, the device 102 compares the received interaction to one or more stored interactions, gesture rules, and/or gesture templates. For example, the processor 104 can retrieve a gesture template for one or more aforementioned interactions, and can compare one or more parameters (such as, for example, a start point, and end point, a path, etc.) of the gesture template with the received interaction. In various embodiments, the medicate training and/or testing data, described above with respect to FIG. 2, can include the gesture template for a particular interaction. Thus, in some embodiments, there is a particular correct gesture for any given interaction. The processor 104 can determine whether the received interaction corresponds with a correct gesture.

When the received interaction does not correspond with a correct gesture, the device 102 can discard the received interaction. The device 102 proceeds to block 410A, awaiting receipt of another interaction. When the received interaction does correspond with a correct gesture, on the other hand, the device 102 can proceed to evaluate the interaction at block 440A.

Then, at block 440A, when the received interaction corresponds with a correct gesture, the device 102 evaluates the received interaction. Evaluation of the received interaction can include, for example, the evaluation described above with respect to block 260 of FIG. 2. Moreover, evaluation of various particular gestures is described in greater detail herein.

FIG. 4B shows a flowchart 400B for another exemplary method of receiving a medical training and/or testing interaction. In some embodiments, the method of flowchart 400B can implement block 250 discussed above with respect to FIG. 2. In some embodiments, the method of flowchart 400B can implement a more specific version of the flowchart 400A, described above with respect to FIG. 4. Particularly, the method of flowchart 400B can receive a pinch gesture.

The method of flowchart 400B can be implemented in whole or in part by the devices described herein, such as the device 102 shown in FIG. 1. Although the illustrated method is described herein with reference to the device 102 discussed above with respect to FIG. 1, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 410B, the device 102 receives a pinch gesture, as described in greater detail herein in the section entitled “Pinch.” In some embodiments, the pinch gesture can include two directions: pinch and spread. The processor 104 can receive an interaction from the digitizer 118, and can determine that the interaction is a pinch gesture, as discussed above with respect to FIG. 4A. The processor 104 can further determine whether the pinch gesture is pinching or spreading, for example by tracking a distance between two inputs that at least partially overlap in time. When the processor 102 determines that the received gesture is a pinch, the device 102 can proceed to block 420B. On the other hand, when the processor 102 determines that the received gesture is a spread, the device 102 can proceed to block 430B.

Next, at block 420B, when the processor 102 determines that the received gesture is a pinch, the processor 102 can cause the display 116 to output a next image in a sequence of images corresponding to a pinch gesture. For example, as will be described in greater detail herein, a pinch motion can cause an image to shrink (for example, the processor 104 can cause the display 116 to output an image of a compressing intravenous drip). The series of images corresponding to the pinch gesture can be loaded from the memory 106, for example as described above with respect to block 220 of FIG. 2. After advancing to the next image in the sequence, the device 102 can proceed to block 440B.

Then, at block 430B, when the processor 102 determines that the received gesture is a spread, the processor 102 can cause the display 116 to output a previous image in a sequence of images corresponding to a spread gesture. For example, as will be described in greater detail herein, a spread motion can cause an image to expand (for example, the processor 104 can cause the display 116 to output an image of an inflating anti-shock garment). The series of images corresponding to the spread gesture can be loaded from the memory 106, for example as described above with respect to block 220 of FIG. 2. After showing to the previous image in the sequence, the device 102 can proceed to block 440B.

Thereafter, at block 440B, the device 102 can wait to receive selection of a submit button. As described in greater detail herein, a submit button can inform the processor 104 that a user is ready for the processor 104 to evaluate a medical training and/or testing answer. In some embodiments, the answer can include the particular image to which the processor 104 has advanced in response to received gestures. When the processor 104 receives another gesture before the submit button is selected, the device 102 can proceed to process the gesture at block 410B. On the other hand, when the processor 104 determines that the submit button is selected before receiving another gesture, the device 102 can proceed to block 450B.

Subsequently, at block 450B, the device can evaluate the received interaction. For example, in some embodiments, the processor 104 can compare the particular image selected via the pinch gesture to a correct answer. The correct answer can be loaded from the memory 106, for example as discussed herein with respect to the medical training and/or testing data and block 210 of FIG. 2. In an embodiment, evaluating the interaction 450B can include evaluating the interaction as discussed above with respect to block 260 of FIG. 2.

FIG. 4C shows a flowchart 400C for another exemplary method of receiving a medical training and/or testing interaction. In some embodiments, the method of flowchart 400C can implement block 250 discussed above with respect to FIG. 2. In some embodiments, the method of flowchart 400C can implement a more specific version of the flowchart 400A, described above with respect to FIG. 4. Particularly, the method of flowchart 400C can receive a point-and-vibrate gesture.

The method of flowchart 400C can be implemented in whole or in part by the devices described herein, such as the device 102 shown in FIG. 1. Although the illustrated method is described herein with reference to the device 102 discussed above with respect to FIG. 1, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 410C, the device 102 receives a point-and-vibrate gesture, as described in greater detail herein in the section entitled “Point-and-Vibrate.” The processor 104 can receive an interaction from the digitizer 118, and can determine that the interaction is a point-and-vibrate gesture, as discussed above with respect to FIG. 4A. The processor 104 can further determine whether a user is holding a finger in a particular location, for example by checking to see if the touch input changes over time (as compared to a threshold change indicative of a release). When the processor 102 determines that the received gesture is held within a range of designated coordinates, the device 102 can proceed to block 420C. On the other hand, when the processor 102 determines that the received gesture is not held within the range of designated coordinates, the device 102 can proceed to block 430C.

Next, at block 420C, when the processor 102 determines that the received gesture is held within a range of designated coordinates, the processor 102 can cause the vibrator 120 to vibrate at a particular rate. For example, as will be described in greater detail herein, the vibration can mimic the beat of a heart, a rate of breathing, etc. After beginning vibration, the device 102 can proceed to block 440C.

Then, at block 430C, when the processor 102 determines that the received gesture is not held within a range of designated coordinates (i.e., released), the processor 102 can cause vibrator 120 to cease vibrating. After ceasing vibration, the device 120 can proceed to block 440C.

Thereafter, at block 440C, the device 102 can wait to receive selection, for example, of an image corresponding to an answer to a medical training and/or testing prompt. As described in greater detail herein, an answer selection can be received after a user senses the vibration generated at block 420C, which can represent a diagnostic output indicative of a correct answer selection. When the processor 104 receives another gesture before an answer is selected, the device 102 can proceed to process the gesture at block 410C. On the other hand, when the processor 104 determines that the answer is selected before receiving another gesture, the device 102 can proceed to block 450C.

Subsequently, at block 450C, the device can evaluate the received interaction. For example, in some embodiments, the processor 104 can compare the selected answer to a correct answer. The correct answer can be loaded from the memory 106, for example as discussed herein with respect to the medical training and/or testing data and block 210 of FIG. 2. In an embodiment, evaluating the interaction 450C can include evaluating the interaction as discussed above with respect to block 260 of FIG. 2.

FIG. 4D shows a flowchart 400D for another exemplary method of receiving a medical training and/or testing interaction. In some embodiments, the method of flowchart 400D can implement block 250 discussed above with respect to FIG. 2. In some embodiments, the method of flowchart 400D can implement a more specific version of the flowchart 400A, described above with respect to FIG. 4. Particularly, the method of flowchart 400D can receive a point-and-hold gesture.

The method of flowchart 400D can be implemented in whole or in part by the devices described herein, such as the device 102 shown in FIG. 1. Although the illustrated method is described herein with reference to the device 102 discussed above with respect to FIG. 1, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 410D, the device 102 receives a point-and-hold gesture, as described in greater detail herein in the section entitled “Point-and-hold.” The processor 104 can receive an interaction from the digitizer 118, and can determine that the interaction is a point-and-hold gesture, as discussed above with respect to FIG. 4A. The processor 104 can further determine whether a user is holding a finger in a particular location, for example by checking to see if the touch input changes over time (as compared to a threshold change indicative of a release). When the processor 102 determines that the received gesture is held within a range of designated coordinates, the device 102 can proceed to block 420D. On the other hand, when the processor 102 determines that the received gesture is not held within the range of designated coordinates, the device 102 can proceed to block 430D.

Next, at block 420D, when the processor 102 determines that the received gesture is a point-and-hold, the processor 102 can cause the display 116 to output a next image in a sequence of images corresponding to a point-and-hold gesture. For example, as will be described in greater detail herein, a point-and-hold motion can cause an image to shrink (for example, the processor 104 can cause the display 116 to output an image of a compressing intravenous drip). The series of images corresponding to the point-and-hold gesture can be loaded from the memory 106, for example as described above with respect to block 220 of FIG. 2. After advancing to the next image in the sequence, the device 102 can proceed to block 410D. Thus, if the user continues to touch within the designated area, the images can continue to advance. In some embodiments, the processor 102 can cause the images to advance periodically, for example every half second. In some embodiments, when the last image in the sequence is reached, the sequence can loop back to the beginning.

Then, at block 430D, when the processor 102 determines that the received gesture is not held within a range of designated coordinates (i.e., released), the processor 102 can cause the display 116 to stop advancing the sequence of images. After ceasing advance of the sequence of images, the device 102 can proceed to block 440D.

Thereafter, at block 440D, the device 102 can wait to receive selection of a submit button. As described in greater detail herein, a submit button can inform the processor 104 that a user is ready for the processor 104 to evaluate a medical training and/or testing answer. In some embodiments, the answer can include the particular image to which the processor 104 has advanced in response to received gestures. When the processor 104 receives another gesture before the submit button is selected, the device 102 can proceed to process the gesture at block 410D. On the other hand, when the processor 104 determines that the submit button is selected before receiving another gesture, the device 102 can proceed to block 450D.

Subsequently, at block 450D, the device can evaluate the received interaction. For example, in some embodiments, the processor 104 can compare the particular image selected via the point-and-hold gesture to a correct answer. The correct answer can be loaded from the memory 106, for example as discussed herein with respect to the medical training and/or testing data and block 210 of FIG. 2. In an embodiment, evaluating the interaction 450D can include evaluating the interaction as discussed above with respect to block 260 of FIG. 2.

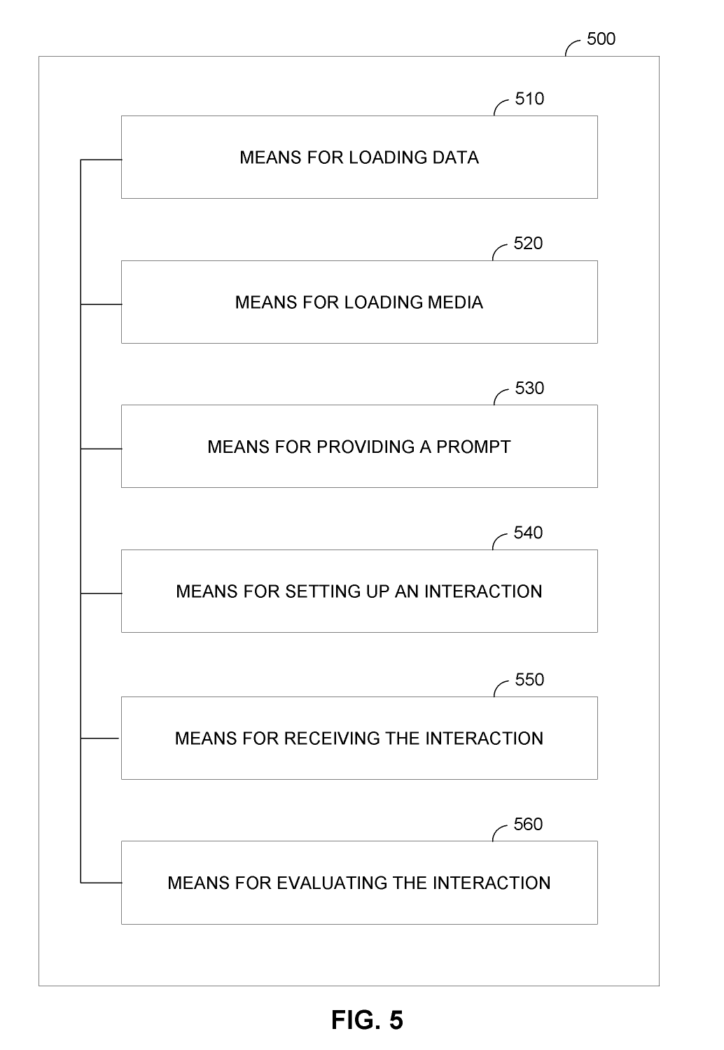

FIG. 5 is a functional block diagram of a mobile touchscreen device 500 for providing interactive medical procedure testing. Those skilled in the art will appreciate that the device 500 may have more components than the simplified system described herein. The device 500 described herein includes only those components useful for describing some prominent features of implementations within the scope of the claims. The device 500 for providing interactive medical procedure testing includes means 510 for loading data, means 520 for loading media, means 530 for providing a prompt, means 540 for setting up an interaction, means 550 for receiving the interaction, and means 560 for evaluating the interaction.

In an embodiment, means 510 for loading data can be configured to perform one or more of the functions described above with respect to block 210 (FIG. 2). In various embodiments, the means 510 for loading data can be implemented by one or more of the processor 104 (FIG. 1), the memory 106 (FIG. 1), and the receiver 112 (FIG. 1).

In an embodiment, means 520 for loading media can be configured to perform one or more of the functions described above with respect to block 220 (FIG. 2). In various embodiments, the means 520 for loading media can be implemented by one or more of the processor 104 (FIG. 1), the memory 106 (FIG. 1), and the receiver 112 (FIG. 1).

In an embodiment, means 530 for providing a prompt can be configured to perform one or more of the functions described above with respect to block 230 (FIG. 2). In various embodiments, the means 530 for providing a prompt can be implemented by one or more of the processor 104 (FIG. 1), the memory 106 (FIG. 1), the user interface 122 (FIG. 1), the display 116 (FIG. 1), and the vibrator 120 (FIG. 1).

In an embodiment, means 540 for setting up an interaction can be configured to perform one or more of the functions described above with respect to block 240 (FIG. 2). In various embodiments, the means 540 for setting up an interaction can be implemented by one or more of the processor 104 (FIG. 1), the memory 106 (FIG. 1), and the display 116 (FIG. 1).

In an embodiment, means 550 for receiving the interaction can be configured to perform one or more of the functions described above with respect to block 250 (FIG. 2). In various embodiments, the means 550 for receiving the interaction can be implemented by one or more of the processor 104 (FIG. 1), the receiver 112 (FIG. 1), and the digitizer 118 (FIG. 1).

In an embodiment, means 560 for evaluating the interaction can be configured to perform one or more of the functions described above with respect to block 260 (FIG. 2). In various embodiments, the means 560 for evaluating the interaction can be implemented by one or more of the processor 104 (FIG. 1) and the memory 106 (FIG. 1).

### Administer Oxygen

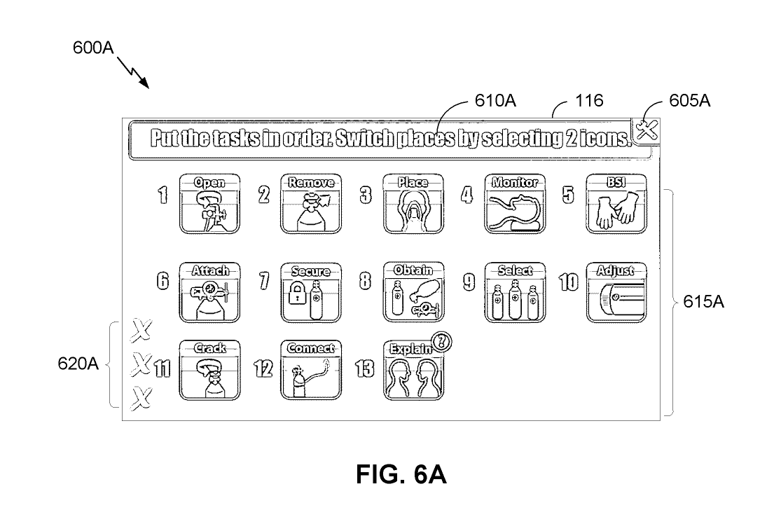

In various embodiments, the device 102 can be configured to provide medical training and/or testing for oxygen administration. For example, the medical training and/or testing data, medical training and/or testing media, medical training and/or testing prompt, and medical training and/or testing interactions, described above with respect to FIG. 1, can relate to training and testing for oxygen administration. In various embodiments, setting up the interaction for oxygen administration testing can include setting up one or more gestures such as image swap, multi-choice point, point, drag-and-drop, image rotate, and/or slider gestures. Although particular exemplary gestures and interfaces are described herein with respect to oxygen administration training and/or testing, any other compatible gesture or interface described herein (including those described with respect to other fields of medical training and/or testing) can be applied to oxygen administration training and/or testing. FIGS. 6A-11B illustrate exemplary interfaces for oxygen administration training and/or testing, according to various embodiments.

### Image Swap

In an embodiment, setting up an interaction for medical training and/or testing data (discussed above with respect to block 240 of FIG. 2) can include setting up an image swap gesture. The processor 104 can load one or more parameters for the image swap gesture from the memory 106. In an embodiment, the image swap gesture can include a quiz-type interaction, where the user moves icons representing the steps of a procedure in an appropriate order.

In an embodiment, loading medical training and/or testing data (discussed above with respect to block 210 of FIG. 2) can include loading a correct ordering for one or more icons. For example, the processor 104 can load the correct ordering from the memory 106. In some embodiments, the processor 104 can also load an initial ordering from the memory 106. In some embodiments, an initial ordering can be randomly or pseudo-randomly determined.

In an embodiment, loading medical training and/or testing media (discussed above with respect to block 220 of FIG. 2) can include loading the one or more icons and instructions. Each icon can represent a step or action in a medical procedure. The instructions can include text such as, for example, “In this exercise you will place icons into the correct order to perform a medical procedure. To do this, tap the icon in the position you would like to move it to. If the position is incorrect, the icons will not move and a red X will appear. If the position is correct, the icons will swap as intended.”

In an embodiment, providing a medical training and/or testing prompt (discussed above with respect to block 230 of FIG. 2) can include displaying the one or more icons and/or the instruction text. For example, the processor 104 can cause the display 116 to output the one or more icons and/or the instruction text discussed above. In an embodiment, the processor 104 causes the display 116 to output the plurality of icons in a grid. In an embodiment, the processor 104 causes the display 116 to output a tutorial illustrating the image swap interaction.

In an embodiment, receiving the medical training and/or testing interaction (discussed above with respect to block 250 of FIG. 2) can include receiving one or more user selections. For example, the processor 104 can receive one or more touch locations from the digitizer 118. The processor 104 can identify one or more selected icons based on the one or more touch locations received from the digitizer 118. For example, in the case of two touch locations (e.g., “multi-touch”), the processor 104 can use only the first touch location and can discard the second (or vice versa). In an embodiment, a user can successively select two images.

In an embodiment, evaluating the medical training and/or testing interaction (discussed above with respect to block 260 of FIG. 2) can include identifying user selection of two icons. In an embodiment, when an icon is selected, the processor 104 can cause the display 116 to output a description of the step represented by the icon. In an embodiment, when an icon is selected, the processor 104 can cause the display 116 to highlight the selected icon.

In an embodiment, the processor 104 can compare the received gesture to an image swap gesture template in the memory 106. For example, the processor 104 can determine whether the user has selected two icons. When switching the two selected images would result in correct placement of at least one image, the processor 104 swaps the locations of the two selected images. In an embodiment, when switching the two images would result in incorrect placement of both images, the processor 104 can determine that an inaccurate answer has been given and can refrain from swapping the location of the two images and/or display an indication to the user of an incorrect selection. The processor 104 can lock the position of correctly placed icons into position and can cause the display 116 to shade the correctly placed icons gray.

In an embodiment, when switching the two images would result in incorrect placement of both images, the processor 104 can cause the vibrator 120 to vibrate. In an embodiment, when switching the two images would result in incorrect placement of both images, the processor 104 can increment a count of incorrect answers and/or cause the display 116 to output a visual indication of an incorrect selection, such as displaying a red “X.” In an embodiment, after a user has given an incorrect answer three times, the processor 104 can reorder the icons (for example, randomly). In an embodiment, after a user has given an incorrect answer three times, the processor 104 can reset a counter of incorrect answers.

In an embodiment, the processor 104 is configured to determine if all the icons are in their correct locations. When all the images are in their correct locations, the processor 104 can determine that a correct answer has been given. In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu.

FIG. 6A illustrates an exemplary image swap interface 600A, according to an oxygen administration training embodiment. As shown, the image swap interface 600A depicts a medical test for oxygen administration in which the user is prompted to “Put the tasks in order. Switch places by selecting 2 icons.” The image swap interface 600A can be implemented in, for example, the device 102 (FIG. 1). In various embodiments, the processor 104 (FIG. 1) can display the image swap interface 600A on the display 116 (FIG. 1). As shown, the image swap interface 600A includes a tool interface 605A, instructions 610A, a plurality of medical task icons 615A (13 shown), and incorrect answer icons 620A. Although various portions of the image swap interface 600A are shown, a person having ordinary skill in the art will appreciate that the portions can be rearranged, portions can be omitted, and/or additional portions can be added.

The tool interface 605A serves to provide navigation, for example to a main menu and/or to one or more other medical training and/or testing interfaces described herein. The instructions 610A serve to instruct the user on how to interact with the image swap interface 600A. Particularly, the instructions 610A instruct the user to “Put the tasks in order. Switch places by selecting 2 icons.” The one or more medical task icons 615A represent individual tasks related to a medical procedure. In the embodiment of FIG. 6A, the medical task icons 615A represent tasks for administering oxygen. Exemplary tasks include opening an oxygen cylinder, removing a plastic wrapper, placing an oxygen delivery device on a patient, monitoring the patient, taking body substance isolation (BSI) precautions, attaching a regulator and flow meter to the oxygen cylinder, securing the oxygen cylinder, obtaining equipment, selecting an oxygen cylinder, adjusting the flow meter, cracking a main valve of the oxygen cylinder, connecting tubing and a delivery device, and explaining the procedure to the patient. The incorrect answer icons 620A serve to indicate when an incorrect answer is given, and how many incorrect answers have been given. In some embodiments, every incorrect swap is counted as an incorrect answer.

### Multi-Choice Point

In an embodiment, setting up an interaction for medical training and/or testing data (discussed above with respect to block 240 of FIG. 2) can include setting up a multi-choice point gesture. The processor 104 can load one or more parameters for the multi-choice point gesture from the memory 106. In an embodiment, the multi-choice point gesture can allow a user to indicate one or more selections, and to indicate that the user is finished selecting.

In an embodiment, loading medical training and/or testing data (discussed above with respect to block 210 of FIG. 2) can include loading information indicating one or more correct selections. For example, the processor 104 can load the correct selections from the memory 106. In some embodiments, the processor 104 can load a color map indicating selectable image regions and/or image regions corresponding to correct selections.

In an embodiment, loading medical training and/or testing media (discussed above with respect to block 220 of FIG. 2) can include loading one or more selectable media (which can be implemented as selectable portions of a single image) and instructions. Each selectable image can represent equipment, actions, responses, and/or configurations related to a medical procedure. The instructions can include text such as, for example, “Select the necessary equipment for standard oxygen delivery. Select all that apply.”

In various embodiments, the medical training and/or testing media can include a background video or image, with or without looping. In various embodiments, the medical training and/or testing media can include hidden images. The processor 104 can cause the display 116 to output the hidden images when predetermined areas of the screen are selected. In various embodiments, the medical training and/or testing media can include explanations for correct and incorrect answers and/or accompanying sounds.

In an embodiment, providing a medical training and/or testing prompt (discussed above with respect to block 230 of FIG. 2) can include displaying the one or more selectable media and/or the instruction text. For example, the processor 104 can cause the display 116 to output the one or more selectable media and/or the instruction text discussed above. In an embodiment, the processor 104 causes the display 116 to output the plurality of selectable media in a grid. In an embodiment, the processor 104 causes the display 116 to output a tutorial illustrating the multi-choice point interaction.

In an embodiment, receiving the medical training and/or testing interaction (discussed above with respect to block 250 of FIG. 2) can include receiving one or more user selections. For example, the processor 104 can receive one or more touch locations from the digitizer 118. The processor 104 can identify one or more selected images or images portions based on the one or more touch locations received from the digitizer 118. In an embodiment, a user can successively select multiple images. In an embodiment, the processor 104 can receive selection of a submit button.

In an embodiment, evaluating the medical training and/or testing interaction (discussed above with respect to block 260 of FIG. 2) can include identifying user selection of at least one selectable image. In an embodiment, when an image is selected, the processor 104 can cause the display 116 to highlight the selected image or image portion. In an embodiment, when an image is selected, the processor 104 can cause the display 116 to output a description of the selected image. In an embodiment, when an image is selected, the processor 104 can cause the user interface 122 output a corresponding sound. In an embodiment, the processor 104 can identify selection of the submit button. In various embodiments, a selected image described herein can be unselected when a user touches the selected image. In some embodiments, selected images are not unselected.

In an embodiment, the processor 104 can compare the received gesture to a multi-choice point gesture template in the memory 106. For example, the processor 104 can determine whether the user has selected the submit button. When the processor 104 detects selection of the submit button, the processor 104 can compare the selected images with the indication of correct selections obtained from the medical training and/or testing data. When the processor 104 determines that an inaccurate answer has been given, the processor 104 can reset the medical training and/or testing prompt. When the processor 104 determines that an inaccurate answer has been given, the processor 104 can cause the display 116 to output an indication that one or more selections were incorrect. When the processor 104 determines that an inaccurate answer has been given, the processor 104 can cause the display 116 to output an explanation indicating why the one or more selections were incorrect.

In an embodiment, the processor 104 is configured to determine if all the selected images are correct. When all the images are correct, the processor 104 can determine that a correct answer has been given. In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu. When the processor 104 determines that an accurate answer has been given, the processor 104 can cause the display 116 to output an explanation indicating why the answer was correct.

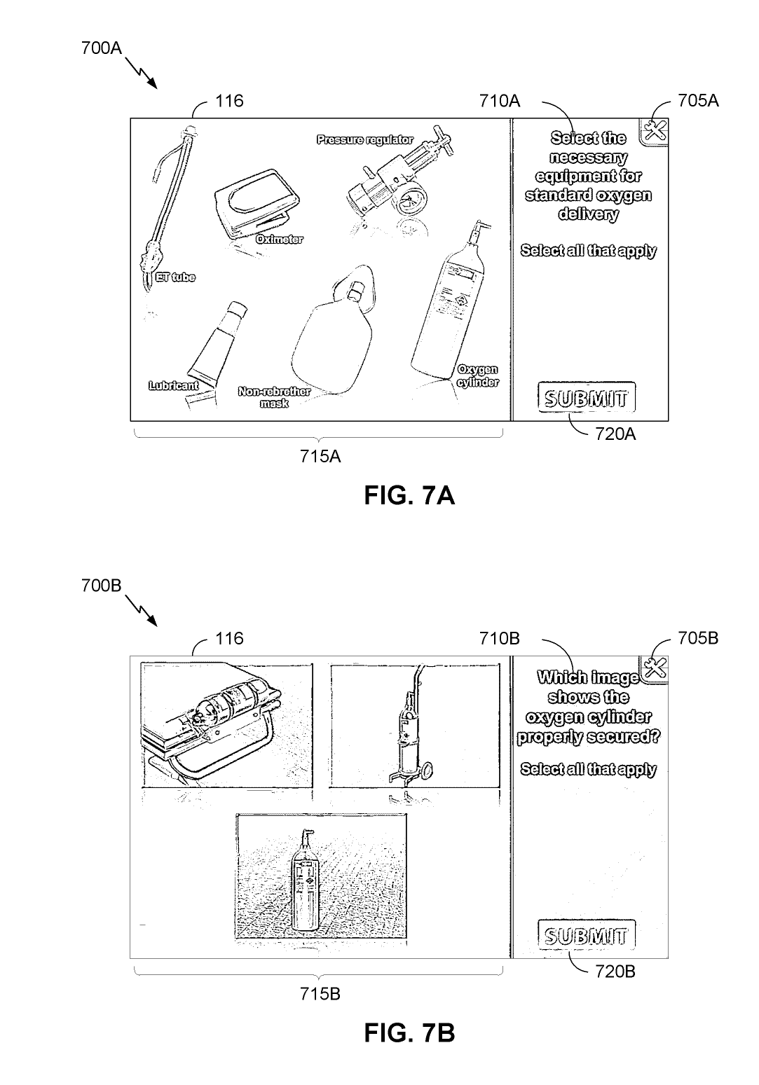

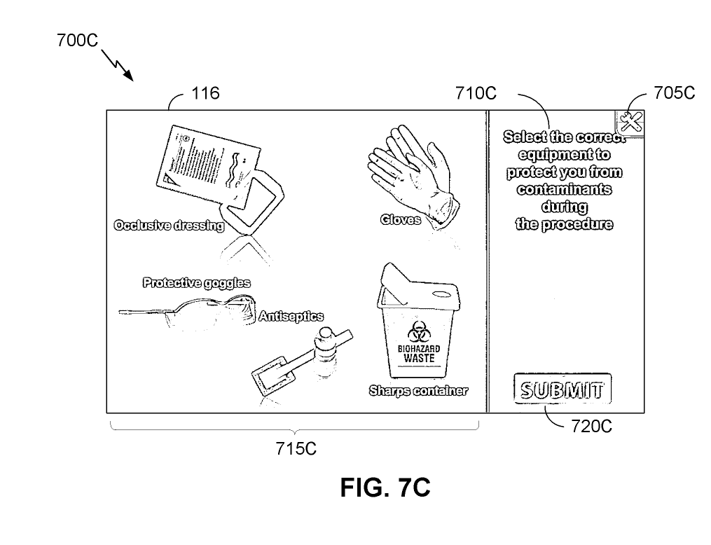

FIG. 7A illustrates an exemplary multi-choice point interface 700A, according to an oxygen administration training embodiment. As shown, the multi-choice point interface 700A depicts a medical test for oxygen administration in which the user is prompted to “select the necessary equipment for standard oxygen delivery.” The multi-choice point interface 700A can be implemented in, for example, the device 102 (FIG. 1). In various embodiments, the processor 104 (FIG. 1) can display the multi-choice point interface 700A on the display 116 (FIG. 1). As shown, the multi-choice point interface 700A includes a tool interface 705A, instructions 710A, a plurality of selectable media 715A, and a submit button 720A. Although various portions of the multi-choice point interface 700A are shown, a person having ordinary skill in the art will appreciate that the portions can be rearranged, portions can be omitted, and/or additional portions can be added.

The tool interface 705A serves to provide navigation, for example to a main menu and/or to one or more other medical training and/or testing interfaces described herein. The instructions 710A serve to instruct the user on how to interact with the multi-choice point interface 700A, and more particularly to “Select the necessary equipment for standard oxygen delivery; Select all that apply.” The one or more selectable media 715A represent individual equipment related to oxygen delivery. Exemplary equipment to display includes an endotracheal tube (ET), an oximeter, a pressure regulator, lubricant, a non-rebreather mask, and an oxygen cylinder. The submit button 720A serves to indicate that the user is ready for the processor 104 to evaluate the interaction.

FIG. 7B illustrates an exemplary multi-choice point interface 700B, according to another oxygen administration training embodiment. As shown, the multi-choice point interface 700B depicts a medical test for oxygen administration in which the user is prompted to select “Which image shows the oxygen cylinder properly secured?” The multi-choice point interface 700B can be implemented in, for example, the device 102 (FIG. 1). In various embodiments, the processor 104 (FIG. 1) can display the multi-choice point interface 700B on the display 116 (FIG. 1). As shown, the multi-choice point interface 700B includes a tool interface 705B, instructions 710B, a plurality of selectable media 715B, and a submit button 720B. Although various portions of the multi-choice point interface 700B are shown, a person having ordinary skill in the art will appreciate that the portions can be rearranged, portions can be omitted, and/or additional portions can be added.

The tool interface 705B serves to provide navigation, for example to a main menu and/or to one or more other medical training and/or testing interfaces described herein. The instructions 710B serve to instruct the user on how to interact with the multi-choice point interface 700B, and more particularly “Which image shows the oxygen cylinder properly secured? Select all that apply.” The one or more selectable media 715B represent various configurations for securing an oxygen cylinder. The submit button 720B serves to indicate that the user is ready for the processor 104 to evaluate the interaction.

FIG. 7C illustrates an exemplary multi-choice point interface 700C, according to another oxygen administration training embodiment. As shown, the multi-choice point interface 700C depicts a medical test for oxygen administration in which the user is prompted to “Select the correct equipment to protect you from contaminants during the procedure.” The multi-choice point interface 700C can be implemented in, for example, the device 102 (FIG. 1). In various embodiments, the processor 104 (FIG. 1) can display the multi-choice point interface 700C on the display 116 (FIG. 1). As shown, the multi-choice point interface 700C includes a tool interface 705C, instructions 710C, a plurality of selectable media 715C, and a submit button 720C. Although various portions of the multi-choice point interface 700C are shown, a person having ordinary skill in the art will appreciate that the portions can be rearranged, portions can be omitted, and/or additional portions can be added.

The tool interface 705C serves to provide navigation, for example to a main menu and/or to one or more other medical training and/or testing interfaces described herein. The instructions 710C serve to instruct the user on how to interact with the multi-choice point interface 700C, and more particularly “Select the correct equipment to protect you from contaminants during the procedure.” The one or more selectable media 715C represent various protective equipment. For example, protective equipment can include occlusive dressing, gloves, protective goggles, antiseptics, and a sharps container. The submit button 720C serves to indicate that the user is ready for the processor 104 to evaluate the interaction.

### Single-Choice Point

In an embodiment, setting up an interaction for medical training and/or testing data (discussed above with respect to block 240 of FIG. 2) can include setting up a single-choice point gesture. The processor 104 can load one or more parameters for the single-choice point gesture from the memory 106. In an embodiment, the single-choice point gesture can allow a user to indicate a single selection.

In an embodiment, loading medical training and/or testing data (discussed above with respect to block 210 of FIG. 2) can include loading information indicating a correct selection. For example, the processor 104 can load the correct selection from the memory 106. In some embodiments, the processor 104 can load a color map indicating selectable image regions and/or an image region corresponding to a correct selection.

In an embodiment, loading medical training and/or testing media (discussed above with respect to block 220 of FIG. 2) can include loading one or more selectable media (which can be implemented as selectable portions of a single image) and instructions. Each selectable image can represent equipment, actions, responses, and/or configurations related to a medical procedure. The instructions can include text such as, for example, “Select the appropriate type of oxygen cylinder.”

In various embodiments, the medical training and/or testing media can include a background video or image, with or without looping. In various embodiments, the medical training and/or testing media can include hidden images. The processor 104 can cause the display 116 to output the hidden images when predetermined areas of the screen are selected. In various embodiments, the medical training and/or testing media can include explanations for correct and incorrect answers and/or accompanying sounds.

In an embodiment, providing a medical training and/or testing prompt (discussed above with respect to block 230 of FIG. 2) can include displaying the one or more selectable media and/or the instruction text. For example, the processor 104 can cause the display 116 to output the one or more selectable media and/or the instruction text discussed above. In an embodiment, the processor 104 causes the display 116 to output the plurality of selectable media in a grid. In an embodiment, the processor 104 causes the display 116 to output a tutorial illustrating the single-choice point interaction.

In an embodiment, receiving the medical training and/or testing interaction (discussed above with respect to block 250 of FIG. 2) can include receiving a single user selection. For example, the processor 104 can receive one or more touch locations from the digitizer 118. The processor 104 can identify a single selected image or image portion based on the one or more touch locations received from the digitizer 118. In an embodiment, the processor 104 can dismiss touch locations not corresponding to a selectable image, portion of an image, or region of the digitizer 118.

In an embodiment, evaluating the medical training and/or testing interaction (discussed above with respect to block 260 of FIG. 2) can include identifying user selection of a single selectable image. In an embodiment, when an image is selected, the processor 104 can cause the display 116 to highlight the selected image or image portion. In an embodiment, when an image is selected, the processor 104 can cause the display 116 to output a description of the selected image. In an embodiment, when an image is selected, the processor 104 can cause the user interface 122 output a corresponding sound.

In an embodiment, the processor 104 can compare the received gesture to a single-choice point gesture template in the memory 106. For example, the processor 104 can determine whether the user has touched a selectable region of the medical training and/or testing media. When the processor 104 detects selection of a selectable image, the processor 104 can compare the selected image with the indication of the correct selection obtained from the medical training and/or testing data. When the processor 104 determines that an inaccurate answer has been given, the processor 104 can reset the medical training and/or testing prompt. When the processor 104 determines that an inaccurate answer has been given, the processor 104 can cause the display 116 to output an indication that the selection was incorrect. When the processor 104 determines that an inaccurate answer has been given, the processor 104 can cause the display 116 to output an explanation indicating why the selection was incorrect.

In an embodiment, the processor 104 is configured to determine if the selected image is correct. When the image is correct, the processor 104 can determine that a correct answer has been given. In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu. When the processor 104 determines that an accurate answer has been given, the processor 104 can cause the display 116 to output an explanation indicating why the answer was correct.

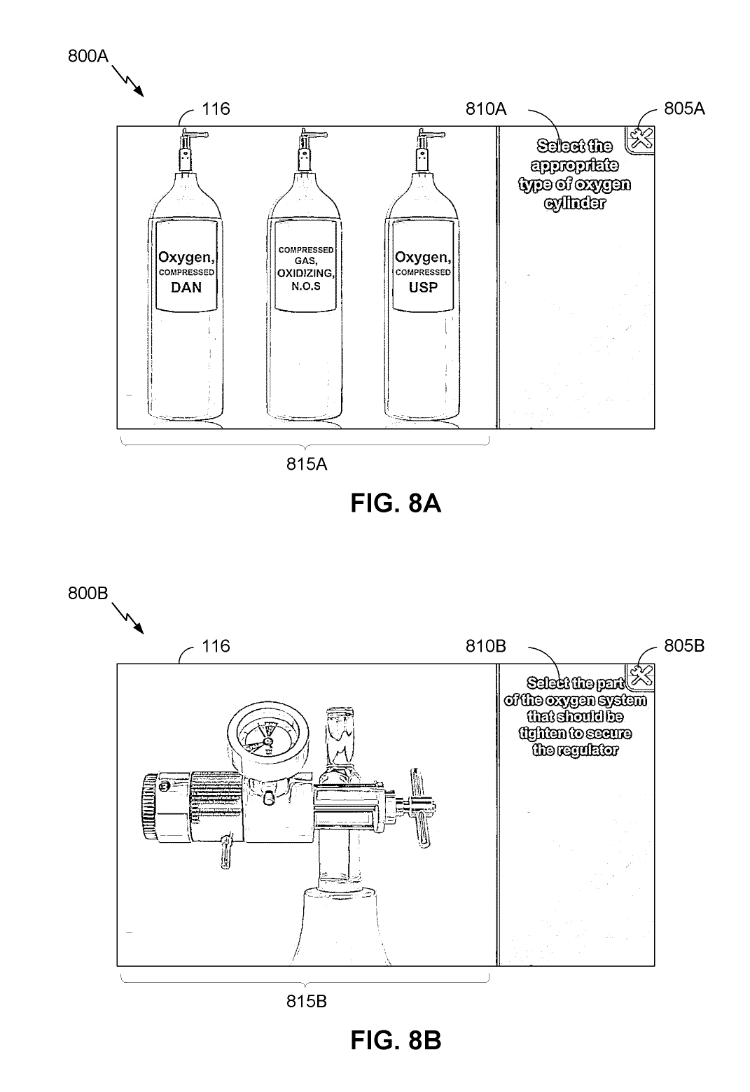

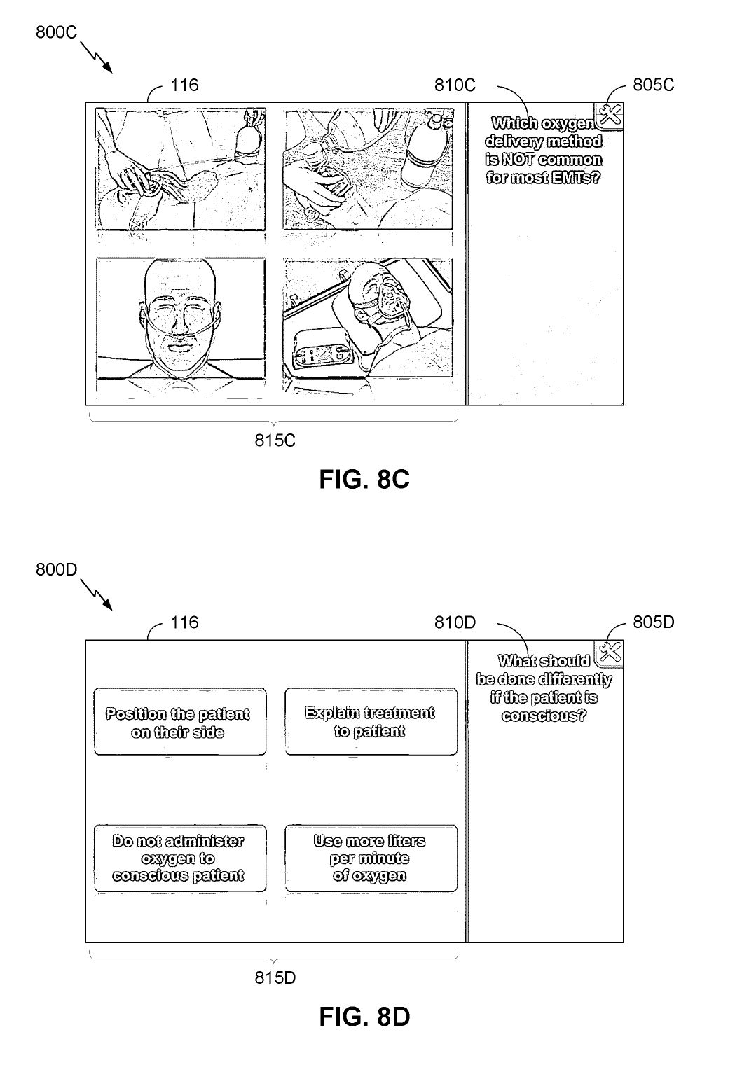

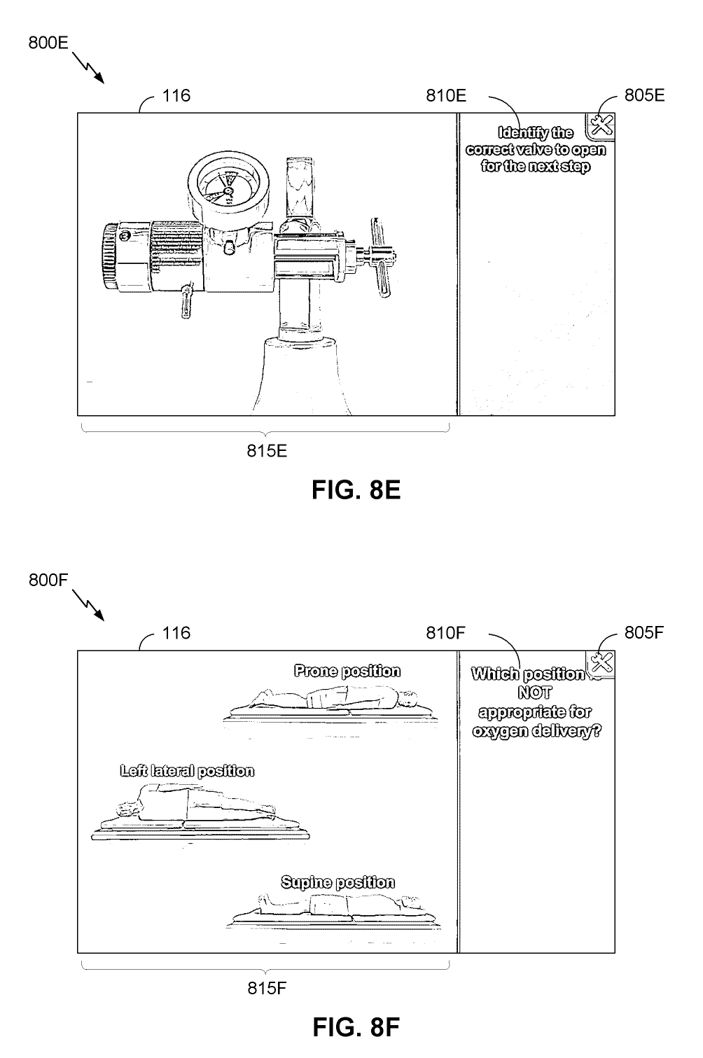

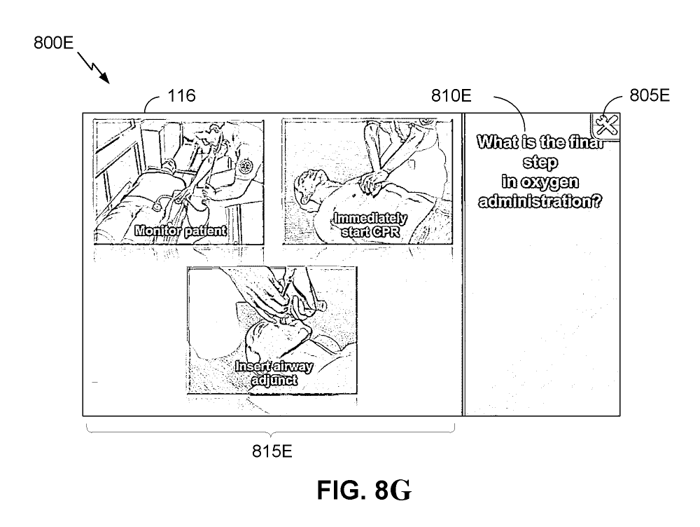

FIG. 8A illustrates an exemplary single-choice point interface 800A, according to an oxygen administration training embodiment. As shown, the single-choice point interface 800A depicts a medical test for oxygen administration in which the user is prompted to “Select the appropriate type of oxygen cylinder.” The single-choice point interface 800A can be implemented in, for example, the device 102 (FIG. 1). In various embodiments, the processor 104 (FIG. 1) can display the single-choice point interface 800A on the display 116 (FIG. 1). As shown, the single-choice point interface 800A includes a tool interface 805A, instructions 810A, and a plurality of selectable media 815A. Although various portions of the single-choice point interface 800A are shown, a person having ordinary skill in the art will appreciate that the portions can be rearranged, portions can be omitted, and/or additional portions can be added.

The tool interface 805A serves to provide navigation, for example to a main menu and/or to one or more other medical training and/or testing interfaces described herein. The instructions 810A serve to instruct the user on how to interact with the single-choice point interface 800A, and more particularly to “Select the appropriate type of oxygen cylinder.” The one or more selectable media 815A represent various grades of oxygen that can be administered.

FIG. 8B illustrates an exemplary single-choice point interface 800B, according to another oxygen administration training embodiment. As shown, the single-choice point interface 800B depicts a medical test for oxygen administration in which the user is prompted to “Select part of the oxygen system that should be tightened to secure the regulator.” The single-choice point interface 800B can be implemented in, for example, the device 102 (FIG. 1). In various embodiments, the processor 104 (FIG. 1) can display the single-choice point interface 800B on the display 116 (FIG. 1). As shown, the single-choice point interface 800B includes a tool interface 805B, instructions 810B, and a plurality of selectable media 815B. Although various portions of the single-choice point interface 800B are shown, a person having ordinary skill in the art will appreciate that the portions can be rearranged, portions can be omitted, and/or additional portions can be added.

The tool interface 805B serves to provide navigation, for example to a main menu and/or to one or more other medical training and/or testing interfaces described herein. The instructions 810B serve to instruct the user on how to interact with the single-choice point interface 800B, and more particularly to “Select part of the oxygen system that should be tightened to secure the regulator.” The one or more selectable media 815B represent various parts of an oxygen system, shown as an integrated drawing with individually selectable regions representing parts.

FIG. 8C illustrates an exemplary single-choice point interface 800C, according to another oxygen administration training embodiment. As shown, the single-choice point interface 800C depicts a medical test for oxygen administration in which the user is prompted to select “Which oxygen delivery method is NOT common for most EMTs?” The single-choice point interface 800C can be implemented in, for example, the device 102 (FIG. 1). In various embodiments, the processor 104 (FIG. 1) can display the single-choice point interface 800C on the display 116 (FIG. 1). As shown, the single-choice point interface 800C includes a tool interface 805C, instructions 810C, and a plurality of selectable media 815C. Although various portions of the single-choice point interface 800C are shown, a person having ordinary skill in the art will appreciate that the portions can be rearranged, portions can be omitted, and/or additional portions can be added.

The tool interface 805C serves to provide navigation, for example to a main menu and/or to one or more other medical training and/or testing interfaces described herein. The instructions 810C serve to instruct the user on how to interact with the single-choice point interface 800C, and more particularly to select “Which oxygen delivery method is NOT common for most EMTs?” The one or more selectable media 815C represent various oxygen delivery methods.

FIG. 8D illustrates an exemplary single-choice point interface 800D, according to another oxygen administration training embodiment. As shown, the single-choice point interface 800D depicts a medical test for oxygen administration in which the user is prompted to select “What should be done differently if the patient is conscious?” The single-choice point interface 800D can be implemented in, for example, the device 102 (FIG. 1). In various embodiments, the processor 104 (FIG. 1) can display the single-choice point interface 800D on the display 116 (FIG. 1). As shown, the single-choice point interface 800D includes a tool interface 805D, instructions 810D, and a plurality of selectable media 815D. Although various portions of the single-choice point interface 800D are shown, a person having ordinary skill in the art will appreciate that the portions can be rearranged, portions can be omitted, and/or additional portions can be added.

The tool interface 805D serves to provide navigation, for example to a main menu and/or to one or more other medical training and/or testing interfaces described herein. The instructions 810D serve to instruct the user on how to interact with the single-choice point interface 800D, and more particularly to select “What should be done differently if the patient is conscious?” The one or more selectable media 815D represent various tasks that can be performed differently. Exemplary tasks that can be performed differently include “position the patient on their side,” “explain treatment to patient,” “do not administer oxygen to conscious patient,” and “use more liters per minute of oxygen.”

FIG. 8E illustrates an exemplary single-choice point interface 800E, according to another oxygen administration training embodiment. As shown, the single-choice point interface 800E depicts a medical test for oxygen administration in which the user is prompted to “Identify the correct valve to open for the next step.” The single-choice point interface 800E can be implemented in, for example, the device 102 (FIG. 1). In various embodiments, the processor 104 (FIG. 1) can display the single-choice point interface 800E on the display 116 (FIG. 1). As shown, the single-choice point interface 800E includes a tool interface 805E, instructions 810E, and a plurality of selectable media 815E. Although various portions of the single-choice point interface 800E are shown, a person having ordinary skill in the art will appreciate that the portions can be rearranged, portions can be omitted, and/or additional portions can be added.

The tool interface 805E serves to provide navigation, for example to a main menu and/or to one or more other medical training and/or testing interfaces described herein. The instructions 810E serve to instruct the user on how to interact with the single-choice point interface 800E, and more particularly to “Identify the correct valve to open for the next step.” The one or more selectable media 815E represent various parts of an oxygen system, including one or more valves, illustrated as an integrated image with individually selectable regions representing parts.

FIG. 8F illustrates an exemplary single-choice point interface 800F, according to another oxygen administration training embodiment. As shown, the single-choice point interface 800F depicts a medical test for oxygen administration in which the user is prompted to select “which position is NOT appropriate for oxygen delivery?” The single-choice point interface 800F can be implemented in, for example, the device 102 (FIG. 1). In various embodiments, the processor 104 (FIG. 1) can display the single-choice point interface 800F on the display 116 (FIG. 1). As shown, the single-choice point interface 800F includes a tool interface 805F, instructions 810F, and a plurality of selectable media 815F. Although various portions of the single-choice point interface 800F are shown, a person having ordinary skill in the art will appreciate that the portions can be rearranged, portions can be omitted, and/or additional portions can be added.

The tool interface 805F serves to provide navigation, for example to a main menu and/or to one or more other medical training and/or testing interfaces described herein. The instructions 810F serve to instruct the user on how to interact with the single-choice point interface 800F, and more particularly to select “which position is NOT appropriate for oxygen delivery?” The one or more selectable media 815F represent various patient positions. Exemplary patient positions include the prone position, left lateral position, and supine position.

FIG. 8G illustrates an exemplary single-choice point interface 800G, according to another oxygen administration training embodiment. As shown, the single-choice point interface 800G depicts a medical test for oxygen administration in which the user is prompted to select “What is the final step in oxygen administration?” The single-choice point interface 800G can be implemented in, for example, the device 102 (FIG. 1). In various embodiments, the processor 104 (FIG. 1) can display the single-choice point interface 800G on the display 116 (FIG. 1). As shown, the single-choice point interface 800G includes a tool interface 805G, instructions 810G, and a plurality of selectable media 815G. Although various portions of the single-choice point interface 800G are shown, a person having ordinary skill in the art will appreciate that the portions can be rearranged, portions can be omitted, and/or additional portions can be added.

The tool interface 805G serves to provide navigation, for example to a main menu and/or to one or more other medical training and/or testing interfaces described herein. The instructions 810G serve to instruct the user on how to interact with the single-choice point interface 800G, and more particularly to select “What is the final step in oxygen administration?” The one or more selectable media 815G represent steps of oxygen administration. Exemplary steps include “monitor patient,” “immediately start CPR,” and “insert airway adjunct.”

### Drag-and-Drop

In an embodiment, setting up an interaction for medical training and/or testing data (discussed above with respect to block 240 of FIG. 2) can include setting up a drag-and-drop gesture. The processor 104 can load one or more parameters for the drag-and-drop gesture from the memory 106. In an embodiment, the drag-and-drop gesture can allow a user to tap and drag medical training and/or testing media from one part of the display 116 (FIG. 1) to another.

In an embodiment, loading medical training and/or testing data (discussed above with respect to block 210 of FIG. 2) can include loading information indicating one or more correct placement locations associated with one or more medical training and/or testing media objects. For example, the processor 104 can load the correct selection from the memory 106. In some embodiments, the processor 104 can load a color map indicating one or more correct placement regions. In some embodiments, each medical training and/or testing media object can be associated with a separate color map.

In an embodiment, loading medical training and/or testing media (discussed above with respect to block 220 of FIG. 2) can include loading a background image, one or more movable images, and instructions. Each movable image can represent equipment, actions, responses, and/or configurations related to a medical procedure. The instructions can include text such as, for example, “Place the appropriate equipment correctly.”

In various embodiments, the medical training and/or testing media can include a background video or image, with or without looping. In various embodiments, the medical training and/or testing media can include hidden images. The processor 104 can cause the display 116 to output the hidden images when predetermined areas of the screen are selected. In various embodiments, the medical training and/or testing media can include explanations for correct and incorrect answers and/or accompanying sounds.

In an embodiment, providing a medical training and/or testing prompt (discussed above with respect to block 230 of FIG. 2) can include displaying the one or more movable images, the background image, and/or the instruction text. For example, the processor 104 can cause the display 116 to output the one or more movable images, the background image, and/or the instruction text discussed above. In an embodiment, the processor 104 causes the display 116 to output a plurality of movable images in a grid. In an embodiment, the processor 104 causes the display 116 to output a tutorial illustrating the drag-and-drop interaction.

In an embodiment, receiving the medical training and/or testing interaction (discussed above with respect to block 250 of FIG. 2) can include receiving one or more user swipes. For example, the processor 104 can receive one or more touch paths from the digitizer 118, which can include a start point and an end point. The processor 104 can track an initial touch at the start point, movement of the touch location to the end point, and release of the touch at the end point. The processor 104 can identify a single movable image based on the initial touch point. In an embodiment, the processor 104 can dismiss initial touch locations not corresponding to a movable image, portion of an image, or region of the digitizer 118.

In an embodiment, evaluating the medical training and/or testing interaction (discussed above with respect to block 260 of FIG. 2) can include identifying user selection and movement of one or more movable images. In an embodiment, when an image is selected, the processor 104 can cause the display 116 to move the selected image along the touch path. In an embodiment, when an image is selected, the processor 104 can cause the display 116 to output a description of the selected image. In an embodiment, when an image is selected, the processor 104 can cause the user interface 122 output a corresponding sound.

In an embodiment, the processor 104 can compare the received gesture to a drag-and-drop gesture template in the memory 106. For example, the processor 104 can determine whether the user has touched a movable region of the medical training and/or testing media. When the processor 104 detects selection of a movable image, the processor 104 can move the selected image to the identified end point. The processor 104 can compare the moved image and end point to a list of movable images and correct end points obtained from the medical training and/or testing data. When the end point matches a correct end point corresponding to the moved image, the processor 104 can determine a correct answer. In an embodiment, the correct end point can include a region of correct end points indicative of an acceptable drop region. In some embodiments, only the end point is used to determine a correct answer. In other embodiments described in greater detail herein, the processor 104 can compare the touch path (or the path of the image) to a correct path.

When the processor 104 determines that an inaccurate answer has been given, the processor 104 can at least partially reset the medical training and/or testing prompt. For example, the processor 104 can cause the display 116 to move the moved image back to the starting point. When the processor 104 determines that an inaccurate answer has been given, the processor 104 can cause the display 116 to output an indication that the movement was incorrect. The indication can be audio, visual, and/or textual. When the processor 104 determines that an inaccurate answer has been given, the processor 104 can cause the display 116 to output an explanation indicating why the selection was incorrect.

When a movable image is moved to a correct region, the processor 104 can cause the display 116 to move the image to a final correct location. For example, the selected image, when moved to an edge of a correct location, or within an acceptable zone, can “snap” to the center of the correct location. In various embodiments, each movable image can have any number of correct locations, including none, one, two, etc.

When a threshold number of movable images are moved to correct locations, the processor 104 can determine that a correct answer has been given. In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu. When the processor 104 determines that an accurate answer has been given, the processor 104 can cause the display 116 to output an explanation indicating why the answer was correct.

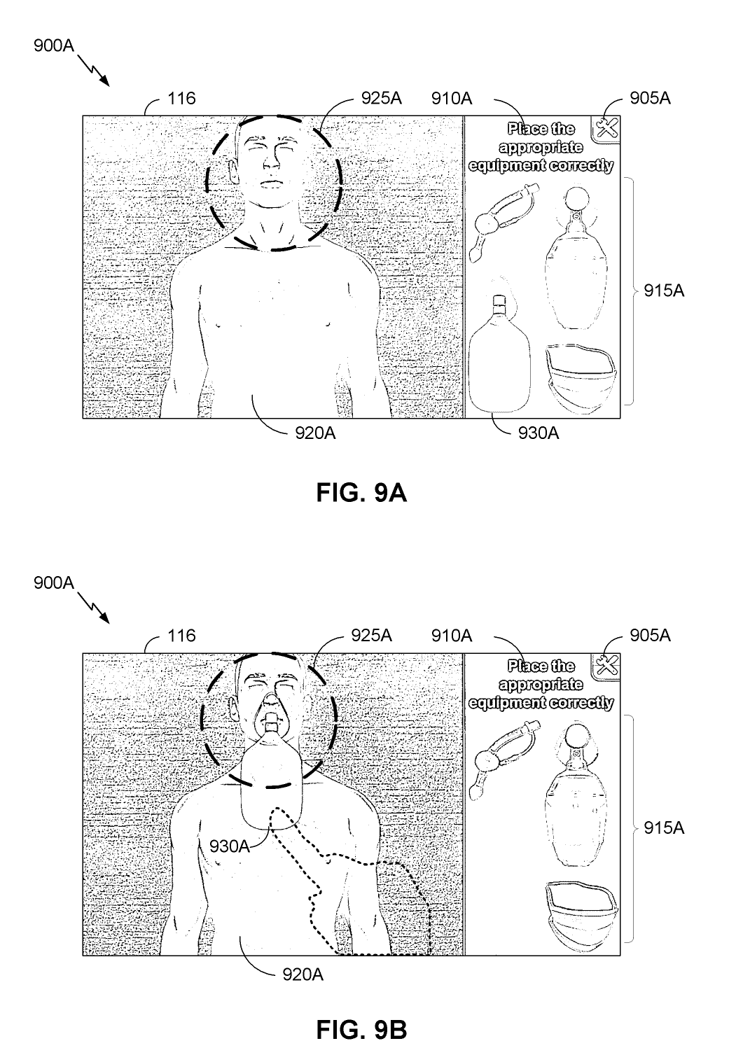

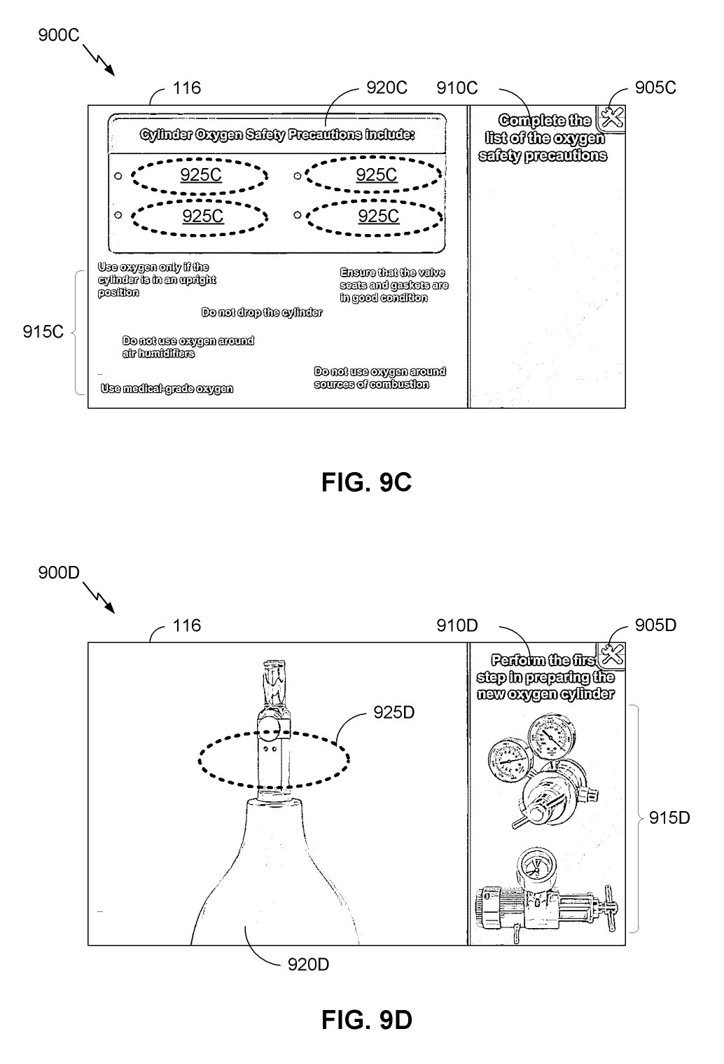

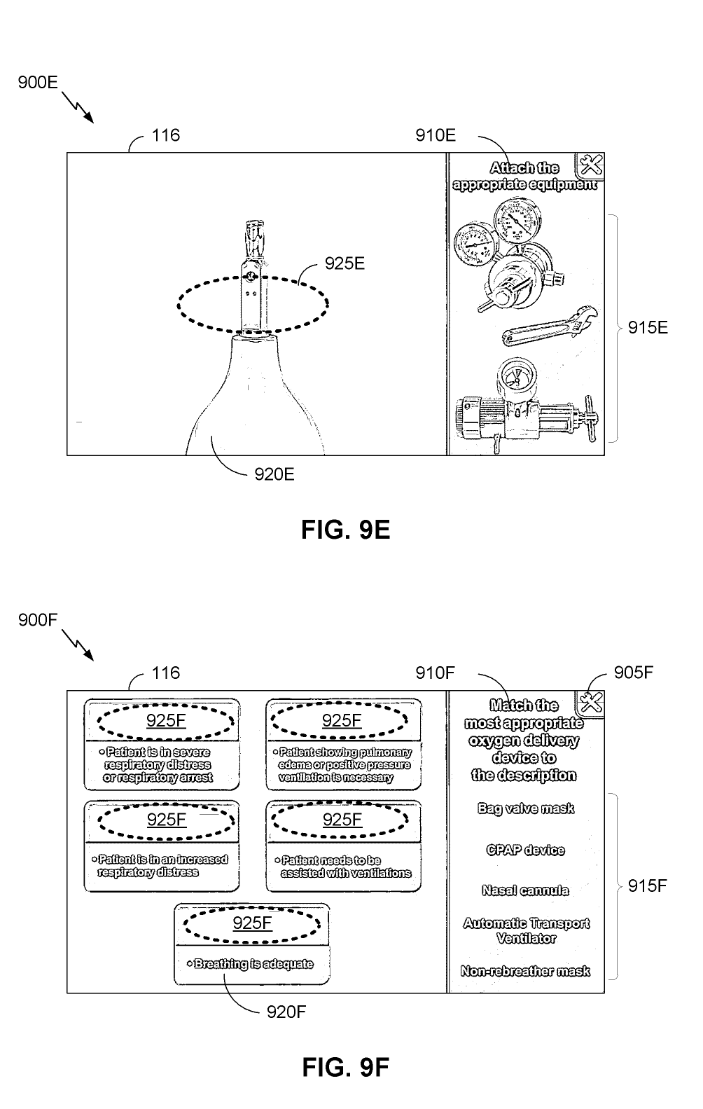

FIG. 9A illustrates an exemplary drag-and-drop interface 900A, according to an oxygen administration training embodiment. As shown, the drag-and-drop interface 900A depicts a medical test for oxygen administration in which the user is prompted to “Place the appropriate equipment correctly.” The drag-and-drop interface 900A can be implemented in, for example, the device 102 (FIG. 1). In various embodiments, the processor 104 (FIG. 1) can display the drag-and-drop interface 900A on the display 116 (FIG. 1). As shown, the drag-and-drop interface 900A includes a tool interface 905A, instructions 910A, a plurality of movable media 915A, a background image 920A, and one or more correct answer regions 925A. Although various portions of the drag-and-drop interface 900A are shown, a person having ordinary skill in the art will appreciate that the portions can be rearranged, portions can be omitted, and/or additional portions can be added.

The tool interface 905A serves to provide navigation, for example to a main menu and/or to one or more other medical training and/or testing interfaces described herein. The instructions 910A serve to instruct the user on how to interact with the drag-and-drop interface 900A, and more particularly to “Place the appropriate equipment correctly.” The one or more movable images 915A represent various equipment for providing oxygen. In various embodiments, the equipment can include a non-rebreather mask 930A and an ET. The background image 920A serves to indicate potential locations for placement of the movable images 915A. The correct answer region 925A, which can be hidden from the user, represents an area into which a particular movable image 915A can be placed correctly.

FIG. 9B illustrates the exemplary drag-and-drop interface 900A of FIG. 9A, according to another oxygen administration training embodiment. As shown in FIG. 9B, the non-rebreather mask 930A has been correctly dragged and released or placed within the correct region 925A. In the illustrated embodiment, the medical training and/or testing data indicates the correct answer region 925A and associates the correct answer region 925A with the non-rebreather mask 930A.

FIG. 9C illustrates an exemplary drag-and-drop interface 900C, according to another oxygen administration training embodiment. As shown, the drag-and-drop interface 900C depicts a medical test for oxygen administration in which the user is prompted to “Complete the list of the oxygen safety precautions.” The drag-and-drop interface 900C can be implemented in, for example, the device 102 (FIG. 1). In various embodiments, the processor 104 (FIG. 1) can display the drag-and-drop interface 900C on the display 116 (FIG. 1). As shown, the drag-and-drop interface 900C includes a tool interface 905C, instructions 910C, a plurality of movable media 915C, a background image 920C, and a plurality of correct answer regions 925C. Although various portions of the drag-and-drop interface 900C are shown, a person having ordinary skill in the art will appreciate that the portions can be rearranged, portions can be omitted, and/or additional portions can be added.

The tool interface 905C serves to provide navigation, for example to a main menu and/or to one or more other medical training and/or testing interfaces described herein. The instructions 910C serve to instruct the user on how to interact with the drag-and-drop interface 900C, and more particularly to “Complete the list of the oxygen safety precautions.” The one or more movable images 915C represent oxygen safety precaution choices (of which some are correct and some are incorrect). In various embodiments, the precaution choices can include “use oxygen only if the cylinder is in an upright position,” “do not drop the cylinder,” “do not use oxygen around air humidifiers,” “ensure that the valve seats and gaskets are in good condition,” “use medical-grade oxygen,” and “do not use oxygen around sources of combustion.” The background image 920C serves to indicate potential locations for placement of the movable images 915C. The correct answer regions 925C, which can be hidden from the user, represent areas into which particular movable images 915C can be placed correctly. In the illustrated embodiment, only a subset of the movable images 915C are associated with the correct answer regions 925C.

FIG. 9D illustrates an exemplary drag-and-drop interface 900D, according to another oxygen administration training embodiment. As shown, the drag-and-drop interface 900D depicts a medical test for oxygen administration in which the user is prompted to “Perform the first step in preparing the new oxygen cylinder.” The drag-and-drop interface 900D can be implemented in, for example, the device 102 (FIG. 1). In various embodiments, the processor 104 (FIG. 1) can display the drag-and-drop interface 900D on the display 116 (FIG. 1). As shown, the drag-and-drop interface 900D includes a tool interface 905D, instructions 910D, a plurality of movable media 915D, a background image 920D, and one or more correct answer regions 925D. Although various portions of the drag-and-drop interface 900D are shown, a person having ordinary skill in the art will appreciate that the portions can be rearranged, portions can be omitted, and/or additional portions can be added.

The tool interface 905D serves to provide navigation, for example to a main menu and/or to one or more other medical training and/or testing interfaces described herein. The instructions 910D serve to instruct the user on how to interact with the drag-and-drop interface 900D, and more particularly to “Perform the first step in preparing the new oxygen cylinder.” The one or more movable images 915D represent oxygen cylinder attachments (of which some are correct and some are incorrect). The background image 920D serves to indicate potential locations for placement of the movable images 915D. The correct answer region 925D, which can be hidden from the user, represents an area into which a particular movable image 915D can be placed correctly. In the illustrated embodiment, only a subset of the movable images 915D are associated with the correct answer region 925D.

FIG. 9E illustrates an exemplary drag-and-drop interface 900E, according to another oxygen administration training embodiment. As shown, the drag-and-drop interface 900E depicts a medical test for oxygen administration in which the user is prompted to “Attach the appropriate equipment.” The drag-and-drop interface 900E can be implemented in, for example, the device 102 (FIG. 1). In various embodiments, the processor 104 (FIG. 1) can display the drag-and-drop interface 900E on the display 116 (FIG. 1). As shown, the drag-and-drop interface 900E includes a tool interface 905E, instructions 910E, a plurality of movable media 915E, a background image 920E, and one or more correct answer regions 925E. Although various portions of the drag-and-drop interface 900E are shown, a person having ordinary skill in the art will appreciate that the portions can be rearranged, portions can be omitted, and/or additional portions can be added.

The tool interface 905E serves to provide navigation, for example to a main menu and/or to one or more other medical training and/or testing interfaces described herein. The instructions 910E serve to instruct the user on how to interact with the drag-and-drop interface 900E, and more particularly to “Attach the appropriate equipment.” The one or more movable images 915E represent oxygen cylinder attachments (of which some are correct and some are incorrect). The background image 920E serves to indicate potential locations for placement of the movable images 915E. The correct answer region 925E, which can be hidden from the user, represents an area into which a particular movable image 915E can be placed correctly. In the illustrated embodiment, only a subset of the movable images 915E are associated with the correct answer region 925E.

FIG. 9F illustrates an exemplary drag-and-drop interface 900F, according to another oxygen administration training embodiment. As shown, the drag-and-drop interface 900F depicts a medical test for oxygen administration in which the user is prompted to “Match the most appropriate oxygen delivery device to the description.” The drag-and-drop interface 900F can be implemented in, for example, the device 102 (FIG. 1). In various embodiments, the processor 104 (FIG. 1) can display the drag-and-drop interface 900F on the display 116 (FIG. 1). As shown, the drag-and-drop interface 900F includes a tool interface 900F, instructions 910F, a plurality of movable media 910F, a background image 920F, and a plurality of correct answer regions 925F. Although various portions of the drag-and-drop interface 900F are shown, a person having ordinary skill in the art will appreciate that the portions can be rearranged, portions can be omitted, and/or additional portions can be added.

The tool interface 905F serves to provide navigation, for example to a main menu and/or to one or more other medical training and/or testing interfaces described herein. The instructions 910F serve to instruct the user on how to interact with the drag-and-drop interface 900F, and more particularly to “Match the most appropriate oxygen delivery device to the description.” The one or more movable images 910F represent oxygen delivery devices. In various embodiments, the oxygen delivery devices include a “bag valve mask,” a “CPAP device,” a “nasal cannula,” an “automatic transport ventilator,” and a “non-rebreather mask.” The background image 920F serves to indicate potential locations for placement of the movable images 915F. The correct answer regions 925F, which can be hidden from the user, represent areas into which particular movable images 915F can be placed correctly. In the illustrated embodiment, each movable image 915F is associated with a single correct answer region 925F.

### Image Rotate

In an embodiment, setting up an interaction for medical training and/or testing data (discussed above with respect to block 240 of FIG. 2) can include setting up a rotate gesture. The processor 104 can load one or more parameters for the rotate gesture from the memory 106. In an embodiment, the rotate gesture can allow a user to tap and rotate medical training and/or testing media around a pivot point.

In an embodiment, loading medical training and/or testing data (discussed above with respect to block 210 of FIG. 2) can include loading information indicating one or more correct rotations or rotation angles (or a range of correct rotations or rotation angles), and a pivot point, with one or more medical training and/or testing media objects. For example, the processor 104 can load a range of correct rotations or rotation angles and a pivot point from the memory 106. In some embodiments, each medical training and/or testing media object can be associated with a separate correct rotation, rotation range, and/or pivot point.

In an embodiment, loading medical training and/or testing media (discussed above with respect to block 220 of FIG. 2) can include loading a background image, one or more rotatable images, and instructions. Each rotatable image can represent equipment, actions, responses, and/or configurations related to a medical procedure. The instructions can include text such as, for example, “Use a finger on the lever to crack the main valve.”

In various embodiments, the medical training and/or testing media can include a background video or image, with or without looping. In various embodiments, the medical training and/or testing media can include hidden images. The processor 104 can cause the display 116 to output the hidden images when predetermined areas of the screen are selected. In various embodiments, the medical and/or accompanying sounds.

In an embodiment, providing a medical training and/or testing prompt (discussed above with respect to block 230 of FIG. 2) can include displaying the one or more rotatable images, the background image, and/or the instruction text. For example, the processor 104 can cause the display 116 to output the one or more rotatable images, the background image, and/or the instruction text discussed above. In an embodiment, the processor 104 causes the display 116 to output a tutorial illustrating the rotate interaction. In an embodiment, the processor 104 can cause the display 116 to flash the rotatable image, thereby indicating which image is rotatable. In an embodiment, the processor 104 can cause the user interface 122 to output audio based on a rotation angle of the rotatable image. In an embodiment, the processor 104 can cause the user interface 122 to output an indication of the rotation angle of the rotatable image, for example, as a text overlay in degrees from a starting position.

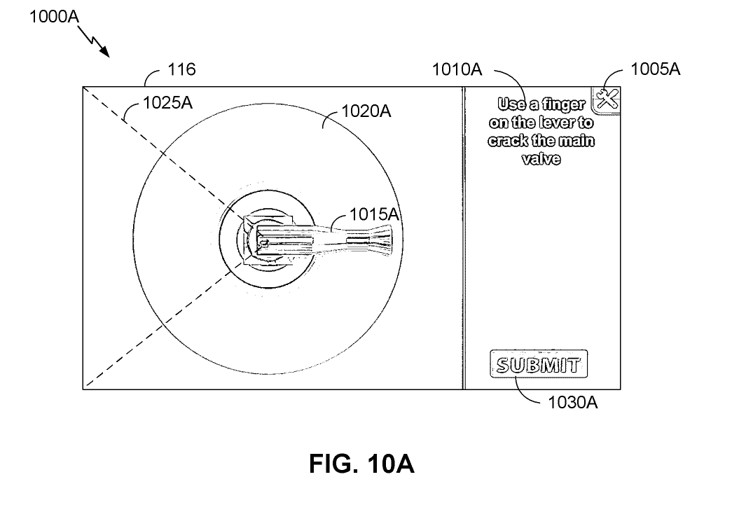

In an embodiment, receiving the medical training and/or testing interaction (discussed above with respect to block 250 of FIG. 2) can include receiving one or more user swipes. For example, the processor 104 can receive one or more touch paths from the digitizer 118, which can include a start point and an end point. The processor 104 can track an initial touch at the start point, movement of the touch location to the end point, and release of the touch at the end point. The processor 104 can identify a single rotatable image based on the initial touch point. In an embodiment, the processor 104 can dismiss initial touch locations not corresponding to a rotatable image, portion of an image, or region of the digitizer 118. In an embodiment, the processor 104 can associate all touch points in the rotate interface 1000A (see FIG. 10A) with a single rotatable image. In an embodiment, the processor 104 can receive selection of a submit button.

In an embodiment, evaluating the medical training and/or testing interaction (discussed above with respect to block 260 of FIG. 2) can include identifying user selection and rotation of one or more rotatable images. In an embodiment, when an image is selected, the processor 104 can cause the display 116 to rotate the selected image based on movement along the touch path. In an embodiment, when an image is selected, the processor 104 can cause the display 116 to output a description of the selected image. In an embodiment, when an image is selected, the processor 104 can cause the user interface 122 output a corresponding sound. In an embodiment, the processor 104 can identify selection of the submit button.

In an embodiment, the processor 104 can compare the received gesture to a rotate gesture template in the memory 106. For example, the processor 104 can determine whether the user has touched a rotatable region of the medical training and/or testing media. When the processor 104 detects selection of a rotatable image, the processor 104 can rotate the selected image based on the end point and/or the path to the end point. For example, the processor 104 can virtually or transparently extend the rotatable image to the entire display 116, and can simulate spinning of the rotatable image along a pivot point. The processor 104 can track a rotation angle of the rotatable image.

When the processor 104 detects selection of the submit button, the processor 104 can compare the tracked rotation angle to the correct angle or range of angles obtained from the medical training and/or testing data. When the rotation angle matches a correct rotation angle (or range of correct rotation angles) corresponding to the rotated image, the processor 104 can determine a correct answer. When the rotation angle does not match the correct rotation angle (or range of correct rotation angles) corresponding to the rotated image, the processor 104 can determine an incorrect answer.

When the processor 104 determines that an inaccurate answer has been given, the processor 104 can at least partially reset the medical training and/or testing prompt. For example, the processor 104 can cause the display 116 to rotate the rotated image back to the starting point. When the processor 104 determines that an inaccurate answer has been given, the processor 104 can cause the display 116 to output an indication that the rotation was incorrect. The indication can be audio, visual, and/or textual. When the processor 104 determines that an inaccurate answer has been given, the processor 104 can cause the display 116 to output an explanation indicating why the selection was incorrect.

When a rotatable image is rotated within a range of correct rotation angles, the processor 104 can cause the display 116 to rotate the image to a final correct rotation angle. For example, the rotated image, when rotated within a range of correct rotation angles, can “snap” to the center of the correct rotation angles. In various embodiments, the rotated image does not “snap” to the center of correct rotation angles.

In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu. When the processor 104 determines that an accurate answer has been given, the processor 104 can cause the display 116 to output an explanation indicating why the answer was correct.

FIG. 10A illustrates an exemplary rotate interface 1000A, according to an oxygen administration training embodiment. As shown, the rotate interface 1000A depicts a medical test for oxygen administration in which the user is prompted to “Use a finger on the lever to crack the main valve.” The rotate interface 1000A can be implemented in, for example, the device 102 (FIG. 1). In various embodiments, the processor 104 (FIG. 1) can display the rotate interface 1000A on the display 116 (FIG. 1). As shown, the rotate interface 1000A includes a tool interface 1005A, instructions 1010A, a rotatable media 1015A, a background image 1020A, a correct rotation range 1025A, which can be hidden from the user, and a submit button 1030A. Although various portions of the rotate interface 1000A are shown, a person having ordinary skill in the art will appreciate that the portions can be rearranged, portions can be omitted, and/or additional portions can be added.

The tool interface 1005A serves to provide navigation, for example to a main menu and/or to one or more other medical training and/or testing interfaces described herein. The instructions 1010A serve to instruct the user on how to interact with the rotate interface 1000A, and more particularly to “Use a finger on the lever to crack the main valve.” The rotatable image 1015A represents equipment for providing oxygen. In the illustrated embodiment, the rotatable image is a lever for cracking a main valve of an oxygen cylinder. The background image 1020A serves to provide context for rotation of the rotatable images 1015A. The correct rotation range 1025A, which can be hidden from the user, represents a range of angles for which rotation of the rotatable image 1015A is correct. The submit button 1030A serves to indicate that the user is ready for the processor 104 to evaluate the interaction.

### Slider

In an embodiment, setting up an interaction for medical training and/or testing data (discussed above with respect to block 240 of FIG. 2) can include setting up a slider gesture. The processor 104 can load one or more parameters for the slider gesture from the memory 106. In an embodiment, the slider gesture can allow a user to move their finger along a path region (for example, horizontally, vertically, diagonally, along a maze, etc.) to adjust an image on the display 116.

In an embodiment, loading medical training and/or testing data (discussed above with respect to block 210 of FIG. 2) can include loading information indicating one or more correct end values (or range or plurality of correct end values) and a slider location. For example, the processor 104 can load a slider location and correct end value from the memory 106.

In an embodiment, loading medical training and/or testing media (discussed above with respect to block 220 of FIG. 2) can include loading one or more background images and instructions. Each background image can represent equipment, actions, responses, and/or configurations related to a medical procedure. The instructions can include text such as, for example, “Using your index finger, adjust the flow meter to the correct range for a nasal cannula.” In some embodiments, the background image can vary according to a slider position. In some embodiments, the background image can be static, and a foreground image can be varied according to the slider position.

In various embodiments, the medical training and/or testing media can include a background video or image, with or without looping. In various embodiments, the medical training and/or testing media can include hidden images. The processor 104 can cause the display 116 to output the hidden images when predetermined areas of the slider are activated. In various embodiments, the medical training and/or testing media can include explanations for correct and incorrect answers and/or accompanying sounds.

In an embodiment, providing a medical training and/or testing prompt (discussed above with respect to block 230 of FIG. 2) can include displaying the background image, and/or the instruction text. For example, the processor 104 can cause the display 116 to output the background image and the instruction text discussed above. In an embodiment, the processor 104 causes the display 116 to output a tutorial illustrating the slider interaction. In an embodiment, the processor 104 can cause the display 116 to flash the slider, thereby indicating a slidable region.

In an embodiment, the processor 104 can cause the user interface 122 to output audio based on a position of the slider. In an embodiment, the processor 104 can cause the user interface 122 to output an indication of the slider location, for example, as a numerical text overlay, a graphical slider, a varying sound, etc. In some embodiments, the slider can be hidden. In some embodiments, the background image can change according to a slider position. In some embodiments, the processor 104 can cause the user interface 122 to output light, sound, and/or vibration based on the specific background image shown and/or slider position.

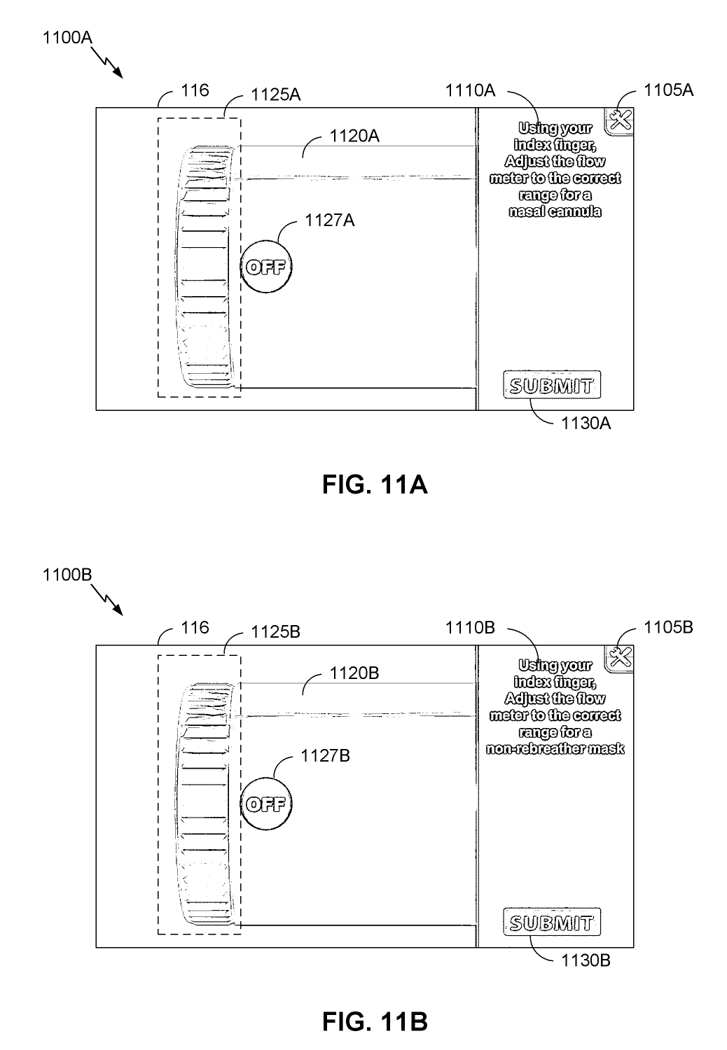

In an embodiment, receiving the medical training and/or testing interaction (discussed above with respect to block 250 of FIG. 2) can include receiving one or more user swipes. For example, the processor 104 can receive one or more touch paths from the digitizer 118, which can include a start point and an end point. The processor 104 can track an initial touch at the start point, movement of the touch location to the end point, and release of the touch at the end point. The processor 104 can identify a slider region based on the initial touch point. In an embodiment, the processor 104 can dismiss initial touch locations not corresponding to the slider region. In an embodiment, the processor 104 can associate all touch points in the slider interface 1100A (see FIG. 11A) with the slider. In an embodiment, the processor 104 can receive selection of a submit button.

In an embodiment, evaluating the medical training and/or testing interaction (discussed above with respect to block 260 of FIG. 2) can include identifying user selection and adjustment of one or more slider regions. In an embodiment, when a slider is selected, the processor 104 can cause the display 116 to display subsequent background images (or in reverse, depending on the direction of the slider motion) based on movement along the touch path. In an embodiment, when the slider is engaged, the processor 104 can cause the user interface 122 output a corresponding sound. In an embodiment, the processor 104 can identify selection of the submit button.

In an embodiment, the processor 104 can compare the received gesture to a slider gesture template in the memory 106. For example, the processor 104 can determine whether the user has touched a slider region of the medical training and/or testing media. When the processor 104 detects selection of a slider region, the processor 104 can adjust the slider and/or background image based on the end point and/or the path to the end point. For example, the processor 104 can advance or retreat the slider. The processor 104 can track a numerical value representing the slider position.

When the processor 104 detects selection of the submit button, the processor 104 can compare the tracked slider position or value to the correct value or range of values obtained from the medical training and/or testing data. When the slider position or value matches a correct value (or range of correct values), the processor 104 can determine a correct answer. When the slider position or value does not match the correct value (or range of correct values), the processor 104 can determine an incorrect answer.

When the processor 104 determines that an inaccurate answer has been given, the processor 104 can at least partially reset the medical training and/or testing prompt. For example, the processor 104 can cause the display 116 to reset the slider position and/or display an initial background image. When the processor 104 determines that an inaccurate answer has been given, the processor 104 can cause the display 116 to output an indication that the slider position was incorrect. The indication can be audio, visual, and/or textual. When the processor 104 determines that an inaccurate answer has been given, the processor 104 can cause the display 116 to output an explanation indicating why the selection was incorrect.

When the slider value is within a range of correct slider values, the processor 104 can cause the display 116 to adjust the slider to a final correct position. For example, the slider, when adjusted within a range of correct values, can “snap” to the center of the correct values. In various embodiments, the slider does not “snap” to the center of correct position.

In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu. When the processor 104 determines that an accurate answer has been given, the processor 104 can cause the display 116 to output an explanation indicating why the answer was correct.

FIG. 11A illustrates an exemplary slider interface 1100A, according to an oxygen administration training embodiment. As shown, the slider interface 1100A depicts a medical test for oxygen administration in which the user is prompted to “Using your index finger, Adjust the flow meter to the correct range for a nasal cannula.” The slider interface 1100A can be implemented in, for example, the device 102 (FIG. 1). In various embodiments, the processor 104 (FIG. 1) can display the slider interface 1100A on the display 116 (FIG. 1). As shown, the slider interface 1100A includes a tool interface 1105A, instructions 1110A, a background image 1120A, a slider area 1125A, and a submit button 1130A. Although various portions of the slider interface 1100A are shown, a person having ordinary skill in the art will appreciate that the portions can be rearranged, portions can be omitted, and/or additional portions can be added.

The tool interface 1105A serves to provide navigation, for example to a main menu and/or to one or more other medical training and/or testing interfaces described herein. The instructions 1110A serve to instruct the user on how to interact with the slider interface 1100A, and more particularly to “Using your index finger, Adjust the flow meter to the correct range for a nasal cannula.” The background image 1120A provides context for the slider interface 1100A. In the illustrated embodiment, the background image 1120A depicts a flow meter with an adjustable flow. In the illustrated embodiment, the slider is hidden within the slider area 1125A. As the user slides the hidden slider in the slider area 1125A, the processor 104 adjusts the background image 1120A to show the slider value (shown as “off”). The submit button 1130A serves to indicate that the user is ready for the processor 104 to evaluate the interaction.

FIG. 11B illustrates an exemplary slider interface 1100B, according to another oxygen administration training embodiment. As shown, the slider interface 1100B depicts a medical test for oxygen administration in which the user is prompted to “Using your index finger, Adjust the flow meter to the correct range for a non-breather mask.” The slider interface 1100B can be implemented in, for example, the device 102 (FIG. 1). In various embodiments, the processor 104 (FIG. 1) can display the slider interface 1100B on the display 116 (FIG. 1). As shown, the slider interface 1100B includes a tool interface 1105B, instructions 1110B, a background image 1120B, a slider area 1125B, and a submit button 1130B. Although various portions of the slider interface 1100B are shown, a person having ordinary skill in the art will appreciate that the portions can be rearranged, portions can be omitted, and/or additional portions can be added.

The tool interface 1105B serves to provide navigation, for example to a main menu and/or to one or more other medical training and/or testing interfaces described herein. The instructions 1110B serve to instruct the user on how to interact with the slider interface 1100B, and more particularly to “Using your index finger, Adjust the flow meter to the correct range for a non-breather mask.” The background image 1120B provides context for the slider interface 1100B. In the illustrated embodiment, the background image 1120B depicts a flow meter with an adjustable flow. In the illustrated embodiment, the slider is hidden within the slider area 1125B. As the user slides the hidden slider in the slider area 1125B, the processor 104 adjusts the background image 1120B to show the slider value (shown as “off”). The submit button 1130B serves to indicate that the user is ready for the processor 104 to evaluate the interaction.

### Cardiopulmonary Resuscitation (CPR)

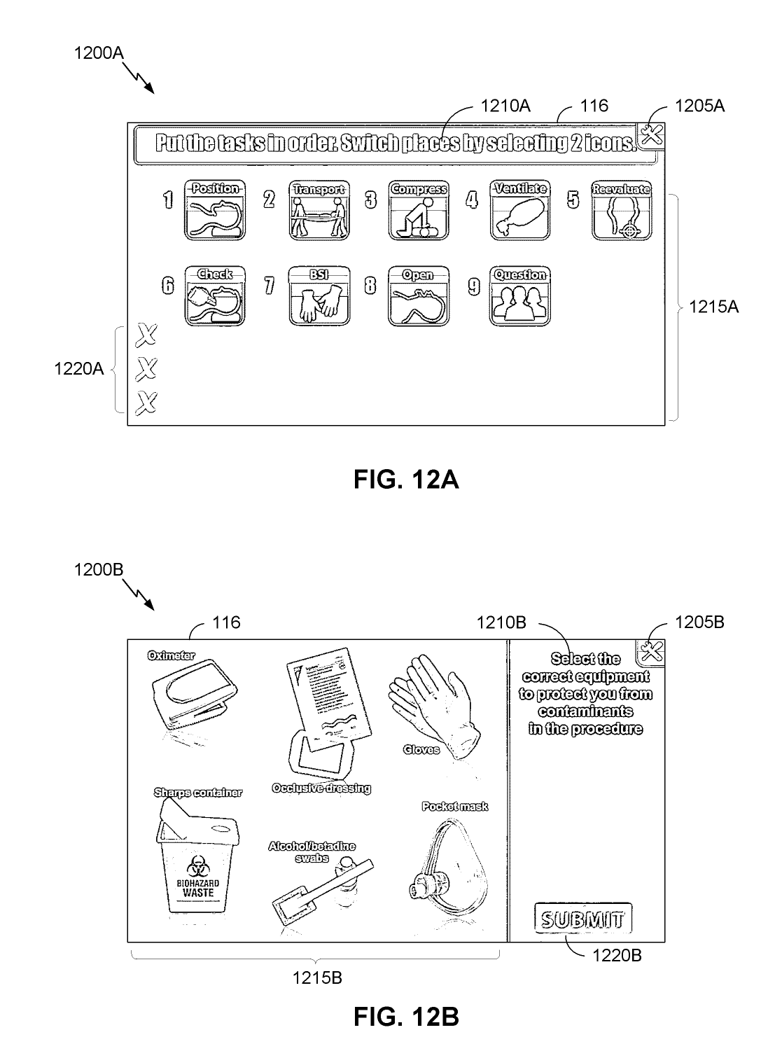

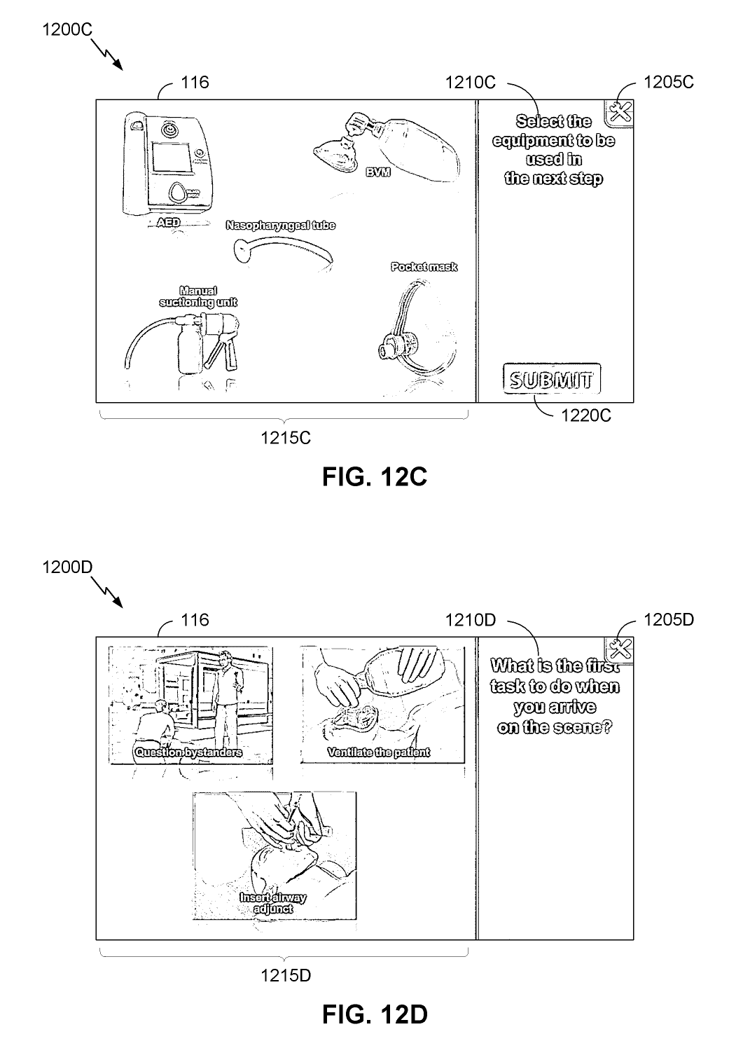

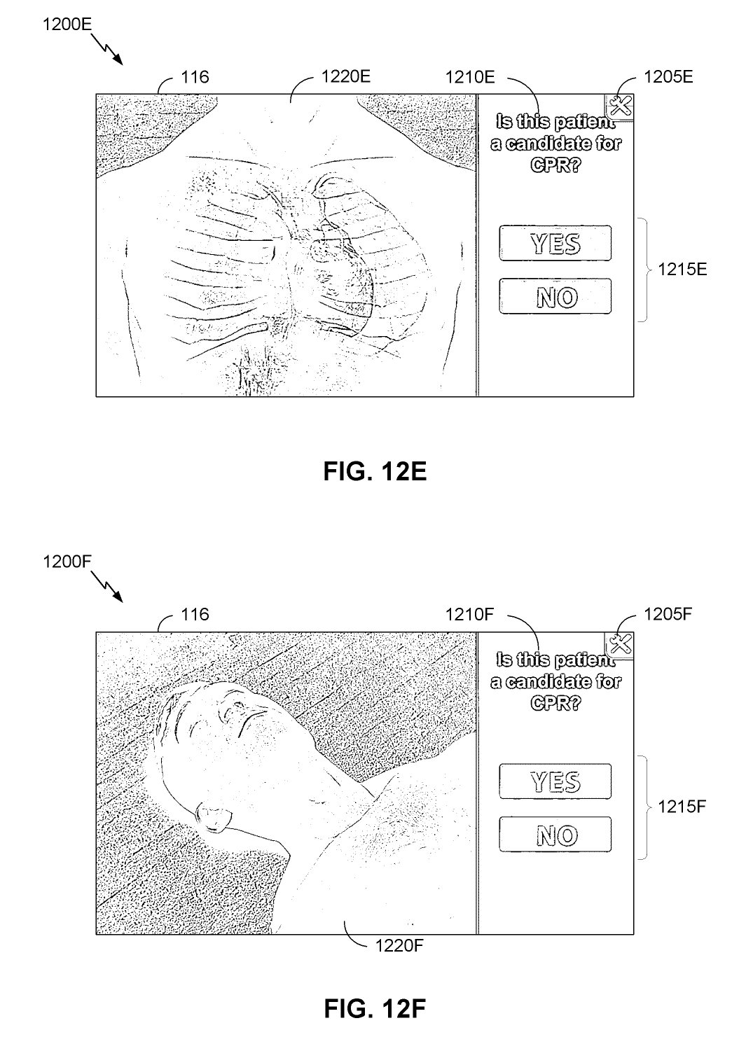

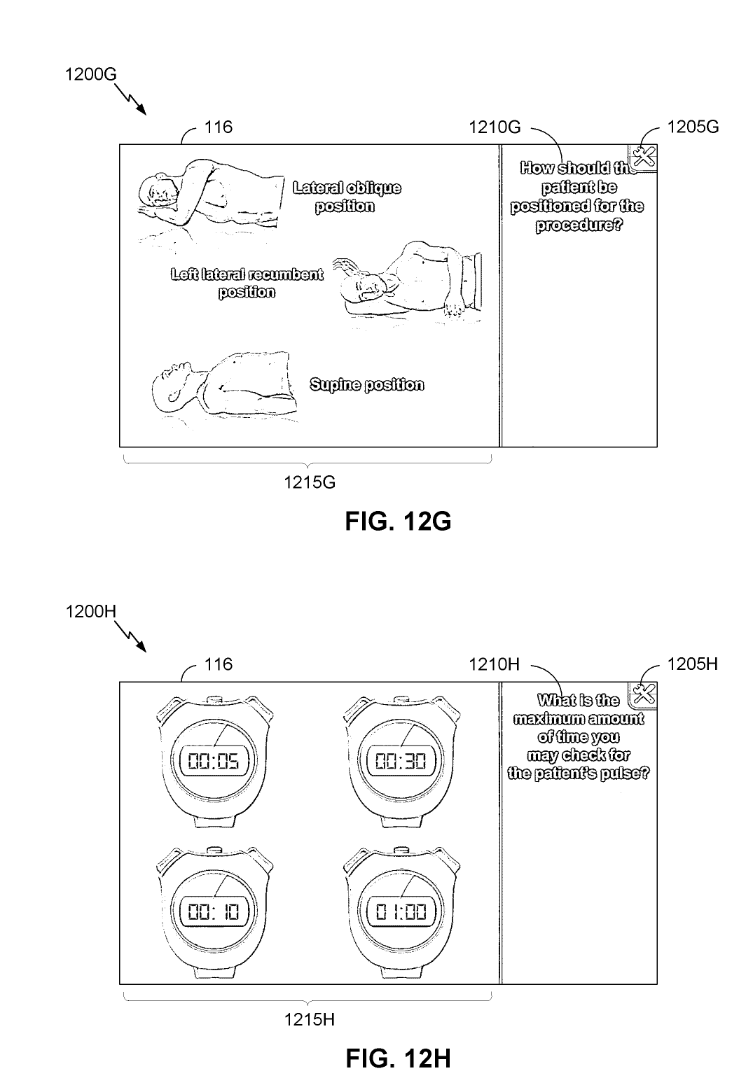

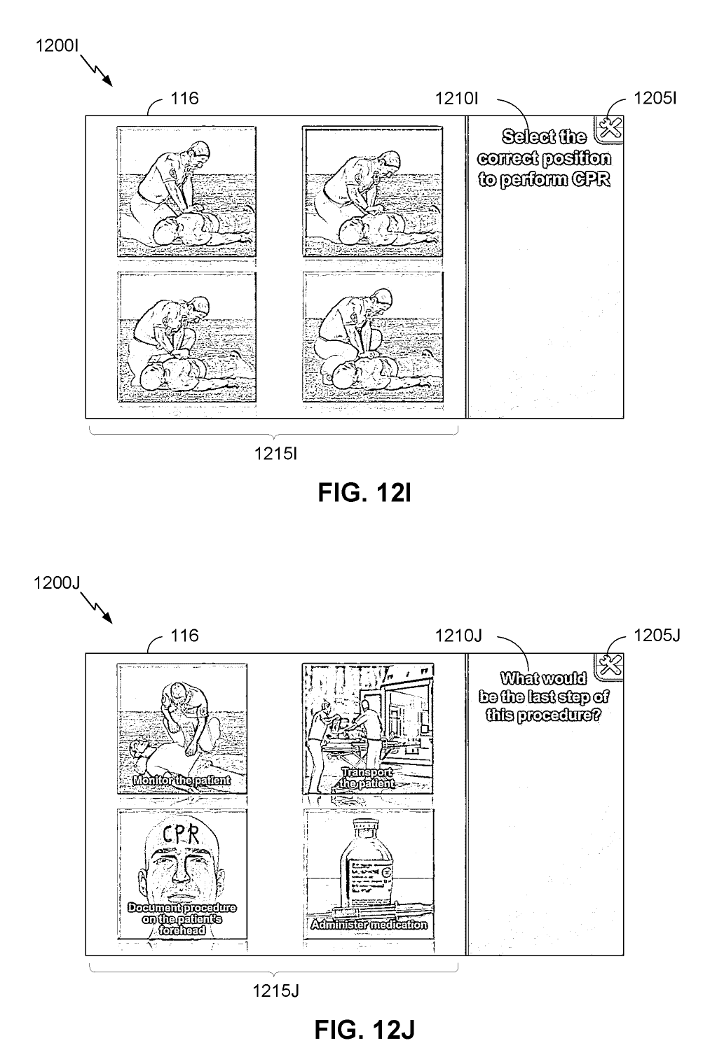

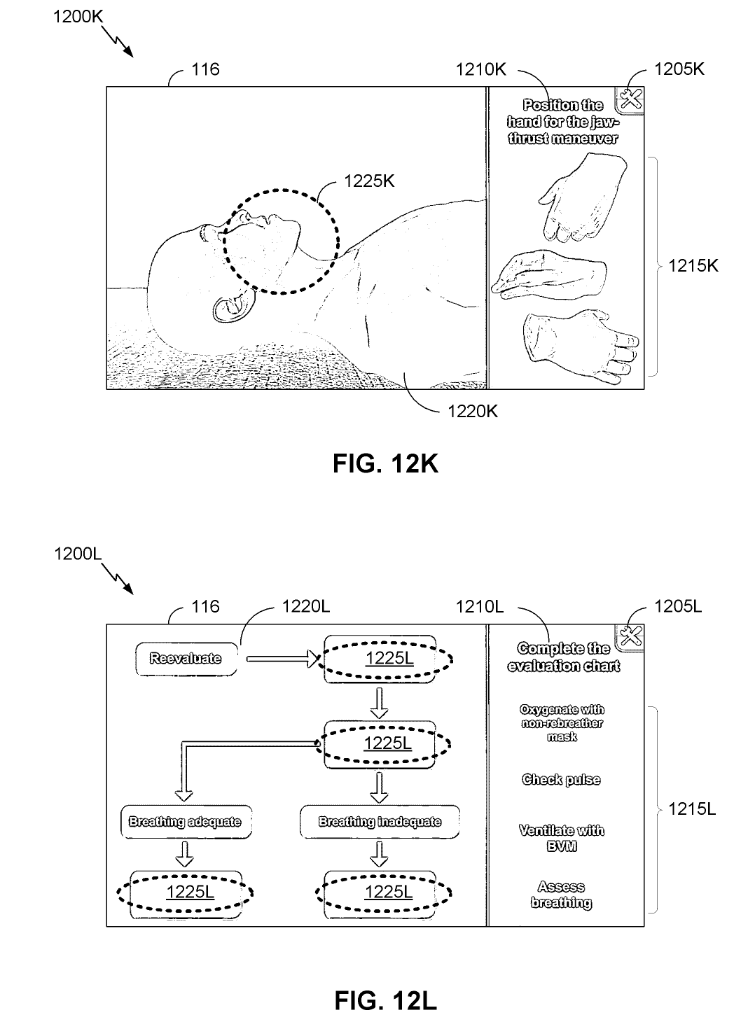

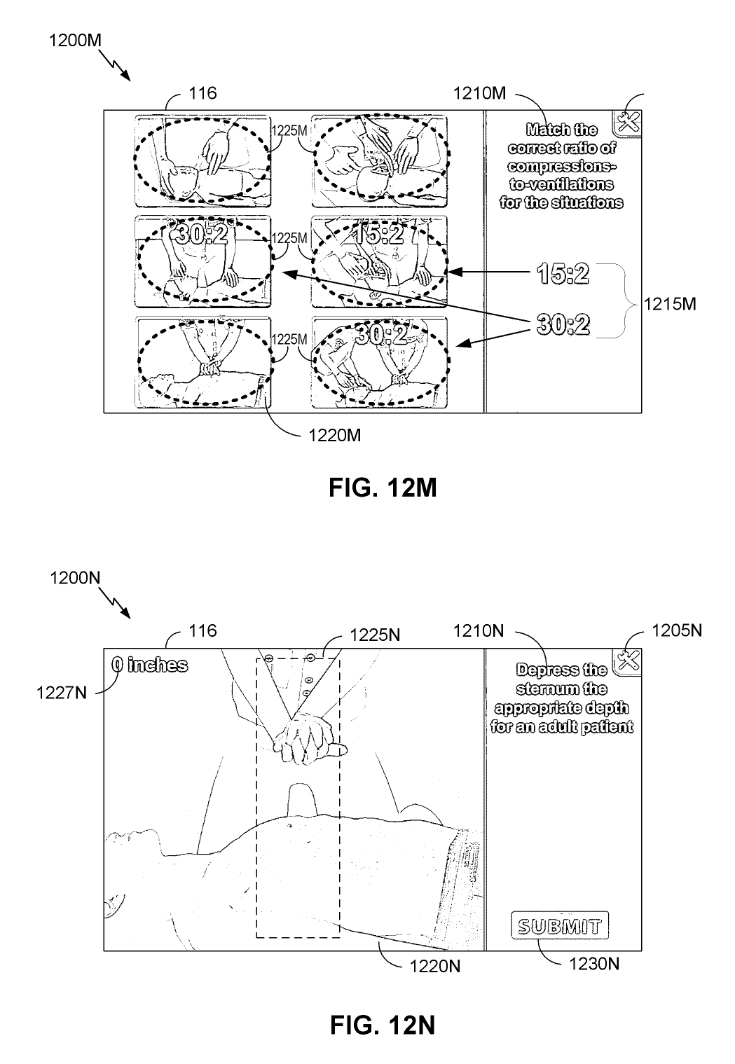

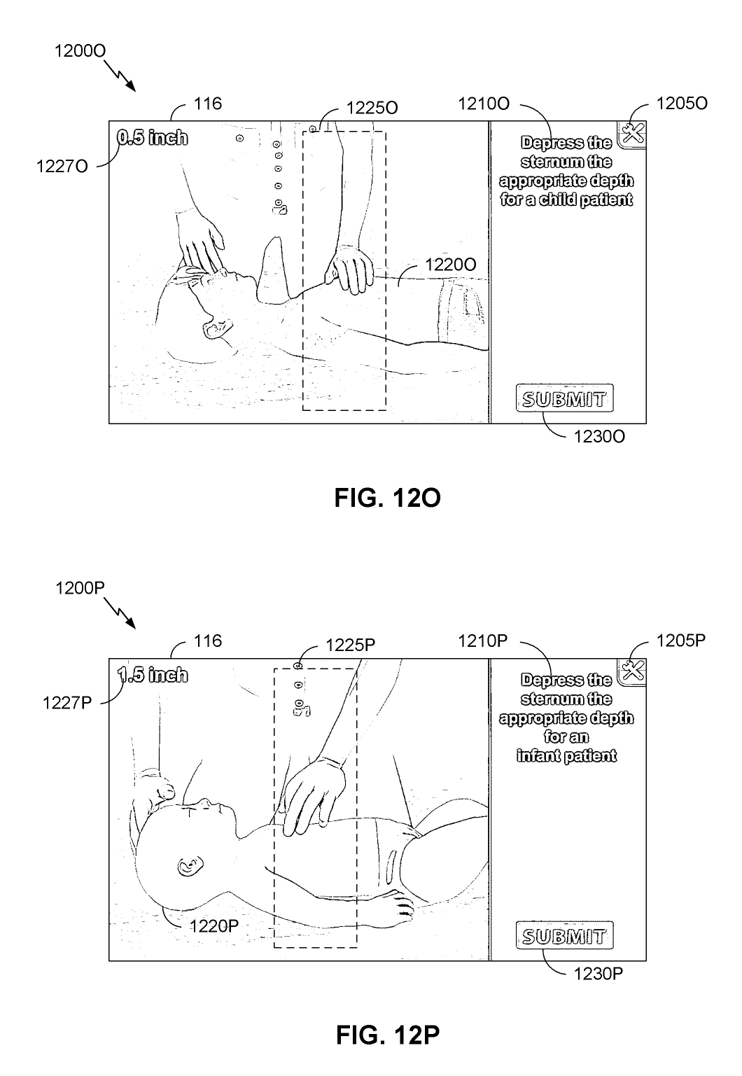

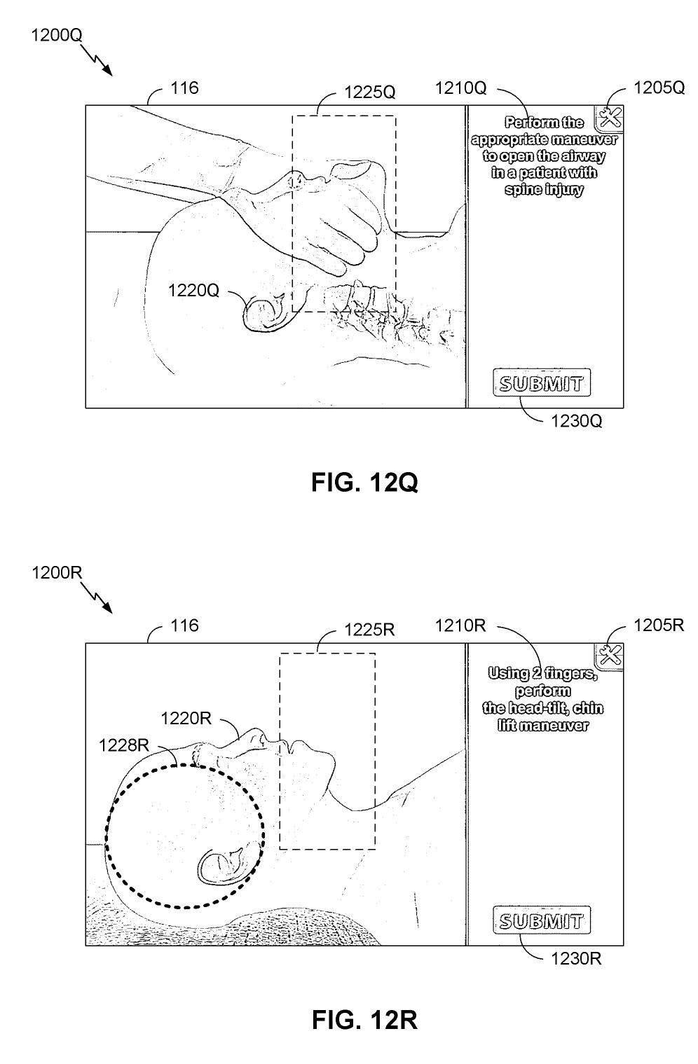

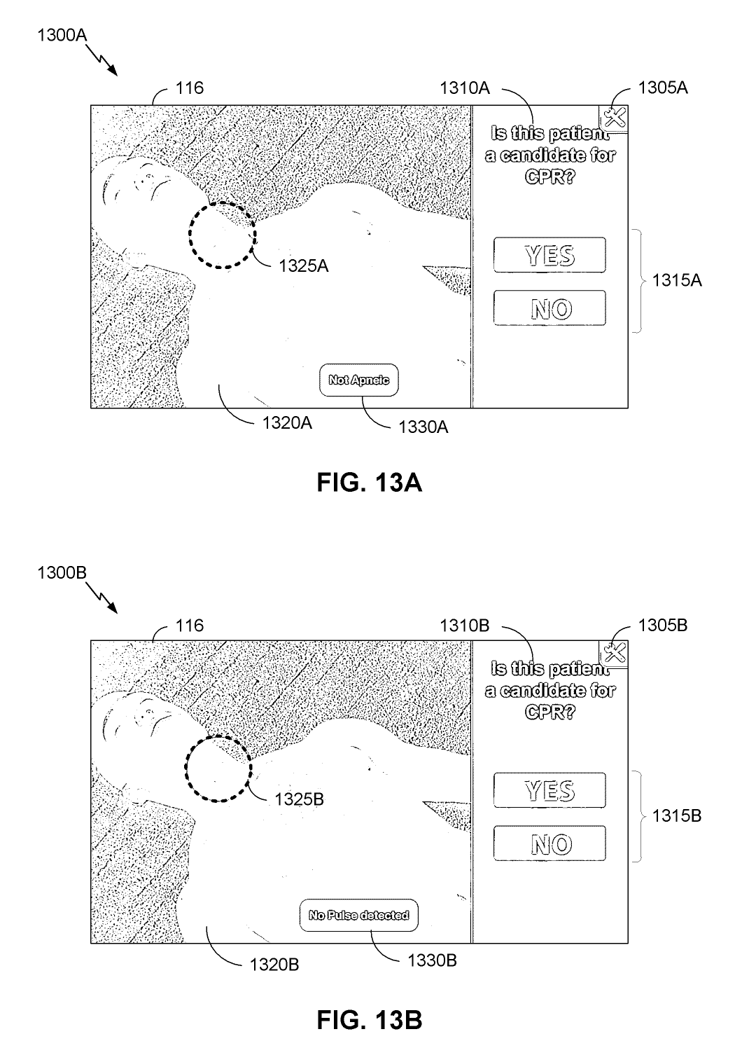

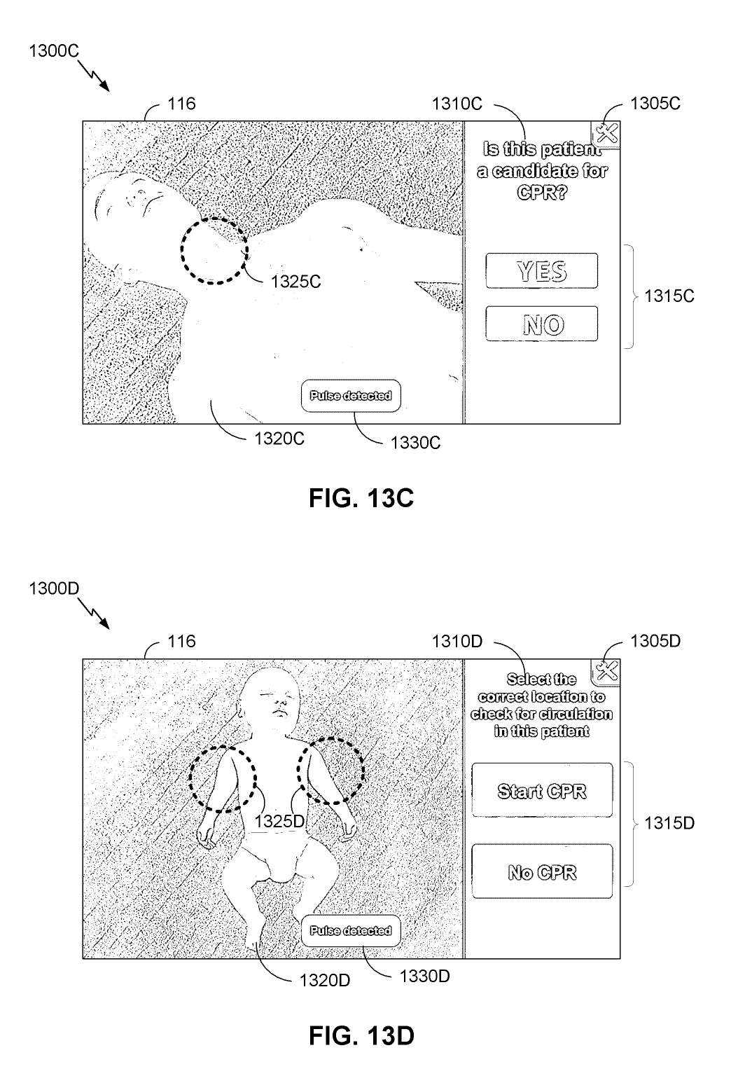

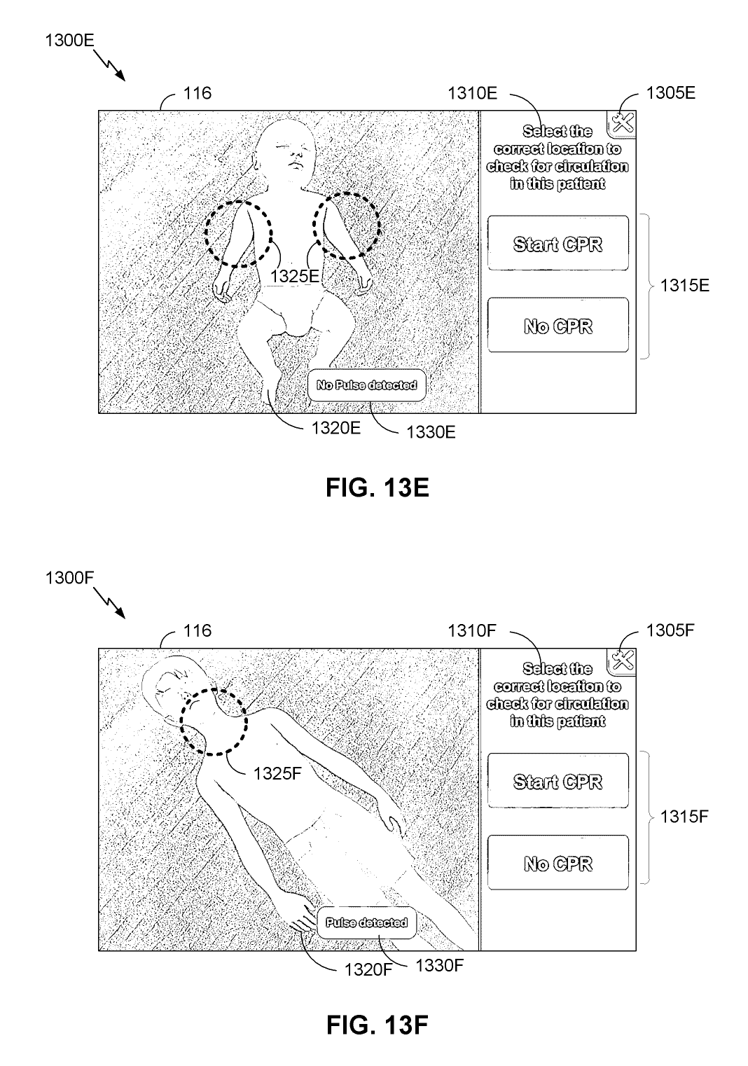

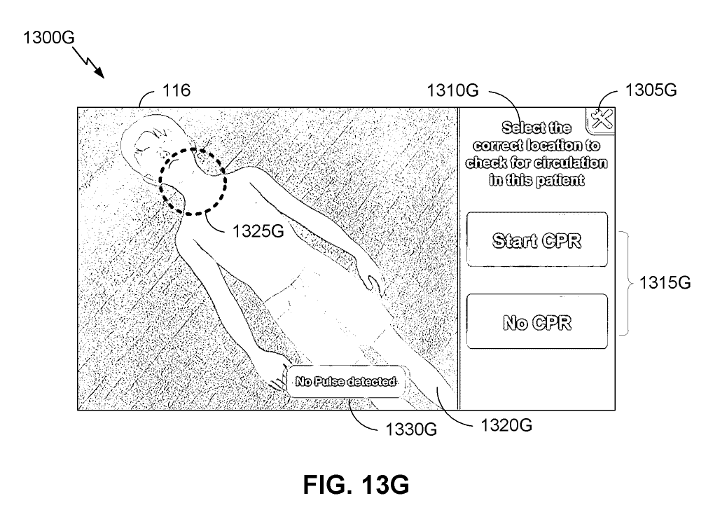

In various embodiments, the device 102 can be configured to provide medical training and/or testing for cardiopulmonary resuscitation. For example, the medical training and/or testing data, medical training and/or testing media, medical training and/or testing prompt, and medical training and/or testing interactions, described above with respect to FIG. 1, can relate to training and/or testing for one or more CPR procedures. In various embodiments, setting up the interaction for CPR testing can include setting up one or more gestures such as image swap, multi-choice point, point, drag-and-drop, image rotate, one and/or two-finger slider, and/or point-and-vibrate gestures. Although particular exemplary gestures and interfaces are described herein with respect to CPR training and/or testing, any other compatible gesture or interface described herein (including those described with respect to other fields of medical training and/or testing) can be applied to CPR training and/or testing. FIGS. 12A-13G illustrate exemplary interfaces for cardiopulmonary resuscitation (CPR) training and/or testing, according to various embodiments.

FIG. 12A illustrates an exemplary image swap interface 1200A, according to another embodiment. As shown, the image swap interface 1200A depicts a medical test for CPR in which the user is prompted to “Put the tasks in order. Switch places by selecting 2 icons.” The image swap interface 1200A can be implemented in, for example, the device 102 (FIG. 1). In various embodiments, the processor 104 (FIG. 1) can display the image swap interface 1200A on the display 116 (FIG. 1). As shown, the image swap interface 1200A includes a tool interface 1205A, instructions 1210A, a plurality of medical task icons 1215A (9 shown), and incorrect answer icons 1220A. Although various portions of the image swap interface 1200A are shown, a person having ordinary skill in the art will appreciate that the portions can be rearranged, portions can be omitted, and/or additional portions can be added.

In some embodiments, the image swap interface 1200A can operate in a substantially similar manner as the image swap interface 600A, described above with respect to FIG. 6A. For example, the tool interface 1205A, instructions 1210A, plurality of medical task icons 1215A, and incorrect answer icons 1220A can operate in a substantially similar manner as the tool interface 605A, instructions 610A, plurality of medical task icons 615A, and incorrect answer icons 620A of FIG. 6A. In some embodiments, the image swap interface 1200A can be a parameterized version of a template image swap interface, customized for CPR training and/or testing. Icons 1215A particularly suitable for CPR testing and training are shown in FIG. 12A

FIGS. 12B-12C illustrate exemplary multi-choice point interfaces 1200B-1200C, according to various embodiments. As shown, the multi-choice point interfaces 1200B-1200C depict medical tests for CPR training. The multi-choice point interfaces 1200B-1200C can be implemented in, for example, the device 102 (FIG. 1). In various embodiments, the processor 104 (FIG. 1) can display the multi-choice point interfaces 1200B-1200C on the display 116 (FIG. 1). As shown, the multi-choice point interfaces 1200B-1200C include tool interfaces 1205B-1205C, instructions 1210B-1210C, pluralities of selectable media 1215B-1215C, and submit buttons 1220B-1220C. Although various portions of the multi-choice point interfaces 1200B-1200C are shown, a person having ordinary skill in the art will appreciate that the portions can be rearranged, portions can be omitted, and/or additional portions can be added.

In some embodiments, the multi-choice point interfaces 1200B-1200C can operate in a substantially similar manner as the multi-choice point interface 700A, described above with respect to FIG. 7A. For example, tool interfaces 1205B-1205C, instructions 1210B-1210C, pluralities of selectable media 1215B-1215C, and submit buttons 1220B-1220C can operate in a substantially similar manner as the tool interface 705A, instructions 710A, plurality of selectable media 715A, and submit button 720A of FIG. 7A. In some embodiments, the multi-choice point interfaces 1200B-1200C can be parameterized versions of a template multi-choice point interface, customized for CPR training and/or testing, as can be seen in the particularized instructions 1210B-1210C and selectable media 1215B-1215C.

FIGS. 12D-12J illustrate exemplary single-choice point interfaces 1200D-1200J, according to various embodiments. As shown, the single-choice point interfaces 1200D-1200J depict medical tests for CPR training The single-choice point interfaces 1200D-1200J can be implemented in, for example, the device 102 (FIG. 1). In various embodiments, the processor 104 (FIG. 1) can display the single-choice point interfaces 1200D-1200J on the display 116 (FIG. 1). As shown, the single-choice point interfaces 1200D-1200J include tool interfaces 1205D-1205J, instructions 1210D-1210J, and pluralities of selectable media 1215D-1215J. Although various portions of the single-choice point interfaces 1200D-1200J are shown, a person having ordinary skill in the art will appreciate that the portions can be rearranged, portions can be omitted, and/or additional portions can be added.

In some embodiments, the single-choice point interfaces 1200D-1200J can operate in a substantially similar manner as the single-choice point interface 800A, described above with respect to FIG. 8A. For example, tool interfaces 1205D-1205J, instructions 1210D-1210J, and pluralities of selectable media 1215D-1215J can operate in a substantially similar manner as the tool interface 805A, instructions 810A, and plurality of selectable media 815A of FIG. 8A. In some embodiments, the single-choice point interfaces 1200D-1200J can be parameterized versions of a template single-choice point interface, customized for CPR training and/or testing, as can be seen in the particularized instructions 1210D-1210J and selectable media 1215D-1215J.

In some embodiments, single-choice point interfaces can include background media, which can include static or moving images (with or without looping). For example, the single-choice point interfaces 1200E-1200F shown in FIGS. 12E-12F include background media 1220E-1220F, respectively. The background media 1220E indicates that the patient has a chest injury. The background media 1200F indicates that the patient has a head injury.

FIGS. 12K-12L illustrate exemplary drag-and-drop interfaces 1200K-1200L, according to various embodiments. As shown, the drag-and-drop interfaces 1200K-1200L depict medical tests for CPR training. The drag-and-drop interfaces 1200K-1200L can be implemented in, for example, the device 102 (FIG. 1). In various embodiments, the processor 104 (FIG. 1) can display the drag-and-drop interfaces 1200K-1200L on the display 116 (FIG. 1). As shown, the drag-and-drop interfaces 1200K-1200L include tool interfaces 1205K-1205L, instructions 1210K-1210L, a plurality of movable media 1215K-1215L, a background image 1220K-1220L, and one or more correct answer regions 1225K-1225L. Although various portions of the drag-and-drop interfaces 1200K-1200L are shown, a person having ordinary skill in the art will appreciate that the portions can be rearranged, portions can be omitted, and/or additional portions can be added.

In some embodiments, the drag-and-drop interfaces 1200K-1200L can operate in a substantially similar manner as the drag-and-drop interface 900A, described above with respect to FIG. 9A. For example, the tool interfaces 1205K-1205L, instructions 1210K-1210L, plurality of movable media 1215K-1215L, background image 1220K-1220L, and one or more correct answer regions 1225K-1225L can operate in a substantially similar manner as the tool interface 905A, instructions 910A, plurality of movable media 915A, background image 920A, and one or more correct answer regions 925A of FIG. 9A. In some embodiments, the drag-and-drop interfaces 1200K-1200L can be a parameterized version of a template drag-and-drop interface, customized for CPR training and/or testing, as can be seen in the particulars of FIGS. 12K-12L.

### Multiple Drag-and-Drop

FIG. 12M illustrates an exemplary multiple drag-and-drop interface 1200M, according to an embodiment. As shown, the multiple drag-and-drop interface 1200M depicts a medical test for CPR training. The multiple drag-and-drop interface 1200M can be implemented in, for example, the device 102 (FIG. 1). In various embodiments, the processor 104 (FIG. 1) can display the multiple drag-and-drop interface 1200M on the display 116 (FIG. 1). As shown, the multiple drag-and-drop interface 1200M includes a tool interface 1205M, instructions 1210M, a plurality of cloneable media 1215M, a background image 1220M, and one or more correct answer regions 1225M. Although various portions of the multiple drag-and-drop interface 1200M are shown, a person having ordinary skill in the art will appreciate that the portions can be rearranged, portions can be omitted, and/or additional portions can be added.

In some embodiments, the multiple drag-and-drop interface 1200M can operate in a substantially similar manner as the drag-and-drop interface 900A, described above with respect to FIG. 9A. For example, the tool interface 1205M, instructions 1210M, background image 1220M, and one or more correct answer regions 1225M can operate in a substantially similar manner as the tool interface 905A, instructions 910A, background image 920A, and one or more correct answer regions 925A of FIG. 9A. In an embodiment, the media 1215M is cloneable rather than movable. In other words, when the user drags the cloneable media 1215M, a copy of the cloneable media 1215M can be left behind. Accordingly, each cloneable media 1215M can be correctly placed into one or more correct answer regions 1225M, as shown in FIG. 12M. In some embodiments, the multiple drag-and-drop interface 1200M can be a parameterized version of a template multiple drag-and-drop interface, customized for CPR training and/or testing, as can be seen from the particulars of FIG. 12M.

In the illustrated embodiment, the background image 1220M indicates various CPR scenarios such as, for example, a single person performing CPR on an infant, two people performing CPR on an infant, a single person performing CPR on an adolescent, two people performing CPR on an adolescent, a single person performing CPR on an adult, and two people performing CPR on an adult.

FIGS. 12N-12Q illustrate exemplary slider interfaces 1200N-1200Q, according to various embodiments. As shown, the slider interfaces 1200N-1200Q depict medical tests for CPR training. The slider interfaces 1200N-1200Q can be implemented in, for example, the device 102 (FIG. 1). In various embodiments, the processor 104 (FIG. 1) can display the slider interfaces 1200N-1200Q on the display 116 (FIG. 1). As shown, the slider interfaces 1200N-1200Q include tool interfaces 1205N-1205Q, instructions 1210N-1210Q, background images 1220N-1220Q, slider areas 1225N-1225Q, slider indicators 1227N-1227Q, and submit buttons 1230N-1230Q. Although various portions of the slider interfaces 1200N-1200Q are shown, a person having ordinary skill in the art will appreciate that the portions can be rearranged, portions can be omitted, and/or additional portions can be added.

In some embodiments, the slider interfaces 1200N-1200Q can operate in a substantially similar manner as the slider interface 1100A, described above with respect to FIG. 11A. For example, the tool interfaces 1205N-1205Q, instructions 1210N-1210Q, background images 1220N-1220Q, a slider area 1225N-1225Q, and submit buttons 1230N-1230Q can operate in a substantially similar manner as the tool interface 1105A, instructions 1110A, background image 1120A, slider area 1125A, and submit button 1130A of FIG. 11A. In some embodiments the slider indicators 1227O-1227Q can indicate a position and/or numerical value of the slider. In some embodiments, the slider indicators 1227O-1227Q can be portions of the background images 1220A, which can change as the slider is adjusted. In some embodiments, the slider interfaces 1200N-1200Q can be a parameterized version of a template slider interfaces, customized for CPR training and/or testing, as can be seen in the particulars of FIGS. 12N-12Q.

In the illustrated embodiment of FIG. 12N, the background image 1220N changes as the slider is adjusted, for example by moving caregiver arms and hands, and compressing the patient's chest. In the illustrated embodiment of FIG. 12O, the background image 1220O changes as the slider is adjusted, for example by moving a caregiver arm and hand, and compressing the patient's chest. In the illustrated embodiment of FIG. 12P, the background image 1220P changes as the slider is adjusted, for example by moving a caregiver arm and hand, and compressing the patient's chest. In the illustrated embodiment of FIG. 12Q, the background image 1220Q changes as the slider is adjusted, for example by moving a caregiver hand, and extending the patient's jaw. In the illustrated embodiment of FIG. 12R, the background image 1220R changes as the slider is adjusted, for example by tilting the patient's head forward and/or back.

### Two-Finger Slider

FIG. 12R illustrates an exemplary two-finger slider interface 1200R, according to an embodiment. As shown, the two-finger slider interface 1200R depicts a medical test for CPR in which the user is prompted to “Using 2 fingers, perform the head-tilt, chin lift maneuver.” The two-finger slider interface 1200R can be implemented in, for example, the device 102 (FIG. 1). In various embodiments, the processor 104 (FIG. 1) can display the two-finger slider interface 1200R on the display 116 (FIG. 1). As shown, the two-finger slider interface 1200R includes a tool interface 1205R, instructions 1210R, a background image 1220R, a slider area 1225R, a static region 1228R, and a submit button 1230R. Although various portions of the two-finger slider interface 1200R are shown, a person having ordinary skill in the art will appreciate that the portions can be rearranged, portions can be omitted, and/or additional portions can be added.

In some embodiments, the two-finger slider interface 1200M can operate in a substantially similar manner as the slider interface 1100A, described above with respect to FIG. 11A. For example, the tool interface 1205R, instructions 1210R, background image 1220R, slider area 1225R, and submit button 1230R can operate in a substantially similar manner as the tool interface 1105R, instructions 1110R, background image 1120R, slider area 1125R, and submit button 1130R of FIG. 11A. In an embodiment, the static region 1228R serves to designate an area, which can be shown or hidden from view, which the user is to touch in order for the slider interface to work. In other words, the processor 104 can activate the slider area 1225R while input is received within the static region 1228R, and can deactivate the slider area 1225R while there is no input within the static region 1228R. Accordingly, a user is to touch within the slider area 1228R while swiping within the slider area 1225R. In some embodiments, the multiple slider interface 1200M can be a parameterized version of a template multiple slider interface, customized for CPR training and/or testing.

In various embodiments, the use of one finger in the static region 1228R while using a second finger in the slider area 1225R can emulate the use of two hands on the head of a CPR patient. Although various interfaces are described herein as “two-finger” interfaces, a person having ordinary skill in the art will appreciate that any method of input can be used.

### Point-and-Vibrate

In an embodiment, setting up an interaction for medical training and/or testing data (discussed above with respect to block 240 of FIG. 2) can include setting up a point-and-vibrate gesture. The processor 104 can load one or more parameters for the point-and-vibrate gesture from the memory 106. In an embodiment, the point-and-vibrate gesture can allow a user to indicate a single selection. In an embodiment, the point-and-vibrate gesture can also provide visual, audio, and/or tactile feedback in response to a non-selection input, which can represent a medical diagnostic action. Although various reactions are described herein as “point-and-vibrate,” in other arrangements vibration can be omitted or replaced with other diagnostic output as described in greater detail herein.

In an embodiment, loading medical training and/or testing data (discussed above with respect to block 210 of FIG. 2) can include loading information indicating a correct selection and information including one or more diagnostic regions. For example, the processor 104 can load the correct selection from the memory 106. In some embodiments, the processor 104 can load a color map indicating selectable image regions, one or more diagnostic regions, and/or an image region corresponding to a correct selection.

In an embodiment, loading medical training and/or testing media (discussed above with respect to block 220 of FIG. 2) can include loading one or more selectable media (which can be implemented as selectable portions of a single image), a background image, instructions, and one or more diagnostic indicators. Each selectable image can represent equipment, actions, responses, and/or configurations related to a medical procedure. The instructions can include text such as, for example, “Select the appropriate type of oxygen cylinder” or a question such as “Is this patient a candidate for CPR?” Diagnostic indicators or diagnostic output can include audio, visual, and/or tactile output indicative of a diagnostic condition. For example, in various embodiments, the diagnostic condition can include presence of a pulse, a pulse rate, presence of breathing, a breathing rate, an environmental condition, etc.

Audio output can include, for example, a simulated stethoscope output, heart monitor output, speech, chest sounds, heart sounds, speech, etc. Visual output can include, for example, textual indications of pulse, pulse rate, breathing, breathing rate, etc. In some embodiments, visual output can include a portion of the display 116, or an external light such as an LED flash, for example flashing in time to a simulated pulse. In various embodiments, tactile output can include, for example, the vibrator 120 vibrating in time to a simulated pulse, a breathing rate, etc.

In various embodiments, the medical training and/or testing media can include a background video or image, with or without looping. In various embodiments, the medical training and/or testing media can include hidden images. The processor 104 can cause the display 116 to output the hidden images when predetermined areas of the screen are selected. In various embodiments, the medical training and/or testing media can include explanations for correct and incorrect answers and/or accompanying sounds.

In an embodiment, providing a medical training and/or testing prompt (discussed above with respect to block 230 of FIG. 2) can include displaying the one or more selectable media, the background image or video, the instruction text, and/or the one or more diagnostic indicators. For example, the processor 104 can cause the display 116 to output the one or more selectable media, the instruction text, the background image, and the diagnostic indicators discussed above. In an embodiment, the processor 104 causes the display 116 to output the plurality of selectable media in a grid. In an embodiment, the processor 104 causes the display 116 to output a tutorial illustrating the point-and-vibrate interaction.

In an embodiment, receiving the medical training and/or testing interaction (discussed above with respect to block 250 of FIG. 2) can include receiving a user input within the one or more diagnostic regions. For example, the processor 104 can receive one or more touch locations from the digitizer 118. The processor 104 can identify a diagnostic action based on the one or more touch locations received from the digitizer 118. In an embodiment, the processor 104 can dismiss touch locations not corresponding to a diagnostic or selectable region of the digitizer 118.

In an embodiment, the processor 104 can cause the user interface 122 to output the diagnostic output when the digitizer 118 receives input within a diagnostic region. In some embodiments, different diagnostic output can correspond with different diagnostic regions. For example, when the processor 104 identifies input within a diagnostic region corresponding to an artery, the processor 104 can cause the vibrator 120 to vibrate in time to a simulated pulse. As another example, when the processor 104 identifies input within a diagnostic region corresponding to a chest, the processor 104 can cause a speaker of the user interface 122 to output chest sounds. In various embodiments, the processor 104 can vary a vibration rate and/or strength based on user input and/or the medical training and/or testing data loaded from the memory 106.

In an embodiment, receiving the medical training and/or testing interaction (discussed above with respect to block 250 of FIG. 2) can include receiving a single user selection. For example, the processor 104 can receive one or more touch locations from the digitizer 118. The processor 104 can identify a single selected image or image portion based on the one or more touch locations received from the digitizer 118. In an embodiment, the processor 104 can dismiss touch locations not corresponding to a selectable image, portion of an image, or region, or diagnostic region, of the digitizer 118.

In an embodiment, evaluating the medical training and/or testing interaction (discussed above with respect to block 260 of FIG. 2) can include identifying user selection of a single selectable image. In an embodiment, when an image is selected, the processor 104 can cause the display 116 to highlight the selected image or image portion. In an embodiment, when an image is selected, the processor 104 can cause the display 116 to output a description of the selected image. In an embodiment, when an image is selected, the processor 104 can cause the user interface 122 output a corresponding sound.

In an embodiment, the processor 104 can compare the received gesture to a point-and-vibrate gesture template in the memory 106. For example, the processor 104 can determine whether the user has touched a selectable or diagnostic region of the medical training and/or testing media. When the processor 104 detects input within a diagnostic region, the processor 104 can cause the user interface 122 to output diagnostic output, as discussed above. For example, when the processor 104 determines what the user is holding a finger on the diagnostic region, the processor 104 can cause the vibrator 120 to vibrate at a particular rate or pattern received in the medical training and/or testing data (or other diagnostic output via the user interface 122).

When the processor 104 determines what the user has stopped holding a finger on the diagnostic region, the processor 104 can cause the vibrator 120 to stop vibrating (or can stop other diagnostic output). In an embodiment, the processor 104 can keep track of a length of time during which input is received at the diagnostic area. The processor 104 can compare the length of time to a threshold for activation of a correct answer. For example, in an embodiment, if the user checks a pulse for less than three seconds, the processor 104 can determine that the pulse has not been checked. In an embodiment, the processor 104 can cause the user interface 122 to provide an indication that a diagnostic action was taken for an insufficient amount of time (for example, a text message can appear). When the processor 104 detects selection of a selectable image, the processor 104 can compare the selected image with the indication of the correct selection obtained from the medical training and/or testing data.

When the processor 104 determines that an inaccurate answer has been given, the processor 104 can reset the medical training and/or testing prompt. When the processor 104 determines that an inaccurate answer has been given, the processor 104 can cause the display 116 to output an indication that the selection was incorrect. When the processor 104 determines that an inaccurate answer has been given, the processor 104 can cause the display 116 to output an explanation indicating why the selection was incorrect. In some embodiments, the processor 104 can test whether it has identified input within a diagnostic region prior to receiving selection of a selectable image. In other words, in some embodiments, a user is to perform a diagnostic action prior to selecting an answer. If the user does not first perform a diagnostic action, the processor 104 can determine that an inaccurate answer has been given. In other embodiments, a user may select a correct answer at any time.

In an embodiment, the processor 104 is configured to determine if the selected image is correct. When the image is correct, the processor 104 can determine that a correct answer has been given. In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu. When the processor 104 determines that an accurate answer has been given, the processor 104 can cause the display 116 to output an explanation indicating why the answer was correct.

FIGS. 13A-13G illustrate exemplary point-and-vibrate interfaces 1300A, according to various embodiments. As shown, the point-and-vibrate interfaces 1300A-1300G depict medical tests for CPR training. The point-and-vibrate interfaces 1300A-1300G can be implemented in, for example, the device 102 (FIG. 1). In various embodiments, the processor 104 (FIG. 1) can display the point-and-vibrate interfaces 1300A-1300G on the display 116 (FIG. 1). As shown, the point-and-vibrate interfaces 1300A-1300G include tool interfaces 1305A-1305G, instructions 1310A-1310G, background images 1320A-1320G, diagnostic regions 1325A-1325G, diagnostic output 1330A-1330G, and pluralities of selectable media 1315A-1315G. Although various portions of the point-and-vibrate interfaces 1300A-1300G are shown, a person having ordinary skill in the art will appreciate that the portions can be rearranged, portions can be omitted, and/or additional portions can be added.

The tool interfaces 1305A-1305G serve to provide navigation, for example to a main menu and/or to one or more other medical training and/or testing interfaces described herein. The instructions 1310A-1310G serve to instruct the user on how to interact with the point-and-vibrate interface 1300A. The background images 1320A-1320G serve to provide context for diagnostic action within the diagnostic regions 1325A-1325G. In some embodiments, the background images 1320A-1320G can indicate an extent of the diagnostic regions 1325A-1325G. In other embodiments, the background images 1320A-1320G do not indicate an extent of the diagnostic regions 1325A-1325G.

The diagnostic regions 1325A-1325G, which can be shown or hidden in various embodiments, serve to indicate (for example, to the processor 104) one or more input locations for diagnostic action. For example, in various embodiments, the diagnostic regions 1325A-1325G can correspond with artery locations. The diagnostic output 1330A-1330G serves to indicate a diagnostic condition (for example, a pulse of a patient) when the user provides input within the diagnostic regions 1325A-1325G. In the illustrated embodiments, diagnostic output 1330A-1330G is textual and tactile. In other embodiments, diagnostic output 1330A-1330G can be any combination of audio, visual, and tactile (e.g., vibration) output, or omitted altogether.

The one or more selectable media 1315A-1315G represent various answers and/or actions. In some embodiments, the one or more selectable media 1315A-1315G can serve to indicate that the user is ready for the processor 104 to evaluate the interaction.

### Airway Management

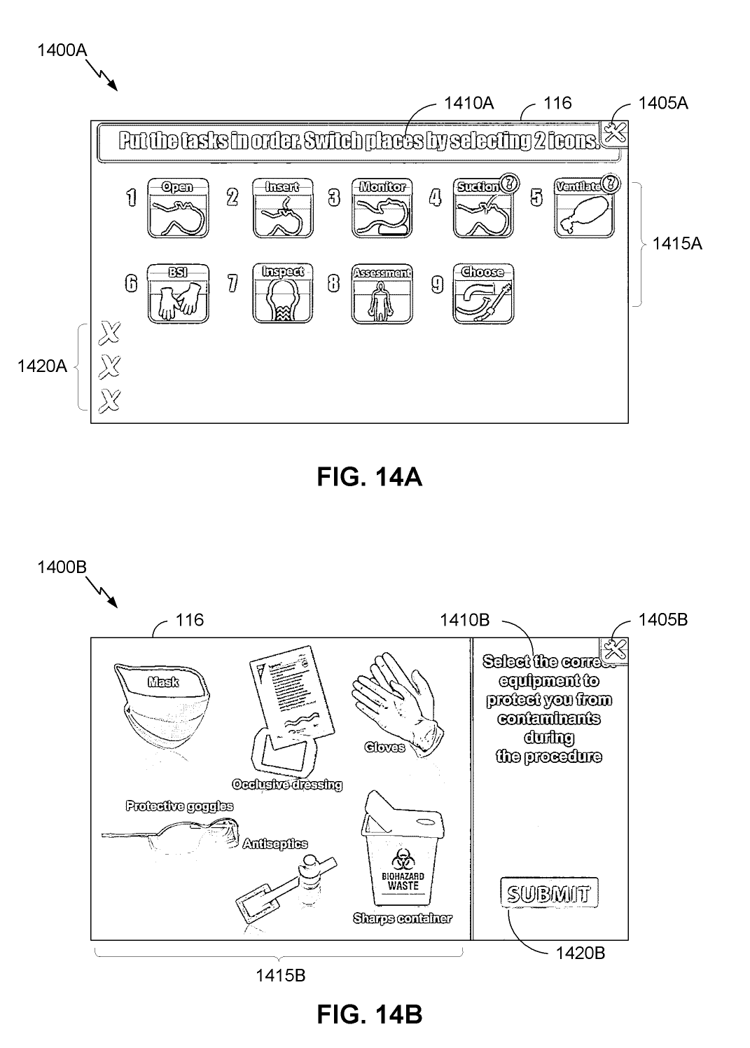

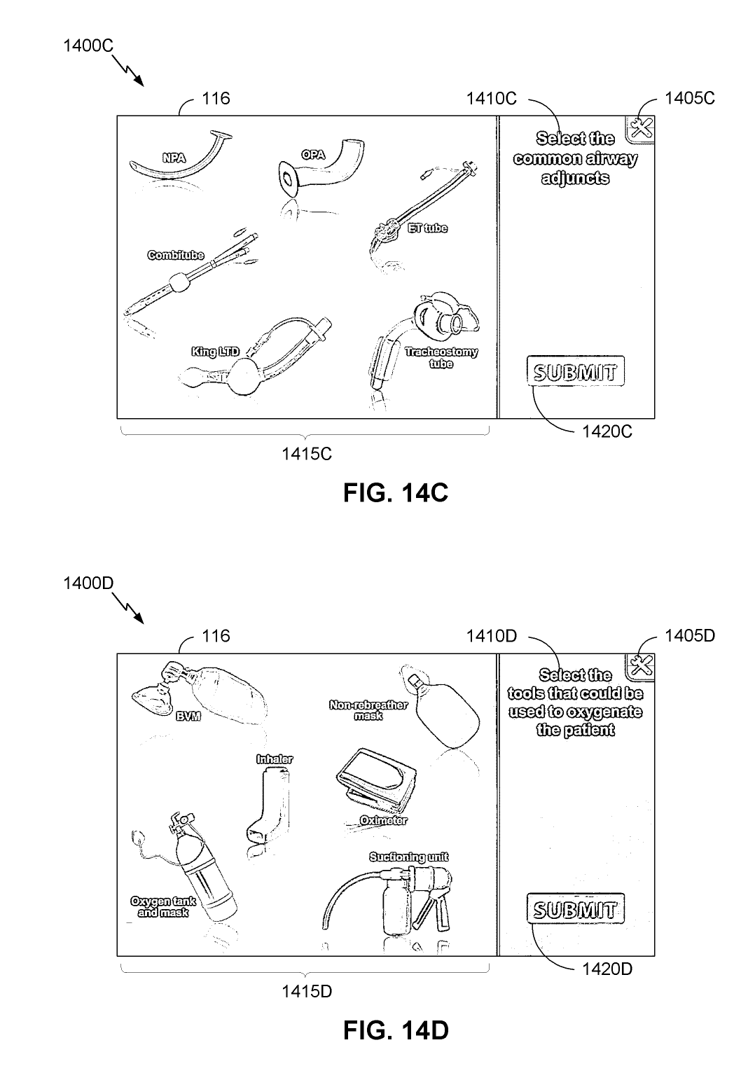

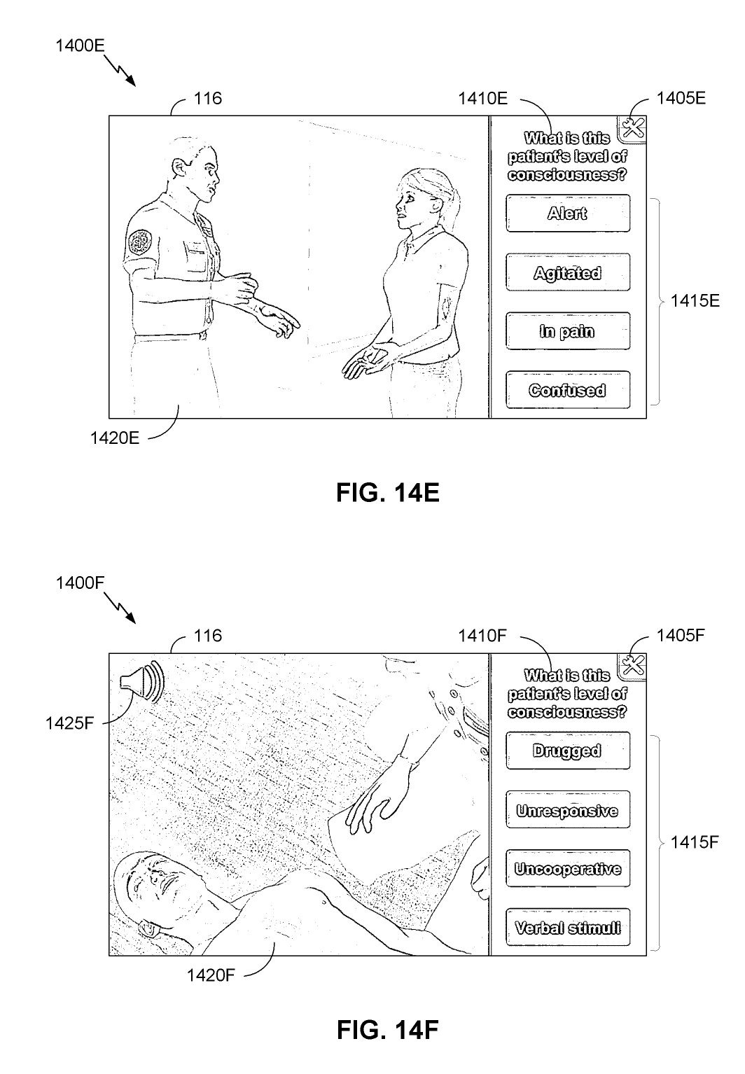

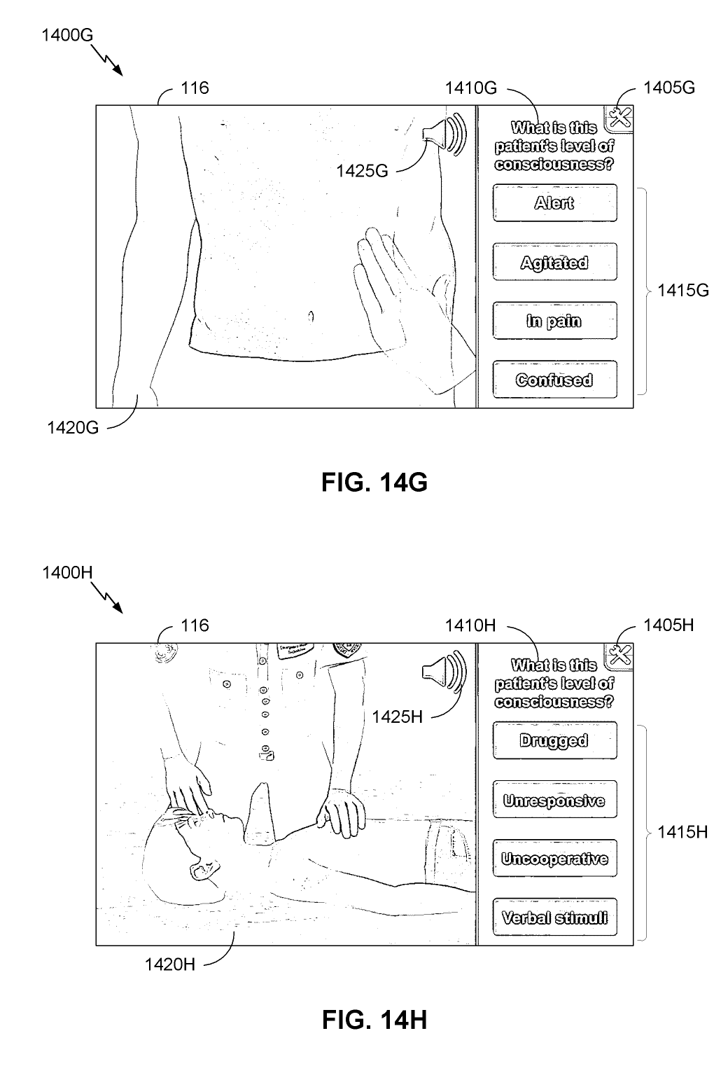

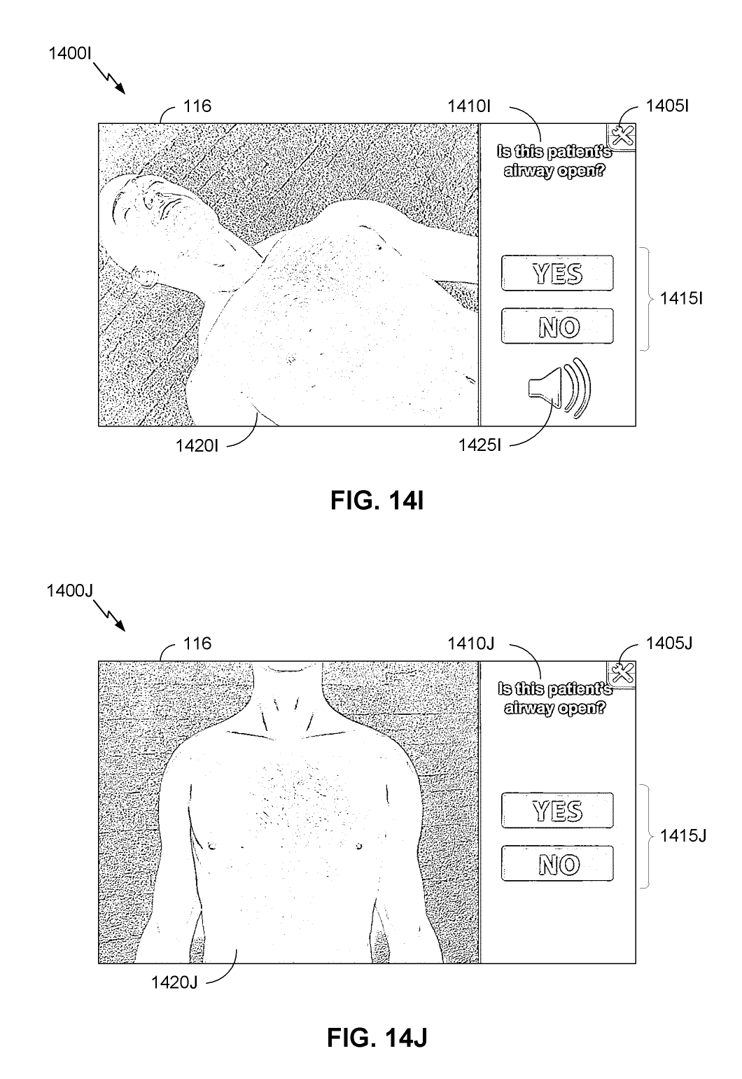

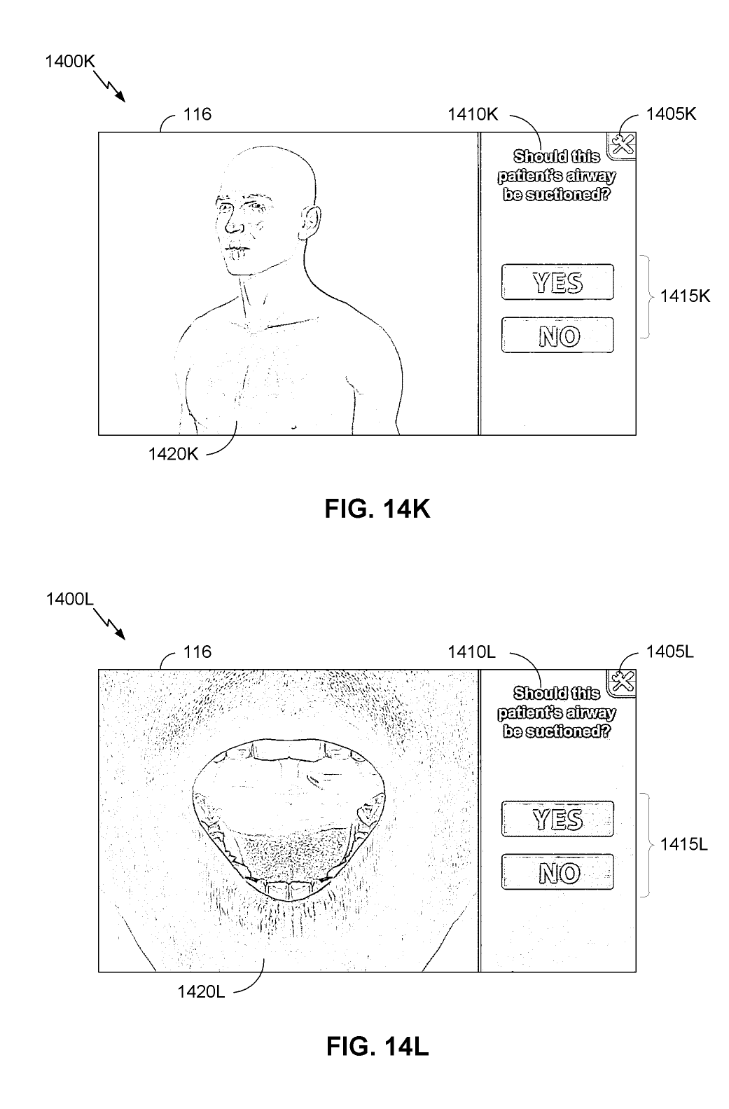

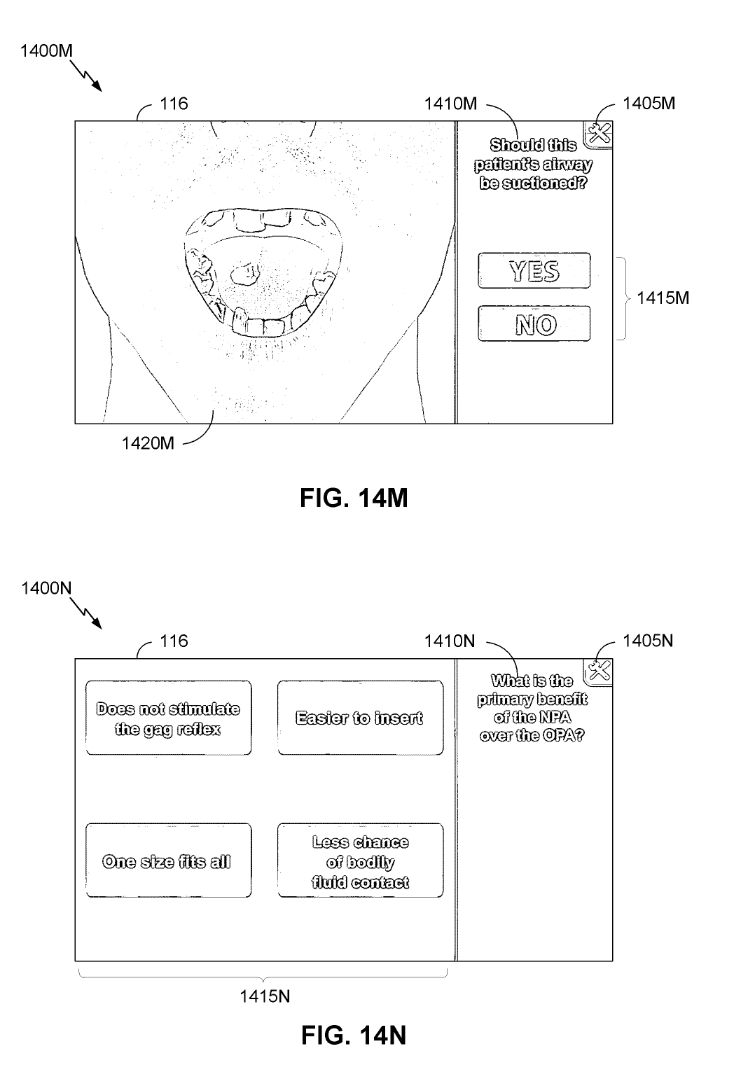

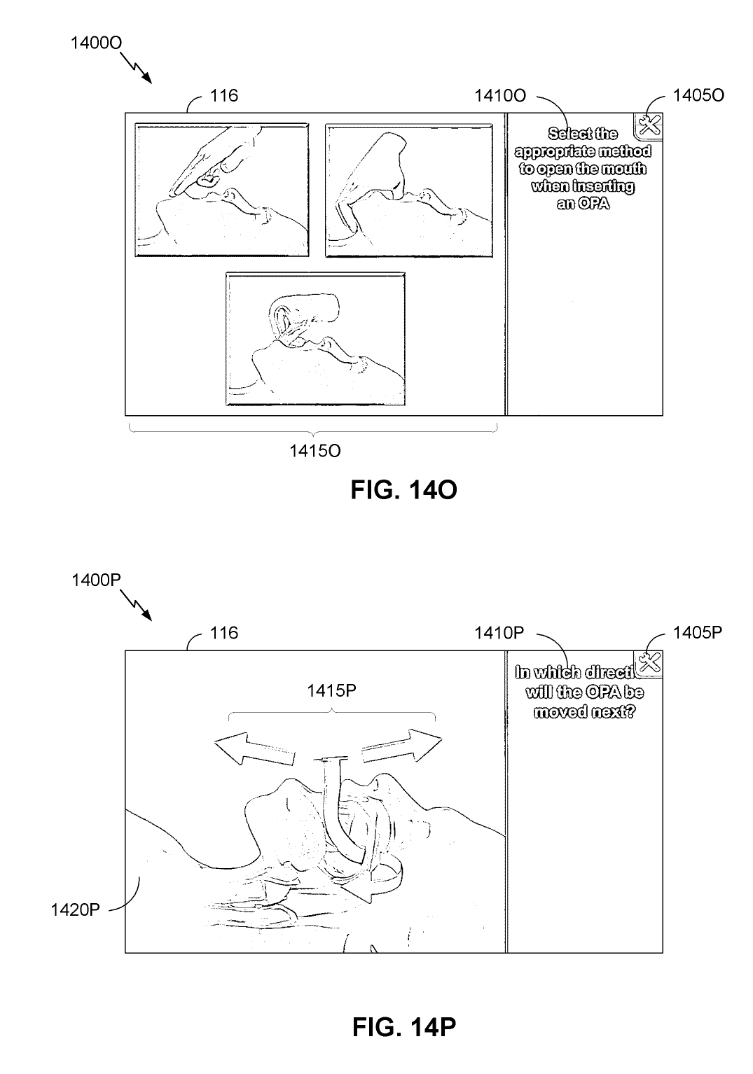

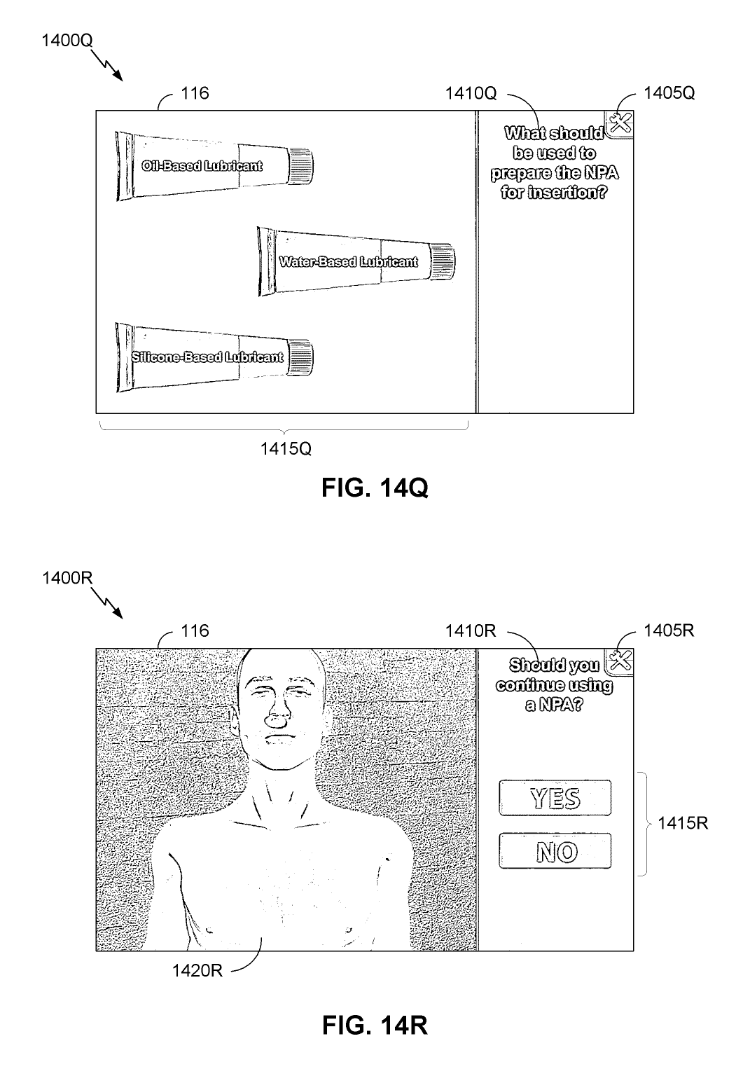

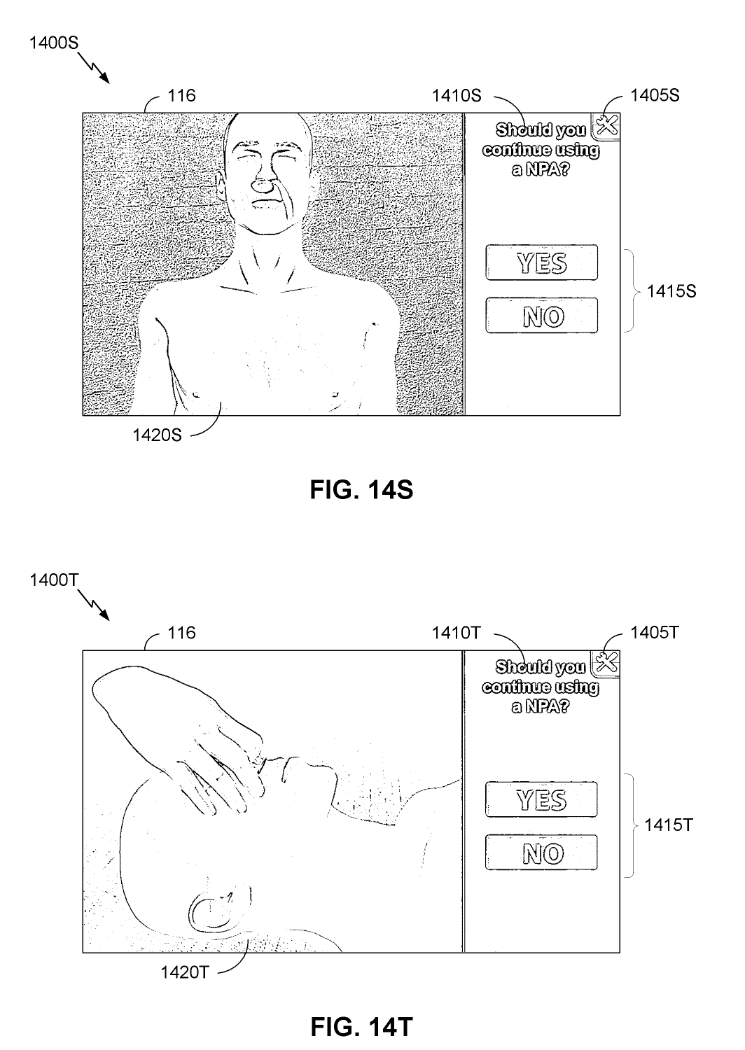

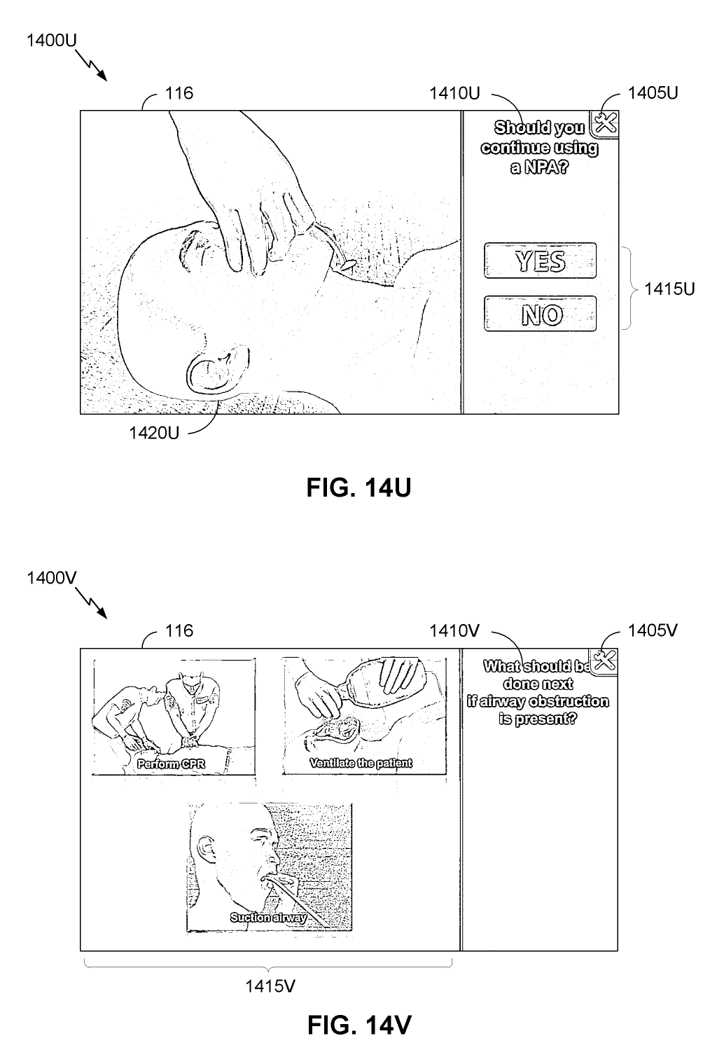

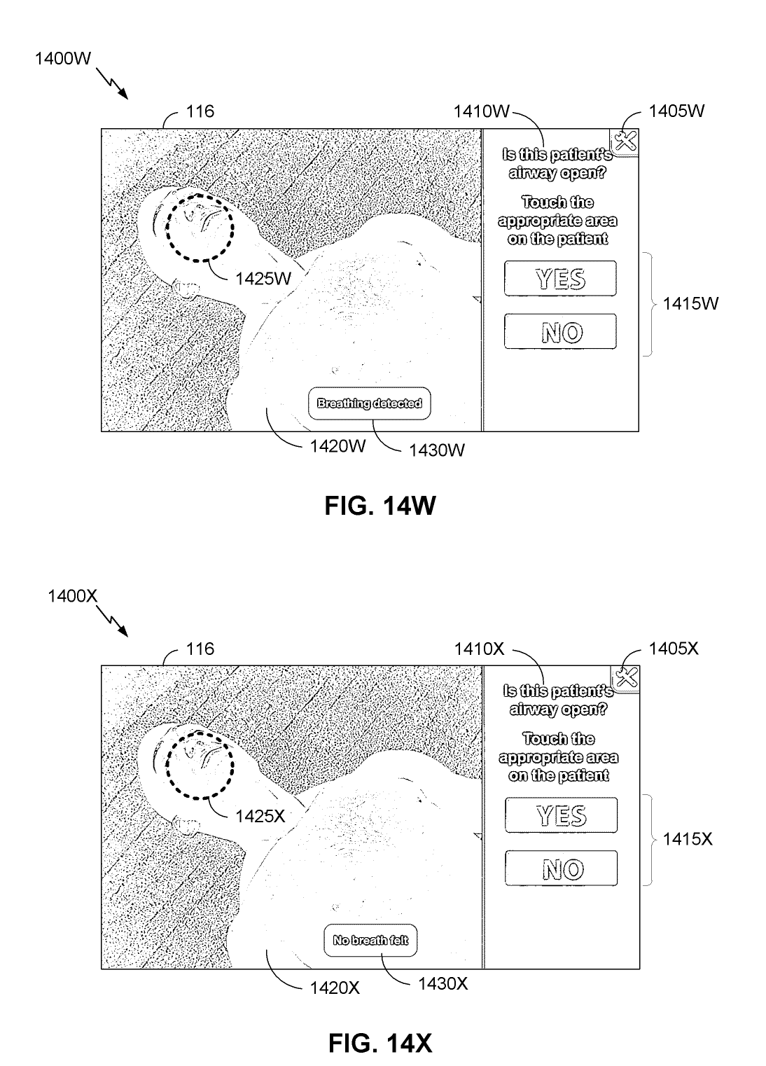

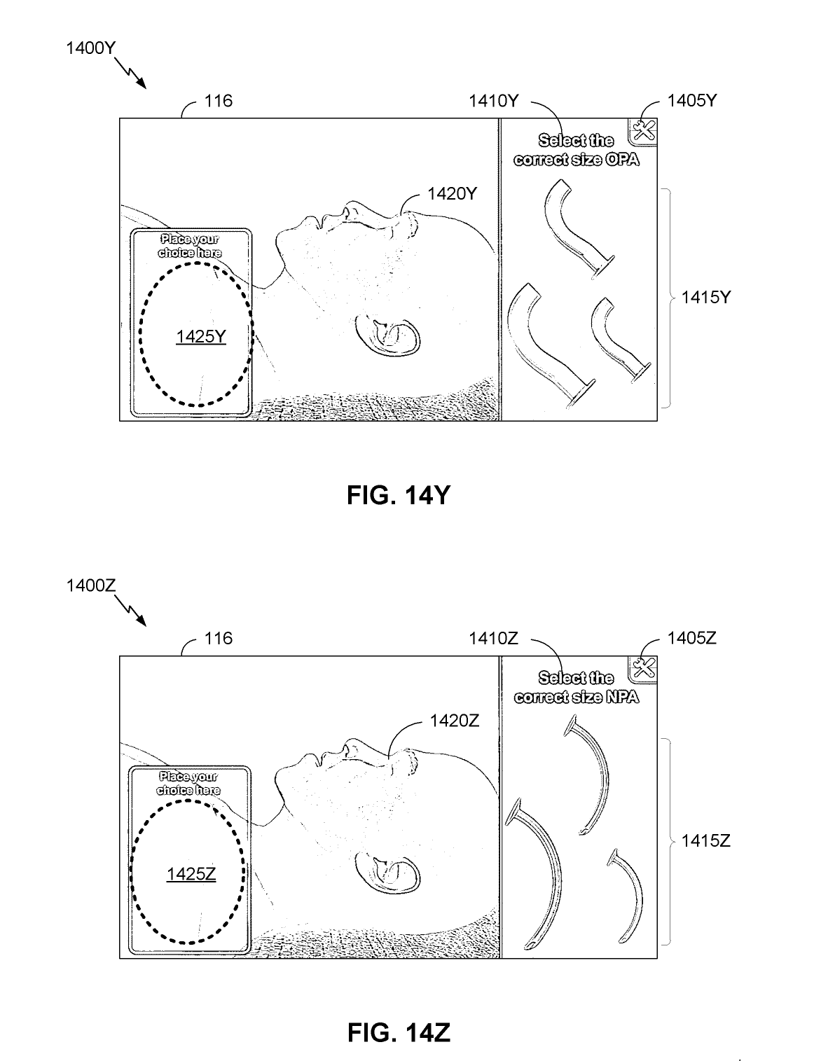

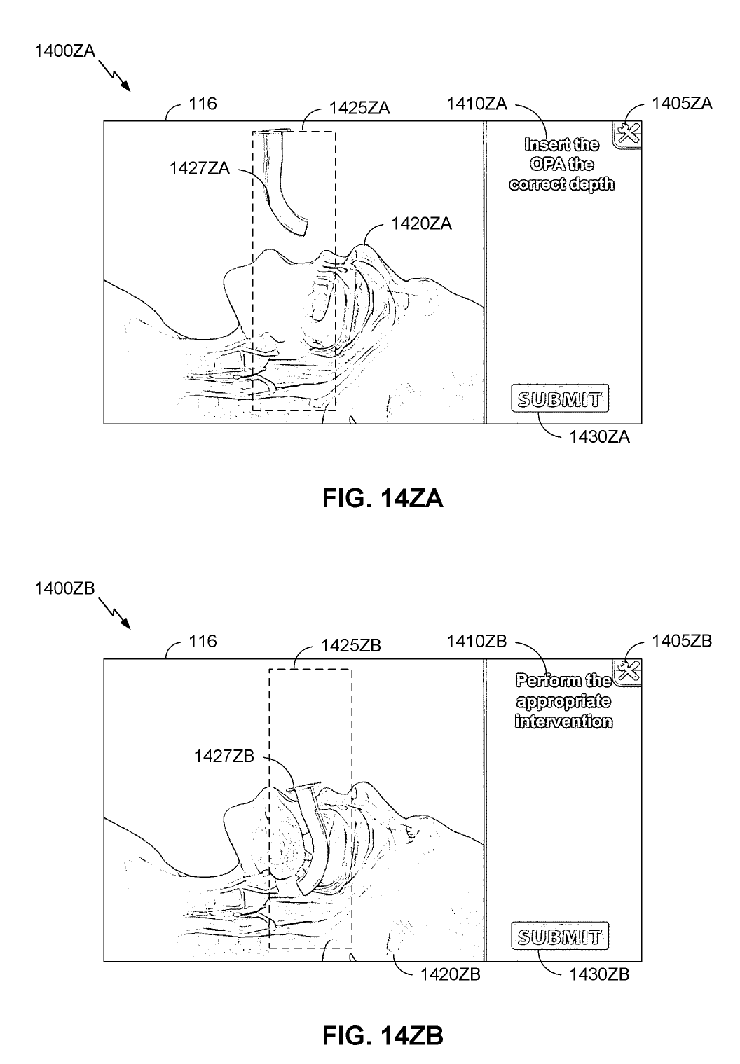

In various embodiments, the device 102 can be configured to provide medical training and/or testing for airway management. For example, the medical training and/or testing data, medical training and/or testing media, medical training and/or testing prompt, and medical training and/or testing interactions, described above with respect to FIG. 1, can relate to training and testing for airway management. In various embodiments, setting up the interaction for airway management testing can include setting up one or more gestures such as image swap, multi-choice point, point, drag-and-drop, image rotate, one- and two-finger slider, and point-and-vibrate gestures. Although particular exemplary gestures and interfaces are described herein with respect to airway management training and/or testing, any other compatible gesture or interface described herein (including those described with respect to other fields of medical training and/or testing) can be applied to airway management training and/or testing. FIGS. 14A-14ZB illustrate exemplary interfaces for airway management training and/or testing, according to various embodiments.

FIG. 14A illustrates an exemplary image swap interface 1400A, according to another embodiment. As shown, the image swap interface 1400A depicts a medical test for airway management in which the user is prompted to “Put the tasks in order. Switch places by selecting 2 icons.” The image swap interface 1400A can be implemented in, for example, the device 102 (FIG. 1). In various embodiments, the processor 104 (FIG. 1) can display the image swap interface 1400A on the display 116 (FIG. 1). As shown, the image swap interface 1400A includes a tool interface 1405A, instructions 1410A, a plurality of medical task icons 1415A (9 shown), and incorrect answer icons 1420A. Although various portions of the image swap interface 1400A are shown, a person having ordinary skill in the art will appreciate that the portions can be rearranged, portions can be omitted, and/or additional portions can be added.

In some embodiments, the image swap interface 1400A can operate in a substantially similar manner as the image swap interface 600A, described above with respect to FIG. 6A. For example, the tool interface 1405A, instructions 1410A, plurality of medical task icons 1415A, and incorrect answer icons 1420A can operate in a substantially similar manner as the tool interface 605A, instructions 610A, plurality of medical task icons 615A, and incorrect answer icons 620A of FIG. 6A. In some embodiments, the image swap interface 1400A can be a parameterized version of a template image swap interface, customized for airway management training and/or testing. Icons 1415A particularly suitable for airway management testing and training are shown in FIG. 14A

FIGS. 14B-14D illustrate exemplary multi-choice point interfaces 1400B-1400D, according to various embodiments. As shown, the multi-choice point interfaces 1400B-1400D depict medical tests for airway management training. The multi-choice point interfaces 1400B-1400D can be implemented in, for example, the device 102 (FIG. 1). In various embodiments, the processor 104 (FIG. 1) can display the multi-choice point interfaces 1400B-1400D on the display 116 (FIG. 1). As shown, the multi-choice point interfaces 1400B-1400D include tool interfaces 1405B-1405D, instructions 1410B-1410D, pluralities of selectable media 1415B-1415D, and submit buttons 1420B-1420D. Although various portions of the multi-choice point interfaces 1400B-1400D are shown, a person having ordinary skill in the art will appreciate that the portions can be rearranged, portions can be omitted, and/or additional portions can be added.

In some embodiments, the multi-choice point interfaces 1400B-1400D can operate in a substantially similar manner as the multi-choice point interface 700A, described above with respect to FIG. 7A. For example, tool interfaces 1405B-1405D, instructions 1410B-1410D, pluralities of selectable media 1415B-1415D, and submit buttons 1420B-1420D can operate in a substantially similar manner as the tool interface 705A, instructions 710A, plurality of selectable media 715A, and submit button 720A of FIG. 7A. In some embodiments, the multi-choice point interfaces 1400B-1400D can be parameterized versions of a template multi-choice point interface, customized for airway management training and/or testing, as can be seen in the particularized instructions 1410B-1410D and selectable media 1415B-1415D.

FIGS. 14E-14V illustrate exemplary single-choice point interfaces 1400E-1400V, according to various embodiments. As shown, the single-choice point interfaces 1400E-1400V depict medical tests for airway management training. The single-choice point interfaces 1400E-1400V can be implemented in, for example, the device 102 (FIG. 1). In various embodiments, the processor 104 (FIG. 1) can display the single-choice point interfaces 1400E-1400V on the display 116 (FIG. 1). As shown, the single-choice point interfaces 1400E-1400V include tool interfaces 1405E-1405V, instructions 1410E-1410V, and pluralities of selectable media 1415E-1415V. Although various portions of the single-choice point interfaces 1400E-1400V are shown, a person having ordinary skill in the art will appreciate that the portions can be rearranged, portions can be omitted, and/or additional portions can be added.

In some embodiments, the single-choice point interfaces 1400E-1400V can operate in a substantially similar manner as the single-choice point interface 800A, described above with respect to FIG. 8A. For example, tool interfaces 1405E-1405V, instructions 1410E-1410V, and pluralities of selectable media 1415E-1415V can operate in a substantially similar manner as the tool interface 805A, instructions 810A, and plurality of selectable media 815A of FIG. 8A. In some embodiments, the single-choice point interfaces 1400E-1400V can be parameterized versions of a template single-choice point interface, customized for airway management training and/or testing, as can be seen in the particularized instructions 1410E-1410V and selectable media 1415E-1415V. In some cases, the selectable media 1415E-N, 1415R-1415U are textual answer choices to questions posed in the instructions, given the background media. In other cases, the selectable media 1415O-1415Q, 1415V include image components.

In some embodiments, single-choice point interfaces can include background media, which can include static or moving images (with or without looping). For example, the single-choice point interfaces 1400E-1400M, 1400P, and 1400R-1400U shown in FIGS. 14E-14M, 14P, and 14R-14U include background media 1420E-1420M, 1420P, and 1420R-1420U, respectively. Moreover, in some embodiments, single-choice point interfaces can include background audio, which can include medical noises (for example, a heart rate, chest sounds, coughing, etc.) or speech (for example, conveying diagnostic information such as a pain complaint, slurred speech, etc.). For example, the single-choice point interfaces 1400E-14001 shown in FIGS. 14F-14I include background audio indicated by audio icons 1425F-1425I, respectively. In various embodiments, background audio can play automatically and can loop, or in response to an activation input (such as a touch on the audio icon 1425F-1425I).

The background image 1420E and accompanying background audio can indicate an alert, agitated, in pain, and/or confused patient. The background image 1420F and accompanying audio can indicate a drugged, unresponsive, uncooperative, and/or verbally stimulated patient. The background media 1420G can include a video of palpation, and the accompanying audio can indicate an alert, agitated, in pain, and/or confused patient. The background image 1420H and accompanying audio can indicate a drugged, unresponsive, uncooperative, and/or verbally stimulated patient. The background media 1420I can include a video of a moving chest indicative of an open airway or a still chest indicative of a closed airway. The accompanying audio can include breath noises or the absence of breath noises indicative of an open and closed airway, respectively. The background media 1420J can include a video of a moving chest indicative of an open airway or a still chest indicative of a closed airway. The background media 1420K can indicate a dry mouth condition. In various embodiments, the background media 1420L can indicate blood and/or other fluid in a patient's mouth (which can be indicated based by, for example, a fluid color). The background media 1420M can indicate broken teeth in a patient's mouth. The background media 1420P can indicate a position of an oropharyngeal airway (OPA) within a patient. The background media 1420R can indicate a nasopharyngeal airway (NPA) fully inserted into a patient's nose. The background media 1420S can indicate a nasopharyngeal airway (NPA) fully inserted into a patient's nose, and still or animated fluid coming out of a nostril. The background media 1420T can animate a nasopharyngeal airway (NPA) fully inserted into a patient's nose. The background media 1420U can animate a nasopharyngeal airway (NPA) partially inserted into a patient's nose due to resistance.

FIGS. 14W-14X illustrate exemplary point-and-vibrate interfaces 1400W-1400X, according to various embodiments. As shown, the point-and-vibrate interfaces 1400W-1400X depict medical tests for airway management training. The point-and-vibrate interfaces 1400W-1400X can be implemented in, for example, the device 102 (FIG. 1). In various embodiments, the processor 104 (FIG. 1) can display the point-and-vibrate interfaces 1400W-1400X on the display 116 (FIG. 1). As shown, the point-and-vibrate interfaces 1400W-1400X include tool interfaces 140W-140X, instructions 141W-141X, background images 142W-142X, diagnostic regions 1425W-1425X, diagnostic output 1430W-1430X, and pluralities of selectable media 1415W-1415X. Although various portions of the point-and-vibrate interfaces 1400W-1400X are shown, a person having ordinary skill in the art will appreciate that the portions can be rearranged, portions can be omitted, and/or additional portions can be added.

In some embodiments, the point-and-vibrate interfaces 1400W-1400X can operate in a substantially similar manner as the point-and-vibrate interface 1300A, described above with respect to FIG. 13A. For example, the tool interfaces 1405W-1405X, instructions 1410W-1410X, background images 1420W-1420X, diagnostic regions 1425W-1425X, diagnostic output 1430W-1430X, and pluralities of selectable media 14315W-1415X can operate in a substantially similar manner as the tool interfaces 1305A-1305G, instructions 1310A-1310G, background images 1320A-1320G, diagnostic regions 1325A-1325G, diagnostic output 1330A-1330G, and pluralities of selectable media 1315A-1315G of FIGS. 13A-13G. In some embodiments, the point-and-vibrate interfaces 1400W-1400X can be a parameterized version of a template point-and-vibrate interface, customized for airway management training and/or testing, as can be seen in the particulars of FIGS. 14W-14X.

FIGS. 14Y-14Z illustrate exemplary drag-and-drop interfaces 1400Y-1400Z, according to various embodiments. As shown, the drag-and-drop interfaces 1400Y-1400Z depict medical tests for airway management training. The drag-and-drop interfaces 1400Y-1400Z can be implemented in, for example, the device 102 (FIG. 1). In various embodiments, the processor 104 (FIG. 1) can display the drag-and-drop interfaces 1400Y-1400Z on the display 116 (FIG. 1). As shown, the drag-and-drop interfaces 1400Y-1400Z include tool interfaces 1405Y-1405Z, instructions 1410Y-1410Z, a plurality of movable media 1415Y-1415Z, a background image 1420Y-1420Z, and one or more correct answer regions 1425Y-1425Z. Although various portions of the drag-and-drop interfaces 1400Y-1400Z are shown, a person having ordinary skill in the art will appreciate that the portions can be rearranged, portions can be omitted, and/or additional portions can be added.

In some embodiments, the drag-and-drop interfaces 1400Y-1400Z can operate in a substantially similar manner as the drag-and-drop interface 900A, described above with respect to FIG. 9A. For example, the tool interfaces 1405Y-1405Z, instructions 1410Y-1410Z, plurality of movable media 1415Y-1415Z, background image 1420Y-1420Z, and one or more correct answer regions 1425Y-1425Z can operate in a substantially similar manner as the tool interface 905A, instructions 910A, plurality of movable media 915A, background image 920A, and one or more correct answer regions 925A of FIG. 9A. In some embodiments, the drag-and-drop interfaces 1400Y-1400Z can be a parameterized version of a template drag-and-drop interface, customized for airway management training and/or testing, as can be seen in the particulars of FIGS. 1Y-1Z.

FIGS. 1ZA-1ZB illustrate exemplary slider interfaces 1400ZA-1400ZB, according to various embodiments. As shown, the slider interfaces 1400ZA-1400ZB depict medical tests for airway management training. The slider interfaces 1400ZA-1400ZB can be implemented in, for example, the device 102 (FIG. 1). In various embodiments, the processor 104 (FIG. 1) can display the slider interfaces 1400ZA-1400ZB on the display 116 (FIG. 1). As shown, the slider interfaces 1400ZA-1400ZB include tool interfaces 1405ZA-1405ZB, instructions 1410ZA-1410ZB, background images 1420ZA-1420ZB, slider areas 1425ZA-1425ZB, slider indicators 1427ZA-1427ZB, and submit buttons 1430ZA-1430ZB. Although various portions of the slider interfaces 1400ZA-1400ZB are shown, a person having ordinary skill in the art will appreciate that the portions can be rearranged, portions can be omitted, and/or additional portions can be added.

In some embodiments, the slider interfaces 1400ZA-1400ZB can operate in a substantially similar manner as the slider interface 1100A, described above with respect to FIG. 11A. For example, the tool interfaces 1405ZA-1405ZB, instructions 1410ZA-1410ZB, background images 1420ZA-1420ZB, slider areas 1425ZA-1425ZB, and submit buttons 1430ZA-1430ZB can operate in a substantially similar manner as the tool interface 1105A, instructions 1110A, background image 1120A, slider area 1125A, and submit button 1130A of FIG. 11A. In some embodiments the slider indicators 1427O-142ZB can indicate a position and/or numerical value of the slider. In some embodiments, the slider indicators 1427O-142ZB can be portions of the background images 1420A, which can change as the slider is adjusted. In some embodiments, the slider interfaces 140ZA-140ZB can be a parameterized version of a template slider interfaces, customized for airway management training and/or testing, as can be seen in the particulars of FIGS. 14ZA-14ZB.

In the illustrated embodiment, the background media 1420ZA changes to show the OPA moving up and down based on the slider input. In the illustrated embodiment, the background media 1420ZB changes to show the OPA moving up and down based on the slider input.

### Shock Management

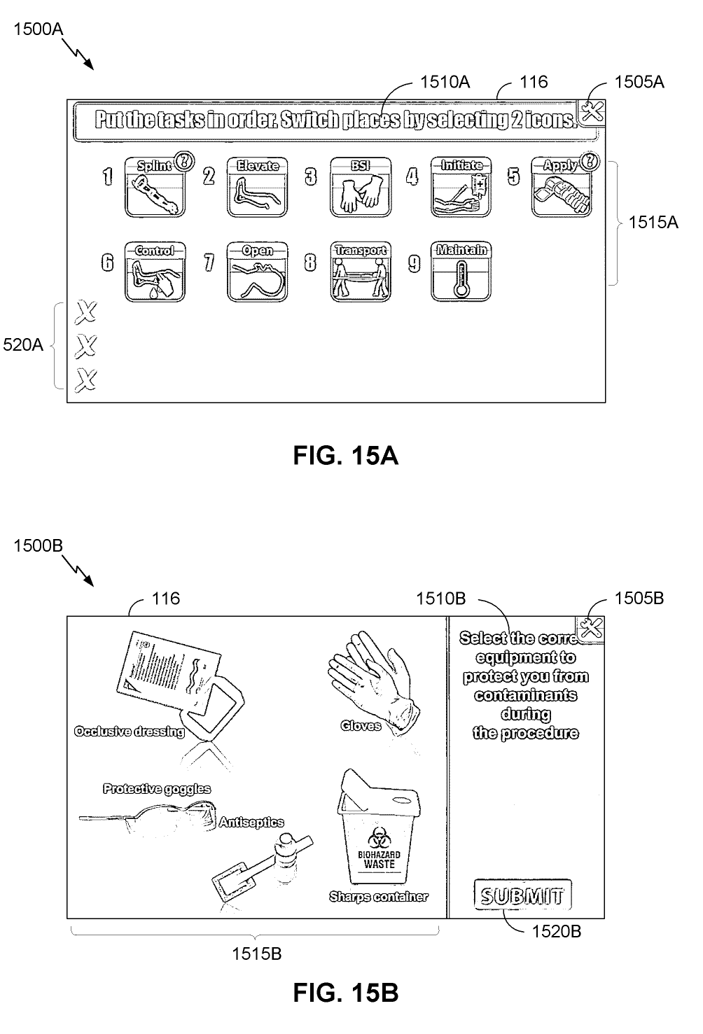

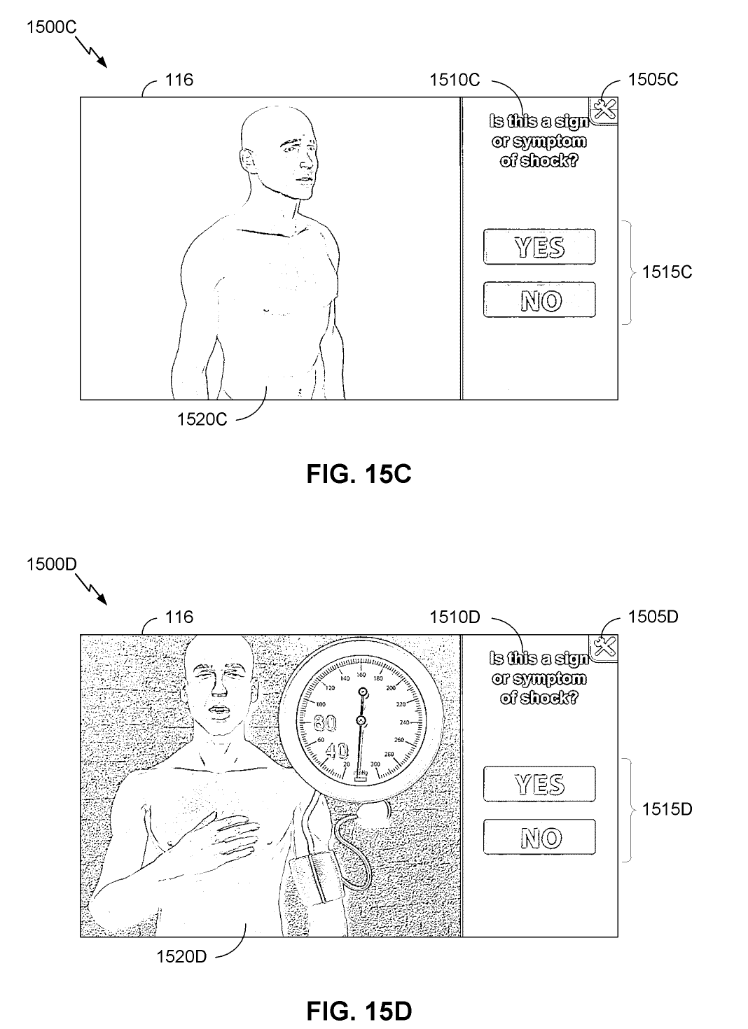

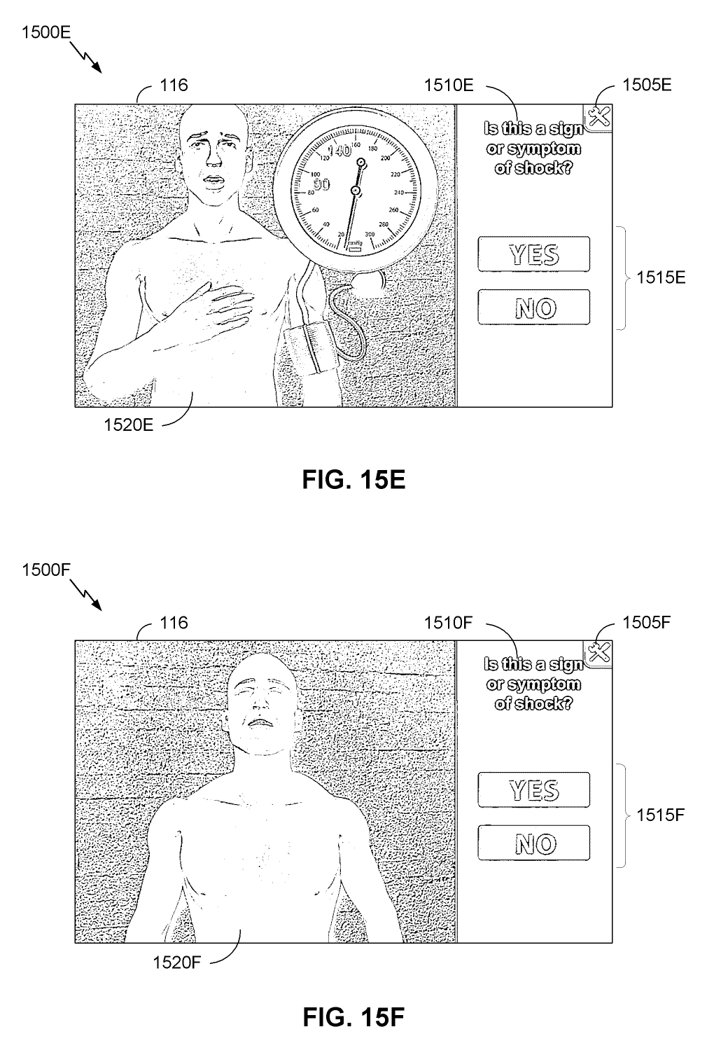

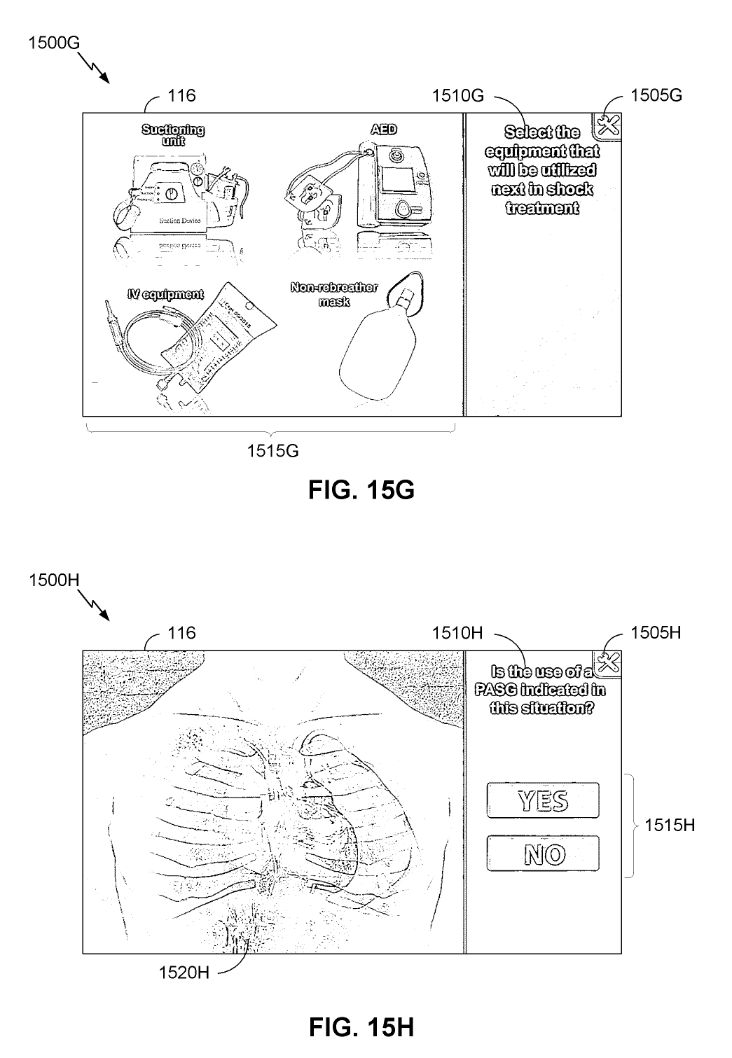

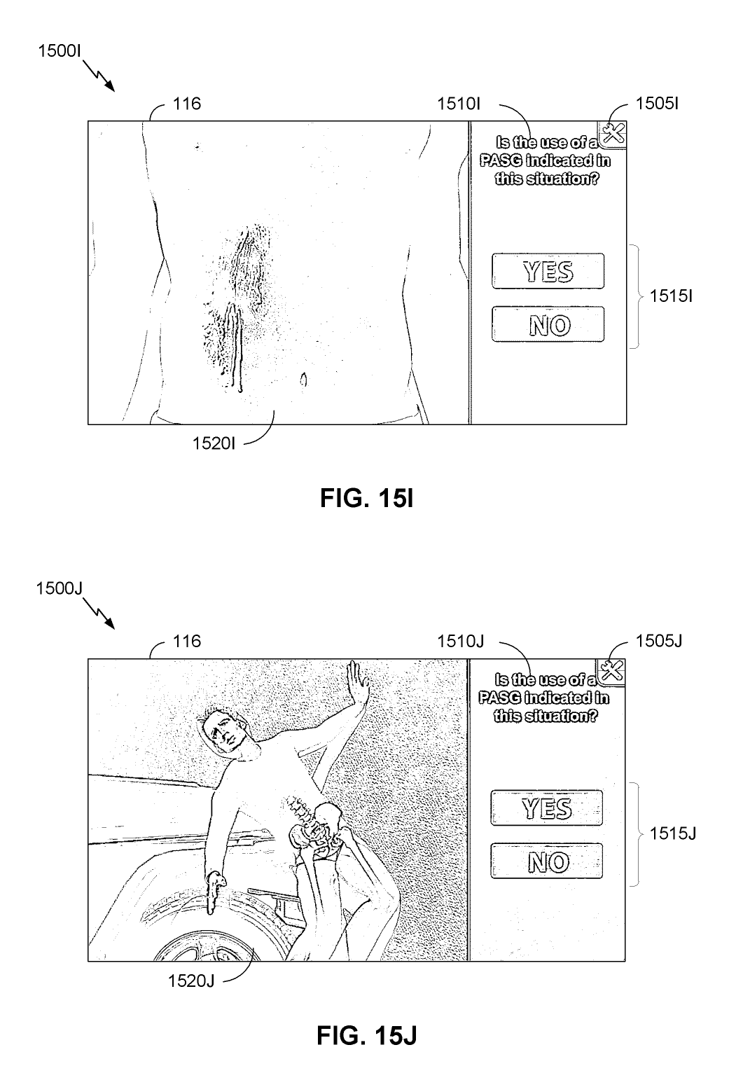

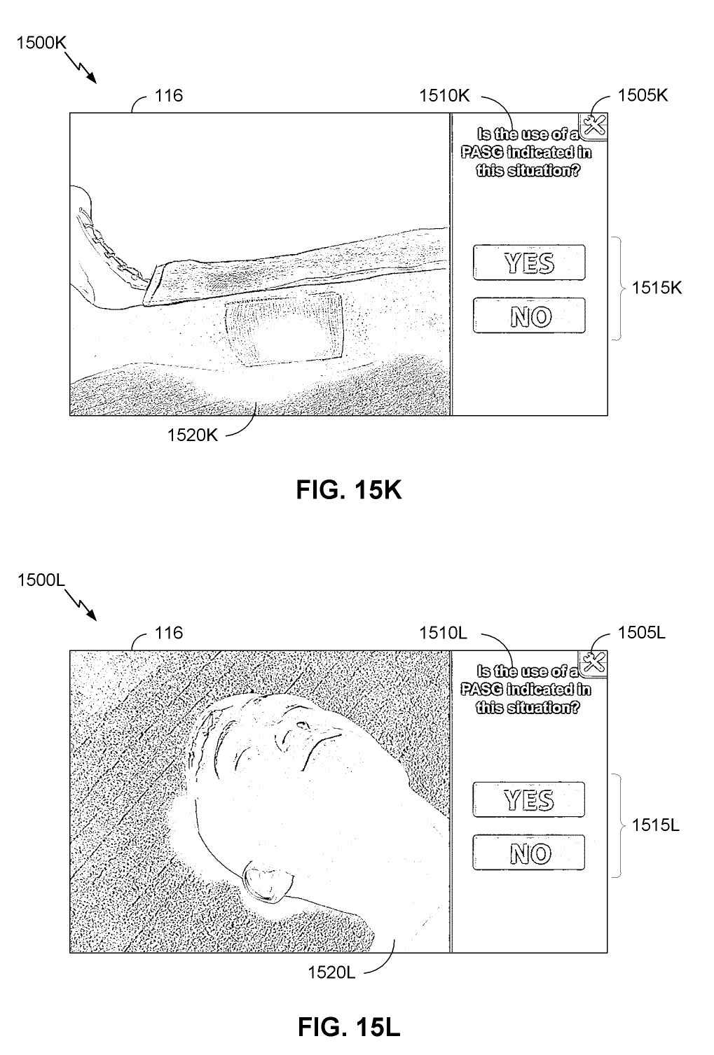

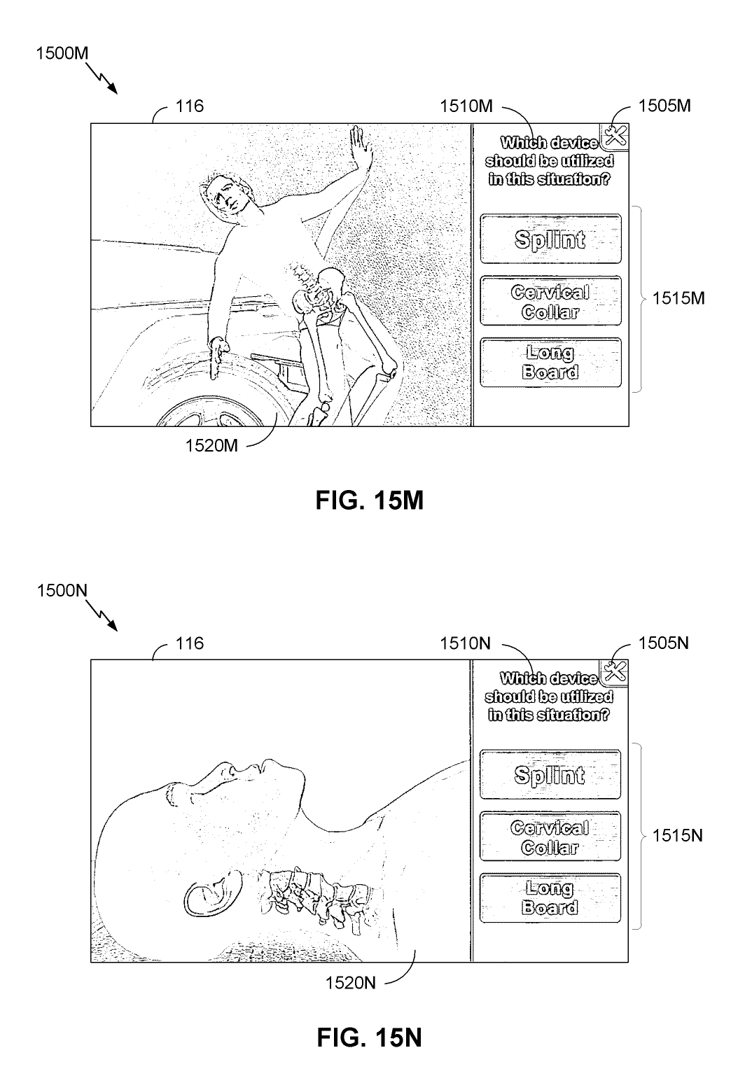

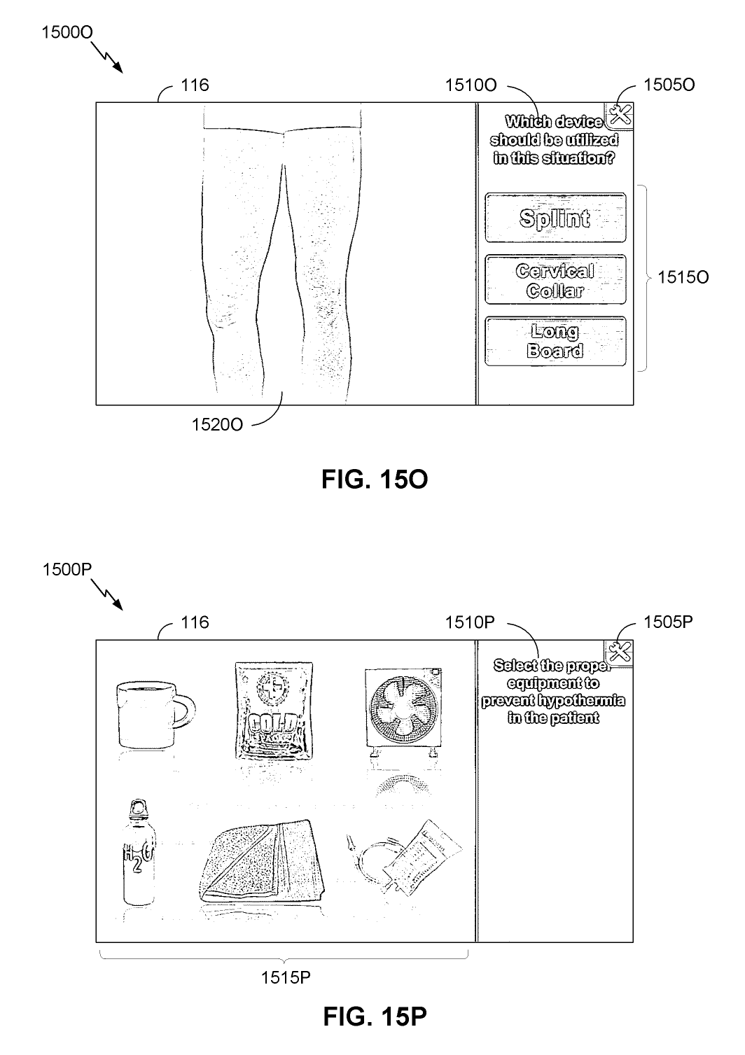

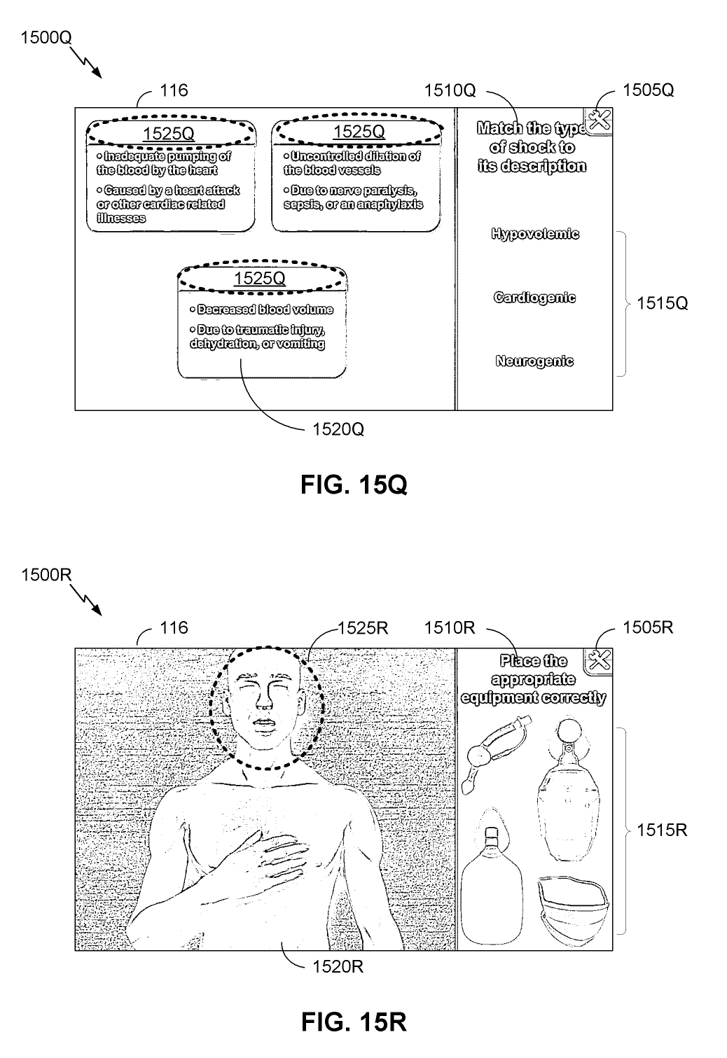

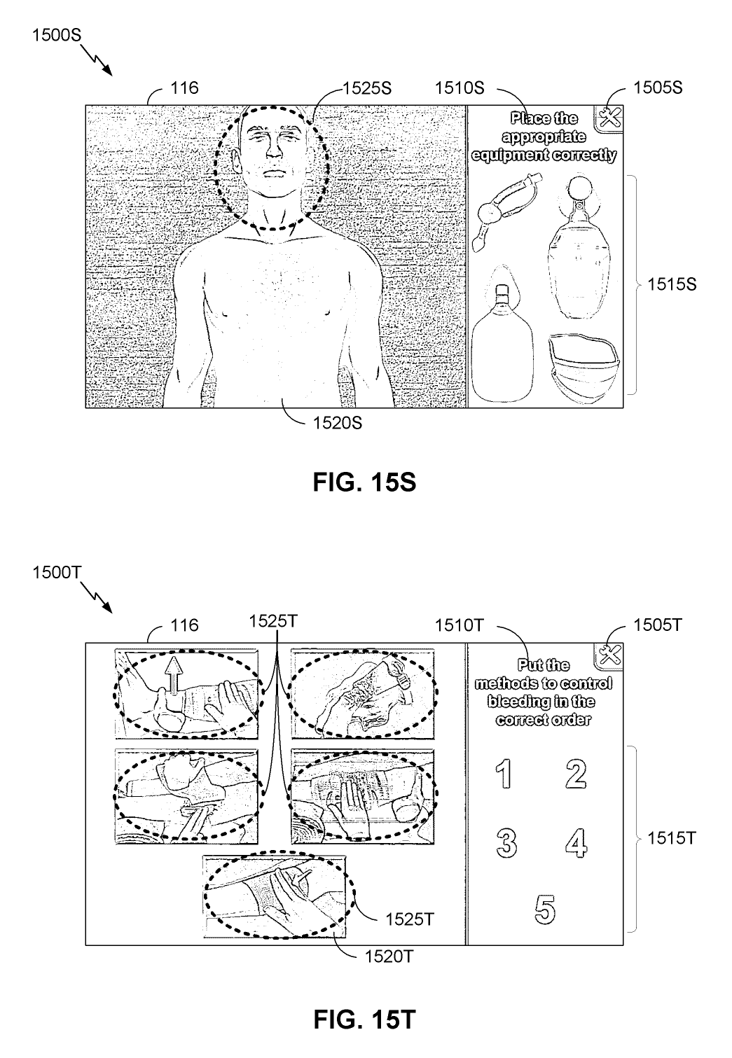

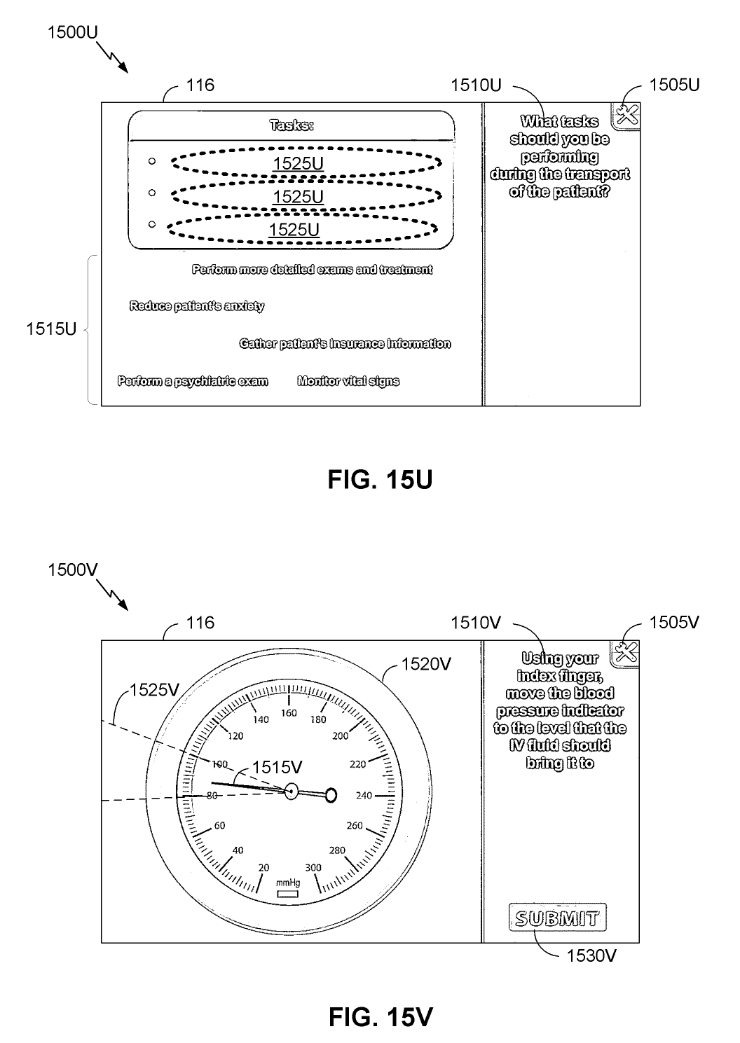

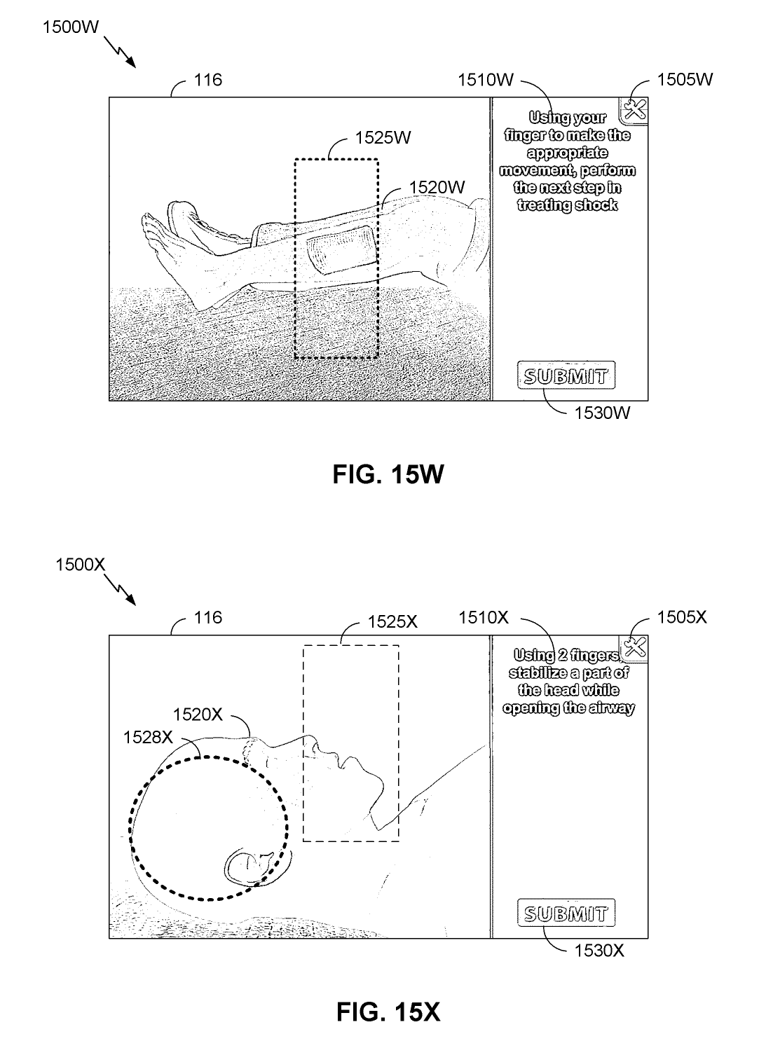

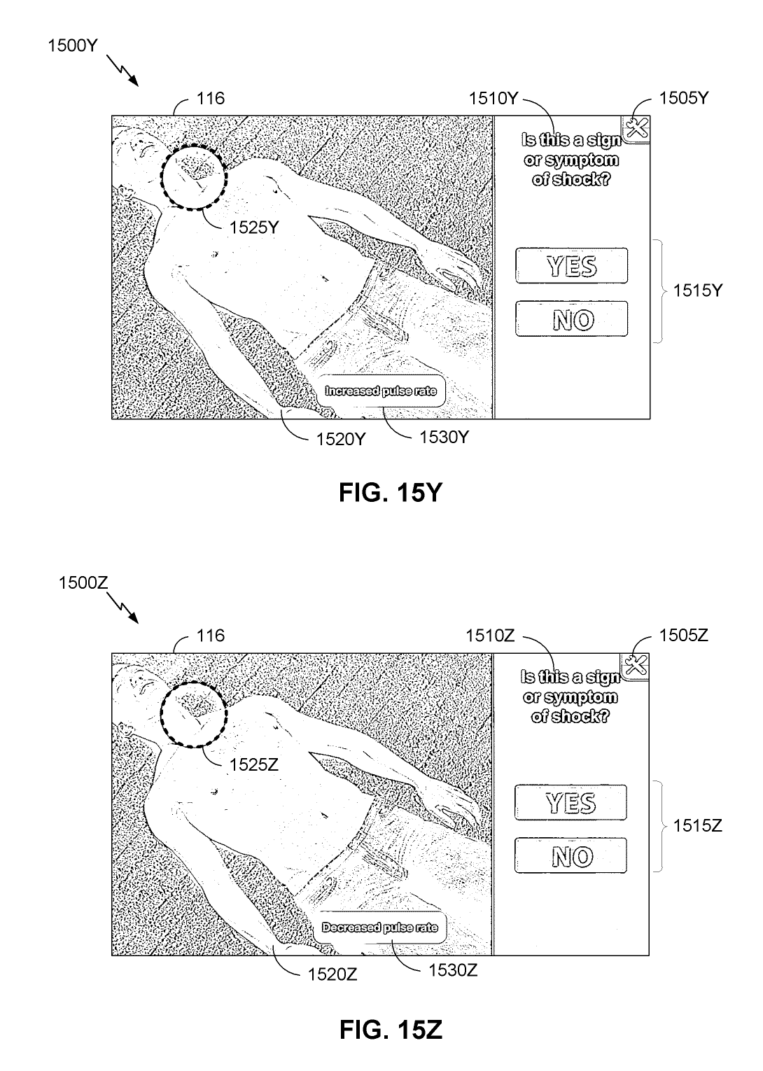

In various embodiments, the device 102 can be configured to provide medical training and/or testing for shock management. For example, the medical training and/or testing data, medical training and/or testing media, medical training and/or testing prompt, and medical training and/or testing interactions, described above with respect to FIG. 1, can relate to training and testing for shock management. In various embodiments, setting up the interaction for shock management testing can include setting up one or more gestures such as image swap, multi-choice point, point, drag-and-drop, image rotate, one- and two-finger slider, point-and-vibrate, pinch, and point-and-hold gestures. Although particular exemplary gestures and interfaces are described herein with respect to shock management training and/or testing, any other compatible gesture or interface described herein (including those described with respect to other fields of medical training and/or testing) can be applied to shock management training and/or testing. FIGS. 15A-17B illustrate exemplary interfaces for shock management training and/or testing, according to various embodiments.

FIG. 15A illustrates an exemplary image swap interface 1500A, according to another embodiment. As shown, the image swap interface 1500A depicts a medical test for shock management in which the user is prompted to “Put the tasks in order. Switch places by selecting 2 icons.” The image swap interface 1500A can be implemented in, for example, the device 102 (FIG. 1). In various embodiments, the processor 104 (FIG. 1) can display the image swap interface 1500A on the display 116 (FIG. 1). As shown, the image swap interface 1500A includes a tool interface 1505A, instructions 1510A, a plurality of medical task icons 1515A (9 shown), and incorrect answer icons 1520A. Although various portions of the image swap interface 1500A are shown, a person having ordinary skill in the art will appreciate that the portions can be rearranged, portions can be omitted, and/or additional portions can be added.

In some embodiments, the image swap interface 1500A can operate in a substantially similar manner as the image swap interface 600A, described above with respect to FIG. 6A. For example, the tool interface 1505A, instructions 1510A, plurality of medical task icons 1515A, and incorrect answer icons 1520A can operate in a substantially similar manner as the tool interface 605A, instructions 610A, plurality of medical task icons 615A, and incorrect answer icons 620A of FIG. 6A. In some embodiments, the image swap interface 1500A can be a parameterized version of a template image swap interface, customized for shock management training and/or testing. Icons 1515A particularly suitable for shock management testing and training are shown in FIG. 15A.

FIG. 15B illustrates an exemplary multi-choice point interface 1500B, according to an embodiment. As shown, the multi-choice point interface 1500B depicts medical tests for shock management training. The multi-choice point interface 1500B can be implemented in, for example, the device 102 (FIG. 1). In various embodiments, the processor 104 (FIG. 1) can display the multi-choice point interface 1500B on the display 116 (FIG. 1). As shown, the multi-choice point interface 1500B includes the tool interface 1505B, instructions 1510B, a plurality of selectable media 1515B, and a submit button 1520B. Although various portions of the multi-choice point interface 1500B are shown, a person having ordinary skill in the art will appreciate that the portions can be rearranged, portions can be omitted, and/or additional portions can be added.

In some embodiments, the multi-choice point interface 1500B can operate in a substantially similar manner as the multi-choice point interface 700A, described above with respect to FIG. 7A. For example, the tool interface 1505B, instructions 1510B, the plurality of selectable media 1515B, and the submit button 1520B can operate in a substantially similar manner as the tool interface 705A, instructions 710A, plurality of selectable media 715A, and submit button 720A of FIG. 7A. In some embodiments, the multi-choice point interface 1500B can be a parameterized version of a template multi-choice point interface, customized for shock management training and/or testing, as can be seen in the particularized instructions 1510B and selectable media 1515B.

FIGS. 15C-15P illustrate exemplary single-choice point interfaces 1500C-1500P, according to various embodiments. As shown, the single-choice point interfaces 1500C-1500P depict medical tests for shock management training. The single-choice point interfaces 1500C-1500P can be implemented in, for example, the device 102 (FIG. 1). In various embodiments, the processor 104 (FIG. 1) can display the single-choice point interfaces 1500C-1500P on the display 116 (FIG. 1). As shown, the single-choice point interfaces 1500C-1500P include tool interfaces 1505C-1505P, instructions 1510C-1510P, and pluralities of selectable media 1515C-1515P. Although various portions of the single-choice point interfaces 1500C-1500P are shown, a person having ordinary skill in the art will appreciate that the portions can be rearranged, portions can be omitted, and/or additional portions can be added.

In some embodiments, the single-choice point interfaces 1500C-1500P can operate in a substantially similar manner as the single-choice point interface 800A, described above with respect to FIG. 8A. For example, tool interfaces 1505C-1505P, instructions 1510C-1510P, and pluralities of selectable media 1515C-1515P can operate in a substantially similar manner as the tool interface 805A, instructions 810A, and plurality of selectable media 815A of FIG. 8A. In some embodiments, the single-choice point interfaces 1500C-1500P can be parameterized versions of a template single-choice point interface, customized for shock management training and/or testing, as can be seen in the particularized instructions 1510C-1510P and selectable media 1515C-1515P. In some cases, the selectable media 1515C-1515F, 1515H-1515O are textual answer choices to questions posed in the instructions, given the background media. In other cases, the selectable media 1515G, 1515P include image components.

In some embodiments, single-choice point interfaces can include background media, which can include static or moving images (with or without looping). For example, the single-choice point interfaces 1500C-1500F and 1500H-1500O shown in FIGS. 15C-15F and 15H-15O include background media 1520C-1520F and 1520H-1520O, respectively. The background image 1520C can indicate a condition of a patient, for example using color (blue to indicate cyanosis, red to indicate flushing, etc), animated or video motion (for example, to show shallow breath, regular breath, no breath, etc.), and the like. In the illustrated embodiment, the background image 1520D indicates low blood pressure by animating a blood pressure cuff and needle, and displaying systolic and diastolic pressures. In the illustrated embodiment, the background image 1520E indicates high blood pressure by animating a blood pressure cuff and needle, and displaying systolic and diastolic pressures. The background image 1520F can indicate a condition of a patient, for example using color (blue to indicate cyanosis, red to indicate flushing, etc.), animated or video motion (for example, to show shallow breath, regular breath, no breath, etc.), and the like.

In the illustrated embodiment, the background image 1520H indicates a chest injury. In the illustrated embodiment, the background image 1520I indicates an abdominal injury. In the illustrated embodiment, the background image 1520J indicates a pelvic injury. In the illustrated embodiment, the background image 1520K indicates a bleeding leg wound. In the illustrated embodiment, the background image 1520L indicates a head wound. In the illustrated embodiment, the background image 1520M indicates multiple injuries. In the illustrated embodiment, the background image 1520N indicates a spinal injury. In the illustrated embodiment, the background image 1520O indicates an extremity injury.

FIGS. 15Q-15U illustrate exemplary drag-and-drop interfaces 1500Q-1500U, according to various embodiments. As shown, the drag-and-drop interfaces 1500Q-1500U depict medical tests for shock management training. The drag-and-drop interfaces 1500Q-1500U can be implemented in, for example, the device 102 (FIG. 1). In various embodiments, the processor 104 (FIG. 1) can display the drag-and-drop interfaces 1500Q-1500U on the display 116 (FIG. 1). As shown, the drag-and-drop interfaces 1500Q-1500U include tool interfaces 1505Q-1505U, instructions 1510Q-1510U, a plurality of movable media 1515Q-1515U, a background image 1520Q-1520U, and one or more correct answer regions 1525Q-1525U. Although various portions of the drag-and-drop interfaces 1500Q-1500U are shown, a person having ordinary skill in the art will appreciate that the portions can be rearranged, portions can be omitted, and/or additional portions can be added.

In some embodiments, the drag-and-drop interfaces 1500Q-1500U can operate in a substantially similar manner as the drag-and-drop interface 900A, described above with respect to FIG. 9A. For example, the tool interfaces 1505Q-1505U, instructions 1510Q-1510U, plurality of movable media 1515Q-1515U, background images 1520Q-1520U, and one or more correct answer regions 1525Q-1525U can operate in a substantially similar manner as the tool interface 905A, instructions 910A, plurality of movable media 915A, background image 920A, and one or more correct answer regions 925A of FIG. 9A. In some embodiments, the drag-and-drop interfaces 1500Q-1500U can be a parameterized version of a template drag-and-drop interface, customized for shock management training and/or testing, as can be seen in the particulars of FIGS. 15Q-15U.

In the illustrated embodiment, the background media 1520R indicates inadequate breathing, for example via an animation of a patient struggling for air or not breathing. In the illustrated embodiment, the background media 1520S indicates adequate breathing, for example via an animation of a patient's chest moving normally. In the illustrated embodiment, the various correct answer regions 1525T of the background media 1520T indicates various methods to control bleeding including elevating a wound, applying a tourniquet, applying direct pressure to a wound, applying dressing to a wound, and applying indirect pressure over dressing, to be matched with movable media 1515T, which are numbers for indication of the proper sequence.

FIG. 15V illustrates an exemplary rotate interface 1500V, according to an embodiment. As shown, the rotate interface 1500V depicts medical tests for shock management training. The rotate interface 1500V can be implemented in, for example, the device 102 (FIG. 1). In various embodiments, the processor 104 (FIG. 1) can display the rotate interface 1500V on the display 116 (FIG. 1). As shown, the rotate interface 1500V includes tool interface 1505V, instructions 1510V, a rotatable media 1515V, a background image 1520V, a correct rotation range 1525V, which can be hidden from the user, and a submit button 1530V. Although various portions of the rotate interface 1500V are shown, a person having ordinary skill in the art will appreciate that the portions can be rearranged, portions can be omitted, and/or additional portions can be added.

In some embodiments, the rotate interface 1500V can operate in a substantially similar manner as the rotate interface 1000A, described above with respect to FIG. 10A. For example, the tool interface 1505V, instructions 1510V, the rotatable media 1515V, the background image 1520V, the correct rotation range 1525V, which can be hidden from the user, and the submit button 1530V can operate in the substantially similar manner as the tool interface 1005A, instructions 1010A, the rotatable media 1015A, the background image 1020A, the correct rotation range 1025A, and the submit button 1030A of FIG. 10A. In some embodiments, the rotate interface 1500V can be a parameterized version of a template rotate interface, customized for shock management training and/or testing, as can be seen in the particularized instructions 1510V and selectable media 1515V.

FIG. 15W illustrates an exemplary slider interface 1500W, according to another embodiment. As shown, the slider interface 1500W depicts medical tests for shock management training. The slider interface 1500W can be implemented in, for example, the device 102 (FIG. 1). In various embodiments, the processor 104 (FIG. 1) can display the slider interface 1500W on the display 116 (FIG. 1). As shown, the slider interface 1500W includes a tool interface 1505W, instructions 1510W, a background image 1520W, a slider area 1525W, and a submit button 1530W. Although various portions of the slider interface 1500W are shown, a person having ordinary skill in the art will appreciate that the portions can be rearranged, portions can be omitted, and/or additional portions can be added.

In some embodiments, the slider interface 1500W can operate in a substantially similar manner as the slider interface 1100A, described above with respect to FIG. 11A. For example, the tool interface 1505W, instructions 1510W, background image 1520W, slider area 1525W, and submit button 1530W can operate in a substantially similar manner as the tool interface 1105A, instructions 1110A, background image 1120A, slider area 1125A, and submit button 1130A of FIG. 11A. In some embodiments, slider indicators can be portions of the background images 1520A, which can change as the slider is adjusted. In some embodiments, the slider interface 1500W can be a parameterized version of a template slider interface, customized for shock management training and/or testing, as can be seen in the particulars of FIG. 15W.

In the illustrated embodiment, the background image 1520W changes as the slider is adjusted, for example by elevating a patient's legs.

FIG. 15X illustrates an exemplary two-finger slider interface 1500X, according to another embodiment. As shown, the two-finger slider interface 1500X depicts medical tests for shock management training. The two-finger slider interface 1500X can be implemented in, for example, the device 102 (FIG. 1). In various embodiments, the processor 104 (FIG. 1) can display the two-finger slider interface 1500X on the display 116 (FIG. 1). As shown, the two-finger slider interface 1500X includes a tool interface 1505X, instructions 1510X, a background image 1520X, a slider area 1525X, a static region 1528X, and a submit button 1530X. Although various portions of the two-finger slider interface 1500X are shown, a person having ordinary skill in the art will appreciate that the portions can be rearranged, portions can be omitted, and/or additional portions can be added.

In some embodiments, the two-finger slider interface 1500X can operate in a substantially similar manner as the two-finger slider interface 1200R, described above with respect to FIG. 12R. For example, the tool interface 1505X, instructions 1510X, background image 1520X, slider area 1525X, static region 1528X, and submit button 1530X can operate in a substantially similar manner as the tool interface 1205R, instructions 1210R, background image 1220R, slider area 1225R, static region 1228R, and submit button 1230R of FIG. 12R. In some embodiments, slider indicators can be portions of the background images 1520R, which can change as the two-finger slider is adjusted. In some embodiments, the two-finger slider interface 1500X can be a parameterized version of a template two-finger slider interface, customized for shock management training and/or testing, as can be seen in the particulars of FIG. 15X.

In the illustrated embodiment, the background image 1520X changes as the two-finger slider is adjusted, for example by tilting the patient's head with one finger while stabilizing the head with another finger.

FIGS. 15Y-15Z illustrate exemplary point-and-vibrate interfaces 1500Y-1500Z, according to various embodiments. As shown, the point-and-vibrate interfaces 1500Y-1500Z depict medical tests for shock management training The point-and-vibrate interfaces 1500Y-1500Z can be implemented in, for example, the device 102 (FIG. 1). In various embodiments, the processor 104 (FIG. 1) can display the point-and-vibrate interfaces 1500Y-1500Z on the display 116 (FIG. 1). As shown, the point-and-vibrate interfaces 1500Y-1500Z include tool interfaces 1505Y-1505Z, instructions 1510Y-1501Z, background images 1520Y-1520Z, diagnostic regions 1525Y-1525Z, diagnostic output 1530Y-1530Z, and pluralities of selectable media 1515Y-1515Z. Although various portions of the point-and-vibrate interfaces 1500Y-1500Z are shown, a person having ordinary skill in the art will appreciate that the portions can be rearranged, portions can be omitted, and/or additional portions can be added.

In some embodiments, the point-and-vibrate interfaces 1500Y-1500Z can operate in a substantially similar manner as the point-and-vibrate interface 1300A, described above with respect to FIGS. 13A-13G. For example, the tool interfaces 1505Y-1505Z, instructions 1510Y-1510Z, background images 1520Y-1520Z, diagnostic regions 1525Y-1525Z, diagnostic output 1530Y-1530Z, and pluralities of selectable media 15315Y-1515Z can operate in a substantially similar manner as the tool interfaces 1305A-1305G, instructions 1310A-1310G, background images 1320A-1320G, diagnostic regions 1325A-1325G, diagnostic output 1330A-1330G, and pluralities of selectable media 1315A-1315G of FIGS. 13A-13G. In some embodiments, the point-and-vibrate interfaces 1500Y-1500Z can be a parameterized version of a template point-and-vibrate interface, customized for shock management training and/or testing, as can be seen in the particulars of FIGS. 15Y-15Z.

### Pinch

In an embodiment, setting up an interaction for medical training and/or testing data (discussed above with respect to block 240 of FIG. 2) can include setting up a pinch gesture. The processor 104 can load one or more parameters for the pinch gesture from the memory 106. In an embodiment, the pinch gesture can allow a user to pinch their fingers on the display 116 in order to mimic the movement of squeezing something (or widening or expanding something in a reverse pinch motion, both motions referred to inclusively as a “pinch”).

In various embodiments, for example, a user can inflate a pneumatic anti-shock garment (PASG), pinch an intravenous (IV) drip, open an eyelid or other opening, etc. In some embodiments, the processor 104 can cause the display 116 to output an image sequence that progresses in response to pinch gestures. In some embodiments, pinch gestures can be limited to one or more portions of the digitizer 118 (for example, via a color map loaded from the memory 106 with the medical training and/or testing data).

In an embodiment, loading medical training and/or testing data (discussed above with respect to block 210 of FIG. 2) can include loading information indicating one or more correct end values (or range or plurality of correct end values) and a pinch area. For example, the processor 104 can load a pinch area and correct end value from the memory 106. In some embodiments, the entire digitizer 118 can be a valid pinch area. In other embodiments, the medical training and/or testing data can include an indication of where on the digitizer 118 the pinch gesture will be effective. Correct end values can include, for example, an amount that a user is to pinch (or expand) an on-screen image in order to give a correct answer.

In an embodiment, loading medical training and/or testing media (discussed above with respect to block 220 of FIG. 2) can include loading one or more background images and instructions. Each background image can represent equipment, actions, responses, and/or configurations related to a medical procedure. The instructions can include text such as, for example, “Inflate the PASG by expanding two fingers on the screen.” In some embodiments, the background image can vary according to a pinch position or amount. In some embodiments, the background image can be static, and a foreground image can be varied according to the pinch position or amount.

In various embodiments, the medical training and/or testing media can include a background video or image, with or without looping. In various embodiments, the medical training and/or testing media can include hidden images. The processor 104 can cause the display 116 to output the hidden images in response to pinch gestures. In various embodiments, the medical training and/or testing media can include explanations for correct and incorrect answers and/or accompanying sounds.

In an embodiment, providing a medical training and/or testing prompt (discussed above with respect to block 230 of FIG. 2) can include displaying the background image, a submit button, and/or the instruction text. For example, the processor 104 can cause the display 116 to output the background image, submit button, and the instruction text discussed above. In an embodiment, the processor 104 causes the display 116 to output a tutorial illustrating the pinch interaction. In an embodiment, the processor 104 can cause the display 116 to flash a pinchable image, thereby indicating a pinchable region.

In an embodiment, the processor 104 can cause the user interface 122 to output audio based on a position or amount of the pinch. In an embodiment, the processor 104 can cause the user interface 122 to output an indication of the pinch location or amount, for example, as a numerical text overlay, a graphical pinch, a varying sound, etc. In some embodiments, the background image can change according to a pinch position or amount. In some embodiments, the processor 104 can cause the user interface 122 to output light, sound, and/or vibration based on the specific background image shown and/or pinch position.

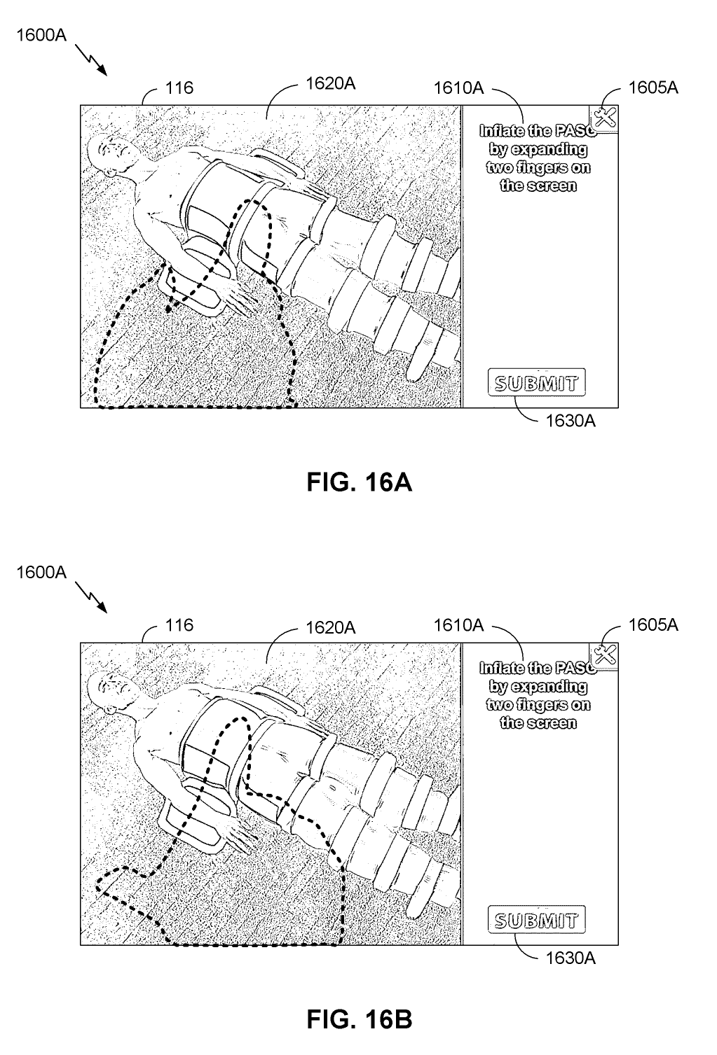

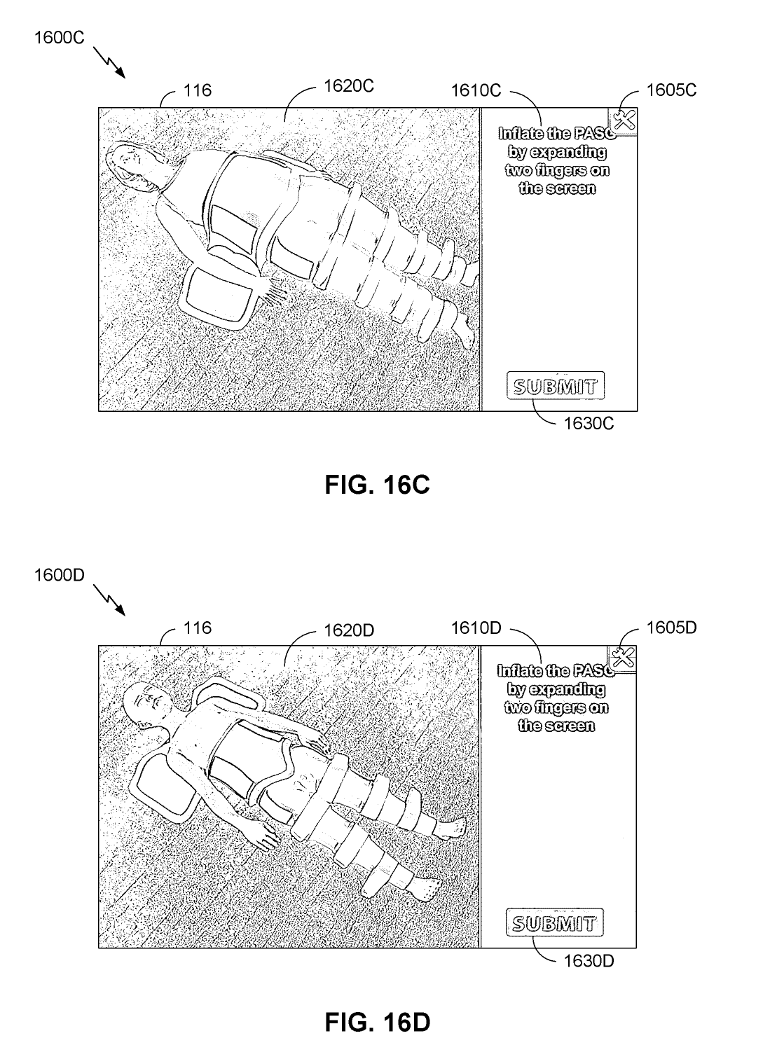

In an embodiment, receiving the medical training and/or testing interaction (discussed above with respect to block 250 of FIG. 2) can include receiving one or more user pinch motions. For example, the processor 104 can receive one or more touch paths from the digitizer 118, which can include a plurality of start points and end points. The processor 104 can track an initial touch at a first start point, movement of the touch location to a first end point, and release of the touch at the first end point. The processor 104 can further track an at least partially concurrent or simultaneous touch at a second start point, movement of the touch location to a second end point, and release of the touch at the second end point. The processor 104 can measure a distance between two touch points, including an absolute distance or a distance along one or more pinch axes (which can be oriented in any way). The processor 104 can identify a pinch region based on the initial touch points. In an embodiment, the processor 104 can dismiss initial touch locations not corresponding to the pinch region. In an embodiment, the processor 104 can associate all touch points in the pinch interface 1600A (see FIG. 16A) with the pinch. In an embodiment, the processor 104 can receive selection of a submit button.

In an embodiment, evaluating the medical training and/or testing interaction (discussed above with respect to block 260 of FIG. 2) can include identifying user selection and adjustment of one or more pinch regions. In an embodiment, when a pinch is detected, the processor 104 can cause the display 116 to display subsequent background images (or in reverse, depending on the direction of the pinch motion) based on movement along the touch paths. In an embodiment, when the pinch is detected, the processor 104 can cause the user interface 122 output a corresponding sound. In an embodiment, the processor 104 can identify selection of the submit button.

In an embodiment, the processor 104 can compare the received gesture to a pinch gesture template in the memory 106. For example, the processor 104 can determine whether the user has touched a pinch region of the medical training and/or testing media. When the processor 104 detects selection of a pinch region, the processor 104 can adjust the pinch and/or background image based on the end point and/or the path to the end point. For example, the processor 104 can advance or retreat the pinch. The processor 104 can track a numerical value representing the pinch position.

When the processor 104 detects selection of the submit button, the processor 104 can compare the tracked pinch position or value to the correct value or range of values obtained from the medical training and/or testing data. When the pinch position or value matches a correct value (or range of correct values), the processor 104 can determine a correct answer. When the pinch position or value does not match the correct value (or range of correct values), the processor 104 can determine an incorrect answer.

When the processor 104 determines that an inaccurate answer has been given, the processor 104 can at least partially reset the medical training and/or testing prompt. For example, the processor 104 can cause the display 116 to reset the pinch position and/or display an initial background image. When the processor 104 determines that an inaccurate answer has been given, the processor 104 can cause the display 116 to output an indication that the pinch position was incorrect. The indication can be audio, visual, and/or textual. When the processor 104 determines that an inaccurate answer has been given, the processor 104 can cause the display 116 to output an explanation indicating why the selection was incorrect.

When the pinch value is within a range of correct pinch values, the processor 104 can cause the display 116 to adjust a pinched image to a final correct position. For example, the pinch, when adjusted within a range of correct values, can “snap” to the center of the correct values. In various embodiments, the pinch does not “snap” to the center of correct position.

In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu. When the processor 104 determines that an accurate answer has been given, the processor 104 can cause the display 116 to output an explanation indicating why the answer was correct.

FIGS. 16A-16B illustrate an exemplary pinch interface 1600A, according to a shock management training embodiment. As shown, the pinch interface 1600A depicts a medical test for shock management in which the user is prompted to “Inflate the PASG by expanding two fingers on the screen.” The pinch interface 1600A can be implemented in, for example, the device 102 (FIG. 1). In various embodiments, the processor 104 (FIG. 1) can display the pinch interface 1600A on the display 116 (FIG. 1). As shown, the pinch interface 1600A includes a tool interface 1605A, instructions 1610A, a background image 1620A, and a submit button 1630A. Although various portions of the pinch interface 1600A are shown, a person having ordinary skill in the art will appreciate that the portions can be rearranged, portions can be omitted, and/or additional portions can be added. For example, in some embodiments, the pinch interface 1600A can include a pinch region (not shown).

The tool interface 1605A serves to provide navigation, for example to a main menu and/or to one or more other medical training and/or testing interfaces described herein. The instructions 1610A serve to instruct the user on how to interact with the pinch interface 1600A, and more particularly to “Inflate the PASG by expanding two fingers on the screen.” The background image 1620A provides context for the pinch interface 1600A. In the illustrated embodiment, the background image 1620A depicts a PASG that inflates and deflates based on a received pinch gesture. As the user moves two fingers away from each other, the processor 104 adjusts the background image 1620A to show the PASG inflates (see FIG. 16B). As the user moves two fingers towards each other, the processor 104 adjusts the background image 1620A to show the PASG deflated (FIG. 16A). The submit button 1630A serves to indicate that the user is ready for the processor 104 to evaluate the interaction.

In the illustrated embodiments of FIGS. 16A-12B, the background image 1620A indicates an adult male patient. FIGS. 16C-16D are similar but illustrate different patients and corresponding PASGs. In the illustrated embodiment of FIG. 16C, the background image 1620C indicates a pregnant woman patient. In the illustrated embodiment of FIG. 16D, the background image 1620D indicates an adolescent patient.

### Point-and-Hold

In an embodiment, setting up an interaction for medical training and/or testing data (discussed above with respect to block 240 of FIG. 2) can include setting up a point-and-hold gesture. The processor 104 can load one or more parameters for the point-and-hold gesture from the memory 106. In an embodiment, the point-and-hold gesture can allow a user to tap and hold on a designated area of the display 116 while images on the display 116 change. When a correct image is on the screen, the can select a submit button. In various embodiments, for examples, the changing images can include a stopwatch time, a number of CPR cycles, etc.

In an embodiment, loading medical training and/or testing data (discussed above with respect to block 210 of FIG. 2) can include loading information indicating one or more correct end values (or range or plurality of correct end values) and a point-and-hold area. For example, the processor 104 can load a point-and-hold area and correct end value from the memory 106. In some embodiments, the entire digitizer 118 can be a valid point-and-hold area. In other embodiments, the medical training and/or testing data can include an indication of where on the digitizer 118 the point-and-hold gesture will be effective. Correct end values can include, for example, an amount of time (or a range or set of times) that a user is to point-and-hold an on-screen image in order to give a correct answer. In some embodiments, the changing image can intermittently cycle while the user holds in the point-and-hold area, and correct end values can include a particular point in that cycle.

In an embodiment, loading medical training and/or testing media (discussed above with respect to block 220 of FIG. 2) can include loading one or more background images and instructions. Each background image can represent equipment, actions, responses, and/or configurations related to a medical procedure. The instructions can include text such as, for example, “How often should you reassess vital signs of an unstable patient? Tap and hold the set button to set the timer to reassess vitals.” In some embodiments, the background image can vary according to a point-and-hold time. In some embodiments, the background image can be static, and a foreground image can be varied according to the point-and-hold time.

In various embodiments, the medical training and/or testing media can include a background video or image, with or without looping. In various embodiments, the medical training and/or testing media can include hidden images. The processor 104 can cause the display 116 to output the hidden images in response to point-and-hold gestures. In various embodiments, the medical training and/or testing media can include explanations for correct and incorrect answers and/or accompanying sounds.

In an embodiment, providing a medical training and/or testing prompt (discussed above with respect to block 230 of FIG. 2) can include displaying the background image, a submit button, and/or the instruction text. For example, the processor 104 can cause the display 116 to output the background image, submit button, and the instruction text discussed above. In an embodiment, the processor 104 causes the display 116 to output a tutorial illustrating the point-and-hold interaction. In an embodiment, the processor 104 can cause the display 116 to flash an image, thereby indicating a hold region.

In an embodiment, the processor 104 can cause the user interface 122 to output audio based on a position or amount of the point-and-hold. In an embodiment, the processor 104 can cause the user interface 122 to output an indication of the point-and-hold time, for example, as a numerical text overlay, an audio announcement, etc. In some embodiments, the background image can change according to a point-and-hold time. In some embodiments, the processor 104 can cause the user interface 122 to output light, sound, and/or vibration based on the specific background image shown and/or point-and-hold time.

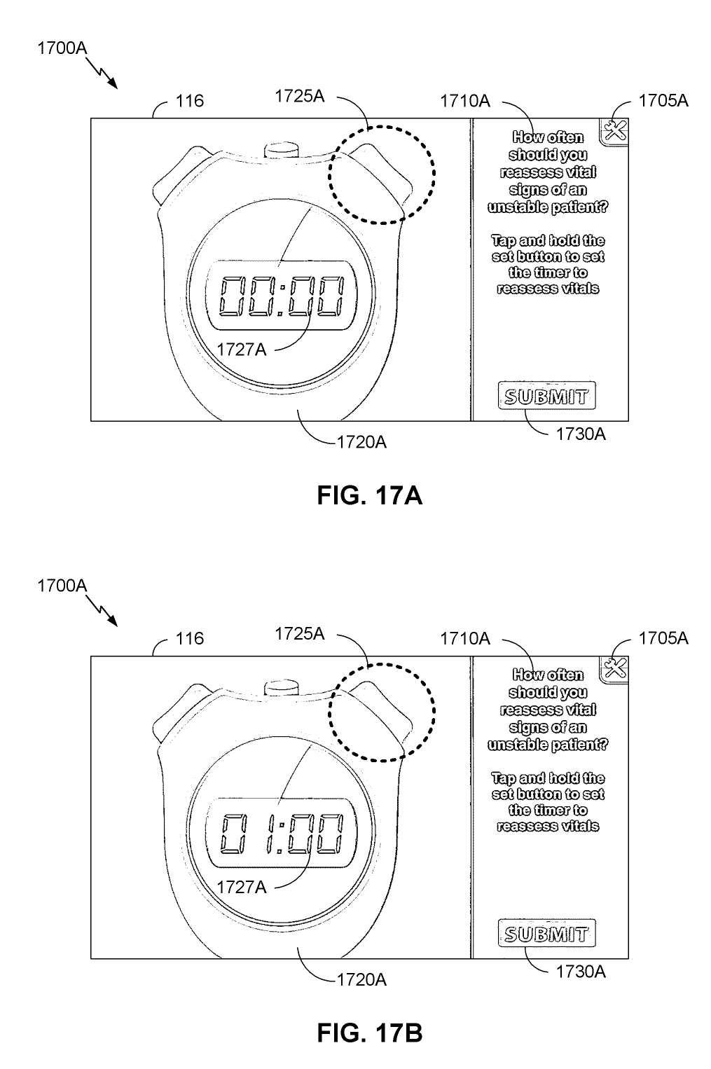

In an embodiment, receiving the medical training and/or testing interaction (discussed above with respect to block 250 of FIG. 2) can include receiving one or more user touch inputs. For example, the processor 104 can receive one or more touch inputs from the digitizer 118. The processor 104 can identify a hold area or region based on the initial touch point. The processor 104 can track an amount of time that a user has touched within the hold area. In an embodiment, the processor 104 can dismiss touch locations not corresponding to the hold area. In an embodiment, the processor 104 can associate all touch points in the point-and-hold interface 1700A (see FIG. 17A) with the point-and-hold gesture. In an embodiment, the processor 104 can receive selection of a submit button.

In an embodiment, evaluating the medical training and/or testing interaction (discussed above with respect to block 260 of FIG. 2) can include identifying user input within the hold area, or selection of a submit button, and adjustment the medical training and/or testing prompt based on the user input. In an embodiment, when a point-and-hold is detected, the processor 104 can cause the display 116 to display subsequent background images based on an amount of time input is received within the hold area. In an embodiment, when the point-and-hold is detected, the processor 104 can cause the user interface 122 output a corresponding sound. In an embodiment, the processor 104 can identify selection of the submit button.

In an embodiment, the processor 104 can compare the received gesture to a point-and-hold gesture template in the memory 106. For example, the processor 104 can determine whether the user has touched a point-and-hold region of the medical training and/or testing media. When the processor 104 detects selection of a point-and-hold region, the processor 104 can adjust the background image based on the amount of time input is received in the hold area. For example, the processor 104 can intermittently advance background images in sequence. The processor 104 can track a numerical value representing a hold time.

When the processor 104 detects selection of the submit button, the processor 104 can compare the tracked hold time or value to the correct value or range of values obtained from the medical training and/or testing data. When the point-and-hold time or value matches a correct value (or range of correct values), the processor 104 can determine a correct answer. When the point-and-hold position or value does not match the correct value (or range of correct values), the processor 104 can determine an incorrect answer.

When the processor 104 determines that an inaccurate answer has been given, the processor 104 can at least partially reset the medical training and/or testing prompt. For example, the processor 104 can cause the display 116 to reset the point-and-hold position and/or display an initial background image. When the processor 104 determines that an inaccurate answer has been given, the processor 104 can cause the display 116 to output an indication that the point-and-hold position was incorrect. The indication can be audio, visual, and/or textual. When the processor 104 determines that an inaccurate answer has been given, the processor 104 can cause the display 116 to output an explanation indicating why the selection was incorrect.

In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu. When the processor 104 determines that an accurate answer has been given, the processor 104 can cause the display 116 to output an explanation indicating why the answer was correct.

FIGS. 17A-17B illustrate an exemplary point-and-hold interface 1700A, according to a shock management training embodiment. As shown, the point-and-hold interface 1700A depicts a medical test for shock management in which the user is prompted to “Tap and hold the set button to set the timer to reassess vitals.” The point-and-hold interface 1700A can be implemented in, for example, the device 102 (FIG. 1). In various embodiments, the processor 104 (FIG. 1) can display the point-and-hold interface 1700A on the display 116 (FIG. 1). As shown, the point-and-hold interface 1700A includes a tool interface 1705A, instructions 1710A, a background image 1720A, a hold area 1725A, and a submit button 1730A. Although various portions of the point-and-hold interface 1700A are shown, a person having ordinary skill in the art will appreciate that the portions can be rearranged, portions can be omitted, and/or additional portions can be added.

The tool interface 1705A serves to provide navigation, for example to a main menu and/or to one or more other medical training and/or testing interfaces described herein. The instructions 1710A serve to instruct the user on how to interact with the point-and-hold interface 1700A. The background image 1720A provides context for the point-and-hold interface 1700A. In the illustrated embodiment, the background image 1720A depicts a timer that advances a time in 30 second intervals when the user provides input within the hold area (see FIG. 17B). The submit button 1730A serves to indicate that the user is ready for the processor 104 to evaluate the interaction.

### Spinal Cord Injury Management

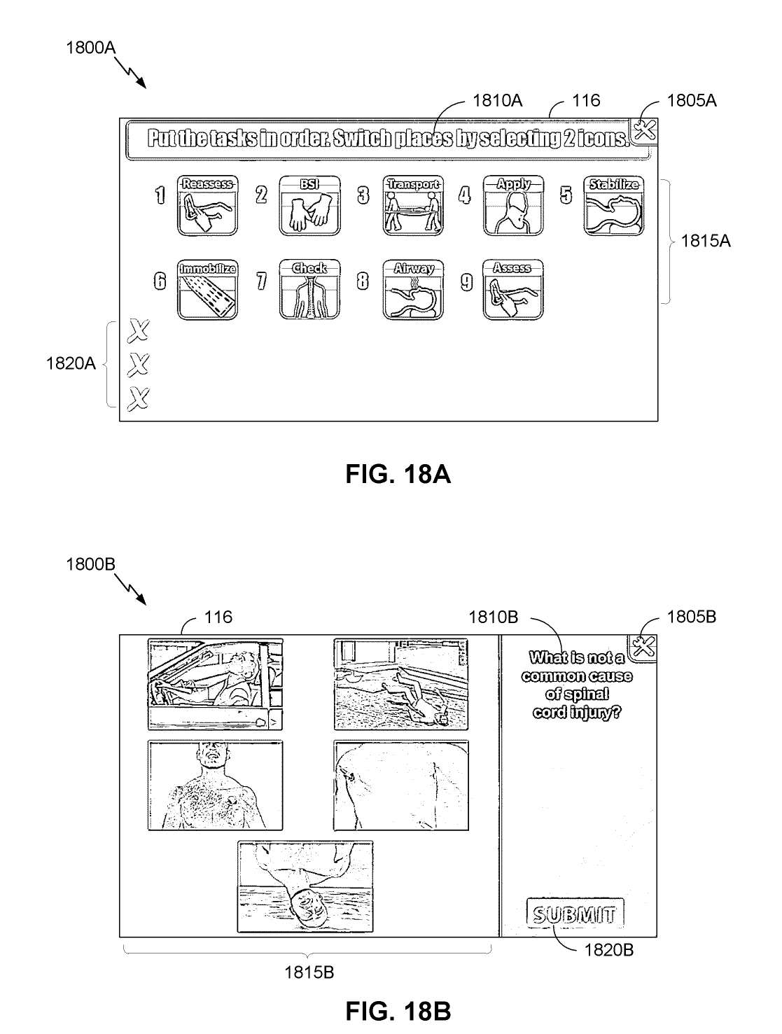

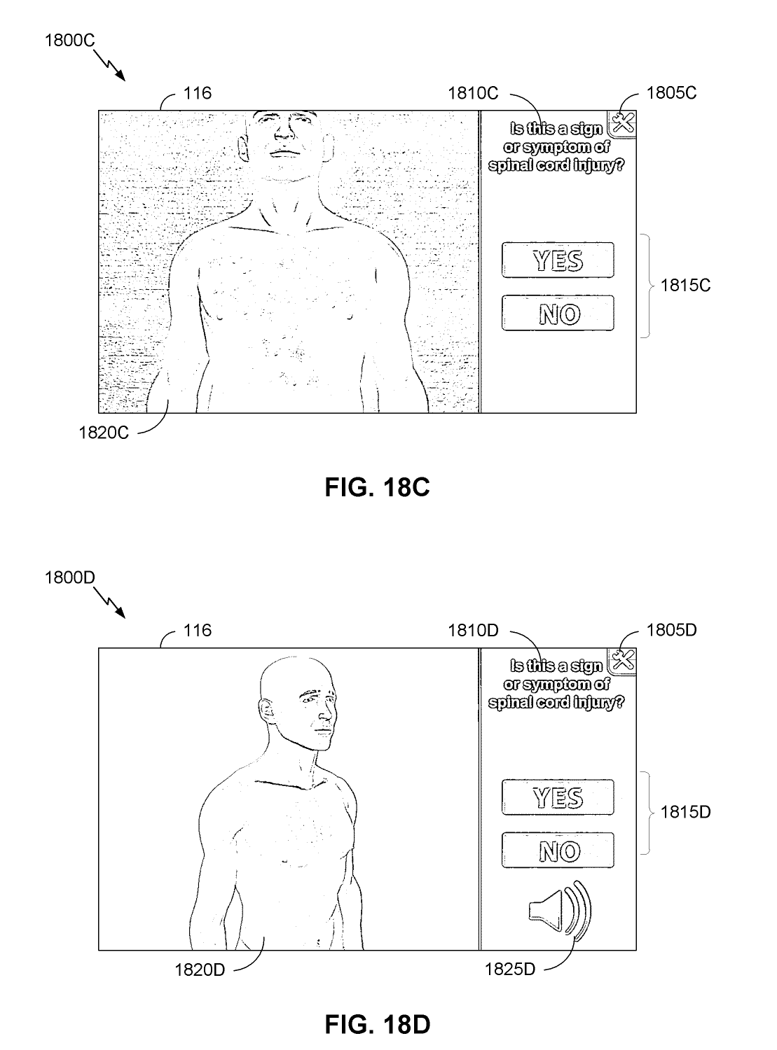

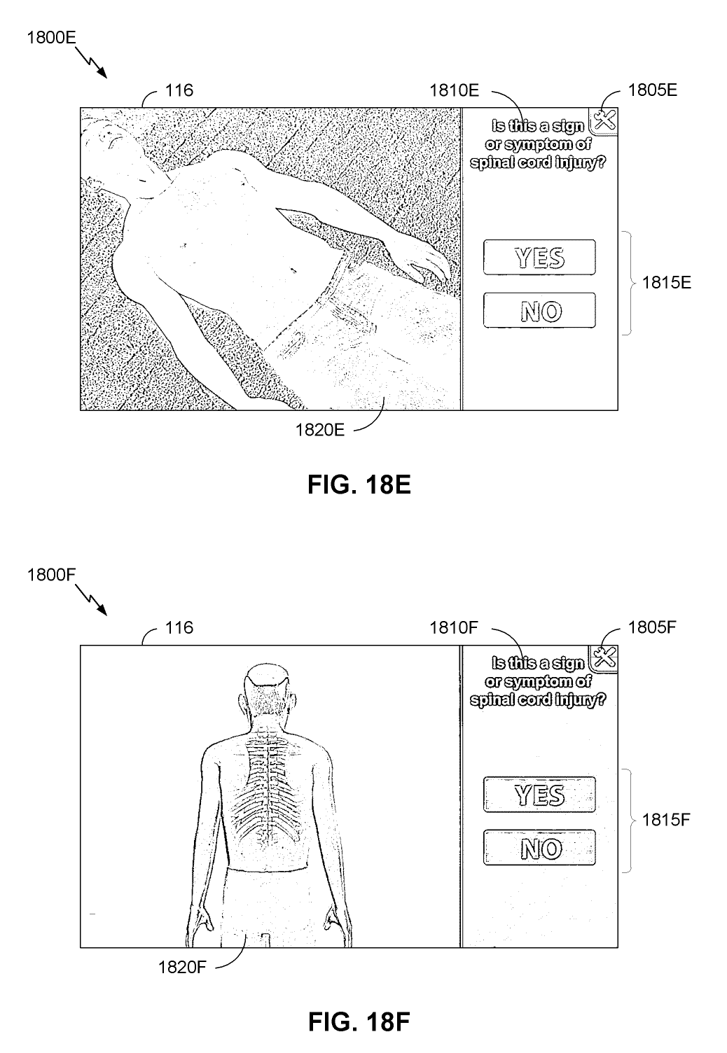

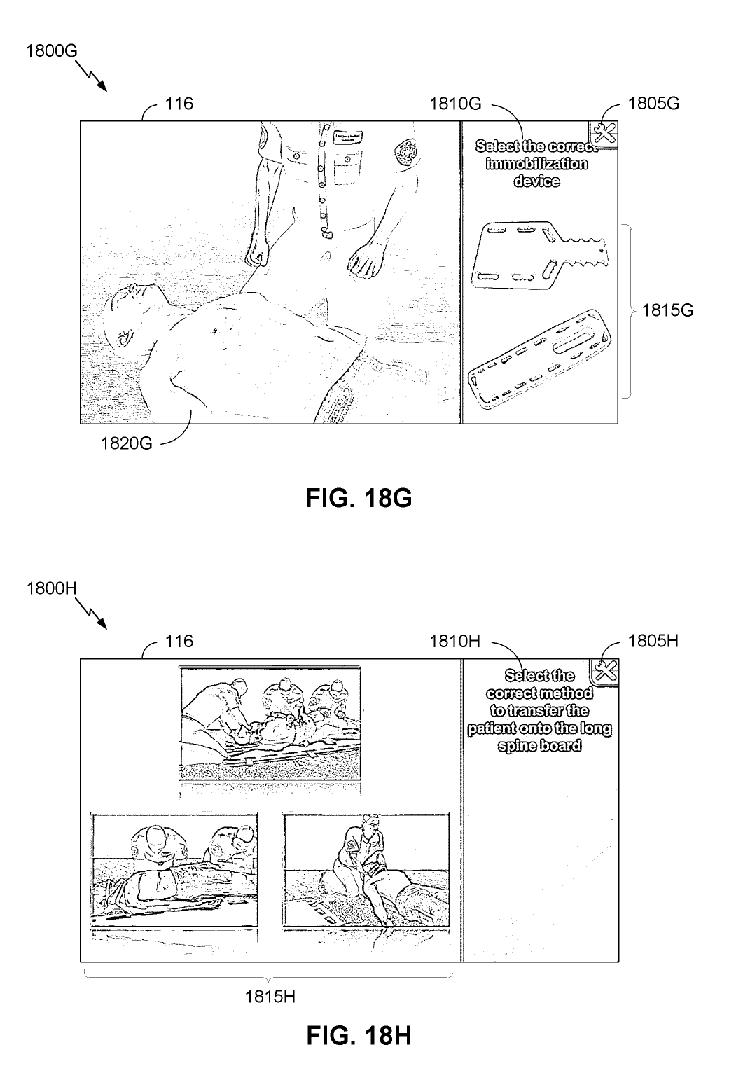

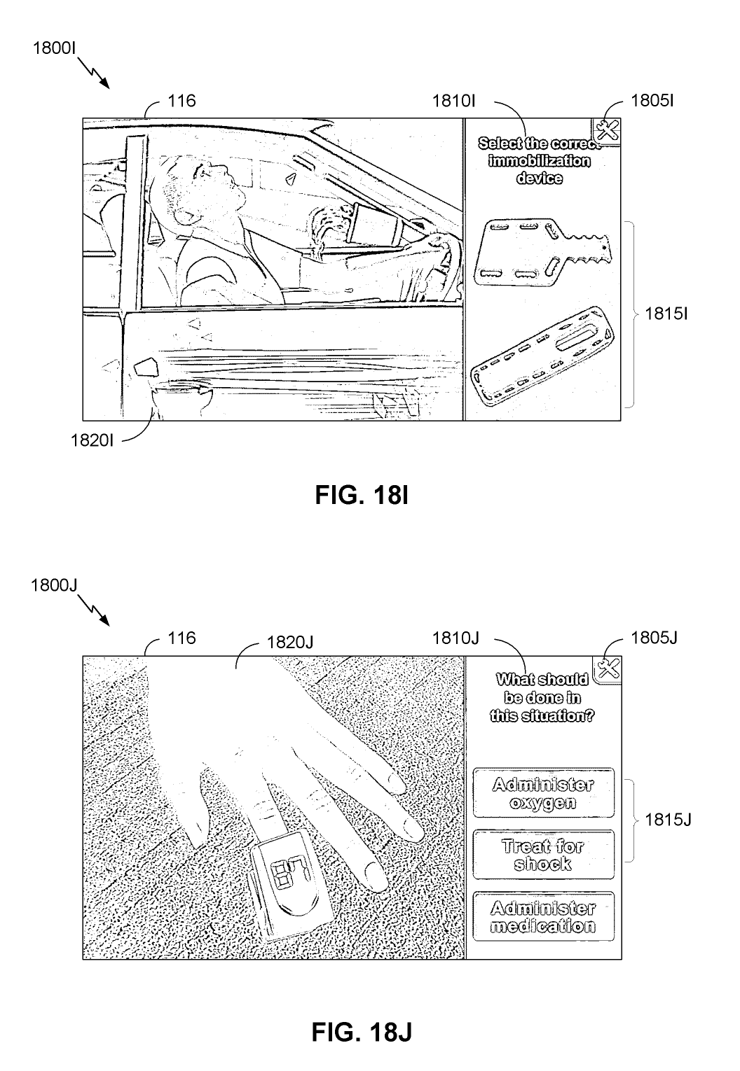

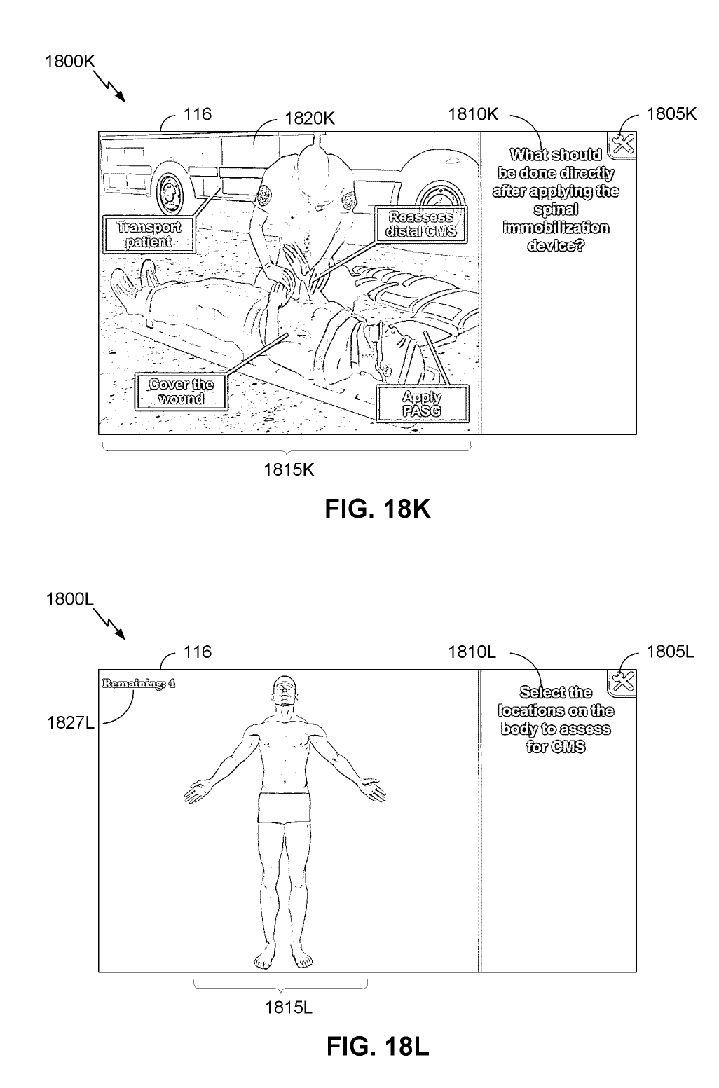

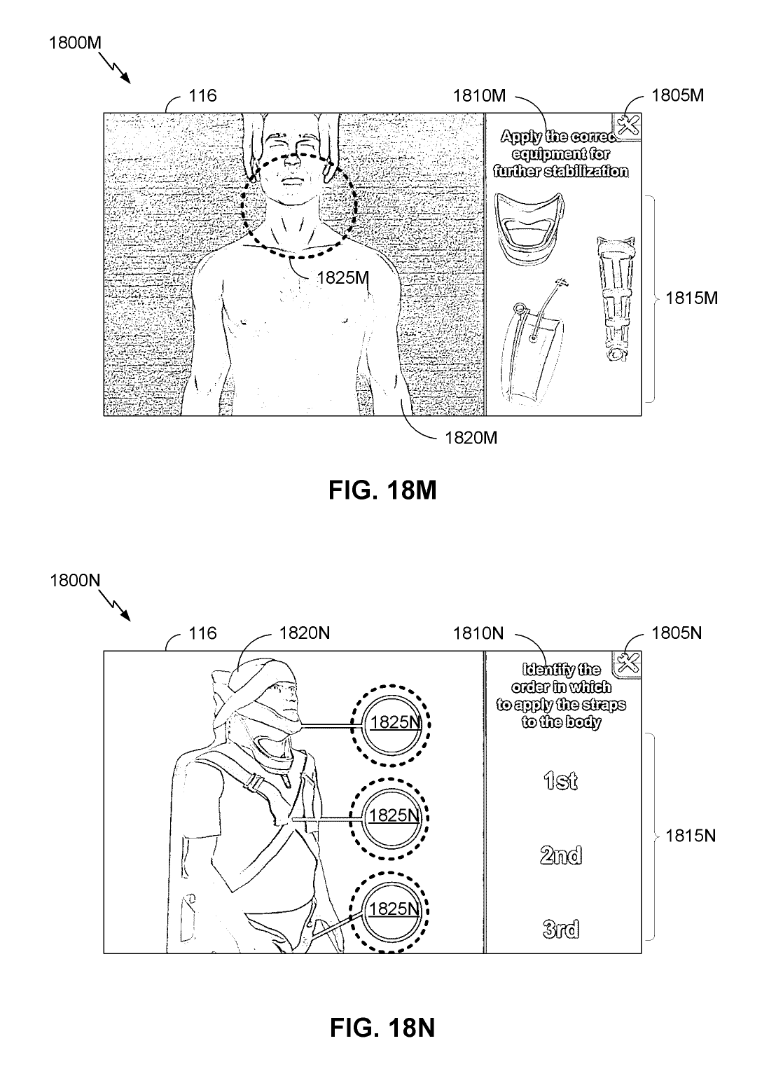

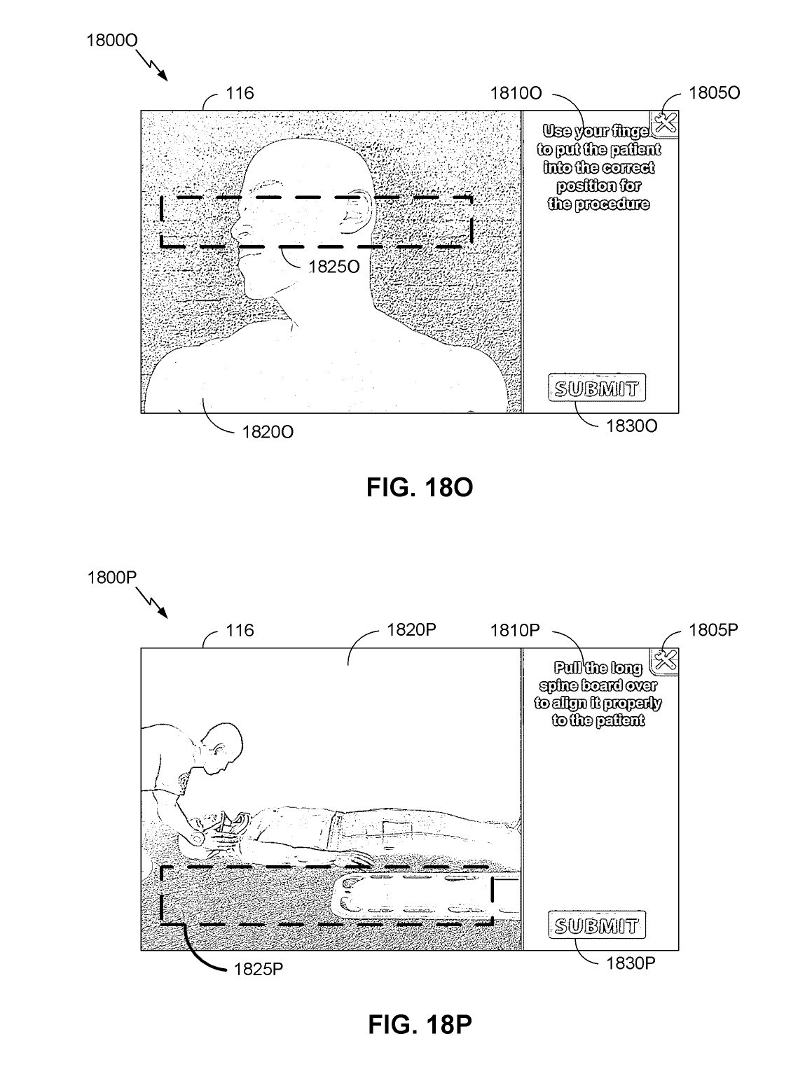

In various embodiments, the device 102 can be configured to provide medical training and/or testing for spinal cord injury management. For example, the medical training and/or testing data, medical training and/or testing media, medical training and/or testing prompt, and medical training and/or testing interactions, described above with respect to FIG. 1, can relate to training and testing for spinal cord injury management. In various embodiments, setting up the interaction for spinal cord injury management testing can include setting up one or more gestures such as image swap, multi-choice point, point, drag-and-drop, slider, and point-and-hold gestures. Although particular exemplary gestures and interfaces are described herein with respect to spinal cord injury management training and/or testing, any other compatible gesture or interface described herein (including those described with respect to other fields of medical training and/or testing) can be applied to spinal cord injury management training and/or testing. FIGS. 18A-18P illustrate exemplary interfaces for spinal cord injury management training and/or testing, according to various embodiments.

FIG. 18A illustrates an exemplary image swap interface 1800A, according to another embodiment. As shown, the image swap interface 1800A depicts a medical test for spinal cord injury management in which the user is prompted to “Put the tasks in order. Switch places by selecting 2 icons.” The image swap interface 1800A can be implemented in, for example, the device 102 (FIG. 1). In various embodiments, the processor 104 (FIG. 1) can display the image swap interface 1800A on the display 116 (FIG. 1). As shown, the image swap interface 1800A includes a tool interface 1805A, instructions 1810A, a plurality of medical task icons 1815A (9 shown), and incorrect answer icons 1820A. Although various portions of the image swap interface 1800A are shown, a person having ordinary skill in the art will appreciate that the portions can be rearranged, portions can be omitted, and/or additional portions can be added.

In some embodiments, the image swap interface 1800A can operate in a substantially similar manner as the image swap interface 600A, described above with respect to FIG. 6A. For example, the tool interface 1805A, instructions 1810A, plurality of medical task icons 1815A, and incorrect answer icons 1820A can operate in a substantially similar manner as the tool interface 605A, instructions 610A, plurality of medical task icons 615A, and incorrect answer icons 620A of FIG. 6A. In some embodiments, the image swap interface 1800A can be a parameterized version of a template image swap interface, customized for spinal cord injury management training and/or testing. Icons 1815A particularly suitable for testing and training on a sequence of steps for spinal cord injury management are shown in FIG. 18A

FIG. 18B illustrates an exemplary multi-choice point interface 1800B, according to an embodiment. As shown, the multi-choice point interface 1800B depicts medical tests for spinal cord injury management training. The multi-choice point interface 1800B can be implemented in, for example, the device 102 (FIG. 1). In various embodiments, the processor 104 (FIG. 1) can display the multi-choice point interface 1800B on the display 116 (FIG. 1). As shown, the multi-choice point interface 1800B includes the tool interface 1805B, instructions 1810B, a plurality of selectable media 1815B, and a submit button 1820B. Although various portions of the multi-choice point interface 1800B are shown, a person having ordinary skill in the art will appreciate that the portions can be rearranged, portions can be omitted, and/or additional portions can be added.

In some embodiments, the multi-choice point interface 1800B can operate in a substantially similar manner as the multi-choice point interface 700A, described above with respect to FIG. 7A. For example, the tool interface 1805B, instructions 1810B, the plurality of selectable media 1815B, and the submit button 1820B can operate in a substantially similar manner as the tool interface 705A, instructions 710A, plurality of selectable media 715A, and submit button 720A of FIG. 7A. In some embodiments, the multi-choice point interface 1800B can be a parameterized version of a template multi-choice point interface, customized for spinal cord injury management training and/or testing, as can be seen in the particularized instructions 1810B and selectable media 1815B of FIG. 18B.

In the illustrated embodiment, selectable media 1815B depict whiplash, falling on one's back, burn, impalement, and falling on one's head.

FIGS. 18C-18K illustrate exemplary single-choice point interfaces 1800C-1800K, according to various embodiments. As shown, the single-choice point interfaces 1800C-1800K depict medical tests for spinal cord injury management training. The single-choice point interfaces 1800C-1800K can be implemented in, for example, the device 102 (FIG. 1). In various embodiments, the processor 104 (FIG. 1) can display the single-choice point interfaces 1800C-1800K on the display 116 (FIG. 1). As shown, the single-choice point interfaces 1800C-1800K include tool interfaces 1805C-1805K, instructions 1810C-1810K, and pluralities of selectable media 1815C-1815K. Although various portions of the single-choice point interfaces 1800C-1800K are shown, a person having ordinary skill in the art will appreciate that the portions can be rearranged, portions can be omitted, and/or additional portions can be added. In some cases, the selectable media 1815C-1815Fm 1515J-1815K are textual answer choices for questions posed in the instructions 1810C-1810F, 1810J-1810K, given the background media 1820C-1820F, 1820J-1820K. In other cases, the selectable media 1815G-1815I include image components.

In some embodiments, the single-choice point interfaces 1800C-1800K can operate in a substantially similar manner as the single-choice point interface 800A, described above with respect to FIG. 8A. For example, tool interfaces 1805C-1805K, instructions 1810C-1810K, and pluralities of selectable media 1815C-1815K can operate in a substantially similar manner as the tool interface 805A, instructions 810A, and plurality of selectable media 815A of FIG. 8A. In some embodiments, the single-choice point interfaces 1800C-1800K can be parameterized versions of a template single-choice point interface, customized for spinal cord injury management training and/or testing, as can be seen in the particularized instructions 1810C-1810K and selectable media 1815C-1815K.

In some embodiments, single-choice point interfaces can include background media, which can include static or moving images (with or without looping). For example, the single-choice point interfaces 1800C-1800G and 1800I-1800K shown in FIGS. 18C-18G and 18I-18K include background media 1820C-1820G and 1820I-1820K, respectively. Moreover, in some embodiments, single-choice point interfaces can include background audio, which can include medical noises (for example, a heart rate, chest sounds, coughing, etc.) or speech (for example, conveying diagnostic information such as a pain complaint, slurred speech, etc.). For example, the single-choice point interfaces 1800D shown in FIG. 18D include a background audio indicated by audio icon 1825D. In various embodiments, background audio can play automatically, or in response to an activation input (such as a touch on the audio icon 1825D), and can loop.

The background media 1820C can indicate a condition of a patient, for example using color (such as red to indicate a flushed condition). In the illustrated embodiment, the background media 1820D, alone or in combination with audio, can indicate a condition of a patient, for example using animated motion (such as chest motion to show fast, slow, or normal breathing) and/or sounds (such as airway sounds). The background media 1820E can indicate a condition of a patient, for example using color (such as gray to indicate a paralyzed condition). The background media 1820F can indicate a condition of a patient, for example using color (such as radiating red lines to indicate a painful condition).

In the illustrated embodiment, the background media 1820G can indicate an adult male patient lying on his back. In the illustrated embodiment, the selectable media 1815H include animated depictions of transferring a patient onto a long spine board by rolling him on his side, lifting him from below, and pulling him by his upper body. In the illustrated embodiment, the background media 1820I includes a short video indicating a patient encountering whiplash in a car. In the illustrated embodiment, the background media 1820J indicates a pulse oximeter reading of 87%. In the illustrated embodiment, the background media 1820K indicates a patient in a spinal immobilization device.

### Countdown Point

FIG. 18L illustrates an exemplary countdown point interface 1800L, according to a spinal cord injury management training embodiment. As shown, the countdown point interface 1800L depicts a medical test for spinal cord injury management in which the user is prompted to “Select the locations on the body to assess for CMS.” The countdown point interface 1800L can be implemented in, for example, the device 102 (FIG. 1). In various embodiments, the processor 104 (FIG. 1) can display the countdown point interface 1800L on the display 116 (FIG. 1). As shown, the countdown point interface 1800L includes a tool interface 1805L, instructions 1810L, a plurality of selectable media 1815L, and a countdown 1827L. Although various portions of the countdown point interface 1800L are shown, a person having ordinary skill in the art will appreciate that the portions can be rearranged, portions can be omitted, and/or additional portions can be added.

The tool interface 1805L serves to provide navigation, for example to a main menu and/or to one or more other medical training and/or testing interfaces described herein. The instructions 1810L serve to instruct the user on how to interact with the countdown point interface 1800L. The one or more selectable media 1815L represent individual body locations for potential circulation, motion, and sensation (CMS) assessment. The countdown 1827L serves to indicate a number of remaining selections. In the illustrated embodiment, there are four locations that the user is to select in order to answer correctly. In some embodiments, the countdown point interface 1800L is similar to a multi-point interface described herein, with no submit button and with an additional countdown indication.

When a user makes a correct selection, the processor 104 decrements the countdown 1827L. In some embodiments, the processor 104 can highlight the correctly selected image 1815L, for example in a particular color such as green. When the user makes an incorrect selection, the processor 104 can increment a tally of incorrect answers. In some embodiments, the processor 104 can highlight the incorrectly selected image 1815L, for example in red. In some embodiments, the processor 104 can display an indication that the selection was incorrect. In some embodiments, the indication can include images, text, audio, vibration, etc. In some embodiments, when the tally of incorrect answers surpasses a threshold, the processor 104 can determine that the user has failed. In some embodiments, when the countdown 1827L reaches zero, the processor 104 can determine that the user has passed.

FIGS. 18M-18N illustrate exemplary drag-and-drop interfaces 1800M-1800N, according to various embodiments. As shown, the drag-and-drop interfaces 1800M-1800N depict medical tests for spinal cord injury management training. The drag-and-drop interfaces 1800M-1800N can be implemented in, for example, the device 102 (FIG. 1). In various embodiments, the processor 104 (FIG. 1) can display the drag-and-drop interfaces 1800M-1800N on the display 116 (FIG. 1). As shown, the drag-and-drop interfaces 1800M-1800N include tool interfaces 1805M-1805N, instructions 1810M-1810N, a plurality of movable media 1815M-1815N, a background image 1820M-1820N, and one or more correct answer regions 1825M-1825N. Although various portions of the drag-and-drop interfaces 1800M-1800N are shown, a person having ordinary skill in the art will appreciate that the portions can be rearranged, portions can be omitted, and/or additional portions can be added.

In some embodiments, the drag-and-drop interfaces 1800M-1800N can operate in a substantially similar manner as the drag-and-drop interface 900A, described above with respect to FIG. 9A. For example, the tool interfaces 1805M-1805N, instructions 1810M-1810N, plurality of movable media 1815M-1815N, background image 1820M-1820N, and one or more correct answer regions 1825M-1825N can operate in a substantially similar manner as the tool interface 905A, instructions 910A, plurality of movable media 915A, background image 920A, and one or more correct answer regions 925A of FIG. 9A. In some embodiments, the drag-and-drop interfaces 1800M-1800N can be a parameterized version of a template drag-and-drop interface, customized for spinal cord injury management training and/or testing, as can be seen in the particulars of FIGS. 18M-18N.

In the illustrated embodiment of FIG. 18M, the background media 1820M indicates a patient with his head positioned for stabilization and the movable media 1815M represent various possible equipment for stabilizing the head. In the illustrated embodiment of FIG. 18N, the background media 1820N indicates a patient positioned to receive long spine board straps and the movable media 1815N represent a sequence for those straps.

FIGS. 18O-12P illustrate exemplary slider interfaces 1800O-1800P, according to various embodiments. As shown, the slider interfaces 1800O-1800P depict medical tests for spinal cord injury management training. The slider interfaces 1800O-1800P can be implemented in, for example, the device 102 (FIG. 1). In various embodiments, the processor 104 (FIG. 1) can display the slider interfaces 1800O-1800P on the display 116 (FIG. 1). As shown, the slider interfaces 1800O-1800P include tool interfaces 1805O-1805P, instructions 1810O-1810P, background images 1820O-1820P, slider areas 1825O-1825P, and submit buttons 1830O-1830P. Although various portions of the slider interfaces 1800O-1800P are shown, a person having ordinary skill in the art will appreciate that the portions can be rearranged, portions can be omitted, and/or additional portions can be added.

In some embodiments, the slider interfaces 1800O-1800P can operate in a substantially similar manner as the slider interface 1100A, described above with respect to FIG. 11A. For example, the tool interfaces 1805O-1805P, instructions 1810O-1810P, background images 1820O-1820P, a slider area 1825O-1825P, and submit buttons 1830O-1830P can operate in a substantially similar manner as the tool interface 1105A, instructions 1110A, background image 1120A, slider area 1125A, and submit button 1130A of FIG. 11A. In some embodiments, the slider indicators 1827O-1827P can be portions (in FIG. 18O the position of the head) of the background images 1820A, which can change as the slider is adjusted. In some embodiments, the slider interfaces 1800O-1800P can be a parameterized version of a template slider interfaces, customized for CPR training and/or testing, as can be seen in the particulars of FIGS. 18O-12P.

In the illustrated embodiment of FIG. 18O, the background media 1820O includes an image of a head that tilts from side to size as the user engages the slider area 1825O. In the illustrated embodiment of FIG. 18P, the background media 1820P includes an image of a long spine board that slides left and right as the user engages the slider area 1825P.

### Fracture Management

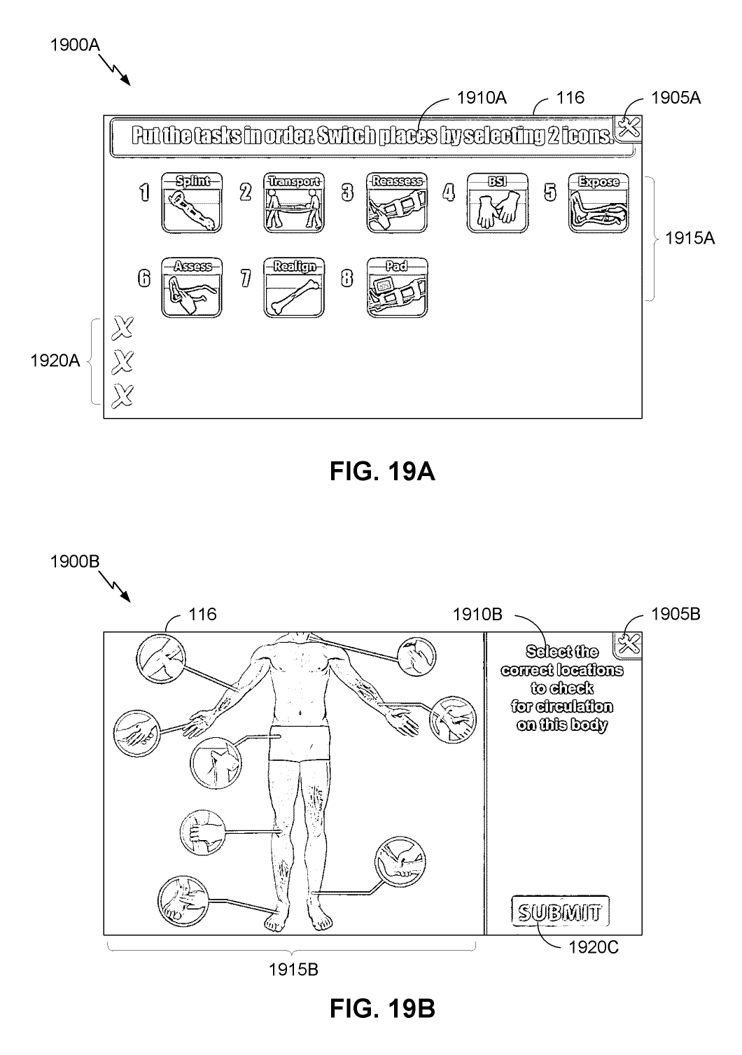

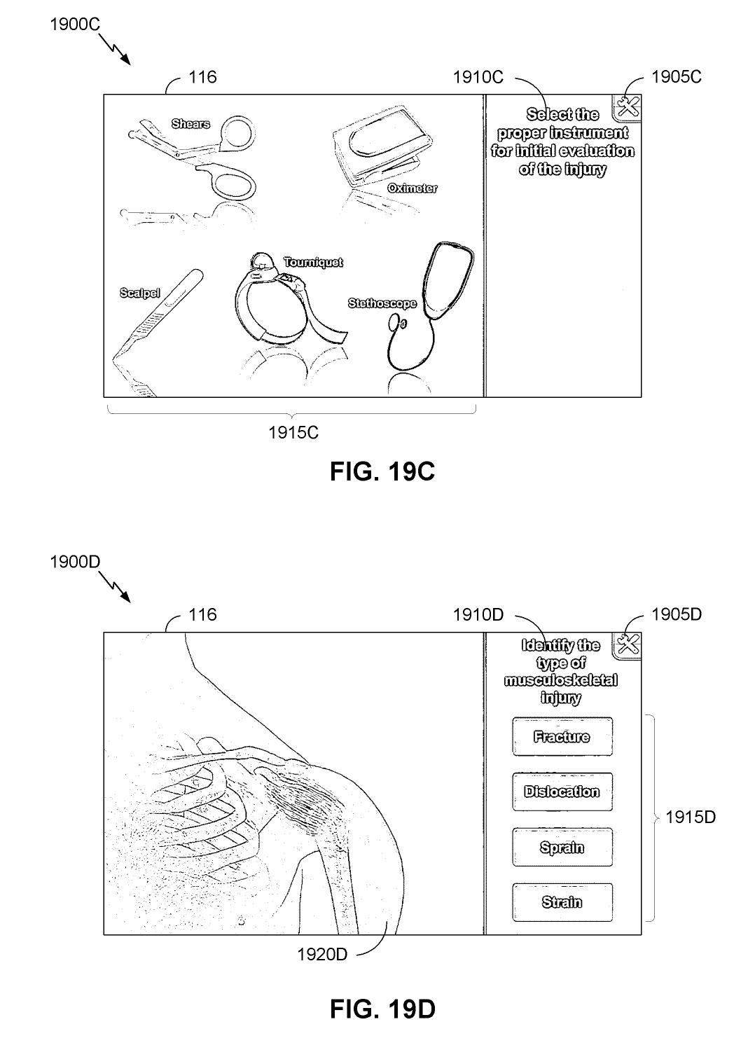

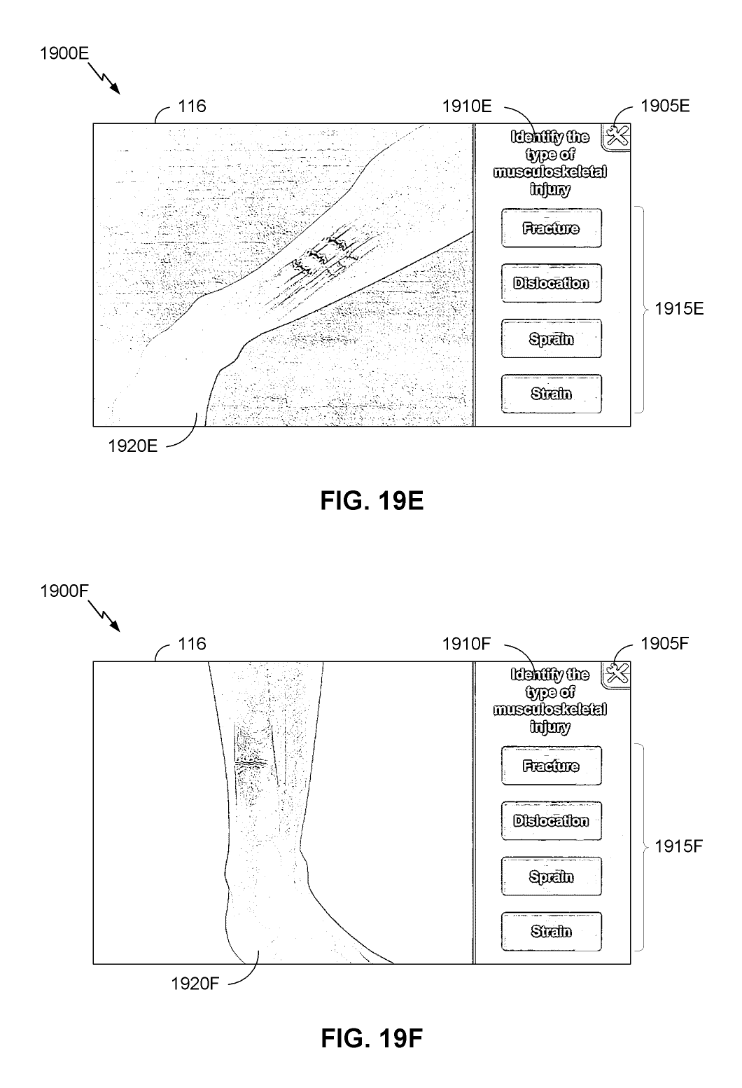

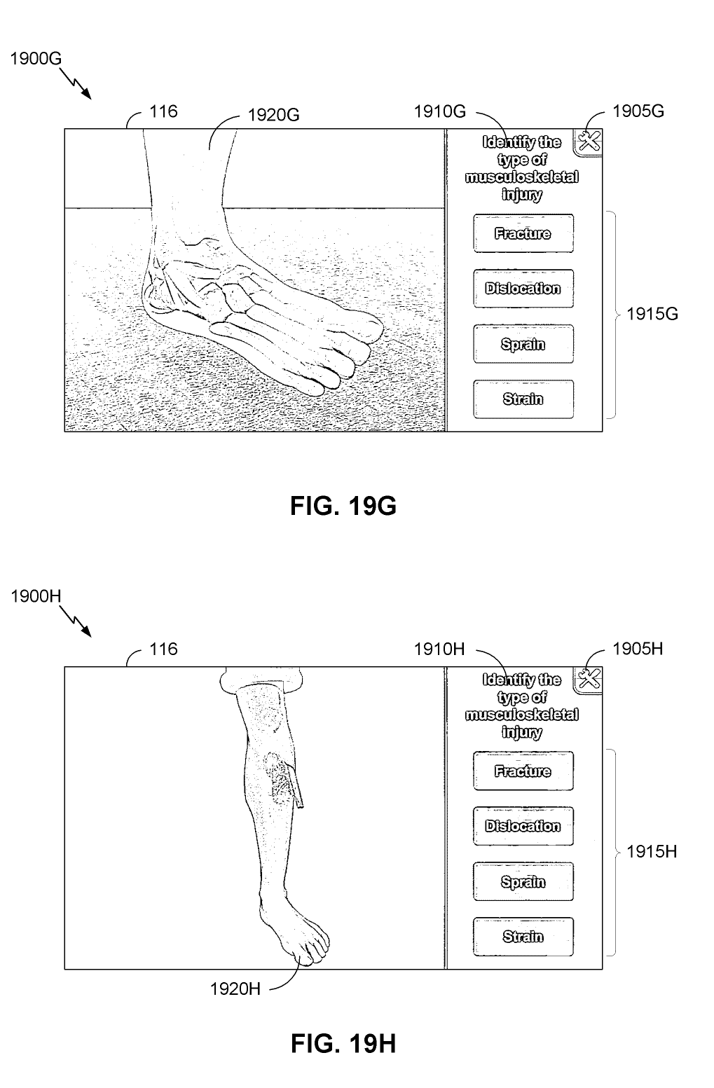

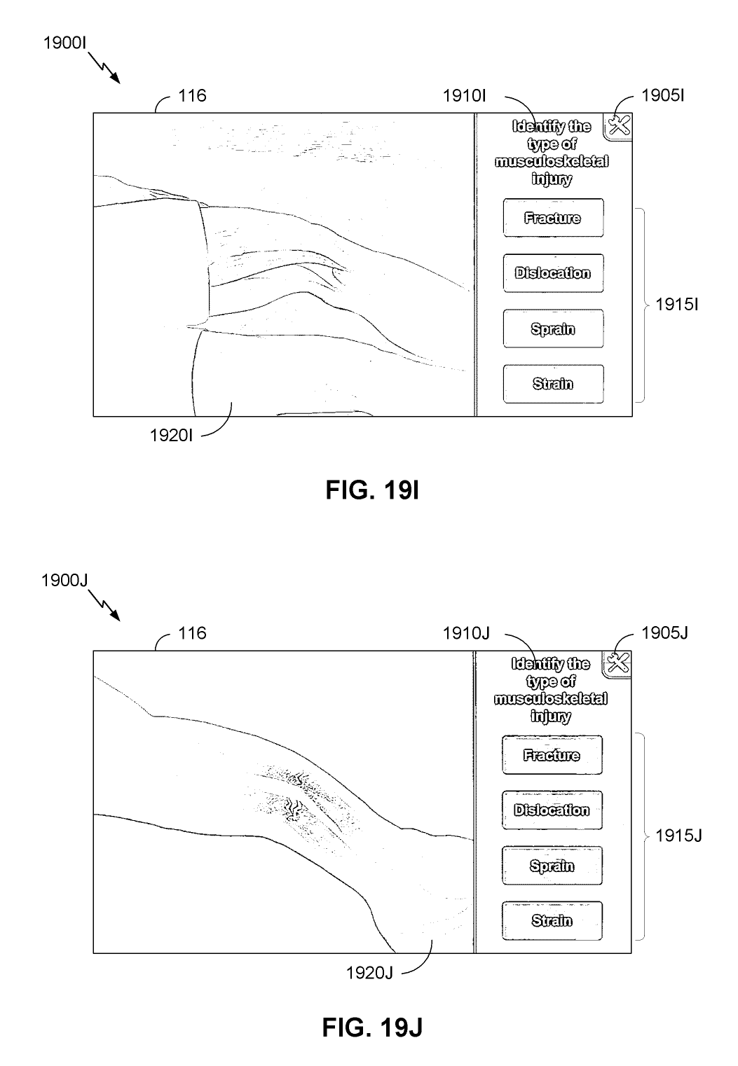

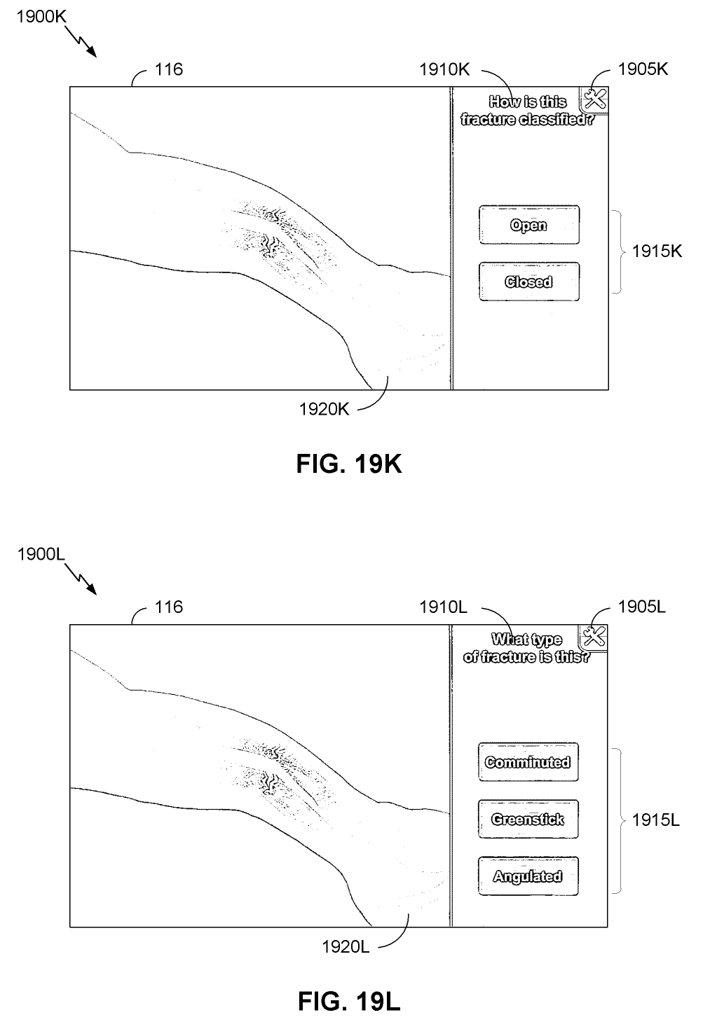

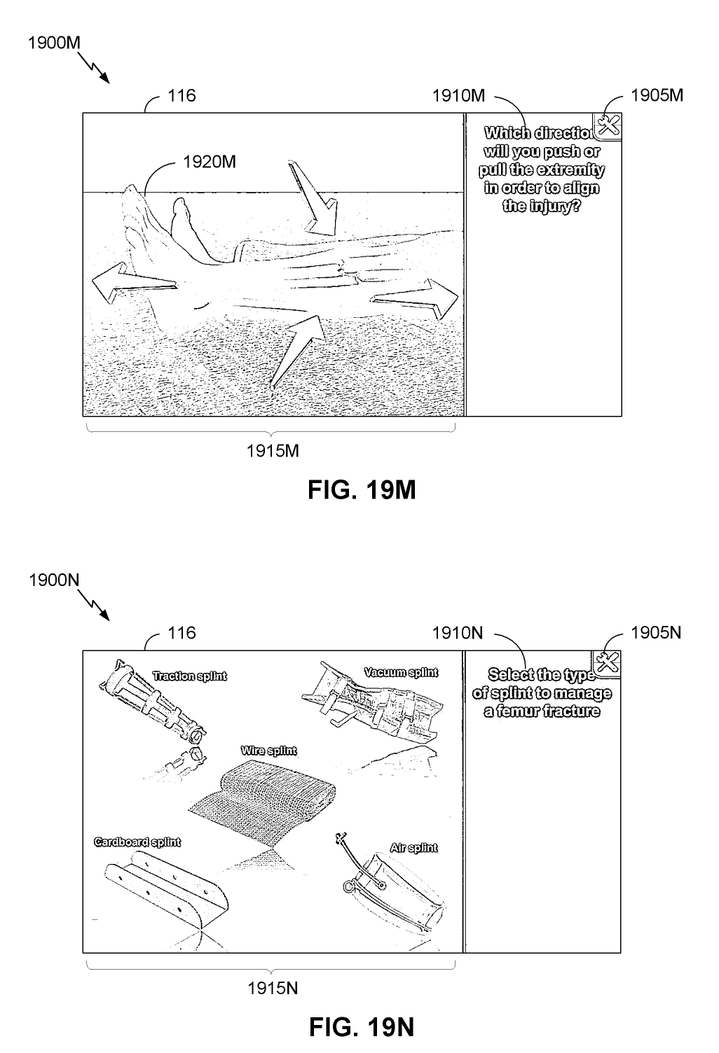

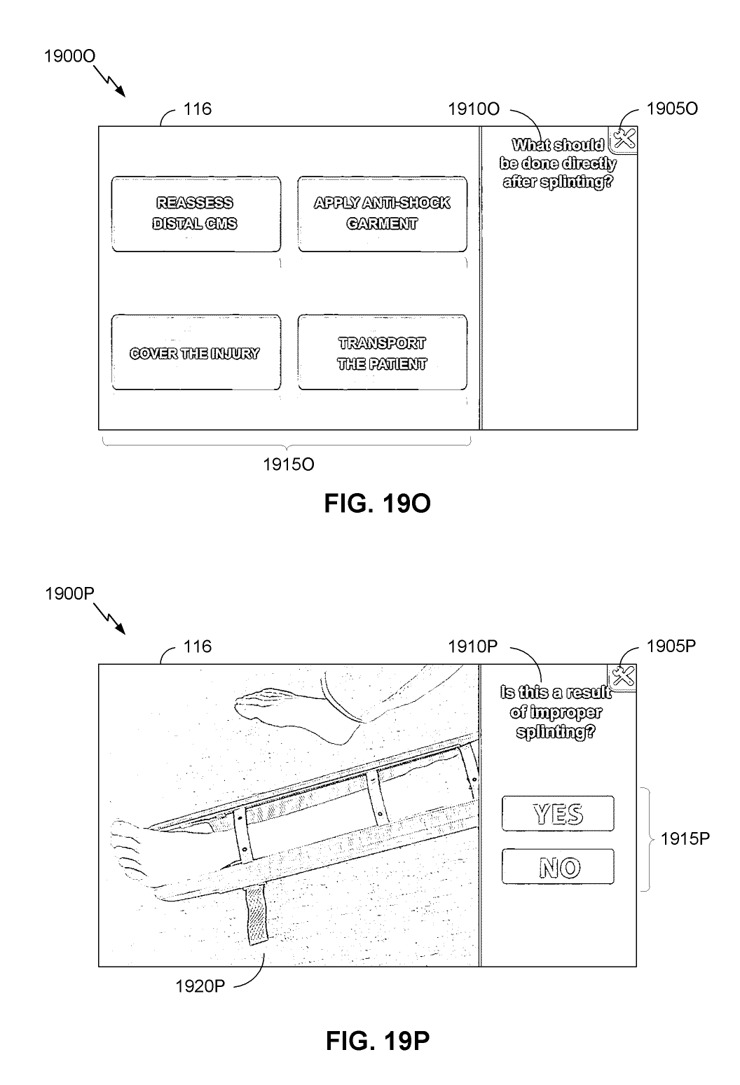

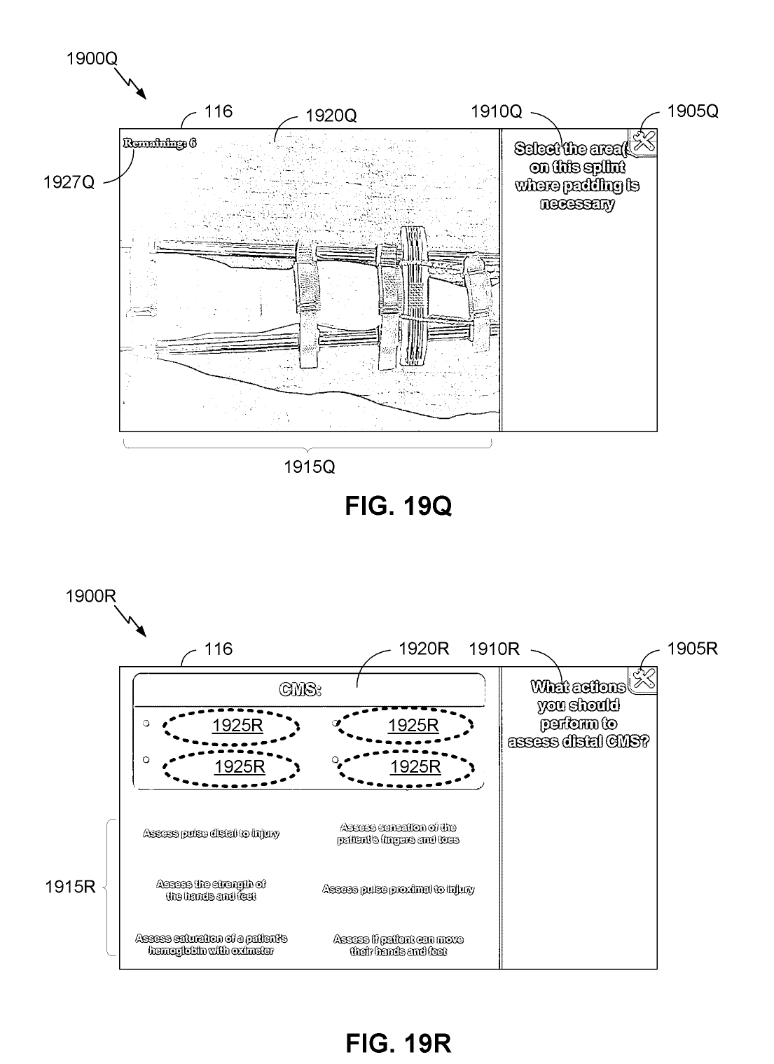

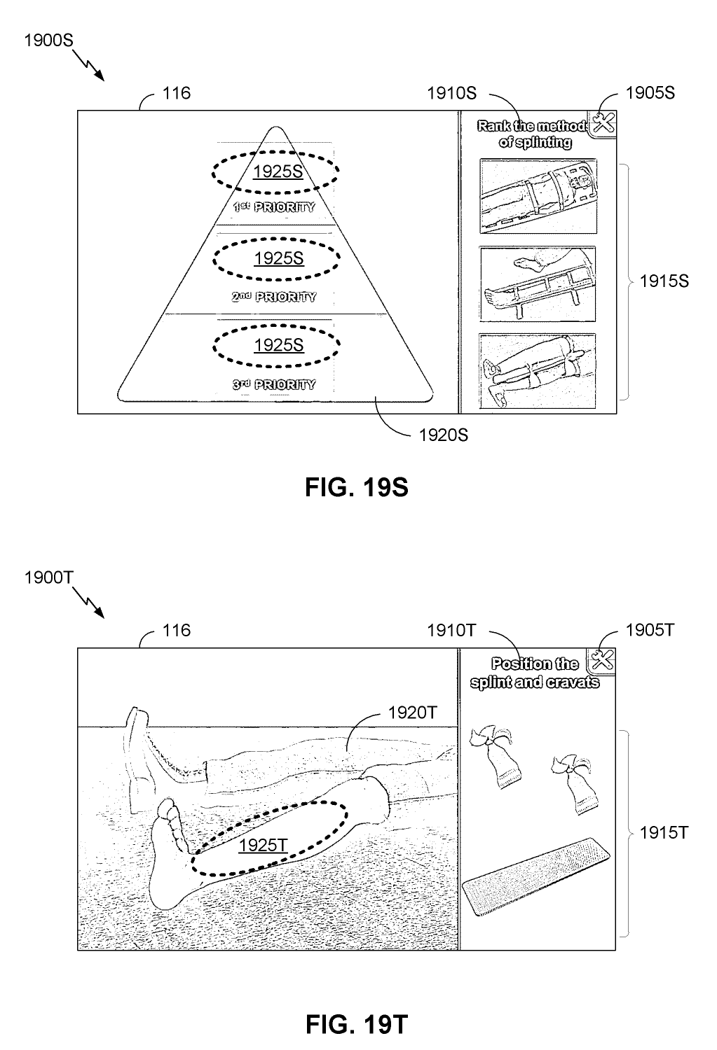

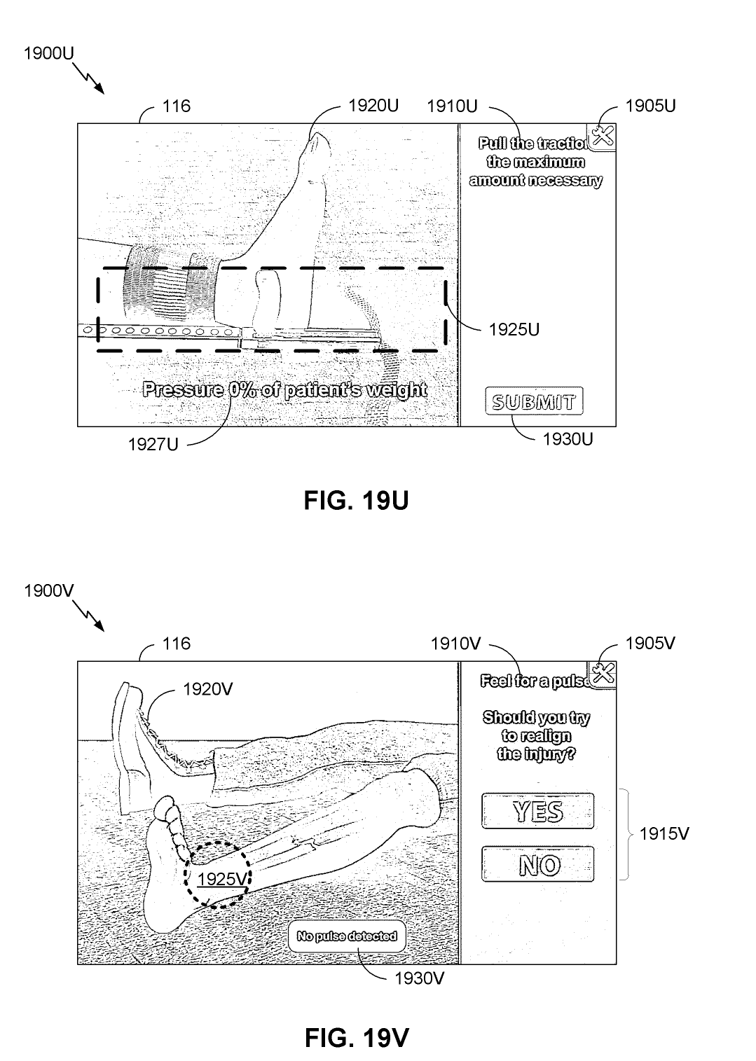

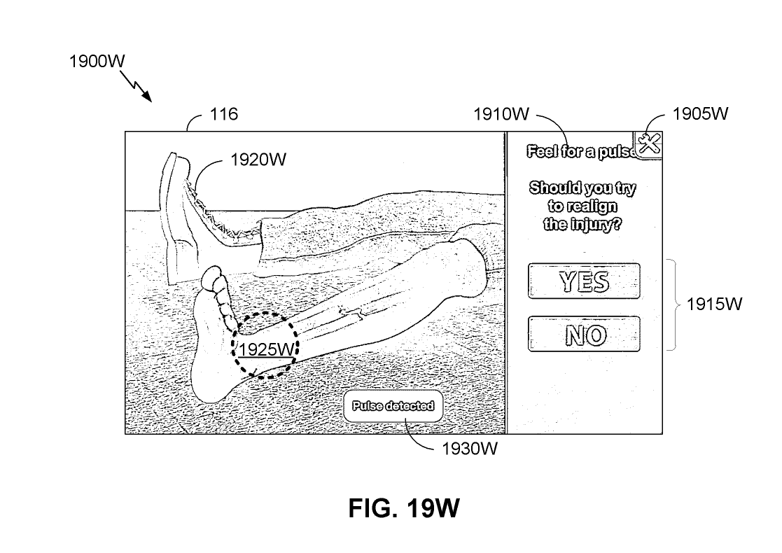

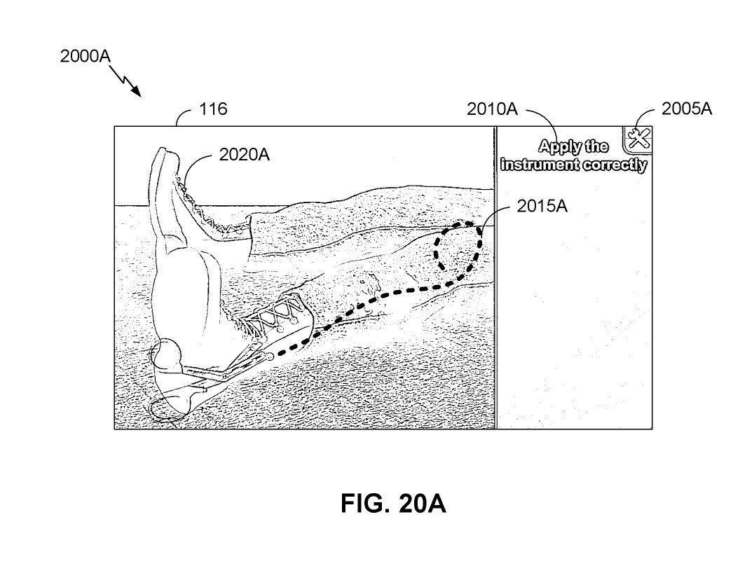

In various embodiments, the device 102 can be configured to provide medical training and/or testing for fracture management. For example, the medical training and/or testing data, medical training and/or testing media, medical training and/or testing prompt, and medical training and/or testing interactions, described above with respect to FIG. 1, can relate to training and testing for fracture management. In various embodiments, setting up the interaction for fracture management testing can include setting up one or more gestures such as image swap, multi-choice point, point, drag-and-drop, slider, point-and-vibrate, and point-and-hold gestures. Although particular exemplary gestures and interfaces are described herein with respect to fracture management training and/or testing, any other compatible gesture or interface described herein (including those described with respect to other fields of medical training and/or testing) can be applied to fracture management training and/or testing. FIGS. 19A-20A illustrate exemplary interfaces for fracture management training and/or testing, according to various embodiments.

FIG. 19A illustrates an exemplary image swap interface 1900A, according to another embodiment. As shown, the image swap interface 1900A depicts a medical test for fracture management in which the user is prompted to “Put the tasks in order. Switch places by selecting 2 icons.” The image swap interface 1900A can be implemented in, for example, the device 102 (FIG. 1). In various embodiments, the processor 104 (FIG. 1) can display the image swap interface 1900A on the display 116 (FIG. 1). As shown, the image swap interface 1900A includes a tool interface 1905A, instructions 1910A, a plurality of medical task icons 1915A (8 shown), and incorrect answer icons 1920A. Although various portions of the image swap interface 1900A are shown, a person having ordinary skill in the art will appreciate that the portions can be rearranged, portions can be omitted, and/or additional portions can be added.

In some embodiments, the image swap interface 1900A can operate in a substantially similar manner as the image swap interface 600A, described above with respect to FIG. 6A. For example, the tool interface 1905A, instructions 1910A, plurality of medical task icons 1915A, and incorrect answer icons 1920A can operate in a substantially similar manner as the tool interface 605A, instructions 610A, plurality of medical task icons 615A, and incorrect answer icons 620A of FIG. 6A. In some embodiments, the image swap interface 1900A can be a parameterized version of a template image swap interface, customized for fracture management training and/or testing. Icons 1915A particularly suitable for fracture management testing and training are shown in FIG. 19A

FIGS. 19B-12C illustrate exemplary multi-choice point interfaces 1900B-1900C, according to various embodiments. As shown, the multi-choice point interfaces 1900B-1900C depict medical tests for fracture management training The multi-choice point interfaces 1900B-1900C can be implemented in, for example, the device 102 (FIG. 1). In various embodiments, the processor 104 (FIG. 1) can display the multi-choice point interfaces 1900B-1900C on the display 116 (FIG. 1). As shown, the multi-choice point interfaces 1900B-1900C include tool interfaces 1905B-1905C, instructions 1910B-1910C, pluralities of selectable media 1915B-1915C, and submit button 1920B. Although various portions of the multi-choice point interfaces 1900B-1900C are shown, a person having ordinary skill in the art will appreciate that the portions can be rearranged, portions can be omitted, and/or additional portions can be added.

In some embodiments, the multi-choice point interfaces 1900B-1900C can operate in a substantially similar manner as the multi-choice point interface 700A, described above with respect to FIG. 7A. For example, tool interfaces 1905B-1905C, instructions 1910B-1910C, pluralities of selectable media 1915B-1915C, and submit button 1920B can operate in a substantially similar manner as the tool interface 705A, instructions 710A, plurality of selectable media 715A, and submit button 720A of FIG. 7A. In some embodiments, the multi-choice point interfaces 1900B-1900C can be parameterized versions of a template multi-choice point interface, customized for fracture management training and/or testing, as can be seen in the particularized instructions 1910B-1910C and selectable media 1915B-1915C.

FIGS. 19D-19P illustrate exemplary single-choice point interfaces 1900D-1900P, according to various embodiments. As shown, the single-choice point interfaces 1900D-1900P depict medical tests for fracture management training. The single-choice point interfaces 1900D-1900P can be implemented in, for example, the device 102 (FIG. 1). In various embodiments, the processor 104 (FIG. 1) can display the single-choice point interfaces 1900D-1900P on the display 116 (FIG. 1). As shown, the single-choice point interfaces 1900D-1900P include tool interfaces 1905D-1905P, instructions 1910D-1910P, and pluralities of selectable media 1915D-1915P. Although various portions of the single-choice point interfaces 1900D-1900P are shown, a person having ordinary skill in the art will appreciate that the portions can be rearranged, portions can be omitted, and/or additional portions can be added.

In some embodiments, the single-choice point interfaces 1900D-1900P can operate in a substantially similar manner as the single-choice point interface 800A, described above with respect to FIG. 8A. For example, tool interfaces 1905D-1905P, instructions 1910D-1910P, and pluralities of selectable media 1915D-1915P can operate in a substantially similar manner as the tool interface 805A, instructions 810A, and plurality of selectable media 815A of FIG. 8A. In some embodiments, the single-choice point interfaces 1900D-1900P can be parameterized versions of a template single-choice point interface, customized for fracture management training and/or testing, as can be seen in the particularized instructions 1910D-1910P and selectable media 1915D-1915P. In some cases, the selectable media 1915D-1915L, 1915O-1915P represent textual answer choices to the questions posed in the instructions 1910D-1910L, 1910O-1910P, given the background media. In other cases, the selectable media 1915M-1915N include images components.

In some embodiments, single-choice point interfaces can include background media, which can include static or moving images (with or without looping). For example, the single-choice point interfaces 1900D-1900M and 1900P shown in FIGS. 19D-19M and 19P include background media 1920D-1920M and 1920P, respectively.

In the illustrated embodiments of FIGS. 19D-19J, the background media 1920D-1920J can indicate one of a fracture, dislocation, sprain, and strain. In the illustrated embodiment of FIG. 19K, the background media 1920K can indicate an open and/or closed fracture. In the illustrated embodiment of FIG. 19L, the background media 1920L can indicate one of a comminuted, greenstick, and angulated fracture. In the illustrated embodiment of FIG. 19M, the background media 1920M can indicate an unaligned fractured bone. In the illustrated embodiment of FIG. 19P, the background media 1920P can indicate a proper or improper splinting by showing, for example, tightness, bruising, and/or rash.

FIG. 19Q illustrates another exemplary countdown point interface 1900Q, according to a fracture management training embodiment. As shown, the countdown point interface 1900Q depicts a medical test for fracture management in which the user is prompted to “Select the area(s) on this splint where padding is necessary.” The countdown point interface 1900Q can be implemented in, for example, the device 102 (FIG. 1). In various embodiments, the processor 104 (FIG. 1) can display the countdown point interface 1900Q on the display 116 (FIG. 1). As shown, the countdown point interface 1900Q includes a tool interface 1905Q, instructions 1910Q, a plurality of selectable media 1915Q, and a countdown 1927Q. Although various portions of the countdown point interface 1900Q are shown, a person having ordinary skill in the art will appreciate that the portions can be rearranged, portions can be omitted, and/or additional portions can be added.

The tool interface 1905Q serves to provide navigation, for example to a main menu and/or to one or more other medical training and/or testing interfaces described herein. The instructions 1910Q serve to instruct the user on how to interact with the countdown point interface 1900Q. The one or more selectable media 1915Q represent potential locations on the background media 1920Q for placement of splint padding. The countdown 1927Q serves to indicate a number of remaining selections. In the illustrated embodiment, there are six locations that the user is to select in order to answer correctly. In some embodiments, the countdown point interface 1900Q is similar to a multi-point interface described herein, with no submit button and with an additional countdown indication.

FIGS. 19R-19T illustrate exemplary drag-and-drop interfaces 1900R-1900T, according to various embodiments. As shown, the drag-and-drop interfaces 1900R-1900T depict medical tests for fracture management training. The drag-and-drop interfaces 1900R-1900T can be implemented in, for example, the device 102 (FIG. 1). In various embodiments, the processor 104 (FIG. 1) can display the drag-and-drop interfaces 1900R-1900T on the display 116 (FIG. 1). As shown, the drag-and-drop drop interfaces 1900R-1900T include tool interfaces 1905R-1905T, instructions 1910R-1910T, a plurality of movable media 1915R-1915T, a background image 1920R-1920T, and one or more correct answer regions 1925R-1925T. Although various portions of the drag-and-drop interfaces 1900R-1900T are shown, a person having ordinary skill in the art will appreciate that the portions can be rearranged, portions can be omitted, and/or additional portions can be added.

In some embodiments, the drag-and-drop interfaces 1900R-1900T can operate in a substantially similar manner as the drag-and-drop interface 900A, described above with respect to FIG. 9A. For example, the tool interfaces 1905R-1905T, instructions 1910R-1910T, plurality of movable media 1915R-1915T, background image 1920R-1920T, and one or more correct answer regions 1925R-1925T can operate in a substantially similar manner as the tool interface 905A, instructions 910A, plurality of movable media 915A, background image 920A, and one or more correct answer regions 925A of FIG. 9A. In some embodiments, the drag-and-drop interfaces 1900R-1900T can be a parameterized version of a template drag-and-drop interface, customized for fracture management training and/or testing, as can be seen in the particulars of FIGS. 19R-18T.

In the illustrated embodiment of FIG. 19T, the background media 1920T indicates potential locations for placement of a splint and cravats.

FIG. 19U illustrates an exemplary slider interface 1900U, according to an embodiment. As shown, the slider interface 1900U depicts a medical test for fracture management training. The slider interface 1900U can be implemented in, for example, the device 102 (FIG. 1). In various embodiments, the processor 104 (FIG. 1) can display the slider interface 1900U on the display 116 (FIG. 1). As shown, the slider interface 1900U includes a tool interface 1905U, instructions 1910U, a background image 1920U, a slider area 1925U, a slider indicator 1927U, and a submit button 1930U. Although various portions of the slider interface 1900U are shown, a person having ordinary skill in the art will appreciate that the portions can be rearranged, portions can be omitted, and/or additional portions can be added.

In some embodiments, the slider interface 1900U can operate in a substantially similar manner as the slider interface 1100A, described above with respect to FIG. 11A. For example, the tool interface 1905U, instructions 1910U, background image 1920U, slider area 1925U, slider indicator 1927U, and submit button 1930U can operate in a substantially similar manner as the tool interface 1105A, instructions 1110A, background image 1120A, slider area 1125A, slider indicator 1127A, and submit button 1130A of FIG. 11A. In some embodiments the slider indicator 1927U can indicate a pressure as a percentage of the patient's weight as the user slides a finger in the slider area 1925U. A portion of the background image 1920U can also change as the slider is adjusted. In some embodiments, the slider indicator 1927U can be a portion of the background image 1920A, which can change as the slider is adjusted. In some embodiments, the slider interface 1900U can be a parameterized version of a template slider interface, customized for CPR training and/or testing, as can be seen in the particulars of FIG. 19U.

In the illustrated embodiment of FIG. 19U, the background media 1920U includes an image of a foot in a traction apparatus that moves from left to right as the user engages the slider area 1925U.

FIGS. 19V-19W illustrate exemplary point-and-vibrate interfaces 1900V-1900W, according to various embodiments. As shown, the point-and-vibrate interfaces 1900V-1900W depict medical tests for airway management training. The point-and-vibrate interfaces 1900V-1900W can be implemented in, for example, the device 102 (FIG. 1). In various embodiments, the processor 104 (FIG. 1) can display the point-and-vibrate interfaces 1900V-1900W on the display 116 (FIG. 1). As shown, the point-and-vibrate interfaces 1900V-1900W include tool interfaces 1905V-1905W, instructions 1910V-1910W, background images 1920V-1920W, diagnostic regions 1925V-1925W, diagnostic output 1930V-1930W, and pluralities of selectable media 1915V-1915W. Although various portions of the point-and-vibrate interfaces 1900V-1900W are shown, a person having ordinary skill in the art will appreciate that the portions can be rearranged, portions can be omitted, and/or additional portions can be added.

In some embodiments, the point-and-vibrate interfaces 1900V-1900W can operate in a substantially similar manner as the point-and-vibrate interface 1300A, described above with respect to FIGS. 13A-13G. For example, the tool interfaces 1905V-1905W, instructions 1910V-1910W, background images 1920V-1920W, diagnostic regions 1925V-1925W, diagnostic output 1930V-1930W, and pluralities of selectable media 1915V-1915W can operate in a substantially similar manner as the tool interfaces 1305A-1305G, instructions 1310A-1310G, background images 1320A-1320G, diagnostic regions 1325A-1325G, diagnostic output 1330A-1330G, and pluralities of selectable media 1315A-1315G of FIGS. 13A-13G. In some embodiments, the point-and-vibrate interfaces 1900V-1900W can be a parameterized version of a template point-and-vibrate interface, customized for fracture management training and/or testing, as can be seen in the particulars of FIGS. 19V-19W.

### Drag-and-Gesture

In an embodiment, setting up an interaction for medical training and/or testing data (discussed above with respect to block 240 of FIG. 2) can include setting up a drag-and-gesture interaction. The processor 104 can load one or more parameters for the drag-and-gesture interaction from the memory 106. In an embodiment, the drag-and-gesture interaction can allow a user to drag their fingers on the display 116 in order draw a pathway on screen. In various embodiments, the line drawn can be any color, thickness, or opacity, can use any line shape, and can have start and end points to get the answer correct. In some embodiments start and end points are not needed for a correct answer. In various embodiments, for example, a user can simulate cutting clothing with medical scissors, making an incision, marking patients with a symbol, disinfecting an area with a wipe, crossing out information on a chart, etc.

In an embodiment, loading medical training and/or testing data (discussed above with respect to block 210 of FIG. 2) can include loading information indicating one or more correct start and/or end values (or range or plurality of correct end values) and a drag-and-gesture path. For example, the processor 104 can load a drag-and-gesture path and correct start and/or end values from the memory 106. In other embodiments, the medical training and/or testing data can include an indication of where on the digitizer 118 the drag-and-gesture interaction will be effective. Correct start and/or end values can include, for example, a line or area where the user is to draw.

In an embodiment, loading medical training and/or testing media (discussed above with respect to block 220 of FIG. 2) can include loading one or more background images and instructions. Each background image can represent equipment, actions, responses, and/or configurations related to a medical procedure. The instructions can include text such as, for example, “Apply the instrument correctly,” “Using your index finger, make an incision through the cricothyroid membrane,” “Document on this patient that he had a tourniquet applied,” “Cross out the information that is not a vital sign,” and “Using your index finger, demonstrate the proper pattern for disinfecting the incision site.” In some embodiments, the background image can vary according to a drag-and-gesture position. In some embodiments, the background image can be static, and a foreground image can be varied according to the drag-and-gesture position.

In various embodiments, the medical training and/or testing media can include a background video or image, with or without looping. In various embodiments, the medical training and/or testing media can include hidden images. The processor 104 can cause the display 116 to output the hidden images in response to drag-and-gesture interactions. In various embodiments, the medical training and/or testing media can include explanations for correct and incorrect answers and/or accompanying sounds.

In an embodiment, providing a medical training and/or testing prompt (discussed above with respect to block 230 of FIG. 2) can include displaying the background image and/or the instruction text. For example, the processor 104 can cause the display 116 to output the background image and the instruction text discussed above. In an embodiment, the processor 104 causes the display 116 to output a tutorial illustrating the drag-and-gesture interaction. In an embodiment, the processor 104 can cause the display 116 to flash an image, thereby indicating a drag-and-gesture path.

In an embodiment, the processor 104 can cause the user interface 122 to output audio based on a position or amount of the drag-and-gesture. In an embodiment, the processor 104 can cause the user interface 122 to output an indication of the drag-and-gesture location or amount, for example, as a numerical text overlay, a graphical drag-and-gesture, a varying sound, etc. In some embodiments, the background image can change according to a drag-and-gesture position. In some embodiments, the processor 104 can cause the user interface 122 to output light, sound, and/or vibration based on the specific background image shown and/or drag-and-gesture position.

In an embodiment, receiving the medical training and/or testing interaction (discussed above with respect to block 250 of FIG. 2) can include receiving one or more user drag-and-gesture motions. For example, the processor 104 can receive one or more touch paths from the digitizer 118, which can include a start point and end point. The processor 104 can track an initial touch at a start point, movement of the touch location to an end point, and release of the touch at the end point. The processor 104 can compare the start point to a correct start point or area, can compare the drag-and-gesture path to a correct path or area, and/or can compare the end point to a correct end point or area. The processor 104 can identify a drag-and-gesture region based on the medical training and/or testing data. In an embodiment, the processor 104 can dismiss initial touch locations not corresponding to the drag-and-gesture region. In an embodiment, the processor 104 can associate all touch points in the drag-and-gesture interface 2000A (see FIG. 20A) with the drag-and-gesture.

In an embodiment, evaluating the medical training and/or testing interaction (discussed above with respect to block 260 of FIG. 2) can include identifying user input of a drag-and-gesture path. In an embodiment, when a drag-and-gesture is detected, the processor 104 can cause the display 116 to display subsequent background images (or in reverse, depending on the direction of the drag-and-gesture motion) based on movement along the touch paths. In an embodiment, when the drag-and-gesture is detected, the processor 104 can cause the user interface 122 to output a corresponding sound. In one embodiment, the processor 104 can cause the display 116 to draw a line under the detected touch path.

In an embodiment, the processor 104 can compare the received gesture to a drag-and-gesture interaction template in the memory 106. For example, the processor 104 can determine whether the user has touched a drag-and-gesture region of the medical training and/or testing media. When the processor 104 detects selection of a drag-and-gesture region, the processor 104 can adjust the drag-and-gesture and/or background image based on the end point and/or the path to the end point. For example, the processor 104 can advance or retreat the drag-and-gesture. The processor 104 can track a numerical value representing the drag-and-gesture position.

When the processor 104 detects selection of the submit button, the processor 104 can compare the tracked drag-and-gesture path to the correct path or range of paths obtained from the medical training and/or testing data. When the drag-and-gesture path matches a correct value (or range of correct values), the processor 104 can determine a correct answer. When the drag-and-gesture position does not match the correct value (or range of correct values), the processor 104 can determine an incorrect answer.

When the processor 104 determines that an inaccurate answer has been given, the processor 104 can at least partially reset the medical training and/or testing prompt. For example, the processor 104 can cause the display 116 to display an initial background image. When the processor 104 determines that an inaccurate answer has been given, the processor 104 can cause the display 116 to output an indication that the drag-and-gesture path was incorrect. The indication can be audio, visual, and/or textual. When the processor 104 determines that an inaccurate answer has been given, the processor 104 can cause the display 116 to output an explanation indicating why the selection was incorrect.

When the drag-and-gesture input is within a range of correct drag-and-gesture values, the processor 104 can cause the display 116 to adjust a drag-and-gestured image to a final correct position. For example, a line corresponding to the drag-and-gesture path, when drawn within a range of correct values, can “snap” to the center of the correct values. In various embodiments, the drag-and-gesture does not “snap” to the center of correct position.

In an embodiment, when the correct answer has been given, the processor 104 can proceed to a next medical test. The next medical test can be referenced in the medical test data. In some embodiments, when the correct answer has been given, the processor 104 can cause the display 116 to output an indication of a correct selection and/or, or can proceed to a main menu. When the processor 104 determines that an accurate answer has been given, the processor 104 can cause the display 116 to output an explanation indicating why the answer was correct.

FIG. 20A illustrates an exemplary drag-and-gesture interface 2000A, according to a fracture management training embodiment. As shown, the drag-and-gesture interface 2000A depicts a medical test for fracture management in which the user is prompted to “Apply the instrument correctly.” The drag-and-gesture interface 2000A can be implemented in, for example, the device 102 (FIG. 1). In various embodiments, the processor 104 (FIG. 1) can display the drag-and-gesture interface 2000A on the display 116 (FIG. 1). As shown, the drag-and-gesture interface 2000A includes a tool interface 2005A, instructions 2010A, a background image 2020A, and a correct path 2015A, which can be hidden. Although various portions of the drag-and-gesture interface 2000A are shown, a person having ordinary skill in the art will appreciate that the portions can be rearranged, portions can be omitted, and/or additional portions can be added. For example, in some embodiments, the drag-and-gesture interface 2000A can include a drag-and-gesture region (not shown).

The tool interface 2005A serves to provide navigation, for example to a main menu and/or to one or more other medical training and/or testing interfaces described herein. The instructions 2010A serve to instruct the user on how to interact with the drag-and-gesture interface 2000A. The background image 2020A provides context for the drag-and-gesture interface 2000A. In the illustrated embodiment, the background image 2020A depicts a patient with an injured leg, which is covered with pants that are cut away as the user follows the correct path 2015A with the illustrated instrument (scissors).

### Triage

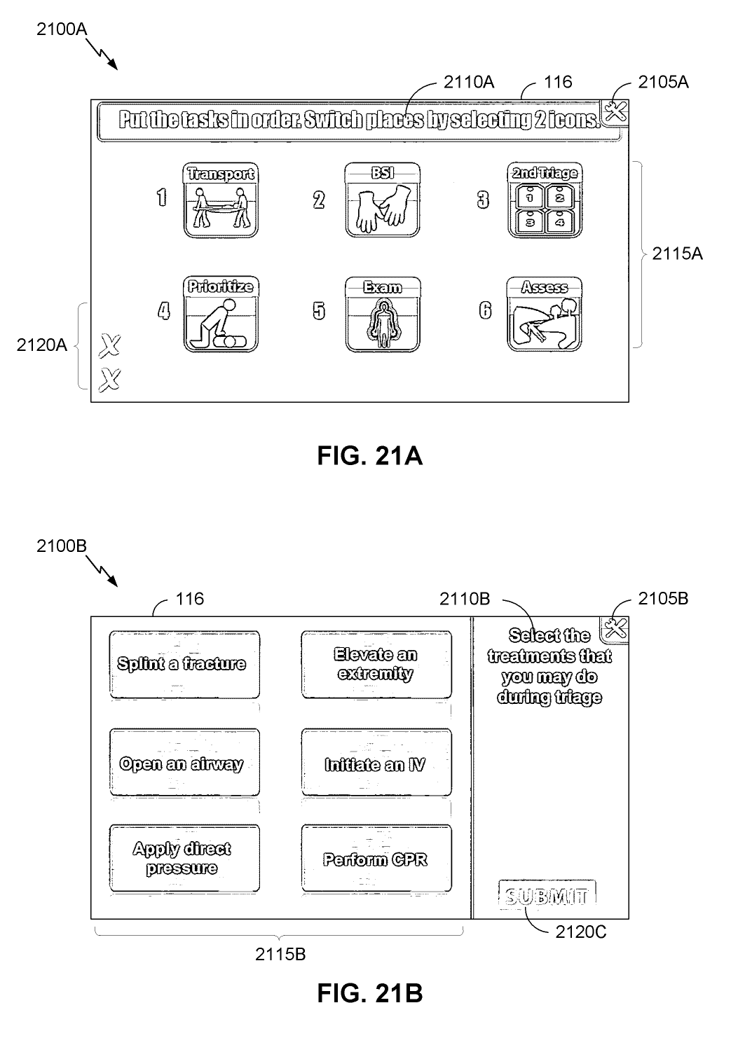

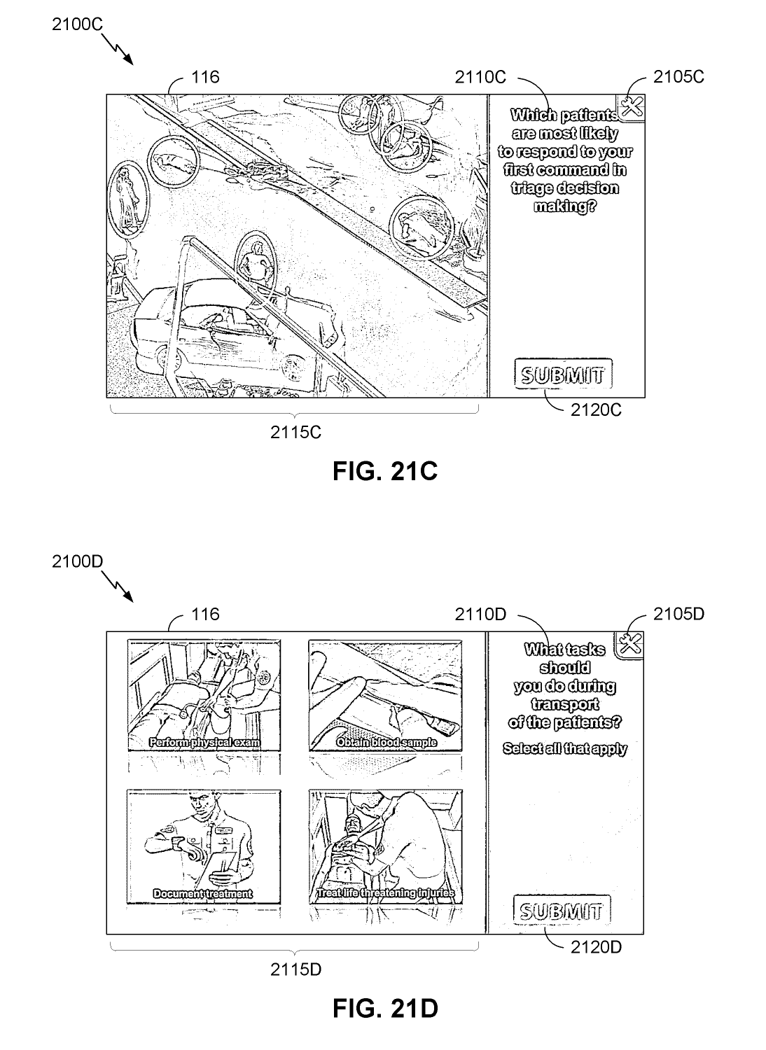

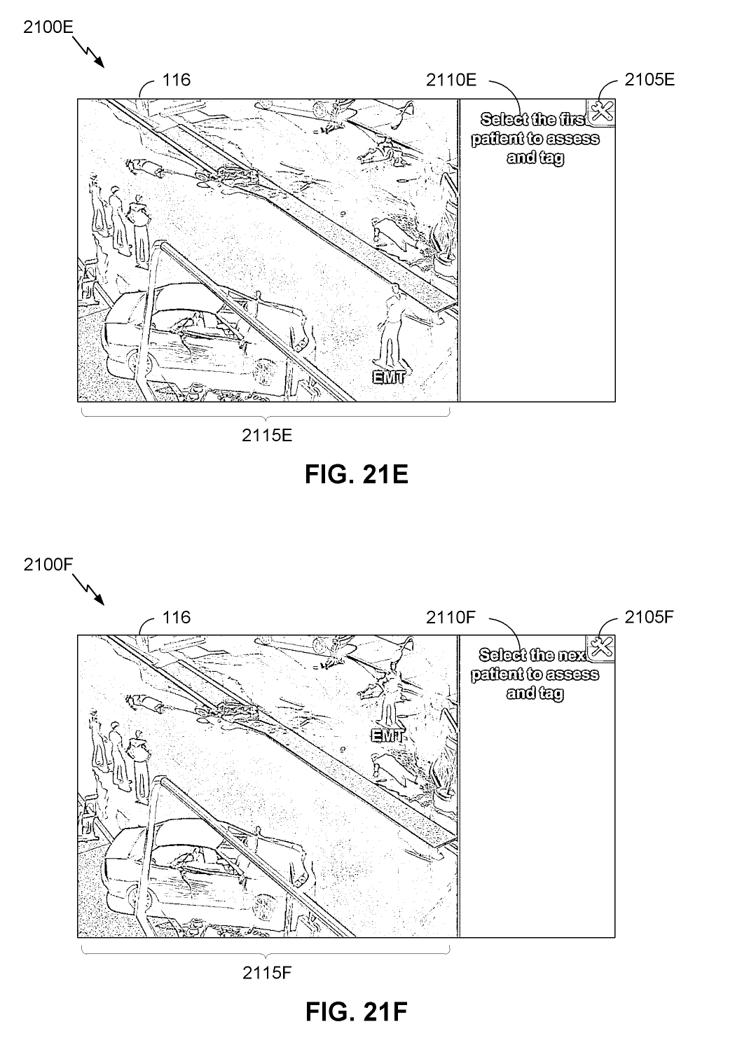

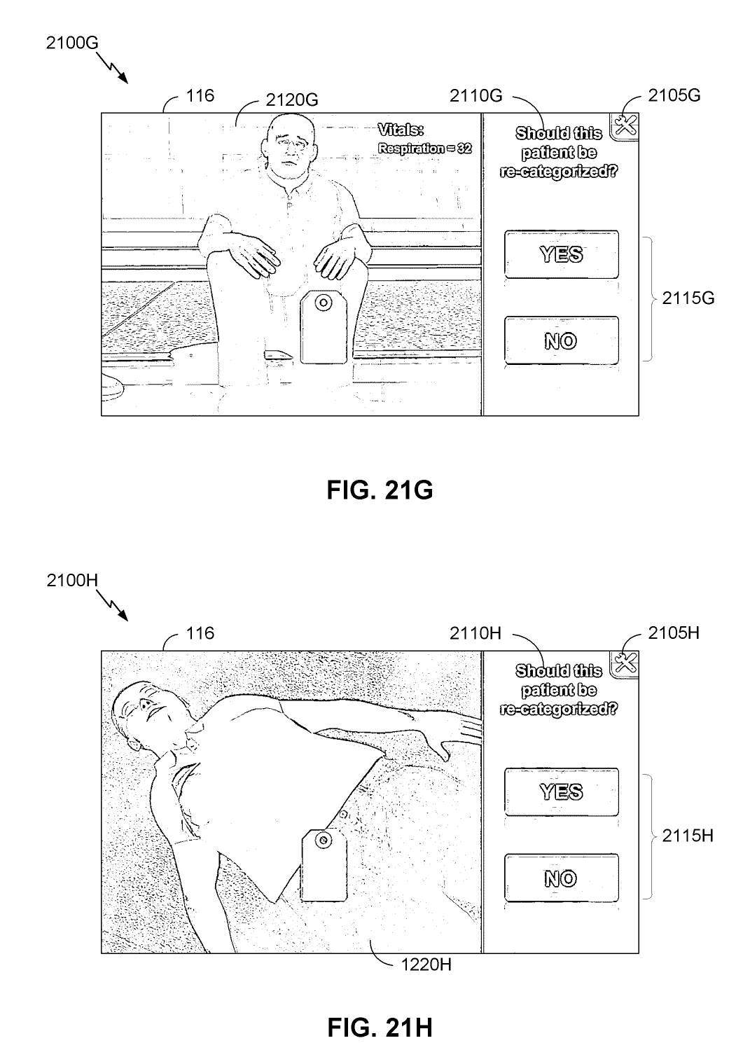

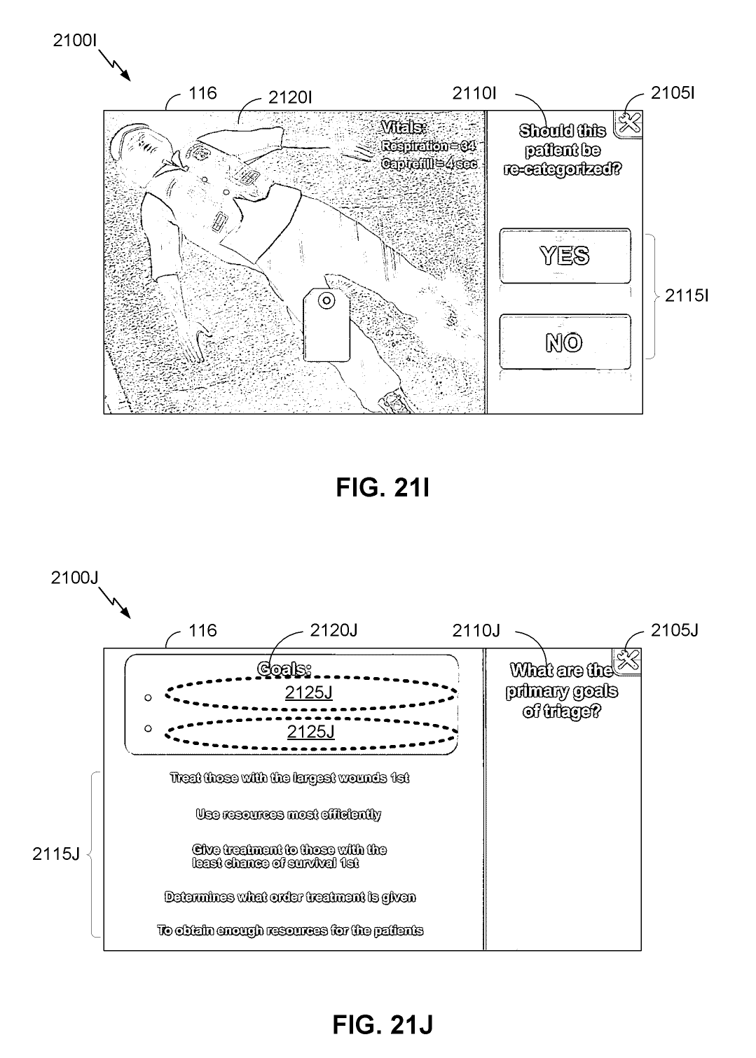

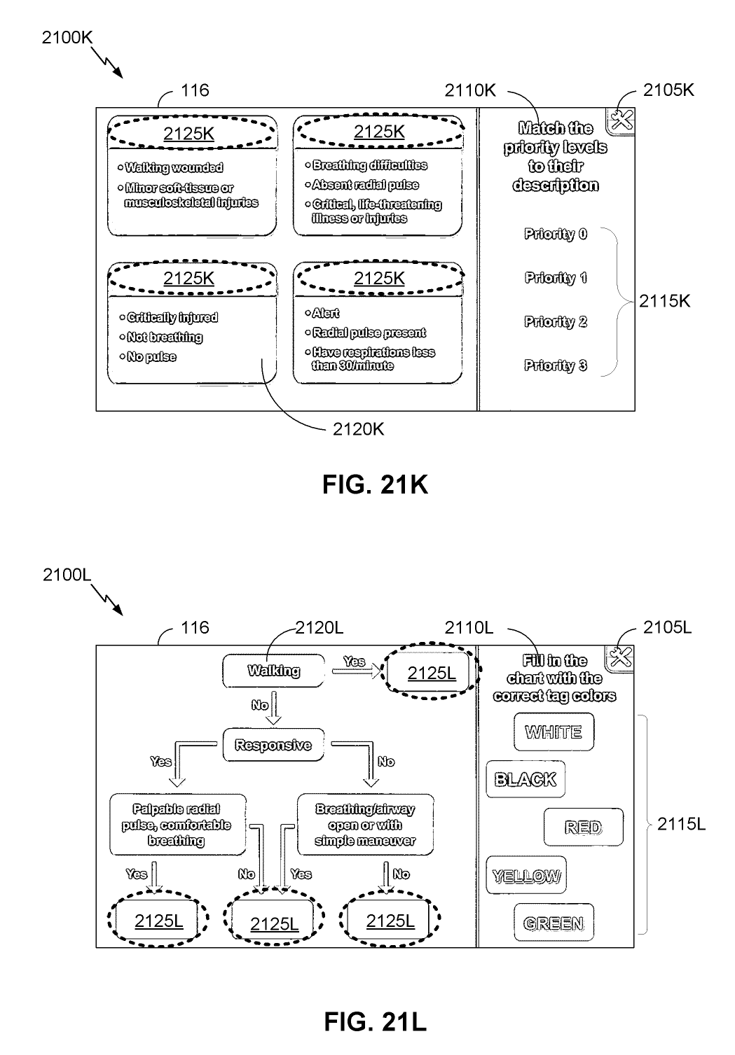

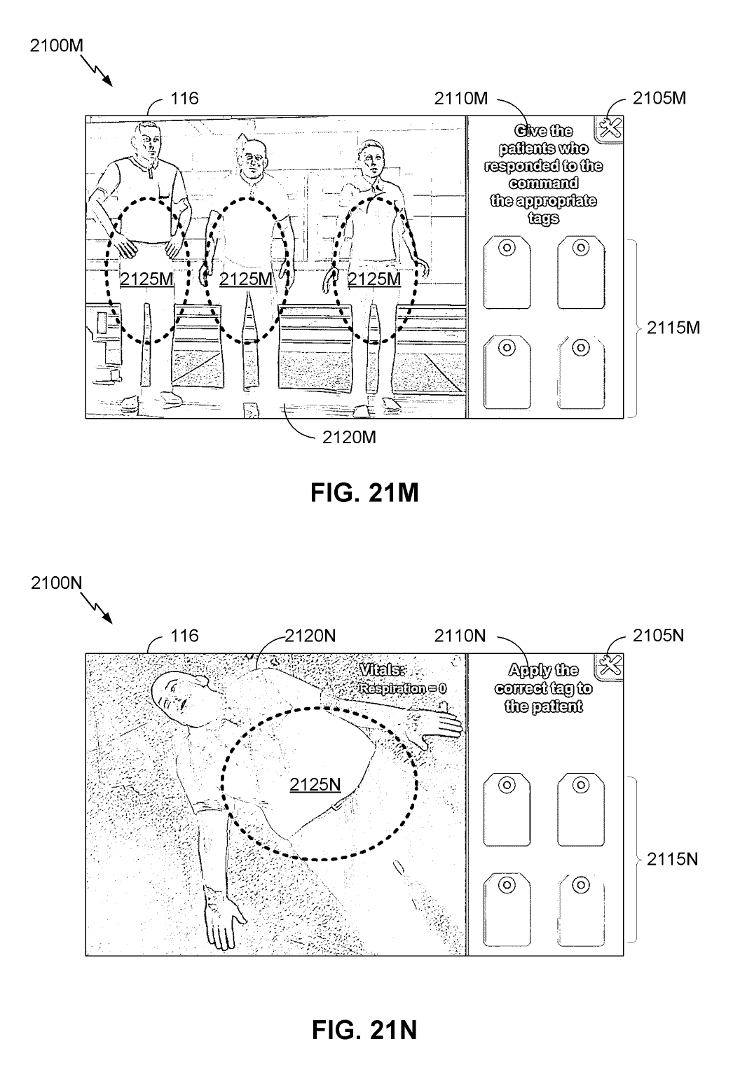

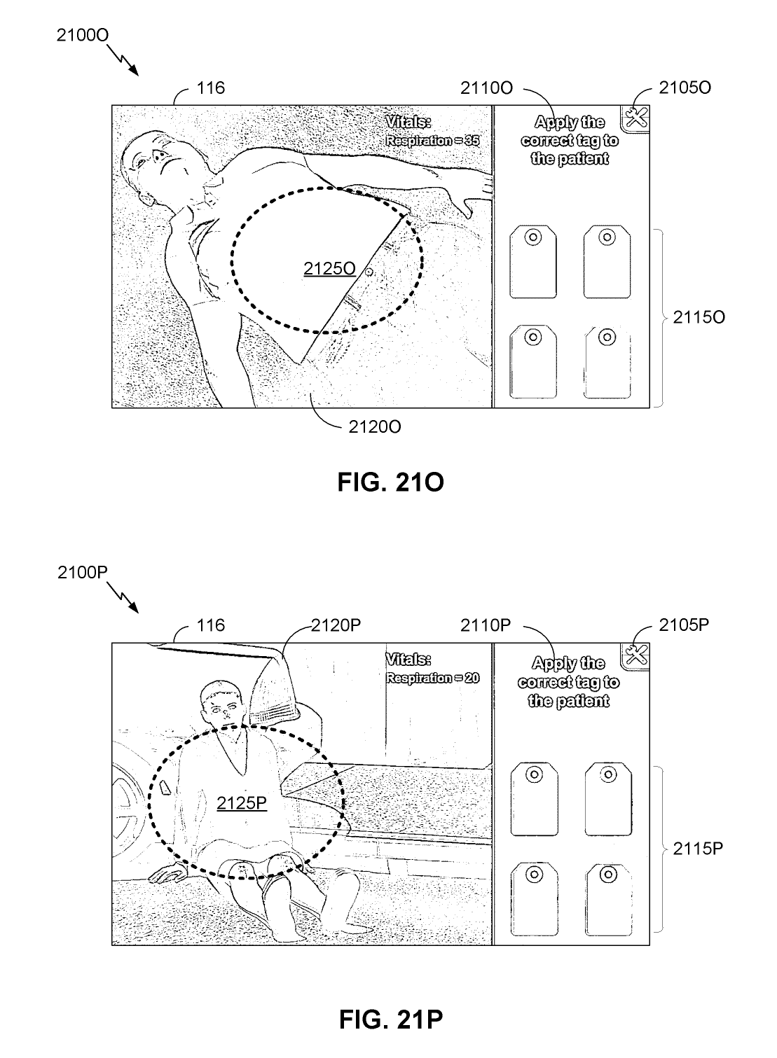

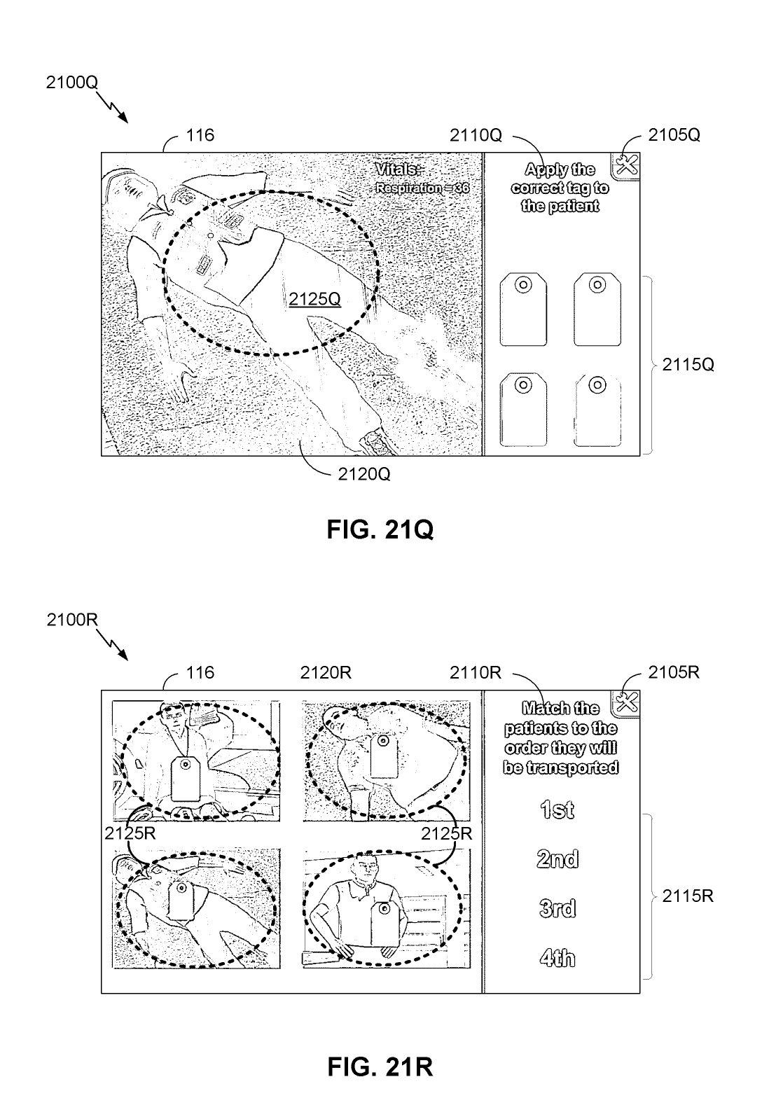

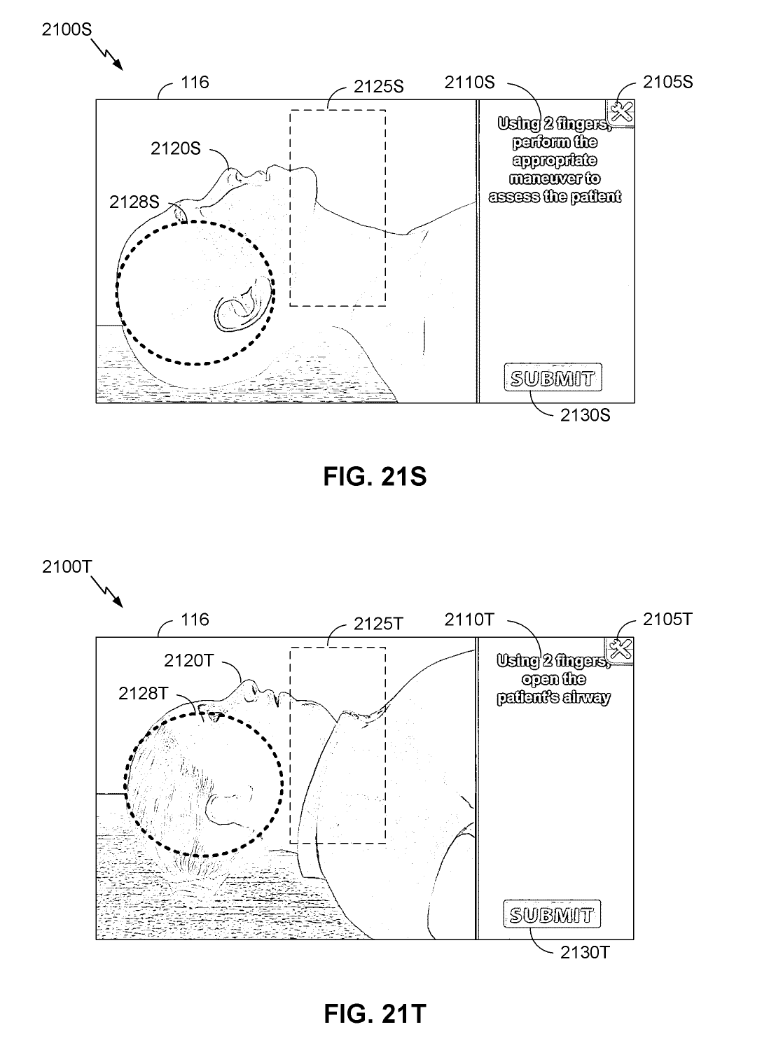

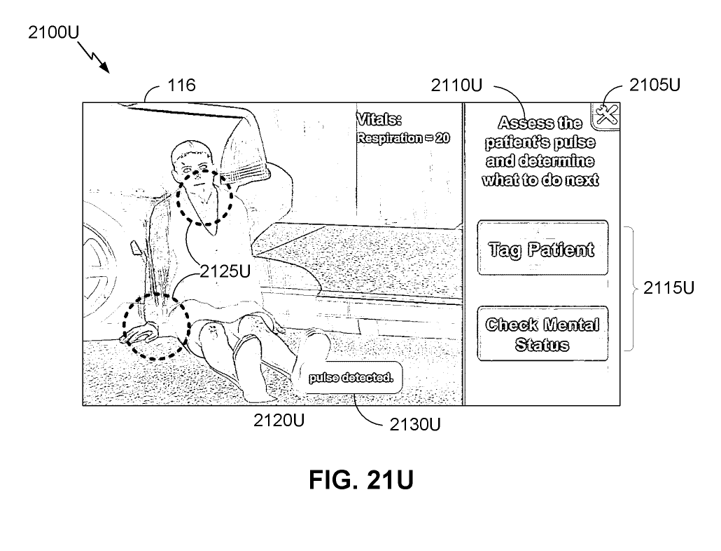

In various embodiments, the device 102 can be configured to provide medical training and/or testing for triage. For example, the medical training and/or testing data, medical training and/or testing media, medical training and/or testing prompt, and medical training and/or testing interactions, described above with respect to FIG. 1, can relate to training and testing for triage. In various embodiments, setting up the interaction for triage testing can include setting up one or more gestures such as image swap, multi-choice point, point, drag-and-drop, point-and-vibrate, and point-and-hold gestures. Although particular exemplary gestures and interfaces are described herein with respect to triage training and/or testing, any other compatible gesture or interface described herein (including those described with respect to other fields of medical training and/or testing) can be applied to triage training and/or testing. FIGS. 21A-21U illustrate exemplary interfaces for triage training and/or testing, according to various embodiments.

FIG. 21A illustrates an exemplary image swap interface 2100A, according to another embodiment. As shown, the image swap interface 2100A depicts a medical test for triage in which the user is prompted to “Put the tasks in order. Switch places by selecting 2 icons.” The image swap interface 2100A can be implemented in, for example, the device 102 (FIG. 1). In various embodiments, the processor 104 (FIG. 1) can display the image swap interface 2100A on the display 116 (FIG. 1). As shown, the image swap interface 2100A includes a tool interface 2105A, instructions 2110A, a plurality of medical task icons 2115A (6 shown), and incorrect answer icons 2120A. Although various portions of the image swap interface 2100A are shown, a person having ordinary skill in the art will appreciate that the portions can be rearranged, portions can be omitted, and/or additional portions can be added.

In some embodiments, the image swap interface 2100A can operate in a substantially similar manner as the image swap interface 600A, described above with respect to FIG. 6A. For example, the tool interface 2105A, instructions 2110A, plurality of medical task icons 2115A, and incorrect answer icons 2120A can operate in a substantially similar manner as the tool interface 605A, instructions 610A, plurality of medical task icons 615A, and incorrect answer icons 620A of FIG. 6A. In some embodiments, the image swap interface 2100A can be a parameterized version of a template image swap interface, customized for triage training and/or testing. Icons 2115A particularly suitable for triage testing and training are shown in FIG. 21A

FIGS. 21B-21D illustrate exemplary multi-choice point interfaces 2100B-2100D, according to various embodiments. As shown, the multi-choice point interfaces 2100B-2100D depict medical tests for triage training. The multi-choice point interfaces 2100B-2100D can be implemented in, for example, the device 102 (FIG. 1). In various embodiments, the processor 104 (FIG. 1) can display the multi-choice point interfaces 2100B-2100D on the display 116 (FIG. 1). As shown, the multi-choice point interfaces 2100B-2100D include tool interfaces 2105B-2105D, instructions 2110B-2110D, pluralities of selectable media 2115B-2115D, and submit buttons 2120B-2120D. Although various portions of the multi-choice point interfaces 2100B-2100D are shown, a person having ordinary skill in the art will appreciate that the portions can be rearranged, portions can be omitted, and/or additional portions can be added.

In some embodiments, the multi-choice point interfaces 2100B-2100D can operate in a substantially similar manner as the multi-choice point interface 700A, described above with respect to FIG. 7A. For example, tool interfaces 2105B-2105D, instructions 2110B-2110D, pluralities of selectable media 2115B-2115D, and submit buttons 2120B-2120D can operate in a substantially similar manner as the tool interface 705A, instructions 710A, plurality of selectable media 715A, and submit button 720A of FIG. 7A. In some embodiments, the multi-choice point interfaces 2100B-2100D can be parameterized versions of a template multi-choice point interface, customized for triage training and/or testing, as can be seen in the particularized instructions 2110B-2110D and selectable media 2115B-2115D.

FIGS. 21E-21I illustrate exemplary single-choice point interfaces 2100E-21001, according to various embodiments. As shown, the single-choice point interfaces 2100E-2100I depict medical tests for triage training. The single-choice point interfaces 2100E-2100I can be implemented in, for example, the device 102 (FIG. 1). In various embodiments, the processor 104 (FIG. 1) can display the single-choice point interfaces 2100E-2100I on the display 116 (FIG. 1). As shown, the single-choice point interfaces 2100E-2100I include tool interfaces 2105E-2105I, instructions 2110E-2110I, and pluralities of selectable media 2115E-2115I. Although various portions of the single-choice point interfaces 2100E-2100I are shown, a person having ordinary skill in the art will appreciate that the portions can be rearranged, portions can be omitted, and/or additional portions can be added.

In some embodiments, the single-choice point interfaces 2100E-2100I can operate in a substantially similar manner as the single-choice point interface 800A, described above with respect to FIG. 8A. For example, tool interfaces 2105E-2105I, instructions 2110E-2110I, and pluralities of selectable media 2115E-2115I can operate in a substantially similar manner as the tool interface 805A, instructions 810A, and plurality of selectable media 815A of FIG. 8A. In some embodiments, the single-choice point interfaces 2100E-2100I can be parameterized versions of a template single-choice point interface, customized for triage training and/or testing, as can be seen in the particularized instructions 2110E-2110I and selectable media 2115E-2115I.

In some embodiments, single-choice point interfaces can include background media, which can include static or moving images (with or without looping). For example, the single-choice point interfaces 2100G-2100I shown in FIGS. 21G-21I include background media 2120G-2120I, respectively. In the illustrated embodiments of FIGS. 21G-21I, the background media 2120G-2120I can indicate a condition of a patient such as, for example, vital signed (e.g., a respiration rate, a cap refill rate, a current triage tag, an alertness, etc.). In some cases, the selectable media 2115G-2115I represent textual answer choices to questions posed in the instruction. In other cases, the selectable media 2115E-2115F include images components.

FIGS. 21J-21R illustrate exemplary drag-and-drop interfaces 2100J-2100R, according to various embodiments. As shown, the drag-and-drop interfaces 2100J-2100R depict medical tests for triage training. The drag-and-drop interfaces 2100J-2100R can be implemented in, for example, the device 102 (FIG. 1). In various embodiments, the processor 104 (FIG. 1) can display the drag-and-drop interfaces 2100J-2100R on the display 116 (FIG. 1). As shown, the drag-and-drop interfaces 2100J-2100R include tool interfaces 2105J-2105R, instructions 2110J-2110R, a plurality of movable media 2115J-2115R, a background image 2120J-2120R, and one or more correct answer regions 2125J-2125R. Although various portions of the drag-and-drop interfaces 2100J-2100R are shown, a person having ordinary skill in the art will appreciate that the portions can be rearranged, portions can be omitted, and/or additional portions can be added.

In some embodiments, the drag-and-drop interfaces 2100J-2100R can operate in a substantially similar manner as the drag-and-drop interface 900A, described above with respect to FIG. 9A. For example, the tool interfaces 2105J-2105R, instructions 2110J-2110R, plurality of movable media 2115J-2115R, background image 2120J-2120R, and one or more correct answer regions 2125J-2125R can operate in a substantially similar manner as the tool interface 905A, instructions 910A, plurality of movable media 915A, background image 920A, and one or more correct answer regions 925A of FIG. 9A. In some embodiments, the drag-and-drop interfaces 2100J-2100R can be a parameterized version of a template drag-and-drop interface, customized for triage training and/or testing, as can be seen in the particulars of FIGS. 21J-21R.

In the illustrated embodiments of FIGS. 21M-21R, the background media 2120M-2120R can indicate a condition of one or more patients such as, for example, an alertness, a standing posture, a reclining posture, a sitting posture, a respiration rate, etc. The movable media 2115M-2115Q of FIGS. 21M-21Q represent tags of different colors representing different priority levels for treatment.

FIGS. 21S-21T illustrate exemplary two-finger slider interfaces 2100S-2100T, according to various embodiments. As shown, the two-finger slider interfaces 2100S-2100T depict medical tests for triage in which the user is prompted to “Using 2 fingers, perform the appropriate maneuver to assess the patient,” or “Using 2 fingers, open the patient's airway.” The two-finger slider interfaces 2100S-2100T can be implemented in, for example, the device 102 (FIG. 1). In various embodiments, the processor 104 (FIG. 1) can display the two-finger slider interfaces 2100S-2100T on the display 116 (FIG. 1). As shown, the two-finger slider interfaces 2100S-2100T include tool interfaces 2105S-2105T, instructions 2110S-2110T, background images 2120S-2120T, slider areas 2125S-2125T, static regions 2128S-2128T, and submit buttons 2130S-2130T. Although various portions of the two-finger slider interfaces 2100S-2100T are shown, a person having ordinary skill in the art will appreciate that the portions can be rearranged, portions can be omitted, and/or additional portions can be added.

In some embodiments, the two-finger slider interfaces 2100M can operate in a substantially similar manner as the slider interfaces 1100A, described above with respect to FIG. 11A. For example, the tool interfaces 2105S-2105T, instructions 2110S-2110T, background image 2120S-2120T, slider area 2125S-2125T, and submit button 2130S-2130T can operate in a substantially similar manner as the tool interfaces 1105S-1105R, instructions 1110S-1110R, background image 1120S-1120R, slider area 1125S-1125R, and submit button 1130S-1130R of FIG. 11A. In various embodiments, the static regions 2128S-2128T each serve to designate an area, which can be shown or hidden from view, which the user is to touch in order for the slider interfaces to work. In other words, the processor 104 can activate the slider area 2125S-2125T while input is received within the static regions 2128S-2128T, and can deactivate the slider areas 2125S-2125T while there is no input within the static regions 2128S-2128T. Accordingly, a user is to touch within the static regions 2128S-2128T while swiping within the slider areas 2125S-2125T. In some embodiments, the multiple slider interfaces 2100M can be a parameterized version of a template multiple slider interfaces, customized for triage training and/or testing.

FIG. 21U illustrate an exemplary point-and-vibrate interface 2100U, according to an embodiment. As shown, the point-and-vibrate interface 2100U depicts a medical test for triage training. The point-and-vibrate interface 2100U can be implemented in, for example, the device 102 (FIG. 1). In various embodiments, the processor 104 (FIG. 1) can display the point-and-vibrate interface 2100U on the display 116 (FIG. 1). As shown, the point-and-vibrate interface 2100U includes a tool interface 2105U, instructions 2110U, a background image 2120U, diagnostic regions 2125U, diagnostic output 2130U, and a plurality of selectable media 2115U. Although various portions of the point-and-vibrate interface 2100U are shown, a person having ordinary skill in the art will appreciate that the portions can be rearranged, portions can be omitted, and/or additional portions can be added.

In some embodiment, the point-and-vibrate interface 2100U can operate in a substantially similar manner as the point-and-vibrate interface 1300A, described above with respect to FIG. 13A. For example, the tool interface 2105U, instructions 2110U, background image 2120U, diagnostic regions 2125U, diagnostic output 2130U, and plurality of selectable media 2115U can operate in a substantially similar manner as the tool interface 1305A, instructions 1310A, background image 1320A, diagnostic regions 1325A, diagnostic output 1330A, and pluralities of selectable media 1315A of FIG. 13A. In some embodiment, the point-and-vibrate interface 2100U can be a parameterized version of a template point-and-vibrate interface, customized for triage training and/or testing, as can be seen in the particulars of FIGS. 21U.

Although various input areas, regions, and portions (for example, selectable media, slider areas, etc.) are shown herein as circles and rectangles, a person having ordinary skill in the art will appreciate that any shapes, vectors, or combinations of pixels, contiguous or non-contiguous, can be used. For example, in various embodiments, the processor 104 (FIG. 1) can load the input areas from the memory 106 (FIG. 1) as one or more color maps, which can be included in medical training and/or testing data or media.

It should be understood that any reference to an element herein using a designation such as “first,” “second,” and so forth does not generally limit the quantity or order of those elements. Rather, these designations can be used herein as a convenient wireless device of distinguishing between two or more elements or instances of an element. Thus, a reference to first and second elements does not mean that only two elements can be employed there or that the first element can precede the second element in some manner. Also, unless stated otherwise a set of elements can include one or more elements.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein can be implemented as electronic hardware (e.g., a digital implementation, an analog implementation, or a combination of the two, which can be designed using source coding or some other technique), various forms of program or design code incorporating instructions (which can be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-9 can be implemented within or performed by an integrated circuit (IC), an access terminal, or an access point. The IC can include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and can execute codes or instructions that reside within the IC, outside of the IC, or both. The logical blocks, modules, and circuits can include antennas and/or transceivers to communicate with various components within the network or within the device. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. The functionality of the modules can be implemented in some other manner as taught herein. The functionality described herein (e.g., with regard to one or more of the accompanying figures) can correspond in some aspects to similarly designated “means for” functionality in the appended claims.

If implemented in software, the functions can be stored on or transmitted over as one or more instructions or code on a computer-readable medium. The steps of a method or algorithm disclosed herein can be implemented in a processor-executable software module which can reside on a computer-readable medium. Computer-readable media includes both computer storage media and communication media including any medium that can be enabled to transfer a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and instructions on a machine readable medium and computer-readable medium, which can be incorporated into a computer program product.

It is understood that any specific order or hierarchy of steps in any disclosed process is an example of a sample approach. Based upon design preferences, it is understood that the specific order or hierarchy of steps in the processes can be rearranged while remaining within the scope of the present disclosure. The accompanying method claims present elements of the various steps in a sample order, and are not meant to be limited to the specific order or hierarchy presented.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of providing interactive medical procedure testing on a mobile touchscreen device, comprising:
providing a medical training and/or testing prompt on the device indicating equipment and/or procedures for one or more of: administering oxygen to a patient, performing cardiopulmonary resuscitation (CPR), performing airway management, managing shock, managing spinal cord injury, managing fracture, and performing triage;
receiving a medical training and/or testing interaction in response to the medical training and/or testing prompt;
evaluating the medical training and/or testing interaction; and
adjusting a characteristic of the device based on said evaluating.

2. The method of claim 1, further comprising loading medical training and/or testing data.

3. The method of claim 2, wherein the medical training and/or testing data comprises one or more parameters for evaluating the medical training and/or testing interaction.

4. The method of claim 2, wherein the medical training and/or testing data comprises one or more of: a reference to medical training and/or testing media, a location of medical training and/or testing media, a gesture profile, information indicative of a correct ordering for one or more icons for an image swap interface, information indicative of a one or more correct selections for a multi-choice interface, information indicative of a single correct selection for a single-choice point interface, information indicative of one or more correct placement locations for a drag-and-drop interface, information indicative of one or more correct rotations or rotation angles for a rotation interface, information indicative of one or more correct end values for a slider interface, one or more static regions for a slider interface, and one or more diagnostic regions for a point-and-vibrate interface.

5. The method of claim 1, further comprising loading medical training and/or testing media.

6. The method of claim 5, wherein the medical training and/or testing media comprises one or more of an introductory video, one or more color maps, one or more still images, audio, and a vibration pattern.

7. The method of claim 5, wherein the medical training and/or testing media comprises one or more of: image swap icons, medical training and/or testing instructions, a background video or image, one or more hidden images, medical training and/or testing instructions, one or more selectable media, one or more movable images, and one or more rotatable images,
wherein the medical training and/or testing media represents equipment, actions, responses, and/or configurations related to administering CPR to a patient.

8. The method of claim 1, wherein providing the medical training and/or testing prompt comprises displaying medical training and/or testing media.

9. The method of claim 1, wherein providing the medical training and/or testing prompt comprises providing one or more of: an image swap interface, a multi-choice point interface, a single-choice point interface, a drag-and-drop interface, a rotate interface, a slider interface, a two-finger slider interface, and a point-and-vibrate interface.

10. The method of claim 1, further comprising setting up the medical training and/or testing interaction.

11. The method of claim 10, wherein setting up the medical training and/or testing interaction comprises displaying medical training and/or testing media, setting a starting image from one or more parameters, and setting up a gesture detection.

12. The method of claim 11, wherein setting up the gesture detection comprises adding one or more event listeners for one or more touch events, detecting one or more finger coordinates, and storing the one or more finger coordinates.

13. The method of claim 1, wherein receiving the medical training and/or testing interaction comprises one or more of: receiving one or more user selections or multi-selection gestures, receiving a single user selection or a single-selection gesture, and receiving one or more user swipes or swipe gestures.

14. The method of claim 1, wherein evaluating the medical training and/or testing interaction comprises adjusting the medical training and/or testing prompt based on the medical training and/or testing interaction, and comparing the medical training and/or testing interaction to a correct response.

15. The method of claim 14, wherein adjusting the medical training and/or testing prompt based on the medical training and/or testing interaction comprises one or more of: swapping the location of two icons, highlighting one or more selections, moving one or more images, rotating one or more images, advancing or reversing a displayed image in a series of images, adjusting a slider, adjusting a slider indicator, and beginning, ending, or adjusting a diagnostic output.

16. The method of claim 14, wherein comparing the medical training and/or testing interaction to a correct response comprises one or more of: comparing one or more input locations to a diagnostic region; comparing one or more input locations to a static region, comparing one or more selected images to one or more correct selections, comparing an ordering of icons to a correct ordering, comparing a position of one or more images to one or more correct regions, comparing a rotation angle of an image to a correct rotation angle, range of rotation angles, or set of correct rotation angles, and comparing a slider value to a correct slider value, range of slider values, or set of slider values.

17. The method of claim 1, wherein adjusting a characteristic of the device comprises one or more of: maintaining a tally of correct and/or incorrect responses, weighting one or more correct and/or incorrect responses and maintaining a weighted score, determining an overall passage or failure based on the tally or weighted score, providing a reward or prize based on passage or failure, displaying a message on a display, storing a result in a memory, transmitting a message via a transmitter, vibrating the device using a vibrator, and playing a sound via a speaker of a user interface.

18. A mobile touchscreen device configured to provide interactive medical procedure testing, comprising:
a display, processor and memory configured to provide a medical training and/or testing prompt indicating equipment and/or procedures for one or more of: administering oxygen to a patient, performing cardiopulmonary resuscitation (CPR), performing airway management, managing shock, managing spinal cord injury, managing fracture, and performing triage;
an input configured to receive a medical training and/or testing interaction in response to the medical training and/or testing prompt; and
wherein the display, processor, and memory are configured to evaluate the medical training and/or testing interaction, and adjust a characteristic of the device based on said evaluating.

19. The device of claim 18, wherein the display, processor, and memory are further configured to load medical training and/or testing data.

20. A non-transitory computer-readable medium comprising code that, when executed, causes a mobile touchscreen device to:
provide a medical training and/or testing prompt indicating equipment and/or procedures for one or more of: administering oxygen to a patient, performing cardiopulmonary resuscitation (CPR), performing airway management, managing shock, managing spinal cord injury, managing fracture, and performing triage;
receive a medical training and/or testing interaction in response to the medical training and/or testing prompt;
evaluate the medical training and/or testing interaction; and
adjust a characteristic of the device based on said evaluating.
